(19) United States
(12) Patent Application Publication
(10) Pub. No.: US 2015/0248387 A1
(43) Pub. Date: Sep. 3, 2015

(54) System for sharing annotation overlays

(71) Applicants: William E. Mattingly, Chicago, IL (US); Kenneth Arthur Wallace, Windermere, FL (US)

(72) Inventors: William E. Mattingly, Chicago, IL (US); Kenneth Arthur Wallace, Windermere, FL (US)

(21) Appl. No.: 14/121,081

(22) Filed: Jul. 29, 2014

Related U.S. Application Data
(63) Continuation-in-part of application No. 13/999,474, filed on Feb. 28, 2014.

(51) Int. Cl. G06F 17/24; G09G 5/377; H04L 29/08; G06Q 50/18

(52) U.S. Cl. CPC G06F 17/241; G06Q 50/184; G09G 5/377; H04L 67/10

(57) ABSTRACT

This application is for an electronic annotation system for annotating (by text, picture, or video) electronic digital content and sharing the annotations as an account owner with third parties without violating any copyrights of the digital content owner. Rather than sharing the electronically annotated digital content with third parties, only an overlay with the electronic annotation is shared with third parties as an account owner. The third parties must have their own legally obtained copy of the digital content. The third parties can open the annotation and independently access the underlying digital content, thereby spatially integrating the two on the third parties' computer screens.

### CROSS REFERENCE TO RELATED APPLICATIONS

This application is a continuation-in-part of U.S. patent application Ser. No. 13/299,474, filed on Feb. 28, 2014 which claims priority to and claims the benefit of U.S. Provisional Patent Application No. 61/852,265, filed on Mar. 15, 2013.

### COMPUTER APPENDIX

This application includes a Computer Listing Appendix on compact disc, hereby incorporated by reference.

### BACKGROUND OF THE INVENTION

1. Field of the Invention

The present invention relates to an electronic annotation system for reading and annotating electronic digital content and sharing the annotations with third parties and sharing annotations by, and among, the user and third parties (also referred to as a “recipient”) without violating the copyright rights of the digital content owners.

2. Description of the Prior Art

There is a current trend to create a totally paperless information environment. More and more information is being created and served as digital content. Two popular forms of digital content include web pages and electronic books, as defined below. As used herein, the term digital content is intended to refer collectively and individually to web pages and electronic books, for example, as defined below.

Web pages are fairly standard files and consist of plain text with formatting instructions commonly known as Hypertext Markup Language (HTML) or Extensible Markup Language (XML). Web pages are viewed by way of various web browsers, such as, Internet Explorer, Netscape and Firefox.

The format of electronic books is not standard. Various formats for such electronic books are known. Each format requires a specific electronic reader to read its format. As used herein, electronic books in various formats are collectively and individually referred to as an electronic book or an e-book.

The main formats for electronic books are .pdf and .epub formats. Electronic content in .pdf format provides an exact picture of a printed page and is therefore suitable for graphical data. However, the .pdf format does not reflow of the digital content to accommodate the size of the screens upon which the content is displayed. For example, to display a .pdf file on a relatively small display, such as a cell phone display, the digital content comprising a .pdf page is simply shrunk down to fit on the cell phone screen.

Electronic publication file formats, i.e. epub files, are different. The ePub file format is an open non-proprietary standard by the International Digital Publishing Forum (IDPB). A major difference between .pdf files and .epub files deals with a “reflow” characteristic. With .epub files, the content may be “reflowed” to fit on the screen without shrinking the size of the content. For example, assume a .pdf file is displayed as a page on a desktop display. Displaying the same .pdf file on a cell phone display that has 10% of the display area of the desktop display would result in the entire page being displayed at a reduced size. Using the same example for an .epub file, the page may be “reflowed” so that only 10% of the data is displayed on the cell phone without shrinking the size of the file being displayed. Some files, for example, fixed layout files with a paginated layout style may also be formatted as epub files. An example of such a file is a picture or a page of digital content that includes a picture. With such fixed layout files formatted in epub format, there is no reflow of the digital content.

Other electronic book formats are also known. For example, Amazon utilizes a proprietary format identified as a .Mobi format. Such .Mobi files are configured to be displayed on Amazon's Kindle electronic readers.

Unlike web pages, known electronic readers are not interactive. Downloaded digital content can only be read and not annotated. Recently, a need has been developed to electronically annotate such electronic content. However, much of the digital content is protected by US copyright laws. As such, while there is no violation of the US copyright laws for annotating a legally purchased copy of digital content, transferring to or sharing the content with a third party with or without annotations, without permission from the copyright owner may raise an issue with respect to whether the copyright owner's rights have been violated, possibly leading to the copyright owner instituting litigation. This uncertainty creates an impediment to the open sharing of ideas and insights through the use of electronic annotations on copyrighted materials.

As such, various systems are known for enabling annotating legally acquired digital content without the ability to share the digital content or the annotations with a third party. An example of such a system is disclosed in U.S. Pat. No. 7,028,267. The '267 patent discloses technique for annotating an electronic file or electronic book without corruption of the file itself. To create an annotation, a user selects an object in the file to locate where the annotation is to be placed. The computer system determines which object has been selected and determines a file position associated with the selected object. The user adds the annotation and, eventually, returns to reading the file. Annotations may include, but are not limited to, highlighting, making textual notes, drawings, doodles, arrows, underlining, strike-throughs, and the like. The annotations may be filtered, navigated, sorted, and indexed per user input.

The system disclosed in the '267 patent thus allows a user to annotate a personal copy of the digital content without concern about violating the digital content copyright owner's right. Unfortunately, such a system has limited utility in that the annotated content cannot be shared with third parties. As such, various digital annotation systems have been developed that allow the annotated digital content to be shared with third parties. Such digital annotation systems include both web page digital content, electronic books and other forms of digital content. U.S. Pat. Nos. 5,826,025; 6,859,909; and 7,409,633, as well as US Patent Application Publication Nos. US 2008/0250311 A1 and US 2009/0132907 A1 and International Patent Application Publication No. WO 03034292 all disclose systems for electronically annotating web pages that enable sharing with third parties. U.S. Pat. No. 7,028,267 and US Patent Application No. US 2013/0042171 A1 and International Patent Application No. WO 9722109 discloses systems for electronically annotating electronic books that enable sharing with third parties. U.S. Pat. No. 8,364,755 discloses an electronic annotation system for annotating pictures in a yearbook and sharing the annotated copy with third parties. US Patent Application Publication Nos. WE 2009/0132941 and US 2011/0289401 A1 disclose electronic annotation systems for annotating maps and sharing the annotated copy with third parties.

The systems described above allow electronically annotated versions of digital content to be shared with third parties. If the underlying digital content is copyrighted or the copyright owner's permission has not been obtained, sharing of the annotated digital content may raise issues with respect to violations of the copyright owner's rights. As such, these systems have limited utility in that only certain types of files, such as government files, can be legitimately shared. Furthermore, sharing annotated content when the intended recipient of the annotated material also has a licensed copy of the underlying digital content may also be problematic if it involves an unauthorized reproduction of the digital content. Thus, there is a need for a system that overcomes this problem.

### SUMMARY OF THE INVENTION

Briefly, the present invention relates to an electronic annotation system for annotating electronic digital content formatted as fixed layout files in a paginated layout style, such as web pages and certain electronic publications, and sharing the annotations with, and among, third parties without violating any copyrights of the digital content owner. Rather than sharing the electronically annotated digital content with, and among, third parties, only an overlay with the electronic annotation is shared with, and among, third parties, thus avoiding potential issues of copyright infringement. In order to use the overlay, such third parties must have their own legally obtained copy of the digital content in order to integrate the annotations at spatially registered sites on the digital content for viewing.

### DESCRIPTION OF THE DRAWING

These and other advantages of the present invention will be readily understood with reference to the following specification and attached drawing wherein:

FIG. 1 is an exemplary block diagram of the system in accordance with the present invention.

FIG. 2 is an exemplary screen shot of a user log-in and home page.

FIG. 3 is an exemplary screen shot of a user account page.

FIGS. 4-6 are exemplary screen shots of a new web page session.

FIG. 7 is an exemplary screen shot of a web page session illustrating an exemplary web page to be annotated on the right and the instructions for annotating the web page on the left.

FIG. 8 is a screen shot of the web page illustrated in FIG. 7, illustrating a dialogue box for use in annotating the page with text or images after the desired text has been highlighted.

FIG. 9 is a screen shot illustrating the annotated portion of the web page and the name of the annotation.

FIG. 10 is similar to FIG. 9 and illustrates an exemplary dialog box once the share button is depressed.

FIG. 11 is similar to FIG. 10 but illustrating a note filled in in the dialog box illustrated in FIG. 10.

FIG. 12 is an exemplary screen shot of a note received by the recipient to review the annotated web page.

FIG. 13 is an exemplary screen shot of a new ePub session in which the book being annotated has text and images but no chapters.

FIG. 14 is an exemplary screen shot of the new ePub session illustrated in FIG. 13 after the “New EPUB Session” is selected showing the ePub electronic book loading.

FIG. 15 is an exemplary screen shot of an ePub session illustrating a portion of the electronic book on the right side and the annotation instructions on the left.

FIG. 16 is similar to FIG. 15 illustrating the image highlighted.

FIG. 17 is similar to FIG. 16 illustrating a note attached to the highlighted portion of the image.

FIG. 18 is an exemplary screen shot illustrating highlighted text.

FIG. 19 is an exemplary screen shot illustrating a dialog box for annotating the highlighted text or images.

FIG. 20 is an exemplary screen shot illustrating the use of a dialog box for attaching a note to the highlighted text.

FIG. 21 is an exemplary screen shot illustrating a note attached to the highlighted text.

FIG. 22 is an exemplary screen shot illustrating a second note being attached to the book.

FIG. 23 is an exemplary screen shot illustrating the two notes have been attached to the book.

FIG. 24 is an exemplary screen shot illustrating a dialog box for sharing the annotations once the “share” button has been depressed.

FIG. 25 is an exemplary screen shot of a note received by the recipient to review the annotated portion of the book.

FIG. 26 is an exemplary screen shot of a second Epub session with text and chapters but no images.

FIG. 27 is an exemplary screen shot of a of an exemplary Epub book on the right and the instructions for annotating the Epub book on the left.

FIG. 28 is an exemplary screen shot of an exemplary Epub book illustrating a navigation button for annotating.

FIG. 29 is an exemplary screen shot which illustrates an exemplary dialog box which appears after portions of the Epub book are highlighted.

FIG. 30 is an exemplary screen shot which illustrates the name of the annotation in a text box and the highlighted portion of the text.

FIG. 31 is an exemplary screen shot illustrating the annotation after the name of the annotation is selected or the highlighted text is selected.

FIG. 32 is an exemplary screen shot illustrating the dialog box after a “share” button is selected.

FIG. 33 is an exemplary screen shot of an email received by a recipient being invited to view the annotation.

FIG. 34 is an exemplary email invitation to a recipient which includes a URL for an annotated image on a web page.

FIG. 35 is an exemplary web page of the annotated web page sent to the recipient.

FIG. 36 is the exemplary web page illustrated in FIG. 35, shown with the annotation in an exemplary pop-up dialog box.

FIG. 37 is similar to FIG. 34 but for an annotation of an image that is included in an epub file.

FIG. 38 is an exemplary web page of the annotated web page sent to the recipient which includes a “CHOOSE FILE “button for uploading the book from the downloaded files, shown with no books uploaded to the recipient's computer.

FIG. 39 is an exemplary web page which illustrates an exemplary epub file “LLC epub” has been uploaded by the recipient into the web application.

FIG. 40 is an exemplary web page illustrating the selected book and the name of the annotations.

FIG. 41 is an exemplary web page illustrating the annotation in an exemplary pop-up dialogue box.

FIG. 42 is an exemplary email invitation to an annotation recipient which includes a URL for an annotated portion of text from an epub file.

FIG. 43 is an exemplary web page for uploading the book from the downloaded files, shown with no books uploaded to the recipient's computer.

FIG. 44 is an exemplary web page shown after an epub book has been uploaded by the recipient into the web application.

FIG. 45 is an exemplary web page illustrating the name of the annotation and the epub book.

FIG. 46 is an exemplary web page illustrating a highlighted portion of the text of a portion of an epub book.

FIG. 47 is an exemplary web page with an annotation appearing in a pop-up dialogue box.

FIG. 48 illustrates an exemplary web page for web sites with special coding.

FIG. 49 is an exemplary logic flow diagram for adding an annotation to an epub book.

FIG. 50 is similar to FIG. 49 but for a web page.

FIG. 51 is an exemplary logic flow diagram for deleting an annotation from an epub book.

FIG. 52 is an exemplary logic flow diagram for deleting an annotation session with respect to a web page.

FIG. 53 is similar to FIG. 52 but for an epub book.

FIG. 54 is an exemplary logic flow diagram for deleting an annotation from a web page.

FIG. 55 is an exemplary logic flow diagram which illustrates linking an annotation to a name link for an epub book.

FIG. 56 is similar to FIG. 55 but for a web page.

FIG. 57 is an exemplary logic flow diagram for displaying an annotation in a portion of an epub book.

FIG. 58 is similar to FIG. 57 but for a web page.

FIG. 59 is an exemplary logic flow diagram which relates to editing an annotation of a portion of an epub book.

FIG. 60 is similar to FIG. 59 but for a web page.

FIG. 61 is an exemplary logic flow diagram which relates to initiating an annotation session of a portion of an epub book.

FIG. 62 is similar to FIG. 61 except it relates to a web page.

FIG. 63 is an exemplary logic flow diagram which relates to selecting a section of an epub book for display.

FIG. 64 is an exemplary logic flow diagram which relates to displaying shared comments on an epub book with a third party recipient.

FIG. 65 is an exemplary logic flow diagram which relates to displaying a shared annotation of an epub book or web page based upon the selection of a shared link in recipient email.

FIG. 66 is an exemplary logic flow diagram which relates to display the annotation once an annotation link is selected.

FIG. 67 is an exemplary logic flow diagram which relates for creating an email to share annotation with a recipient.

FIG. 68 is an exemplary logic flow diagram which relates to user log-in to the system.

FIG. 69 is an exemplary logic flow diagram which relates to initiating a new annotation session of an epub book.

FIG. 70 is similar to FIG. 69 except it relates to an annotation session of a web page.

FIG. 71 is an exemplary screen shot of an image added to a dialogue box by clicking “Insert/Edit Image” icon and then locate and open picture file on user's computer, shown as an image demo.

FIG. 72 is an exemplary screen shot illustrating an example where the highlighted language has been annotated with the image demo picture with the name of the annotation “USPTO Picture” appearing on the left of the image.

FIG. 73 is an exemplary screen shot of an example in which a video has been added to the dialogue box by clicking “Embed/Movies” icon and then locating and opening a movie file on user's computer, indicated here as “Video Demo 1.”

FIG. 74 is an exemplary screen shot of text being written to illustrate that the hypertext link created by annotating the USPTO website which may now be used in an entirely new text, for example, as a footnote.

FIG. 75 is an exemplary screen shot illustrating an example of Recipient 1 opening an email in their account after the recipient has clicked on a hyperlink to illustrate the exemplary multi-color-coded annotations by user 1, appearing to the left of the image.

FIG. 76 is an exemplary screen shot illustrating an example of recipient 1 opening the “USPTO Picture” annotation or the highlighted content showing the “Image Demo” annotation for viewing.

FIG. 77 is an exemplary screen shot illustrating the screen after recipient 1 opens the “USPTO Movie Annotation Created” or the highlighted text showing the Video Demo 1 annotation for viewing for viewing.

FIG. 78 is an exemplary screen shot illustrating the screen view once recipient 1 opens an email invitation allowing recipient 1 to add new annotations or edits to the user's web page session by, clicking “Edit Annotation (registration required)”

FIG. 79 is an exemplary screen shot illustrating a text edit made by recipient 1 (bchgmatt@gmail.com) to user's sharing of image annotation to the “USPTO” Session.

FIG. 80 is an exemplary screen shot illustrating an image edit made by recipient 1 (bchgmatt@gmail.com) to user's sharing of text annotation to the “USPTO” session.

FIG. 81 is an exemplary screen shot illustrating a video edit made by recipient 1 (bchgmatt@gmail.com) to user's sharing of text annotation to the “USPTO” session.

FIG. 82 is an exemplary screen shot illustrating a text edit made by recipient 1 (bchgmatt@gmail.com) to user's sharing of image annotation to the “USPTO” session.

FIG. 83 is an exemplary screen shot illustrating an image edit made by recipient 1 (bchgmatt@gmail.com) to user's sharing of image annotation to the “USPTO” session.

FIG. 84 is an exemplary screen shot illustrating a video edit made by recipient 1 (bchgmatt@gmail.com) to user's sharing of image annotation to the “USPTO” session.

FIG. 85 is an exemplary screen shot illustrating a text edit made by recipient 1 (bchgmatt@gmail.com) to user's sharing of video annotation to the “USPTO” session.

FIG. 86 is an exemplary screen shot illustrating an image edit made by recipient 1 (bchgmatt@gmail.com) to user's sharing of video annotation to the “USPTO” session.

FIG. 87 is an exemplary screen shot illustrating a video edit made by recipient 1 (bchgmatt@gmail.com) to user's sharing of video annotation to the “USPTO” session.

FIG. 88 is an exemplary screen shot illustrating recipient 1 opening an e-mail invitation which allows recipient 1 to add new annotations or edits to the user's web page session by clicking on the button; “Edit Annotation”.

FIG. 89 is an exemplary screen shot illustrating the addition of a new annotation which allows recipient 1 to select a position on the webpage to which recipient's annotation will apply, wherein selection is color-coded and a box is opened for the addition of text, image or video annotation.

FIG. 90 is an exemplary screen shot of an annotation (which is color-coded) created by recipient 1 which results in one of the following being added to the left of the screen: “Recipient annotation;” “Recipient picture comment;” or “Recipient video comment”.

FIG. 91 is an exemplary screen shot illustrating an example of the user and other recipients viewing recipient 1's text annotation by clicking on black highlighted area or on the “Recipient's Annotation.” User and all Recipients will see Recipient's Annotation.

FIG. 92 is an exemplary screen shot illustrating an example of the user and other recipients viewing recipient 1's image annotation by clicking on black highlighted area or on the “Recipient Picture Comment.”

FIG. 93 is an exemplary screen shot illustrating the highlighted blue language is annotated with the “Video Demo 1” which causes the name of the annotation “USPTO Movies Annotation Created” appears on the left.

FIG. 94 is an exemplary screen shot illustrating recipient 1's video annotation by clicking on black highlighted area or on the “Recipient Video Comment” which allows the user and all recipients will see the Recipient Video Comment.

FIG. 95 is an exemplary screen shot of an example of recipient 2 opening an e-mail invitation to add new annotations or edits to the user's web page session by clicking “Edit Annotation”.

FIG. 96 is an exemplary screen shot illustrating a text edit made by recipient 2 (tropcom@hotmail.com) to recipient 1's (bchgmatt@gmail.com) text edit to the user's sharing of text annotation to “USPTO” Session.

FIG. 97 is an exemplary screen shot illustrating an image edit made by recipient 2 (tropcom@hotmail.com) to recipient l's (bchgmatt@gmail.com) image edit to the User's sharing of the text annotation to the “USPTO” session.

FIG. 98 is an exemplary screen shot illustrating a video edit made by recipient 2 (tropcom@hotmail.com) to recipient l's (bchgmatt@gmail.com) video edit to the user's sharing of the image annotation to the “USPTO” session.

FIG. 99 is an exemplary screen shot illustrating an example of Recipient 1 opening an e-mail invitation in order to add new annotations or edits to the user's web page session by clicking the “Edit Annotation” button.

FIG. 100 is an exemplary screen shot illustrating recipient 2's text annotation.

FIG. 101 is an exemplary screen shot illustrating recipient 2's image annotation.

FIG. 102 is an exemplary screen shot illustrating recipient 2's video annotation.

FIG. 103 is an exemplary screen shot illustrating the user's text edit to the recipient's edit to the user's sharing of the annotation to “USPTO” session.

FIG. 104 is an exemplary screen shot illustrating the user's image edit to the Recipient's edit to the user's sharing of the annotation to the “USPTO” session.

FIG. 105 is an exemplary screen shot illustrating the user's video edit to the recipient's edit to the User's sharing of annotation to the “USPTO” session.

FIG. 106 is an exemplary screen shot which illustrates that the highlighted language has been annotated with the image demo picture which causes the name of the annotation, “23A Create Picture,” to appear on the left of the image.

FIG. 107 is an exemplary screen shot illustrating an image being added to the dialogue box by clicking “Insert/Edit Image” icon.

FIG. 108 is an exemplary screen shot illustrating a highlighted blue image being annotated with the “Video Demo 1” causing the name of the annotation, “23C Create Video on Image,” to appear on the left.

FIG. 109 is an exemplary screen shot illustrating an Image being added to the dialogue box by clicking “Embed/Movies” icon.

FIG. 110 is an exemplary screen shot illustrating that text being written to illustrate that the hypertext link created by annotating the electronic book website may now be used in an entirely new text, for example, as a footnote.

FIG. 111 is an exemplary screen shot m illustrating recipient 1 opening the “23A Create Picture” annotation or highlighted content showing the “Image Demo” annotation.

FIG. 112 is an exemplary screen shot illustrating recipient opening the “23C Create video on image” or highlighted content showing the “Video Demo 1” annotation.

FIG. 113 is an exemplary screen shot of an example of recipient 1 opening an e-mail and clicking on hyperlink and uploading an epub file in order to annotate the epub file.

FIG. 114 is an exemplary screen shot of a text edit made by Recipient 1 (bchgmatt@gmail.com) to User's sharing of text annotation to “EPUB” Session.

FIG. 115 is an exemplary screen shot of an Image edit made by Recipient 1 (bchgmatt@gmail.com) to User's sharing of text annotation to “EPUB” Session.

FIG. 116 is an exemplary screen shot of a video edit made by Recipient 1 (bchgmatt@gmail.com) to User's sharing of text annotation to “EPUB” Session.

FIG. 117 is an exemplary screen shot of a Text edit made by Recipient 1 (bchgmatt@gmail.com) to User's sharing of image annotation to “EPUB” Session.

FIG. 118 is an exemplary screen shot of an image edit made by Recipient 1 (bchgmatt@gmail.com) to User's sharing of image annotation to “EPUB” Session.

FIG. 119 is an exemplary screen shot of a video edit made by Recipient 1 (bchgmatt@gmail.com) to User's sharing of image annotation to “EPUB” Session.

FIG. 120 is an exemplary screen shot of a Text edit made by Recipient 1 (bchgmatt@gmail.com) to User's sharing of video annotation to “EPUB” Session.

FIG. 121 is an exemplary screen shot of an image edit made by Recipient 1 (bchgmatt@gmail.com) to User's sharing of video annotation to “EPUB” Session.

FIG. 122 is an exemplary screen shot of a video edit made by Recipient 1 (bchgmatt@gmail.com) to User's sharing of video annotation to “EPUB” Session.

FIG. 123 is an exemplary screen shot of Recipient 1 opening e-mail and clicking on hyperlink.

FIG. 124 is an exemplary screen shot of recipient 1's text annotation initiated by clicking on “Recipient annotation by text” or highlighted content.

FIG. 125 is an exemplary screen shot illustrating recipient 1's image annotation by clicking on “Recipient annotation of image” or highlighted content.

FIG. 126 is an exemplary screen shot illustrating recipient 1's video annotation by clicking on “Recipient annotation by video” or highlighted content.

FIG. 127 is an exemplary screen shot illustrating recipient 2's edit by text.

FIG. 128 is an exemplary screen shot illustrating recipient 2's edit by image.

FIG. 129 is an exemplary screen shot illustrating recipient 2's edit by video.

FIG. 130 is an exemplary screen shot illustrating recipient 2's text annotation.

FIG. 131 is an exemplary screen shot illustrating recipient 2's image annotation.

FIG. 132 is an exemplary screen shot illustrating recipient 2's video annotation.

FIG. 133 is an exemplary screen shot illustrating user's (bchgmatt@hotmail.com) text edit to recipient's edit to user's sharing of annotation to “EPUB” Session.

FIG. 134 is an exemplary screen shot illustrating user's (bchgmatt@hotmail.com) image edit to recipient's edit to User's sharing of annotation to “EPUB” Session.

FIG. 135 is an exemplary screen shot illustrating user's (bchgmatt@hotmail.com) video edit to Recipient's edit to User's sharing of annotation to “EPUB” Session.

FIG. 136 is an exemplary screen shot illustrating the highlighted red language has been annotated with the image demo picture with the name of the annotation, “Chapter 7, Paragraph 1,” appearing on the left.

FIG. 137 is an exemplary screen shot illustrating an image added to dialogue box by clicking “Insert/Edit Image” icon by locating and opening a picture file on user's computer, shown here as image demo.

FIG. 138 is an exemplary screen shot illustrating the highlighted blue language is annotated with the “Video Demo 1 and the name of the annotation “Chapter 8, Paragraph 1,” appearing on the left.

FIG. 139 is an exemplary screen shot of an image added to dialogue box by clicking “Embed/Movies” icon by locating and open picture file on user's computer, indicated here as “Video Demo 1”.

FIG. 140 is an exemplary screen shot of illustrating recipient 1 opening the “Chapter 7, Paragraph 1” annotation or the highlighted content showing the “Image Demo” annotation.

FIG. 141 is an exemplary screen shot illustrating Recipient 1 opens “Chapter 8, Paragraph 1” annotation on or highlighted content showing the Video Demo 1 annotation.

FIG. 142 is an exemplary screen shot illustrating recipient 1 opening e-mail and clicking on hyperlink.

FIG. 143 is an exemplary screen shot illustrating recipient 1's text annotation by clicking on “Recipient text annotation” or highlighted content.

FIG. 144 is an exemplary screen shot illustrating Recipient 1 opening the “Chapter 7, Paragraph 1” annotation or the highlighted content showing the “Image Demo” annotation.

FIG. 145 is an exemplary screen shot illustrating recipient 1's video annotation by clicking on “Recipient annotation by video” or highlighted content.

FIG. 146 is an exemplary screen shot of open PDF file from downloads on user's computer.

FIG. 147 is an exemplary screen shot of a start of a new session by filling in the name of the session “IRS Publ” and choosing “New PDF Session”.

FIG. 148 is an exemplary screen shot of the PDF with the Instruction for annotating the PDF appears on the left.

FIG. 149 is an exemplary screen shot illustrating highlighted text on the PDF page to access edit box for use in creating an annotation in text, image or video.

FIG. 150 is an exemplary screen shot of the highlighted section of the PDF annotated by text with the name of the annotation “PDF User Annotation” appearing on the left.

FIG. 151 is an exemplary screen shot selection of the “share” button to e-mail an invitation to view or edit annotations or to create new annotation.

FIG. 152 is an exemplary screen shot illustrating an image added to the annotation box by clicking “Insert Edit Image” icon and locating the image on list of images to open.

FIG. 153 is an exemplary screen shot illustrating the highlighted language annotated with a NASA image with the name of the annotation “PDF Image Annotation” appearing to the left.

FIG. 154 is an exemplary screen shot

FIG. 155 is an exemplary screen shot illustrating a video annotation from NASA appearing in the annotation box with the name of the annotation “PDF Video Annotation” appearing on the left.

FIG. 156 is an exemplary screen shot illustrating select of a “Share” button to send an e-mail invitation.

FIG. 157 is an exemplary screen shot illustrating recipient 1 opening an e-mail.

FIG. 158 is an exemplary screen shot illustrating text being written to illustrate that the hypertext link created by annotating the PDF website may now be used in an entirely new text, for example, as a footnote.

FIG. 159 is an exemplary screen shot illustrating a recipient uploading a PDF from the recipient's computer.

FIG. 160 is an exemplary screen shot illustrating a PDF file uploaded.

FIG. 161 is an exemplary screen shot illustrating the selection of the text annotation “PDF User Annotation” to view text.

FIG. 162 is an exemplary screen shot illustrating the selection of the “PDF Image Annotation” to view image annotation.

FIG. 163 is an exemplary screen shot illustrating the selection of the “PDF Video annotation” to view annotation.

FIG. 164 is an exemplary screen shot illustrating recipient 1 opening e-mail and clicking on hyperlink.

FIG. 165 is an exemplary screen shot illustrating a text edit made by recipient 1 (bchgmatt@gmail.com) to user's sharing of text annotation to “IRS Publ 1” Session.

FIG. 166 is an exemplary screen shot illustrating an image edit made by recipient 1 (bchgmatt@gmail.com) to user's sharing of text annotation to “IRS Publ 1” Session.

FIG. 167 is an exemplary screen shot illustrating a video edit made by recipient 1 (bchgmatt@gmail.com) to user's sharing of text annotation to “IRS Publ 1” Session.

FIG. 168 is an exemplary screen shot illustrating a text edit made by recipient 1 (bchgmatt@gmail.com) to user's sharing of image annotation to “IRS Publ 1” Session.

FIG. 169 is an exemplary screen shot illustrating an image edit made by recipient 1 (bchgmatt@gmail.com) to user's sharing of image annotation to “IRS Publ 1” Session.

FIG. 170 is an exemplary screen shot illustrating a video edit made by recipient 1 (bchgmatt@gmail.com) to user's sharing of image annotation to “IRS Publ 1” Session.

FIG. 171 is an exemplary screen shot illustrating a text edit by recipient 1 to a video annotation.

FIG. 172 is an exemplary screen shot text edit made by recipient 1 (bchgmatt@gmail.com) to User's sharing of video image.

FIG. 173 is an exemplary screen shot illustrating a video edit made by recipient 1 (bchgmatt@gmail.com) to user's sharing of video image.

FIG. 174 is an exemplary screen shot illustrating recipient 1 opening an e-mail and clicking on a hyperlink.

FIG. 175 is an exemplary screen shot illustrating recipient 1's text annotation after clicking on “Recipient text annotation” or highlighted content.

FIG. 176 is an exemplary screen shot illustrating recipient 1's image annotation after clicking on “Recipient image annotation” or highlighted content.

FIG. 177 is an exemplary screen shot illustrating recipient 1's video annotation by clicking on “Recipient video annotation” or highlighted content.

FIG. 178 is an exemplary screen shot after Recipient 2 opens the e-mail and clicks on the hyperlink.

FIG. 179 is an exemplary screen shot illustrating a text edit by recipient 2 (tropcom@hotmail.com).

FIG. 180 is an exemplary screen shot illustrating an image edit by recipient 2 (tropcom@hotmail.com).

FIG. 181 is an exemplary screen shot illustrating a video edit by recipient 2 (tropcom@hotmail.com).

FIG. 182 is an exemplary screen shot after recipient 2 opens e-mail and clicks on hyperlink.

FIG. 183 is an exemplary screen shot illustrating recipient 2's text annotation.

FIG. 184 is an exemplary screen shot illustrating recipient 2's image annotation.

FIG. 185 is an exemplary screen shot illustrating recipient 2's video annotation.

FIG. 186 is an exemplary screen shot illustrating user's text edit to recipient's edit to user's sharing of annotation to “PDF” Session.

FIG. 187 is an exemplary screen shot illustrating user's image edit to recipient's edit to user's sharing of annotation to “PDF” Session.

FIG. 188 is an exemplary screen shot illustrating user's video edit to recipient's edit to user's sharing of annotation to “PDF” Session.

FIG. 189 is an exemplary screen shot illustrating an exemplary picture for uploading.

FIG. 190 is an exemplary screen shot illustrating highlighting the context of document in order to make the annotation box appear.

FIG. 191 is an exemplary screen shot illustrating selection of the icon “Insert/Edit Images” in the annotation box to generate the “Image Properties” box.

FIG. 192 is an exemplary screen illustrating the selection of the “Choose File” button to locate new picture file on the user's hard drive.

FIG. 193 is an exemplary screen shot illustrating the selection of a download named “NASA Picture” and then clicking the “Open” button.

FIG. 194 is an exemplary screen shot illustrating the selection of a file with the selection illustrated next to the “Choose File” button.

FIG. 195 is an exemplary screen shot illustrating the selection of a file, “NASA Picture jpg”, which will appear in the server box and is available for loading into the annotation box.

FIG. 196 is an exemplary screen shot illustrating a NASA image in the “Image Properties” box.

FIG. 197 is an exemplary screen shot illustrating a NASA photo appearing in annotation box.

FIG. 198 is an exemplary screen shot illustrating “NASA Picture Upload 1” appearing on the left column of index of annotations.

FIG. 199 is an exemplary screen shot illustrating an exemplary uploaded picture.

FIG. 200 is an exemplary screen shot illustrating the process of uploading a video.

FIG. 201 is an exemplary screen shot illustrating the process of highlighting the context of a document in order to make the annotation box appear.

FIG. 202 is an exemplary screen shot illustrating the process of selecting the icon “Embed Movies” in the annotation box to generate the “movie properties” box.

FIG. 203 is an exemplary screen shot illustrating the process of select a “URL Video Download” and then click “Open” button.

FIG. 204 is an exemplary screen shot illustrating the URL appearing in the URL box.

FIG. 205 is an exemplary screen shot illustrating a downloaded video appearing in the annotation box.

FIG. 206 is an exemplary screen shot illustrating the annotation entitled “URL Video Upload” appearing in the left column.

FIG. 207 is an exemplary screen shot illustrating the highlighting to which the annotation is attached.

FIG. 208 is an exemplary screen shot illustrating the annotation box appearing with the video content displayed.

FIG. 209 is a flow chart for an annotation display of a web page.

FIG. 210 is a flow chart for an annotation display name link of a web page.

FIG. 211 is a flow chart for an Annotation Edit of a web page.

FIG. 212 is a flow chart for an Annotation Shared Web Page Display

FIG. 213 is a flow chart of an Annotation Display for an Epub book.

FIG. 214 is a flow chart of an Annotation Display Name Link for an Epub book.

FIG. 215 is a flow chart of an Annotation Edit of an Epub book.

FIGS. 216-217 represent a flow chart of an Annotation Shared Epub display.

FIG. 218 illustrates a flow chart of an Annotation Start New Session for a pdf book.

FIG. 219 illustrates a flow chart of an Annotation Select Session for a pdf book.

FIGS. 220-221 represent a flow chart for an Annotation Shared pdf display.

FIG. 222 illustrates a flow chart for an Annotation Shared Email Sent.

FIG. 223 illustrates a flow chart for an Annotation Edit for a pdf file.

FIG. 224 illustrates a flow chart for an Annotation Display for a pdf file.

FIG. 225 illustrates a flow chart for an Annotation Delete for a pdf file.

FIG. 226 illustrates a flow chart for an Annotation Add for a pdf file.

FIG. 227 illustrates a flow chart for an Annotate Delete Session.

FIG. 228 illustrates a flow chart for an Annotation Display Name Link for a pdf file.

FIG. 229 illustrates a flow chart an Annotation Shared PDF (Select PDF File).

### DETAILED DESCRIPTION

The present invention relates to an annotation system for electronically annotating electronic digital content and sharing the annotations with, by or among, third parties without violating the copyright rights of the digital content owner. Rather than sharing the electronically annotated digital content with, by or among, third parties, only an overlay with the electronic annotation is shared with other users who have their own legally obtained copy of the digital content.

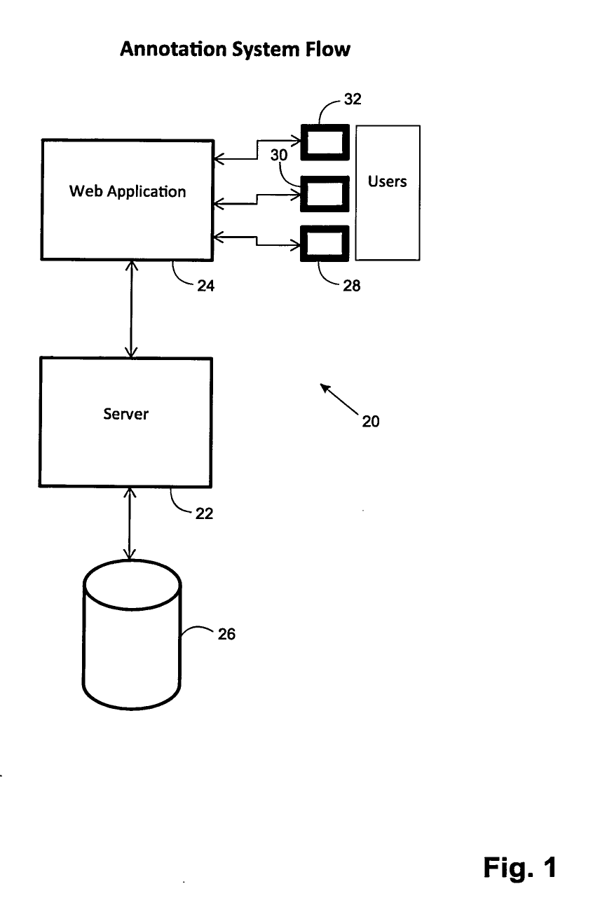

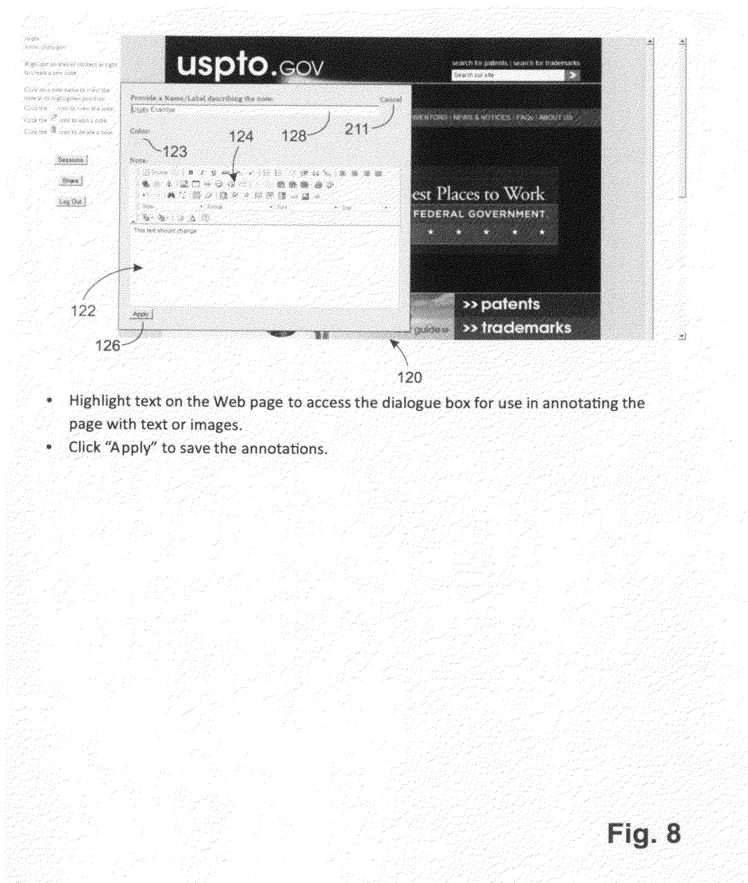

Referring first to FIG. 1, the electronic annotation system is generally identified with the reference numeral 20. The system 20 includes at least one server 22 with, for example, a web application 24 and a database 26. One or more users 28, 30 and 32 can interact with the electronic annotation system 20 by way of the web application 24, for example. The electronic annotations, for example, as illustrated in FIG. 8, may be generated and shared by users 28, 30 and 32.

Unlike other known systems, the electronic annotation system 20 does not merge the electronic annotations with the digital content, which may be protected by the US copyright laws. Rather, the electronic annotation system 20 requires each of the users 28, 30 and 32 to have their own licensed copy of the same digital content. The annotations are configured as transparent electronic overlays. The overlays are spatially registered with the digital content. In order to share comments with another user, the first user simply sends the overlay by sending a hyperlink to the web application to a recipient, for example, by email. The recipient is instructed to open up a legally obtained version of the digital content by way of the web application. Upon opening the web application by checking the hyperlink, the annotations—for example, text, images, or video—show up in the same place on the recipient's digital content since the annotations are spatially registered with the digital content, for example by x-y co-ordinates, other coordinate systems, vectors or other means. Because the digital content itself is not being shared or reproduced, there will be no violations of the copyright owner's rights.

As mentioned above, the annotations are spatially registered with the digital content. As such, it is understood that the system is useful with digital content in a paginated layout style, for example, fixed layout files, such as web pages and electronic publication (epub) files formatted in a paginated layout style. For such content, the X-Y coordinates of a page of the content is readily determined. For each annotation, the system automatically determines the page and the X-Y coordinates on the page that identifies where the annotation was made on the page. In accordance with the invention, the annotations can be sent to a third party via a hyperlink to the web application which, when opened, creates an overlay spatially displayed on the recipient's page at the same X-Y coordinates as the page where the annotation was made. Within the web application, the recipient opens up their licensed copy of the digital content and opens up the overlay to view the overlay.

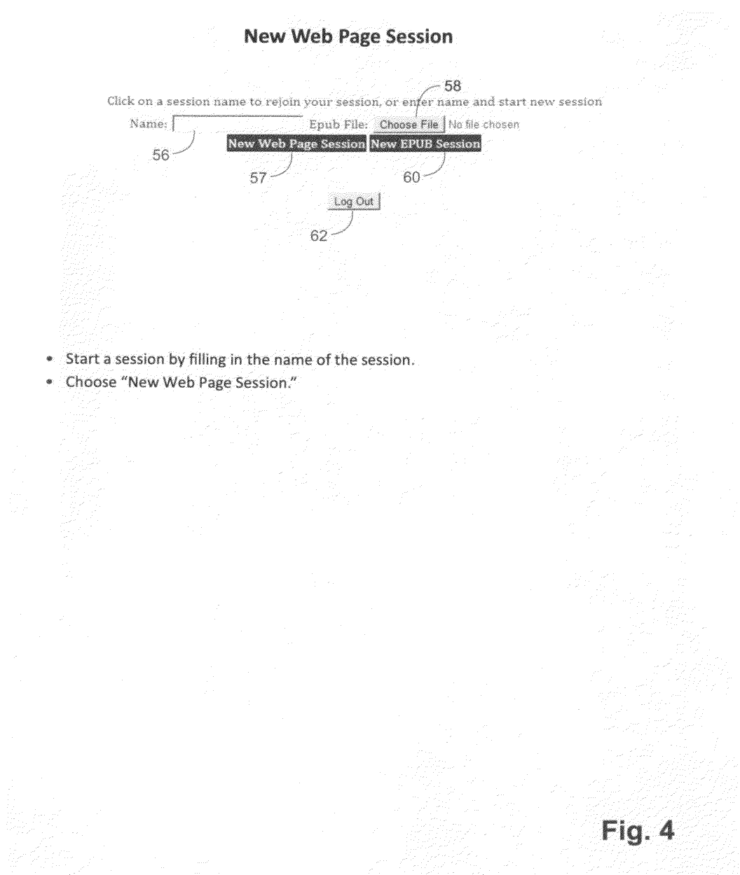

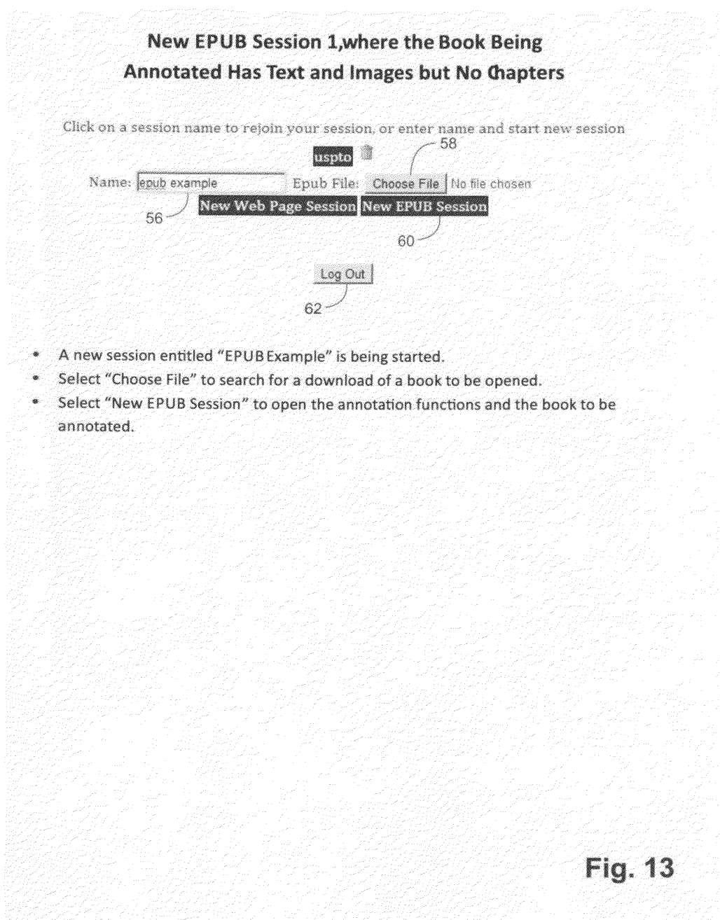

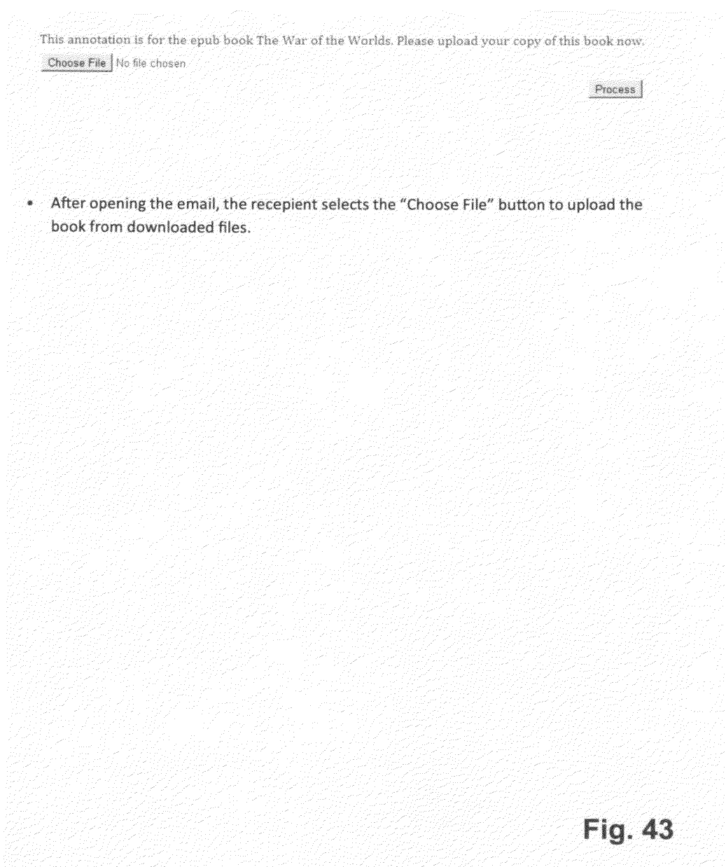

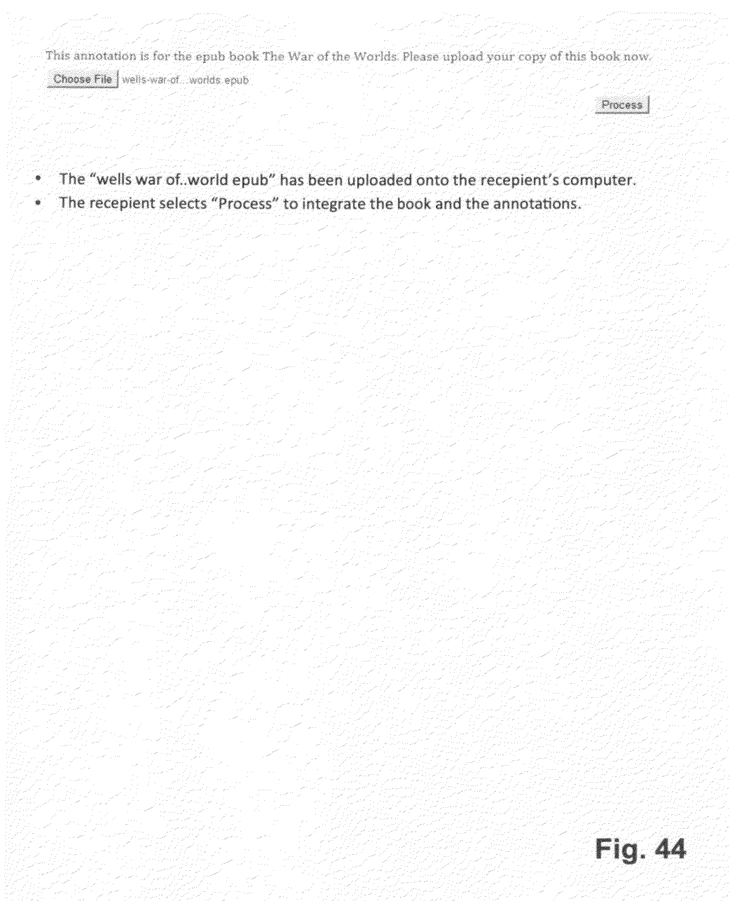

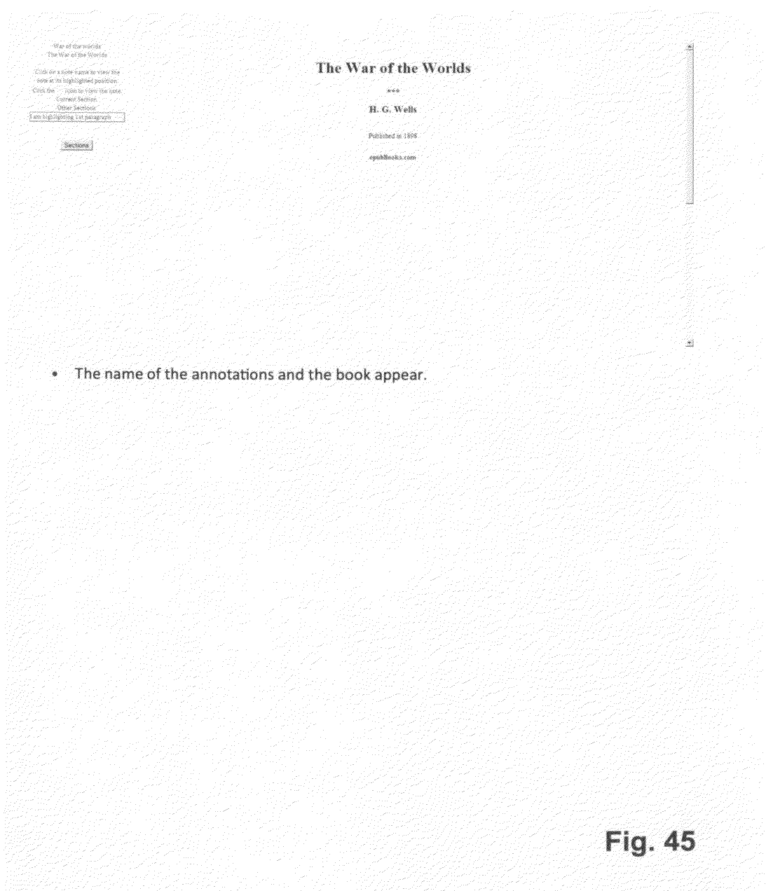

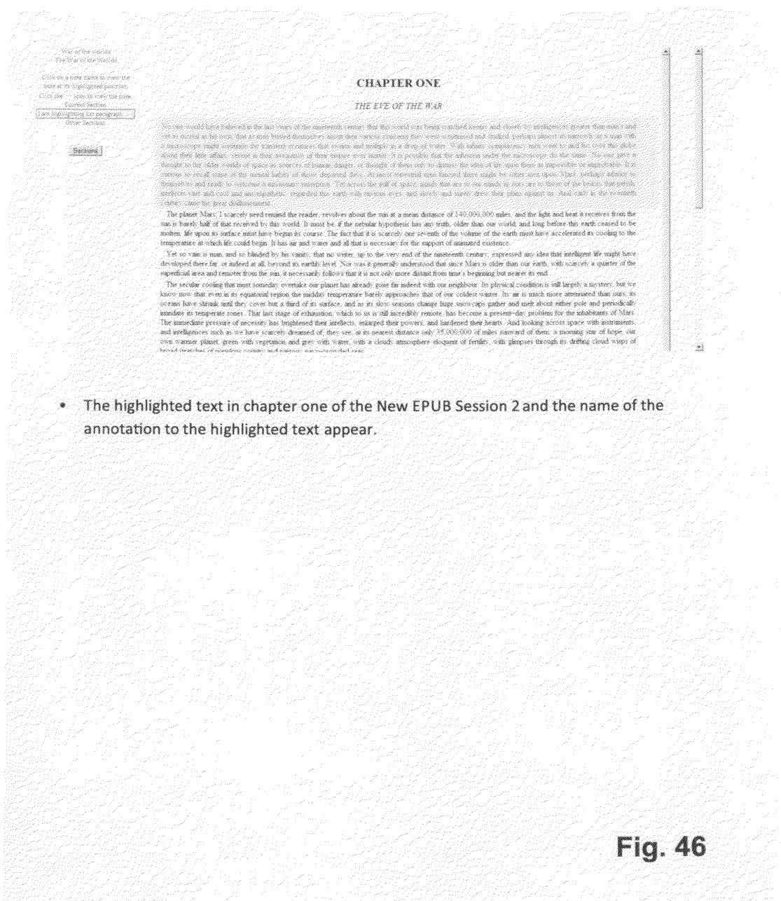

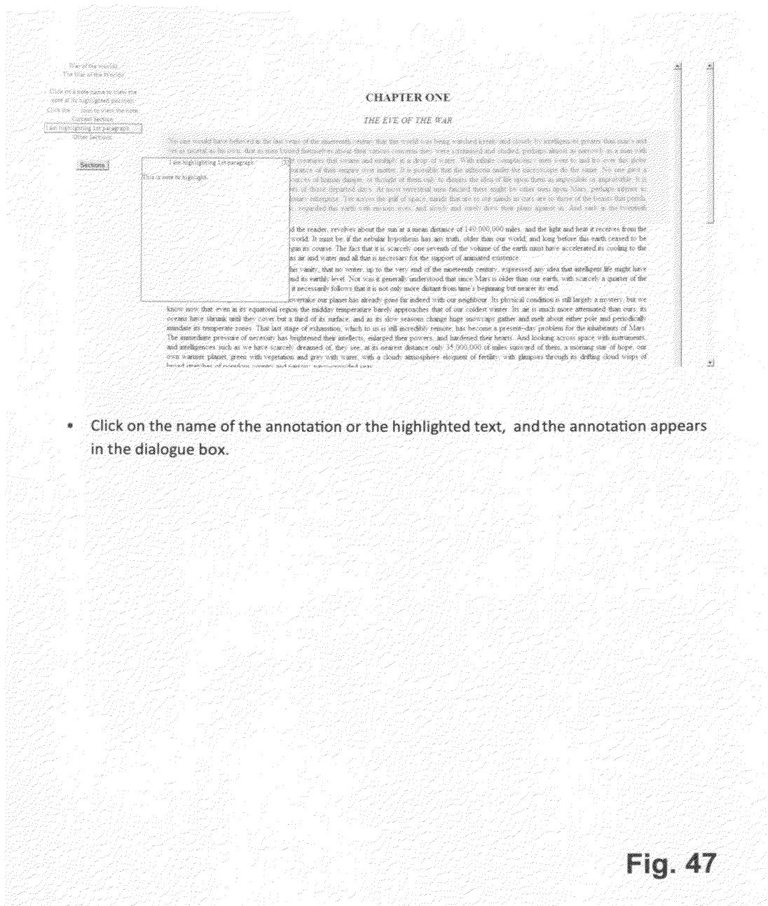

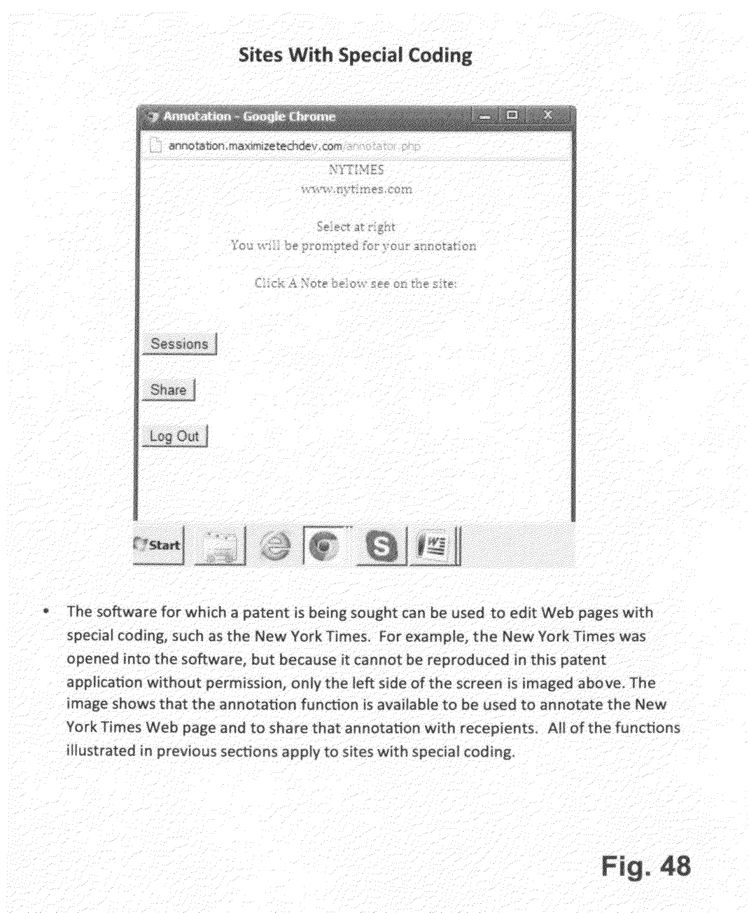

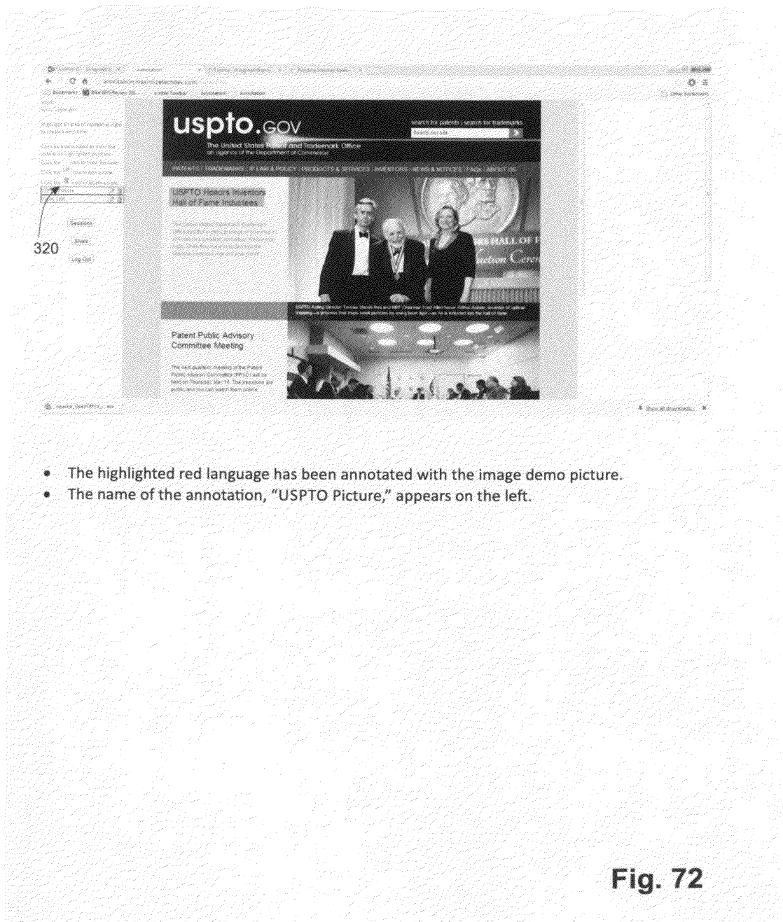

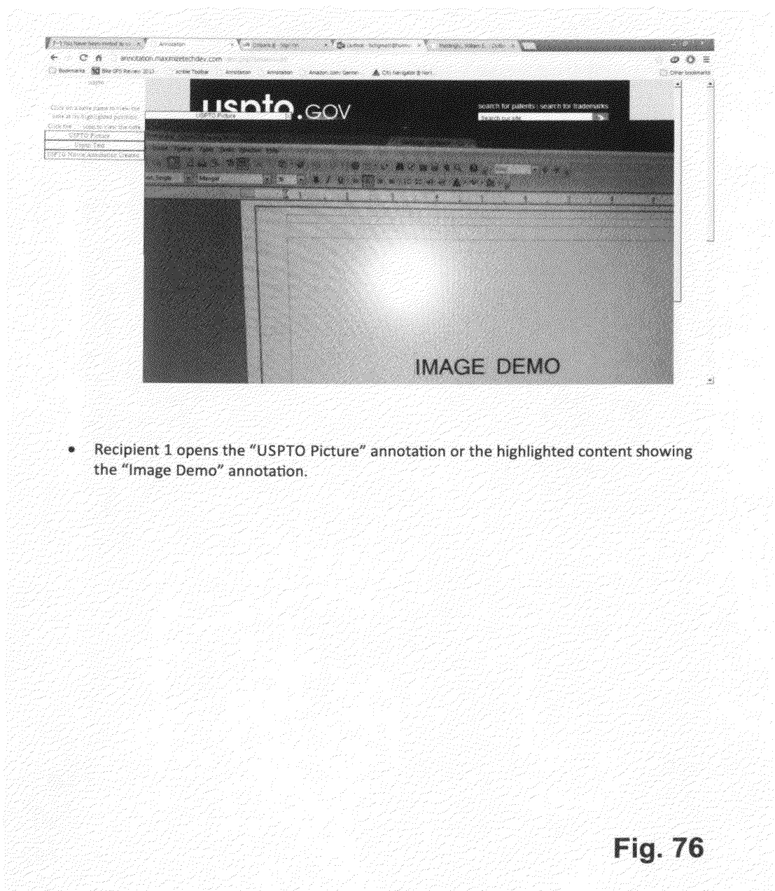

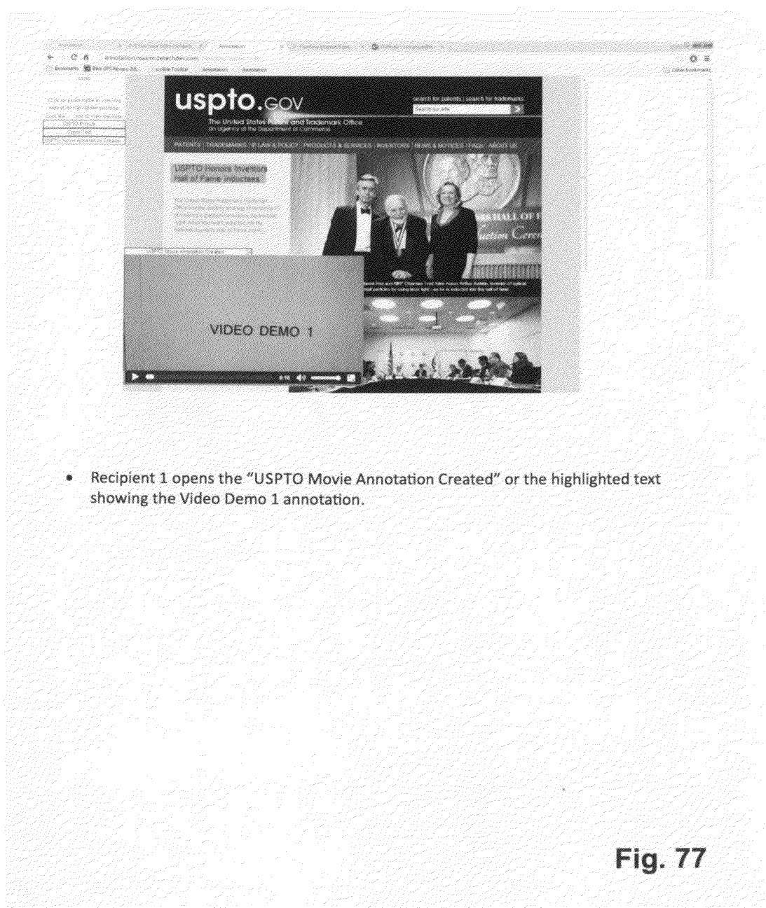

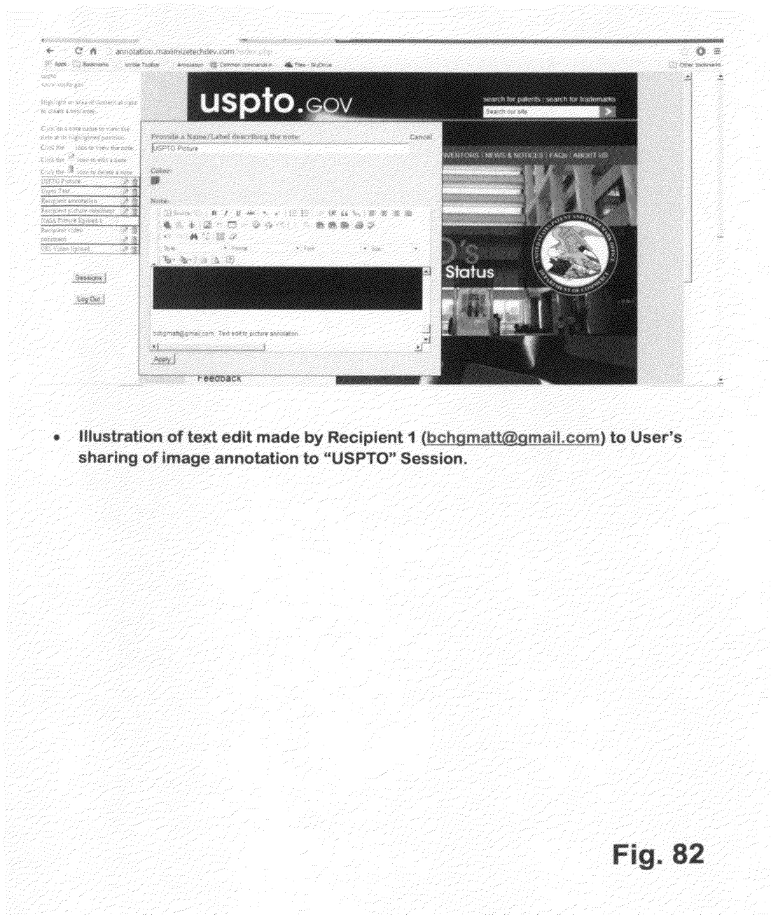

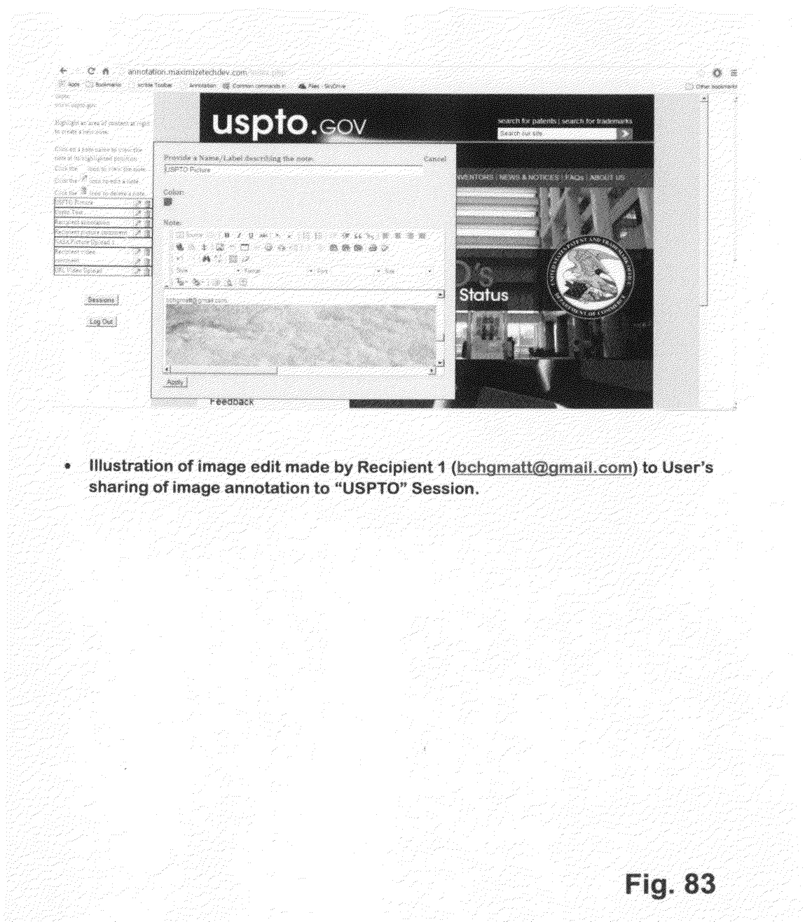

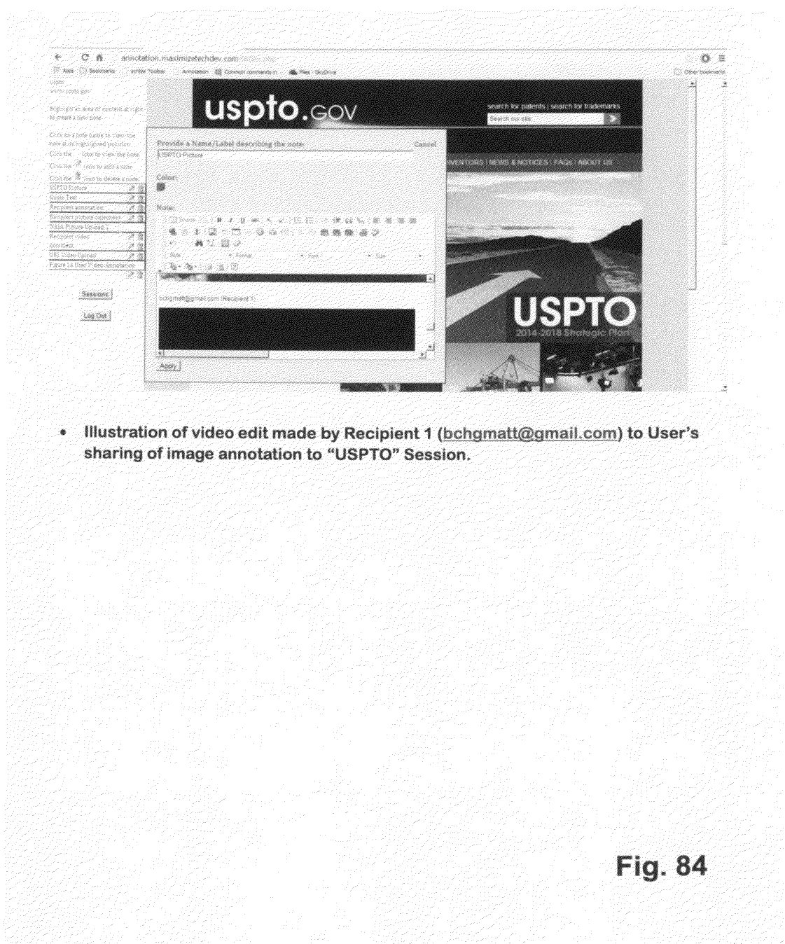

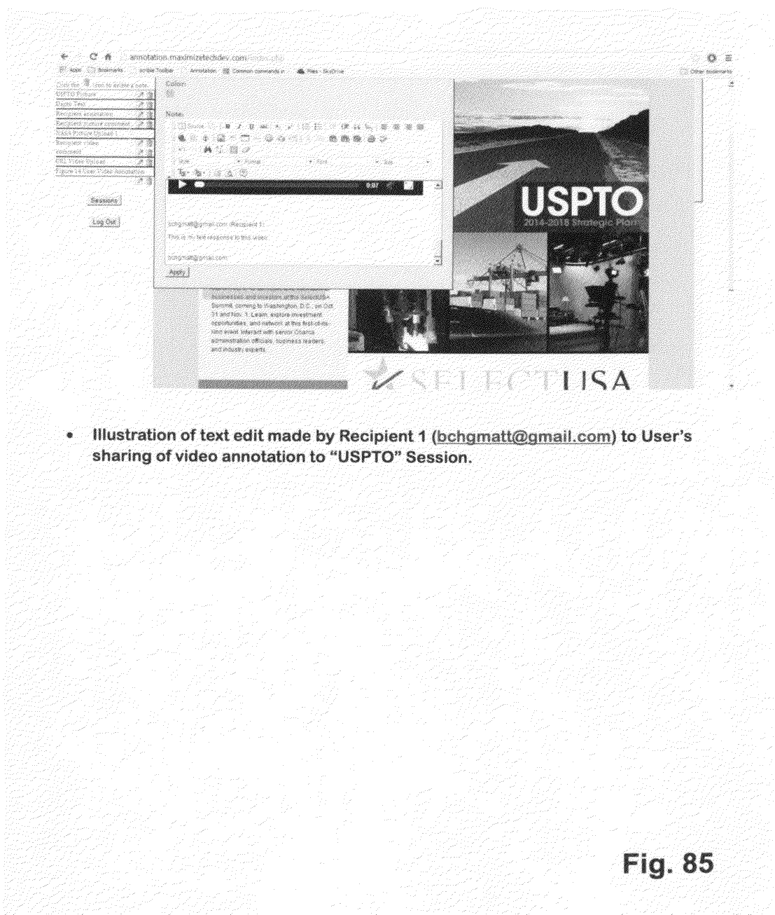

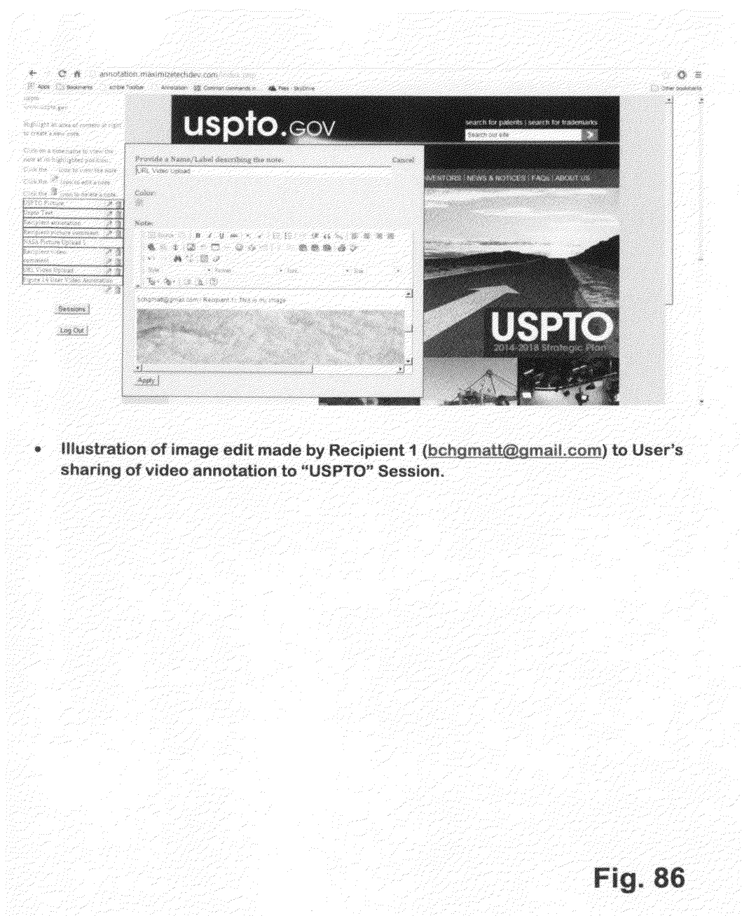

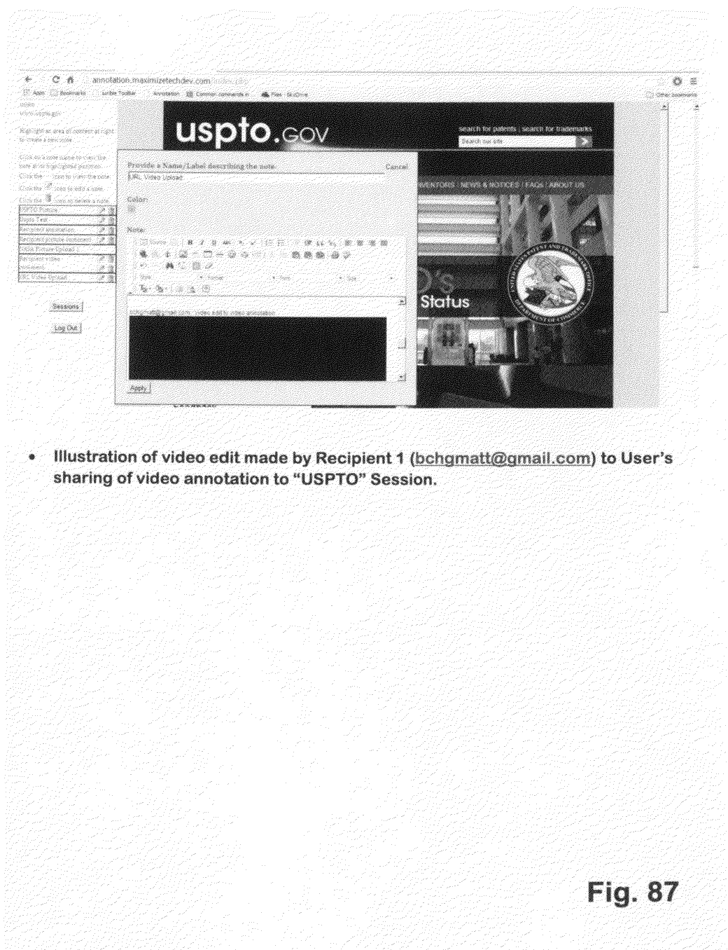

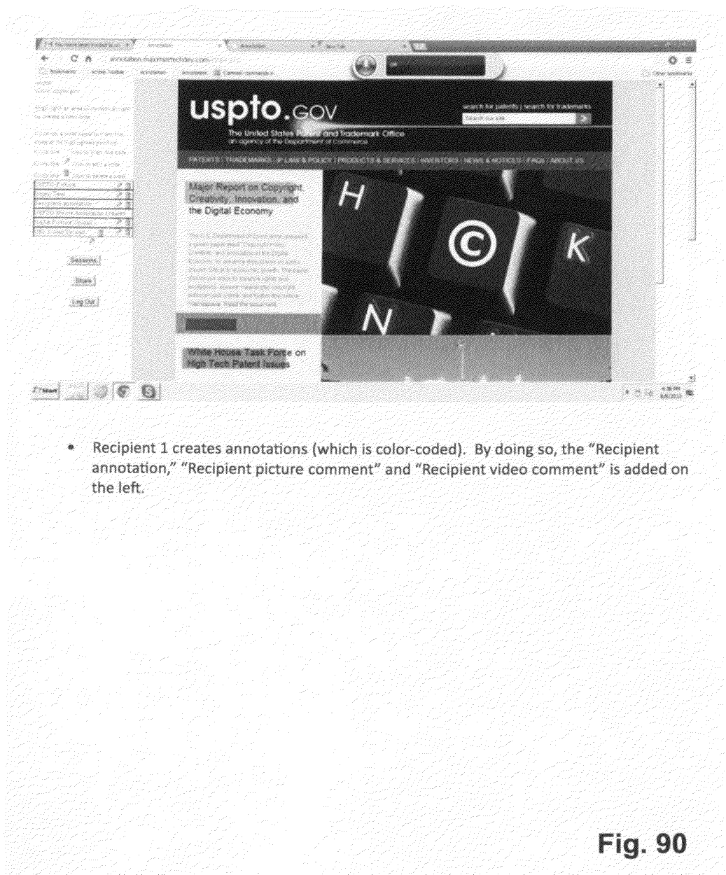

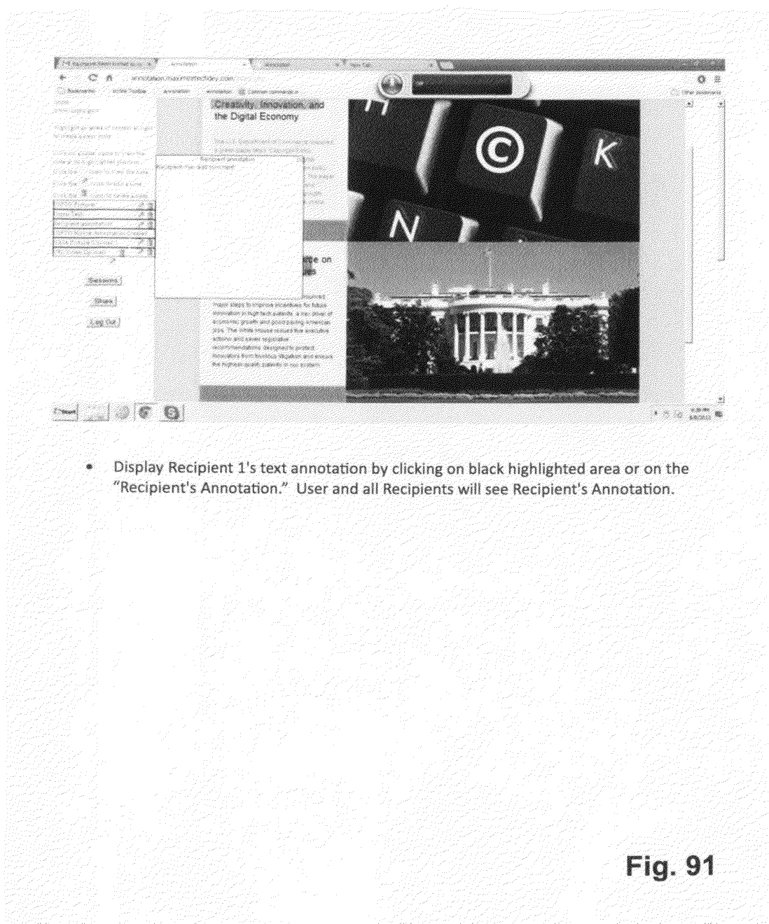

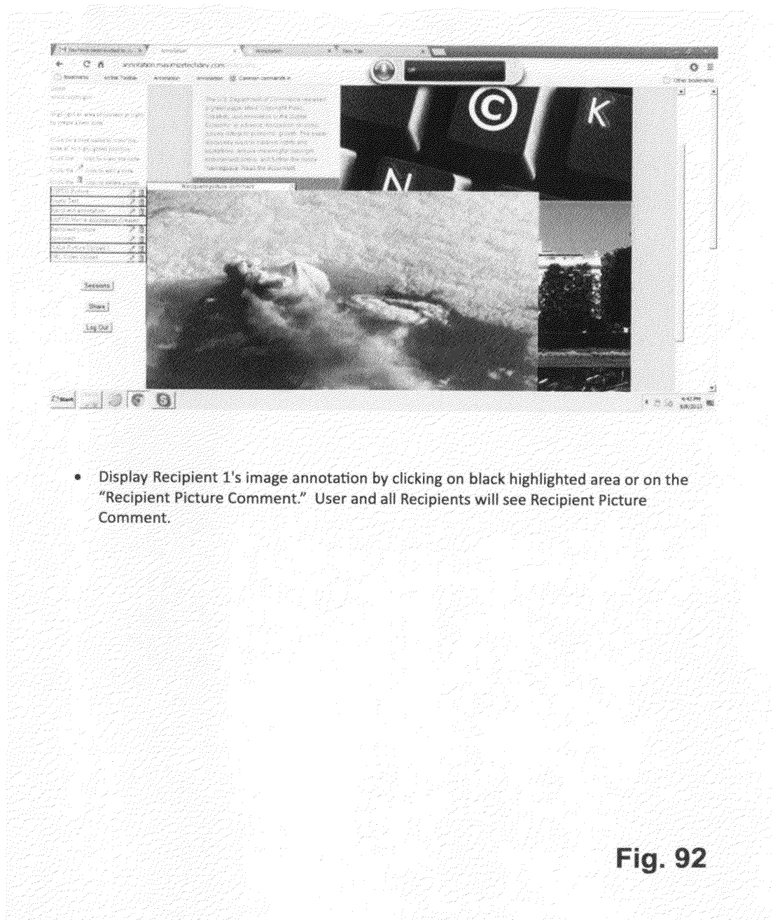

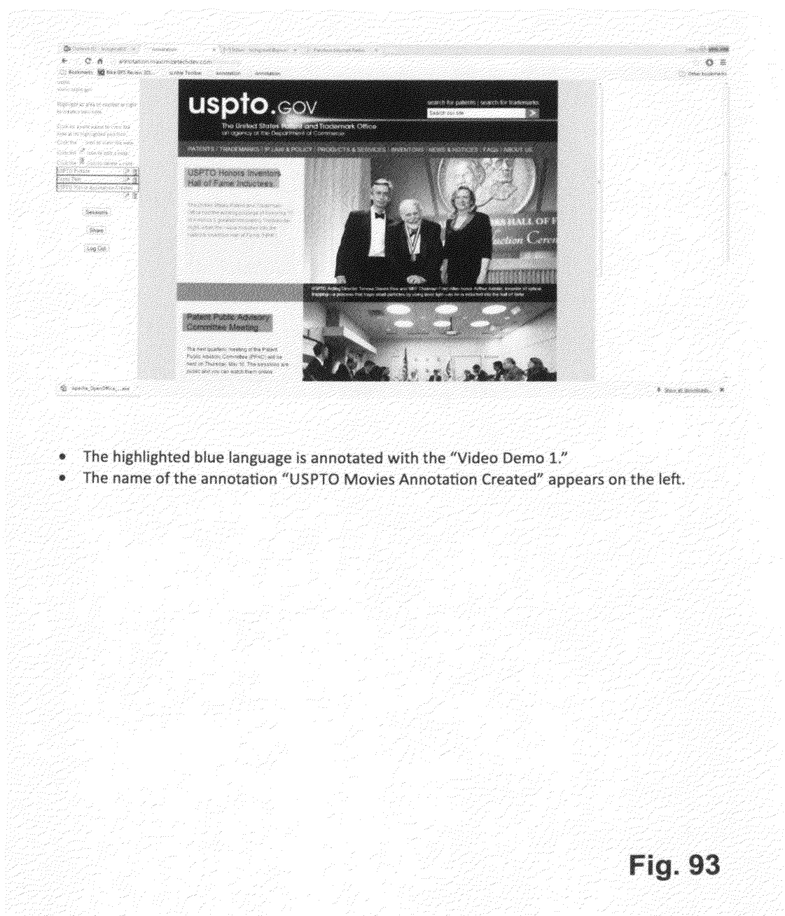

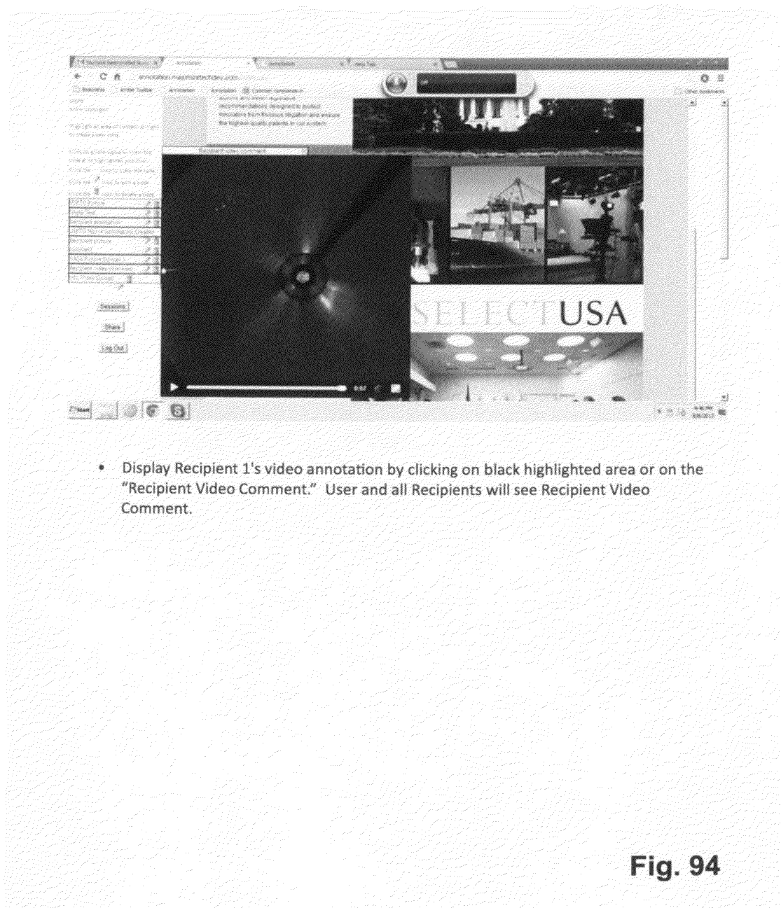

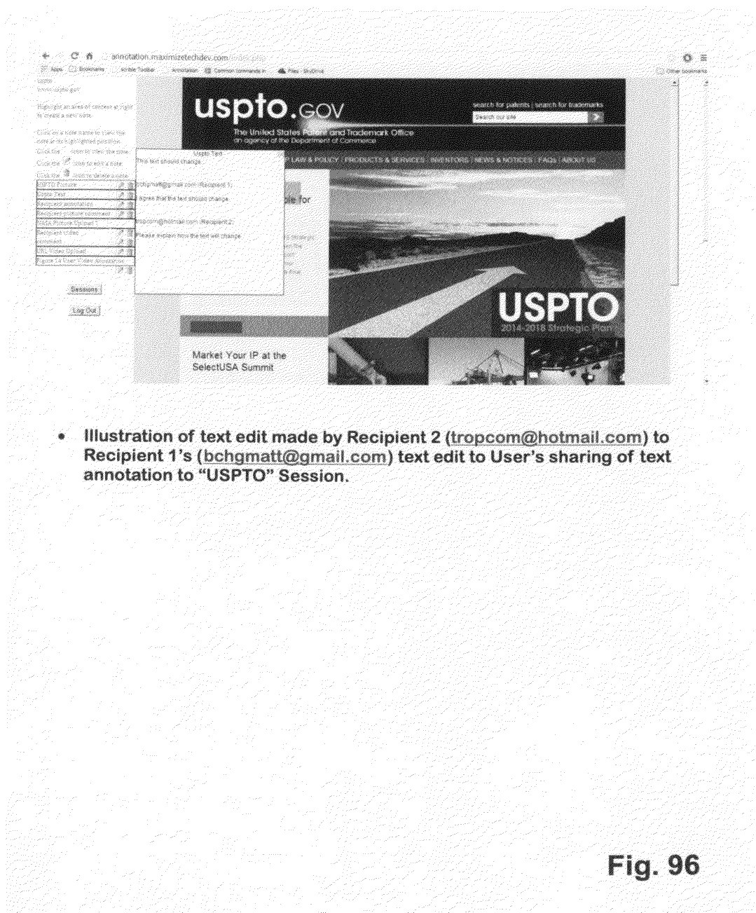

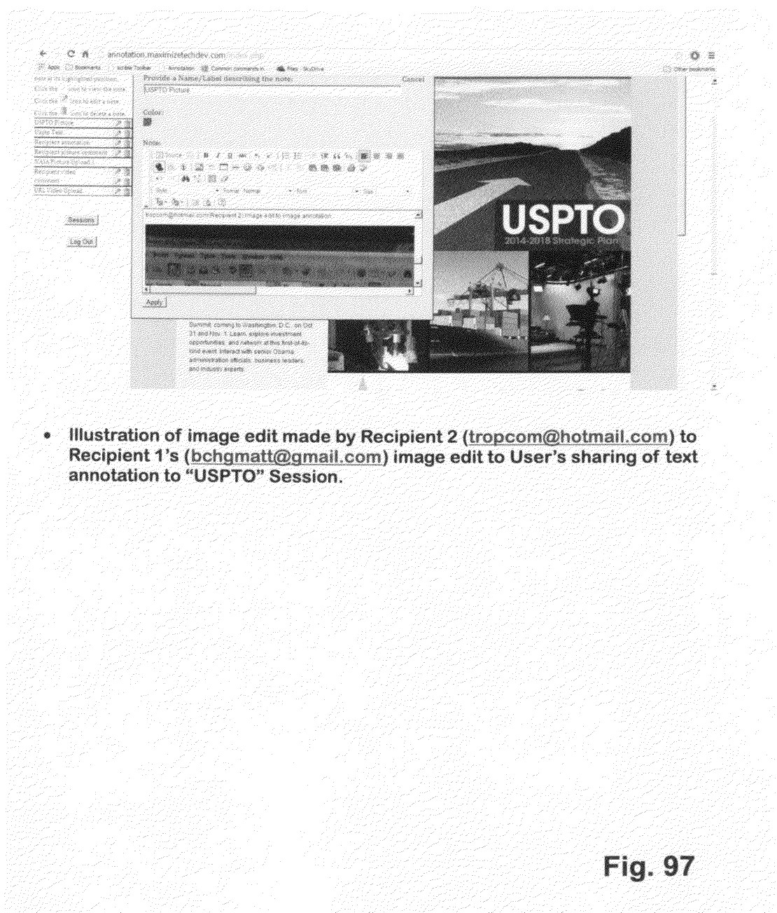

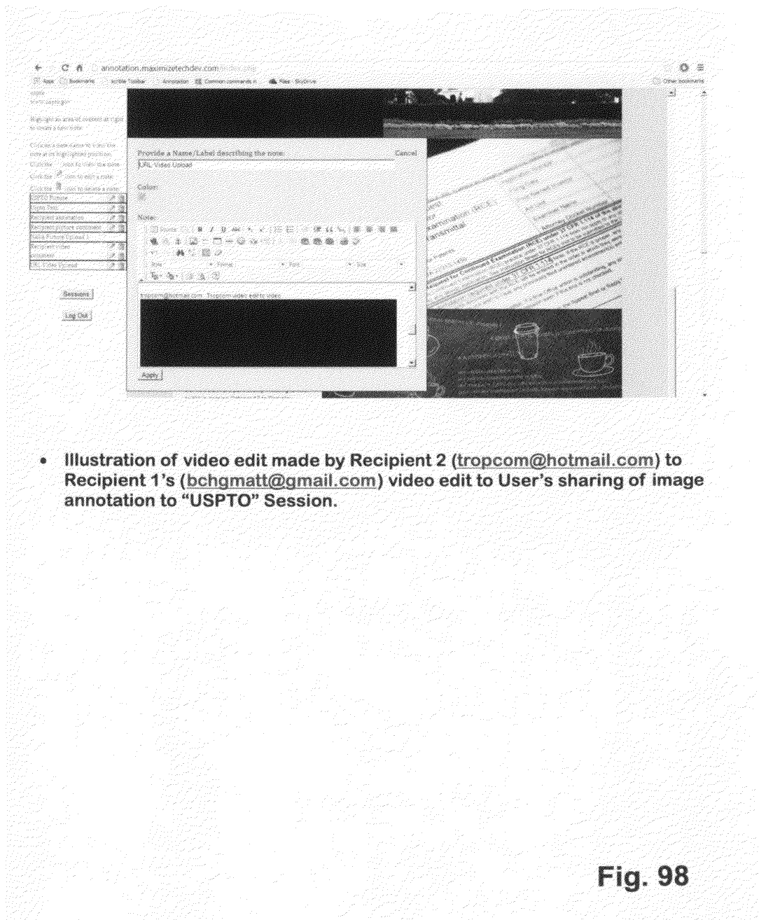

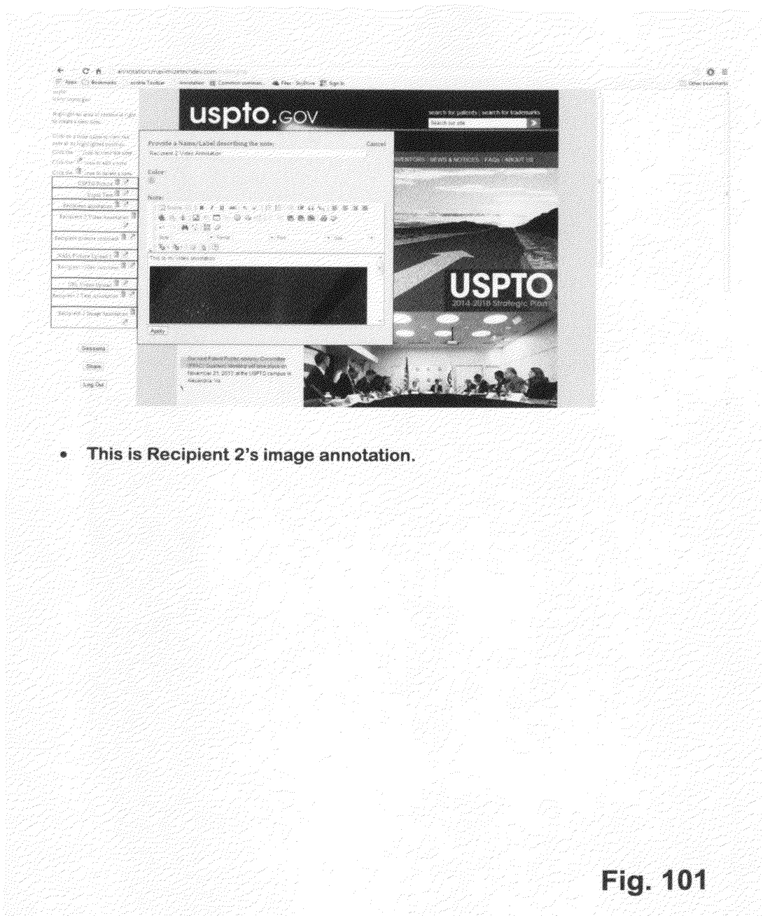

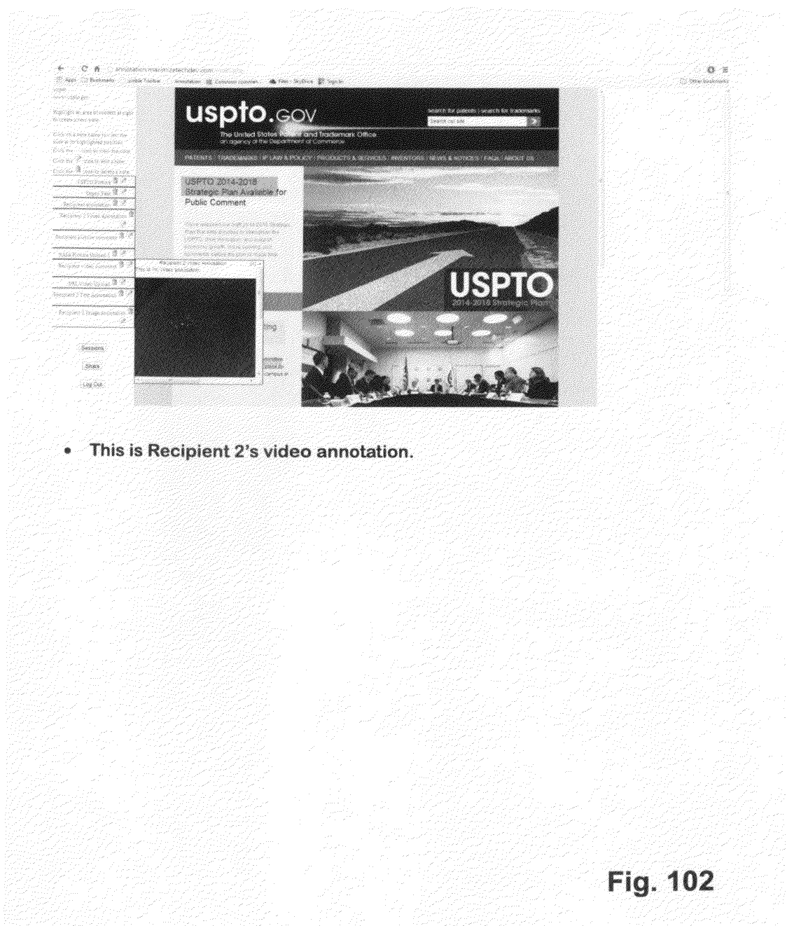

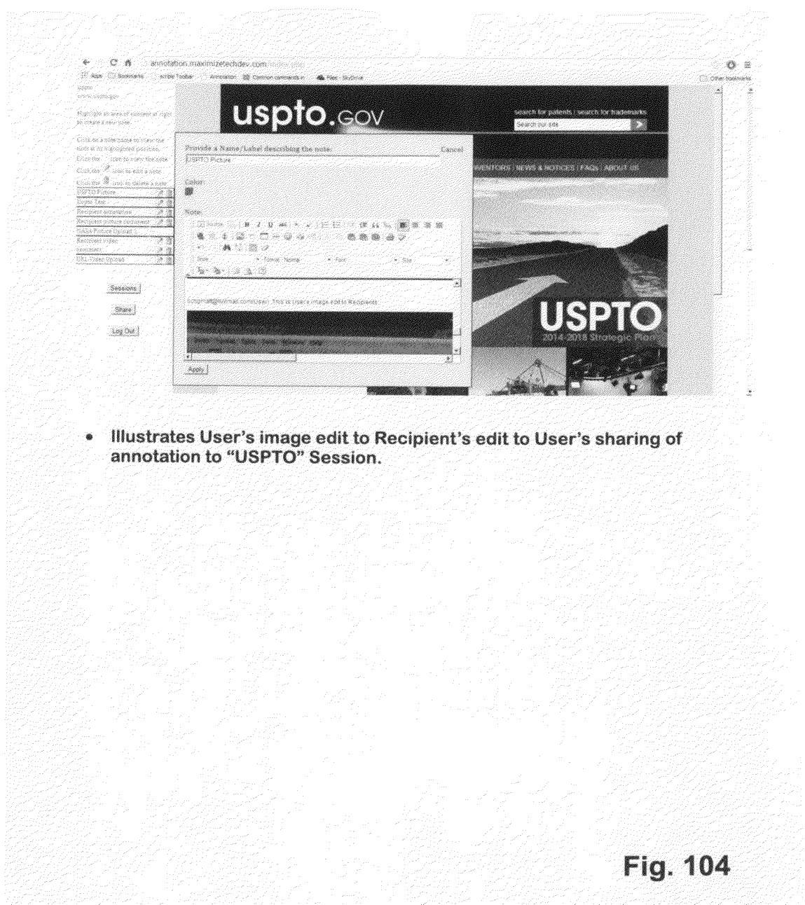

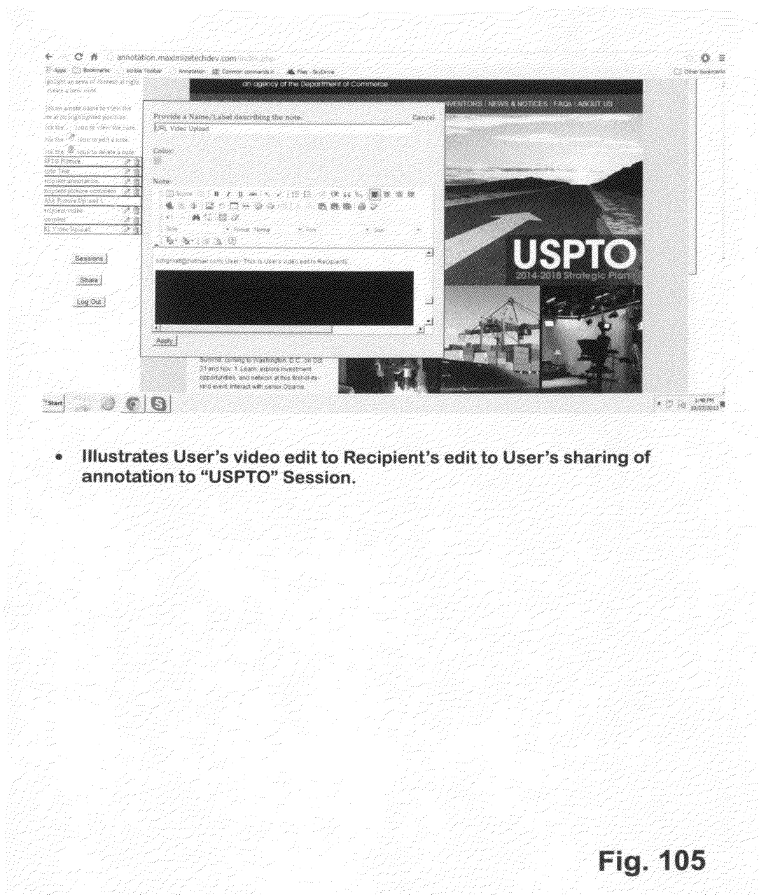

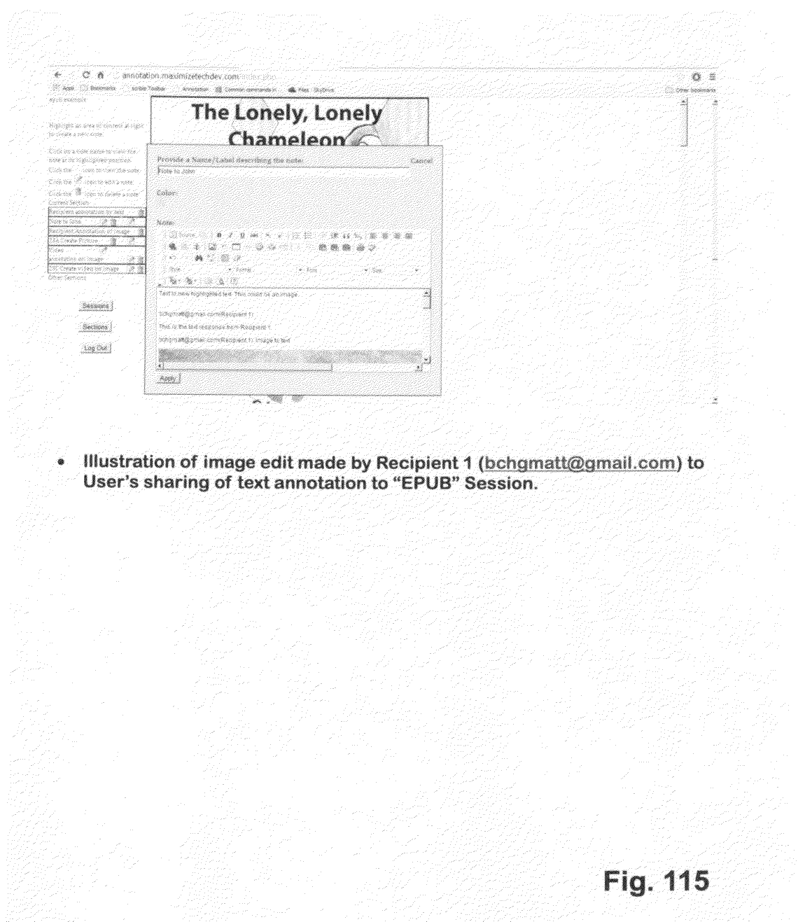

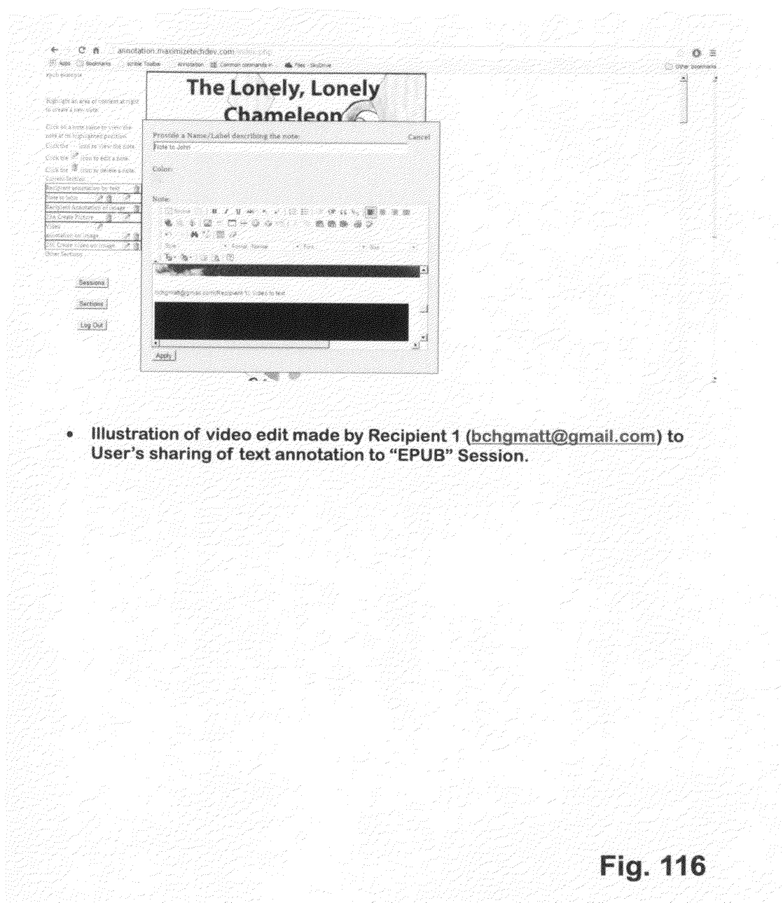

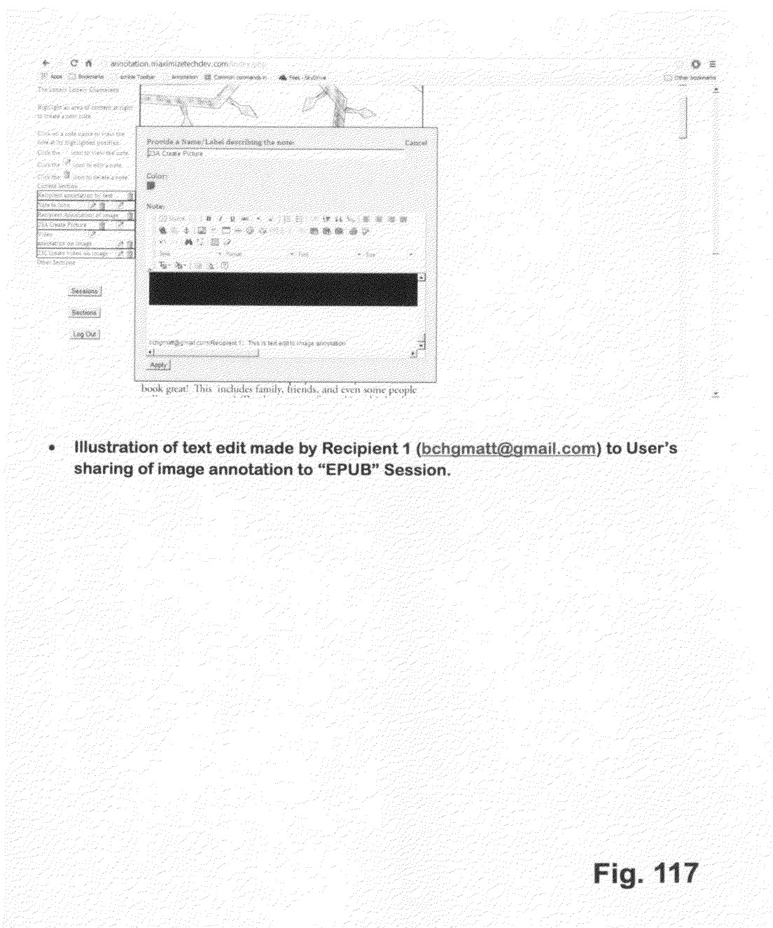

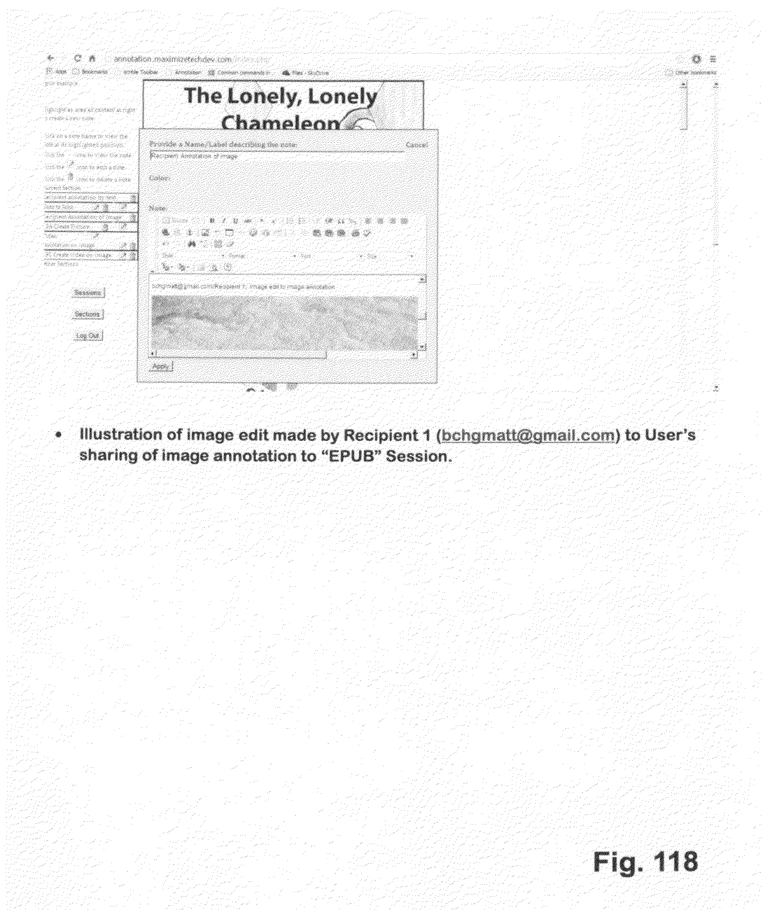

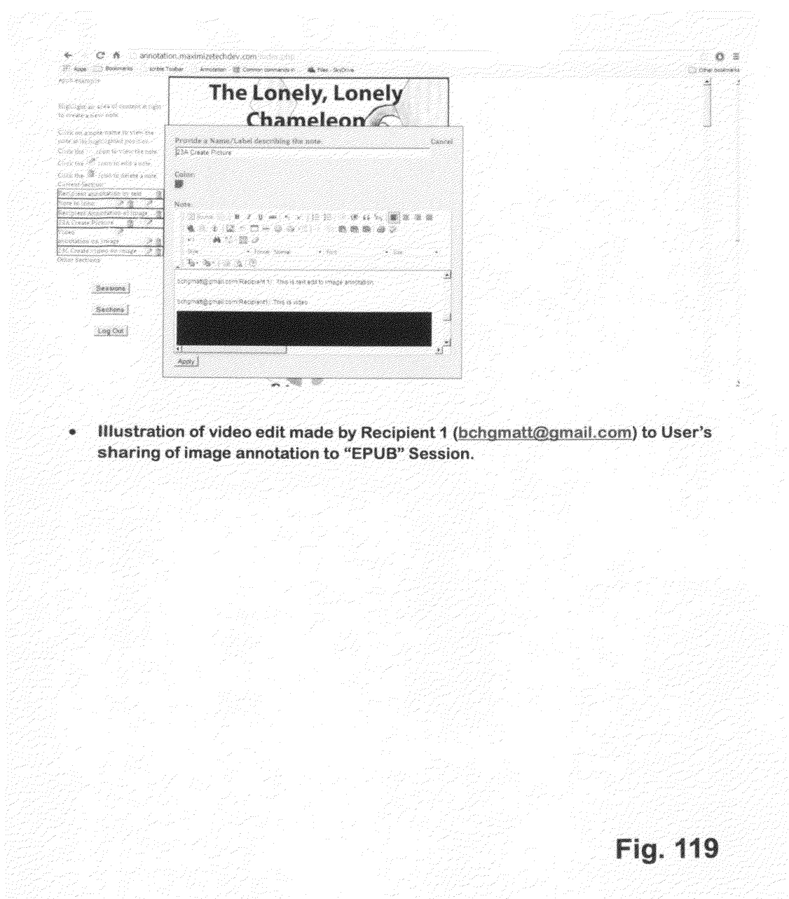

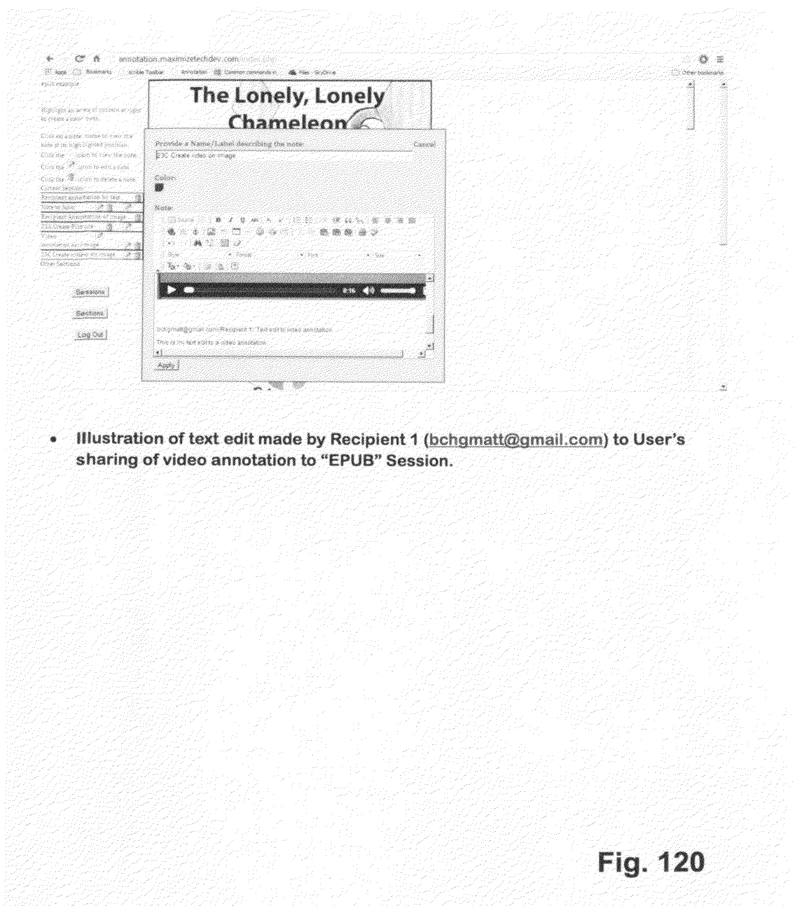

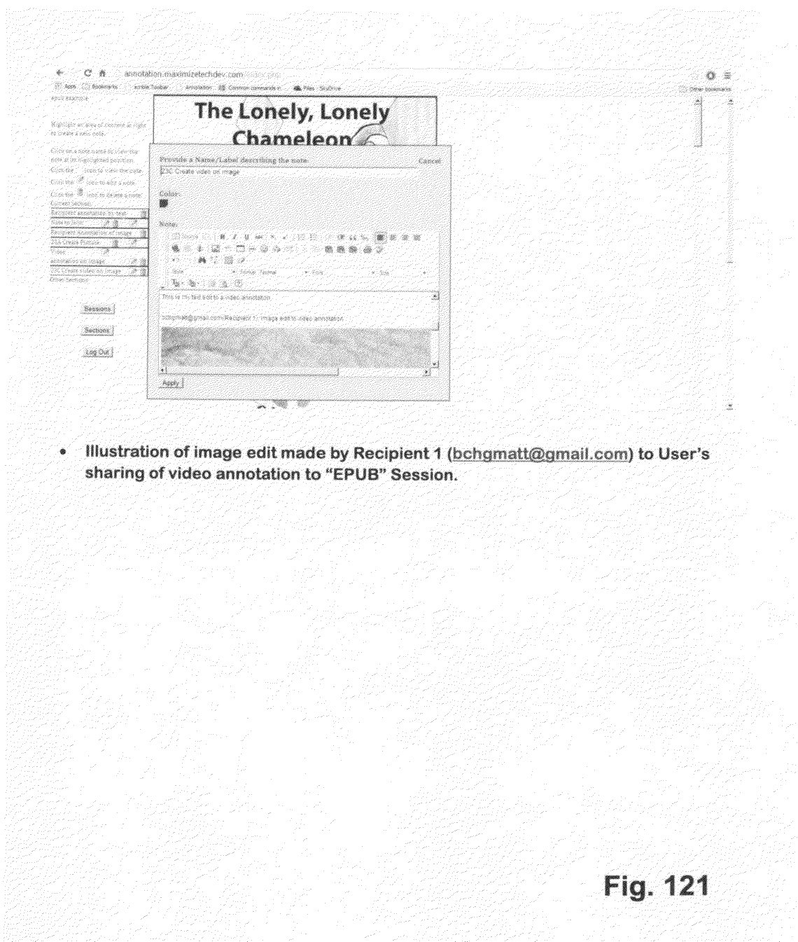

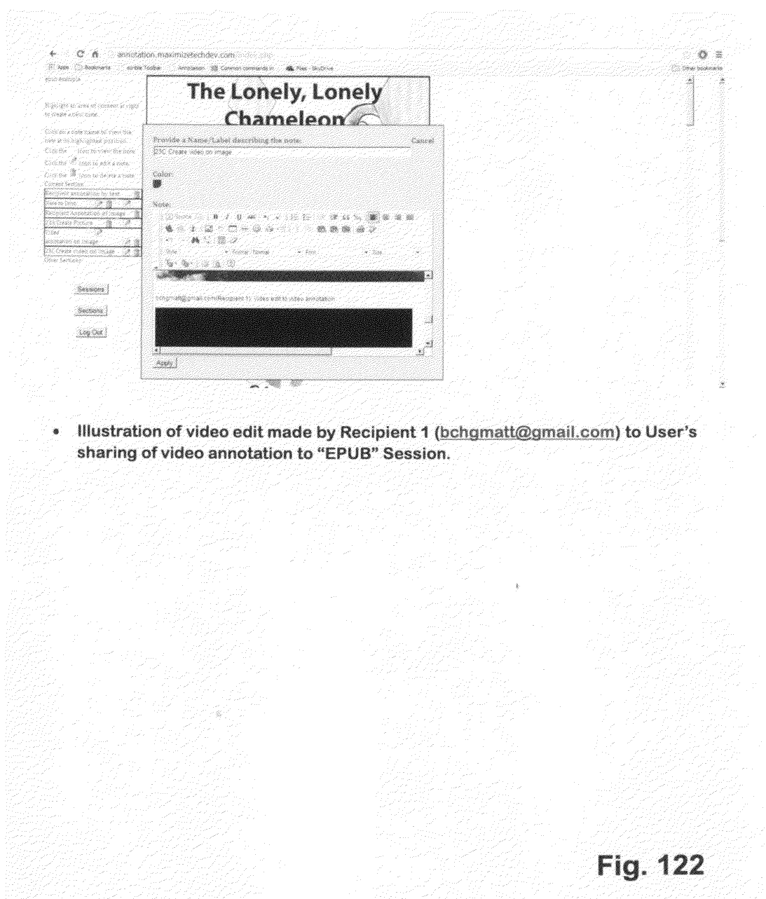

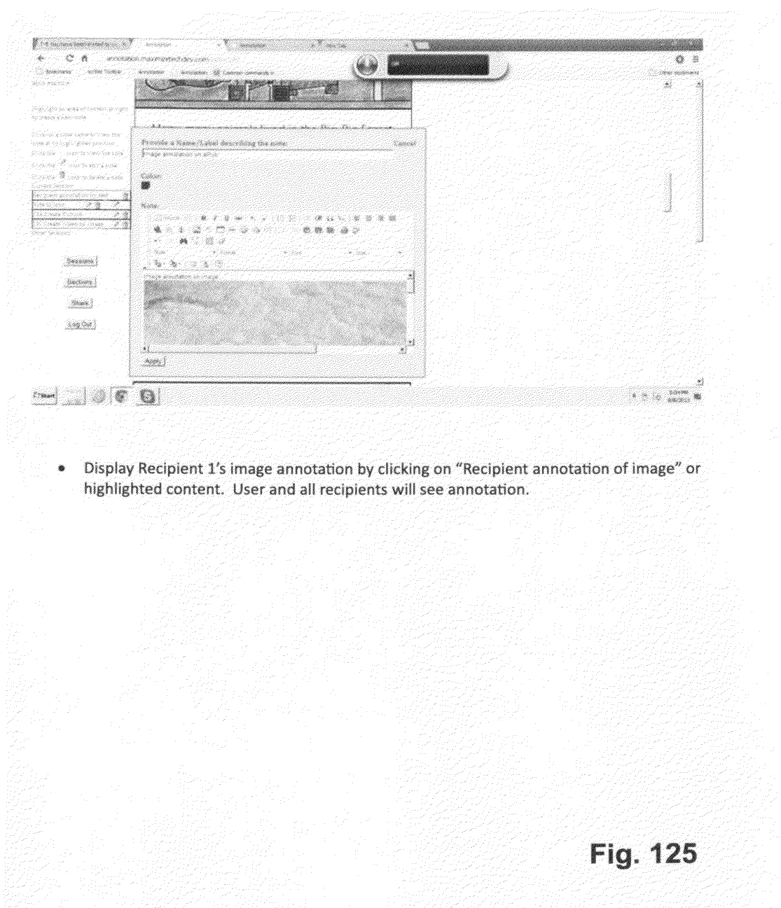

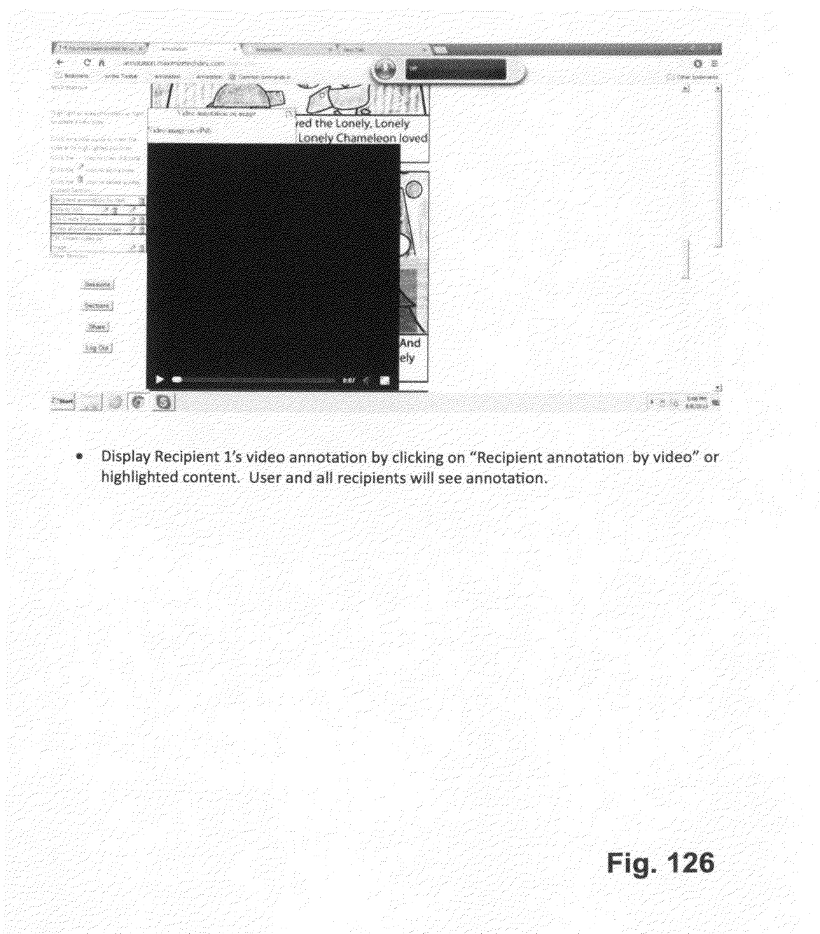

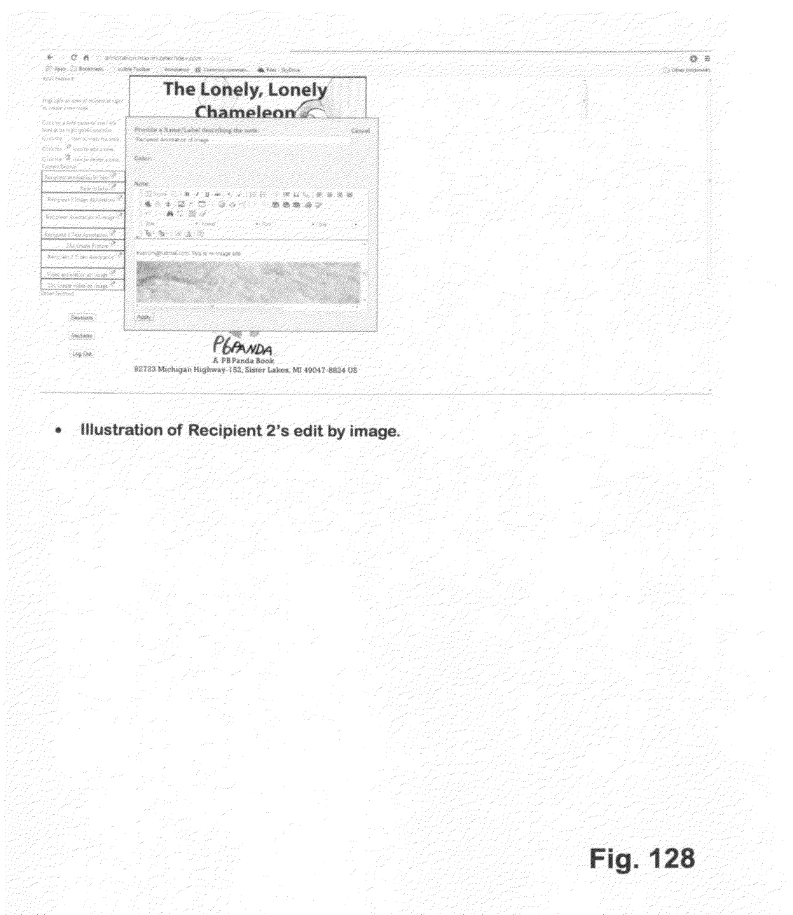

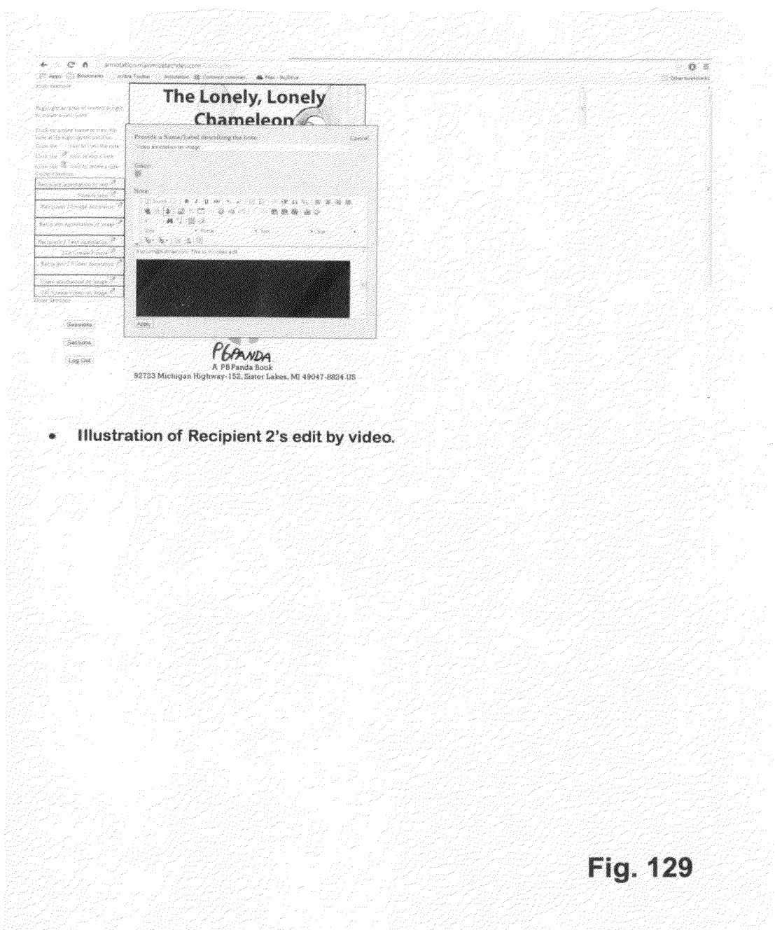

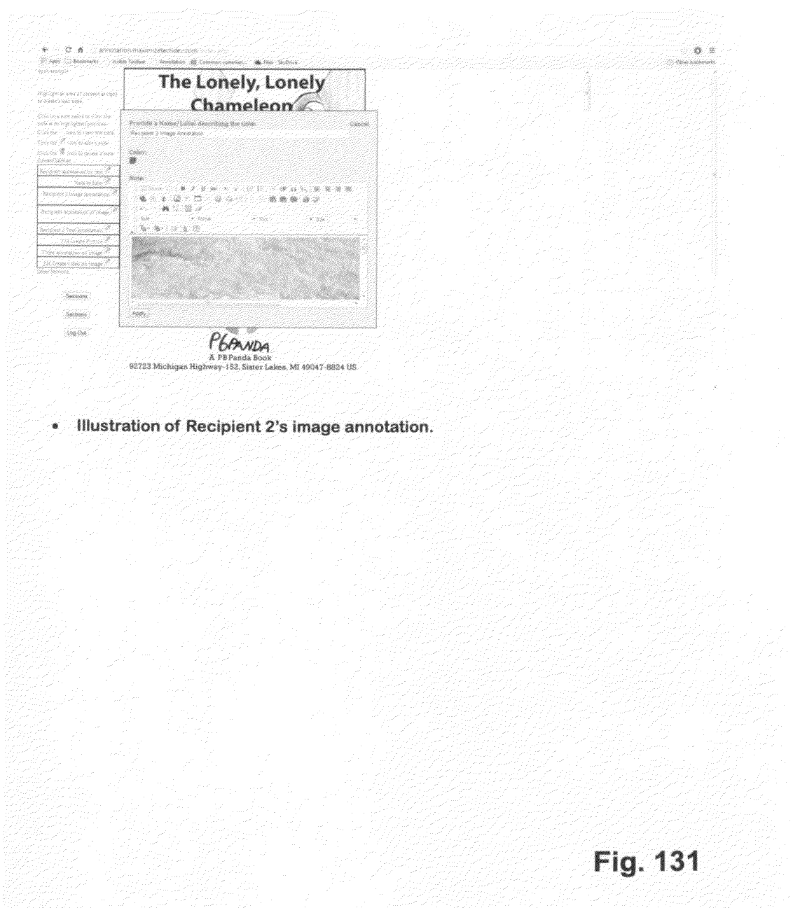

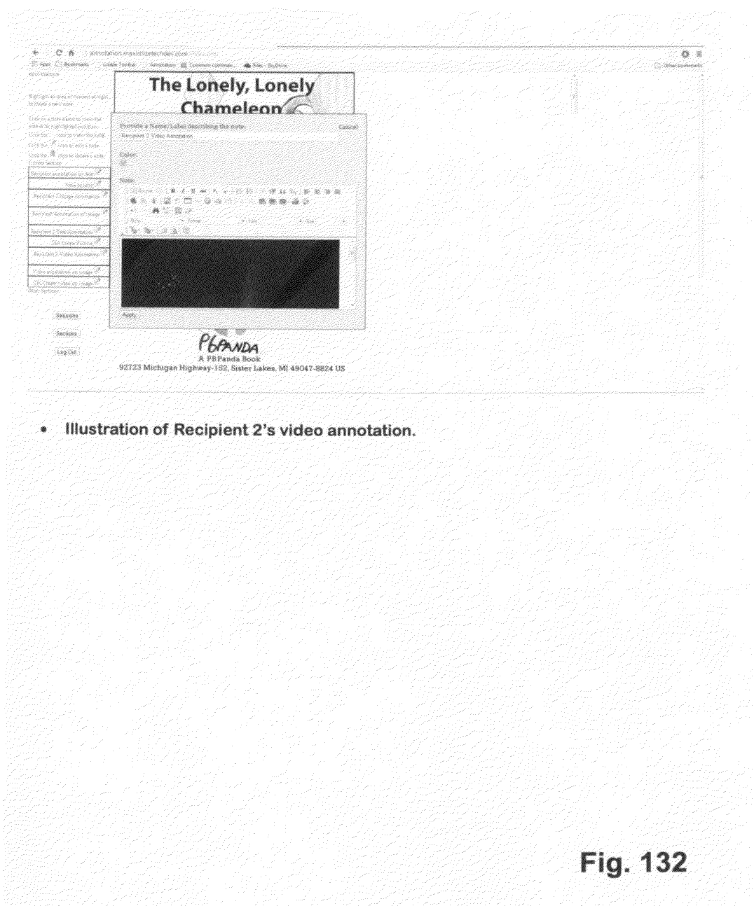

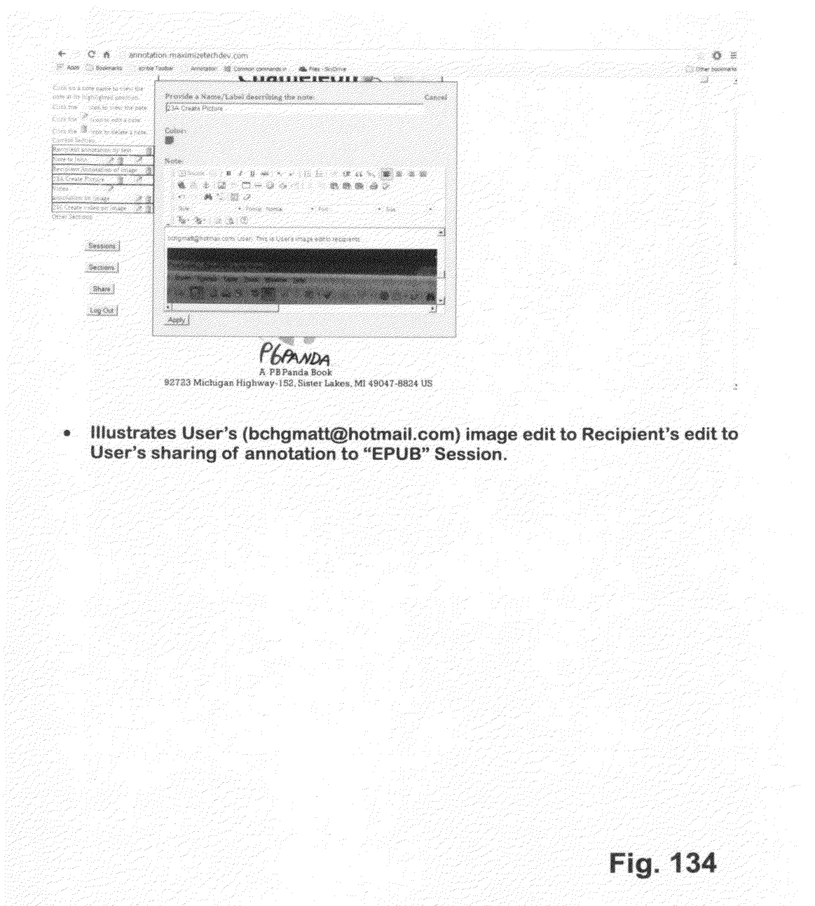

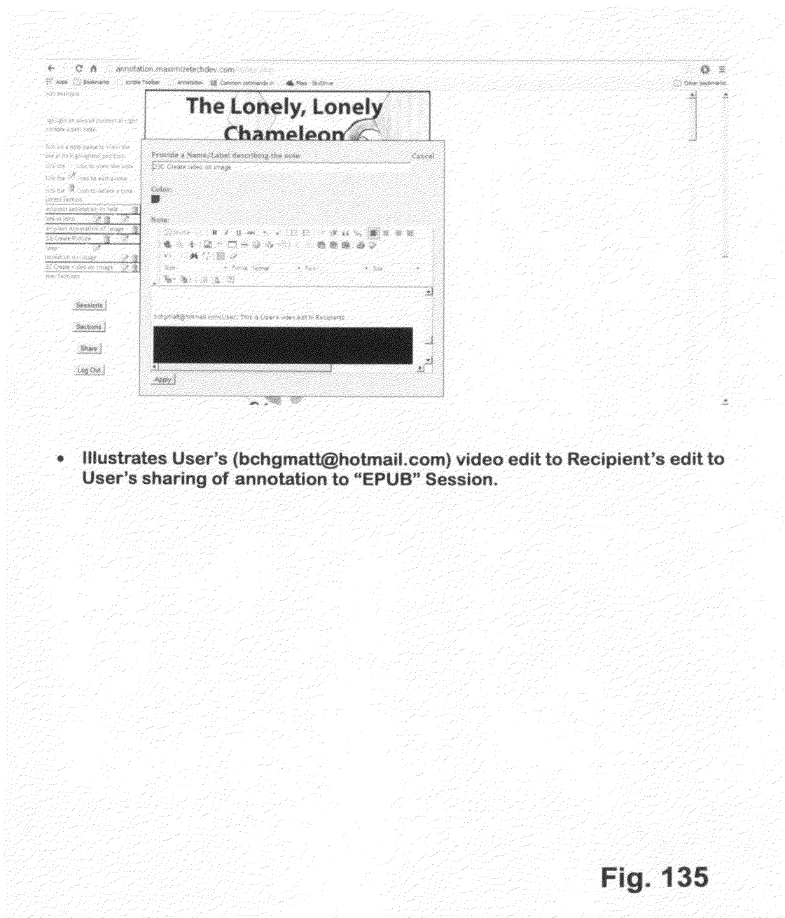

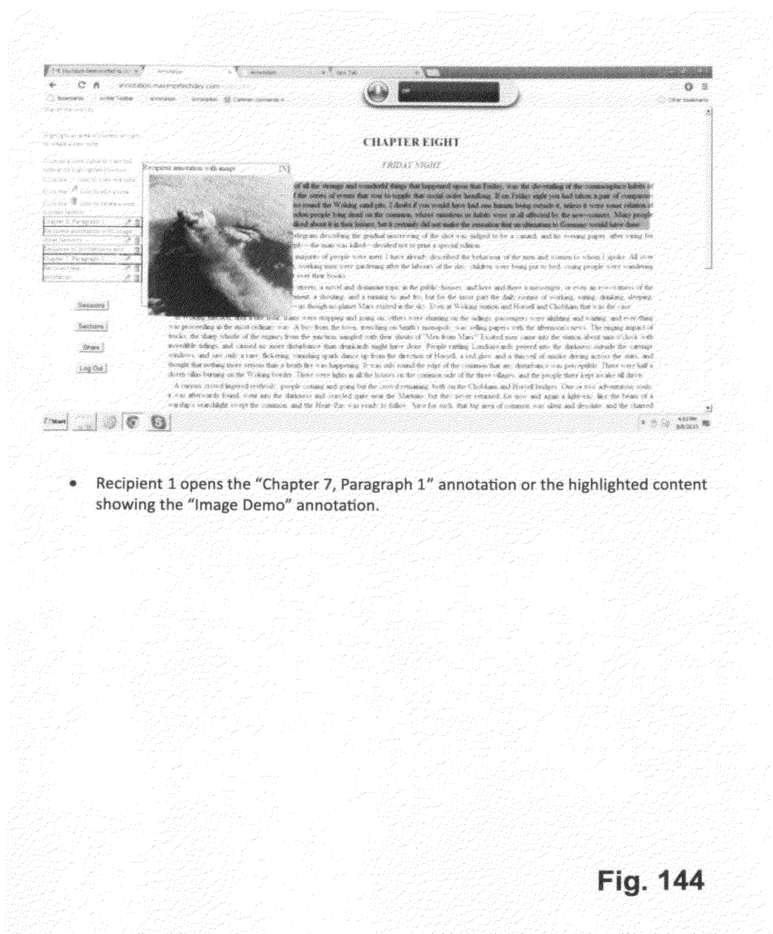

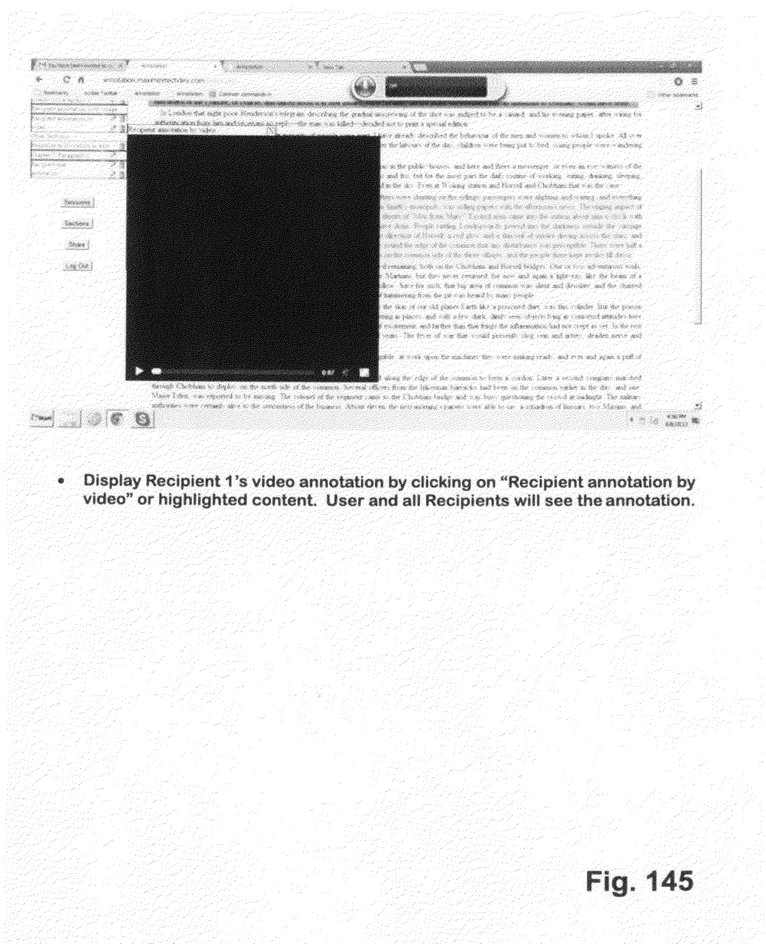

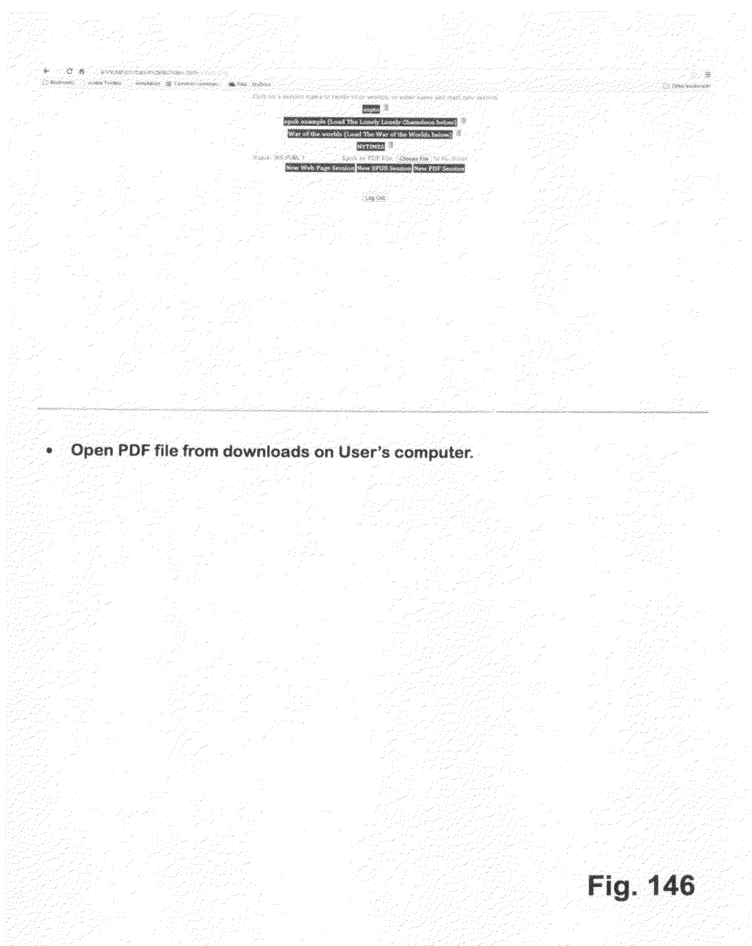

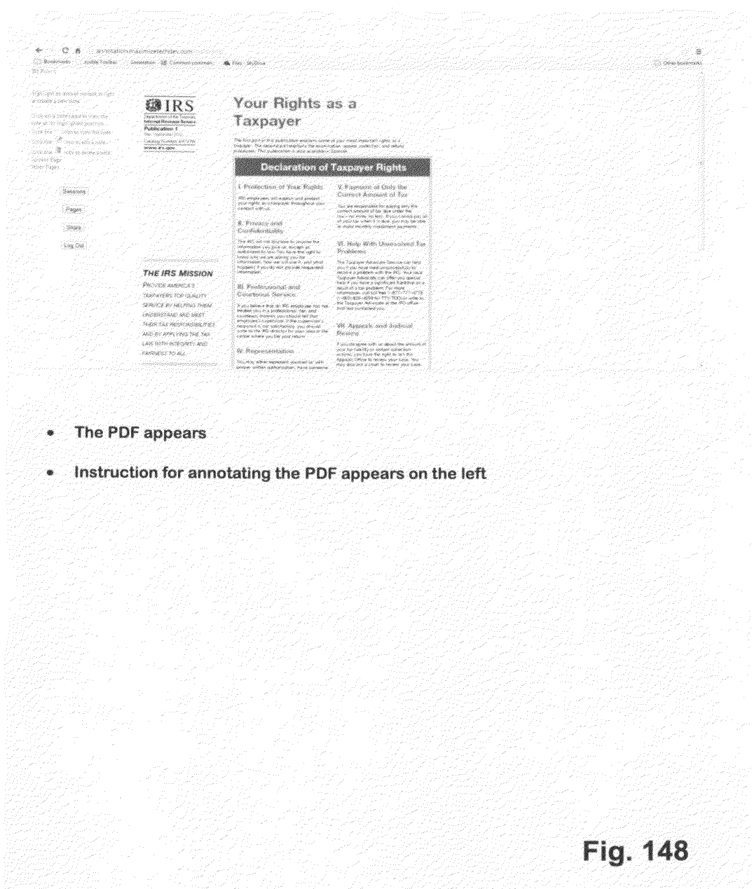

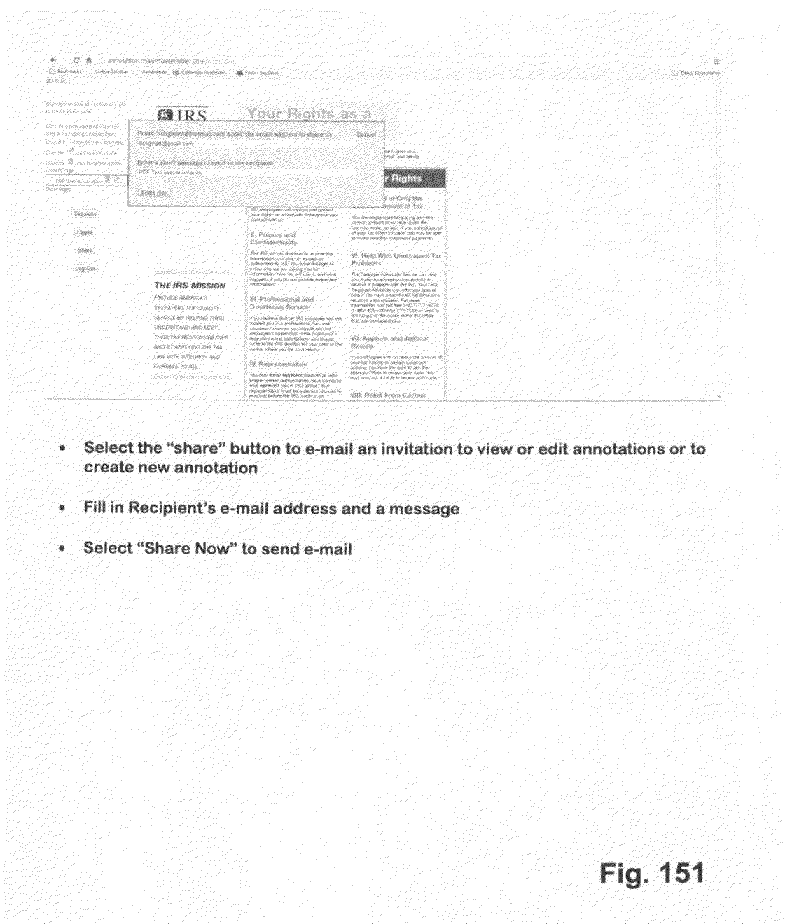

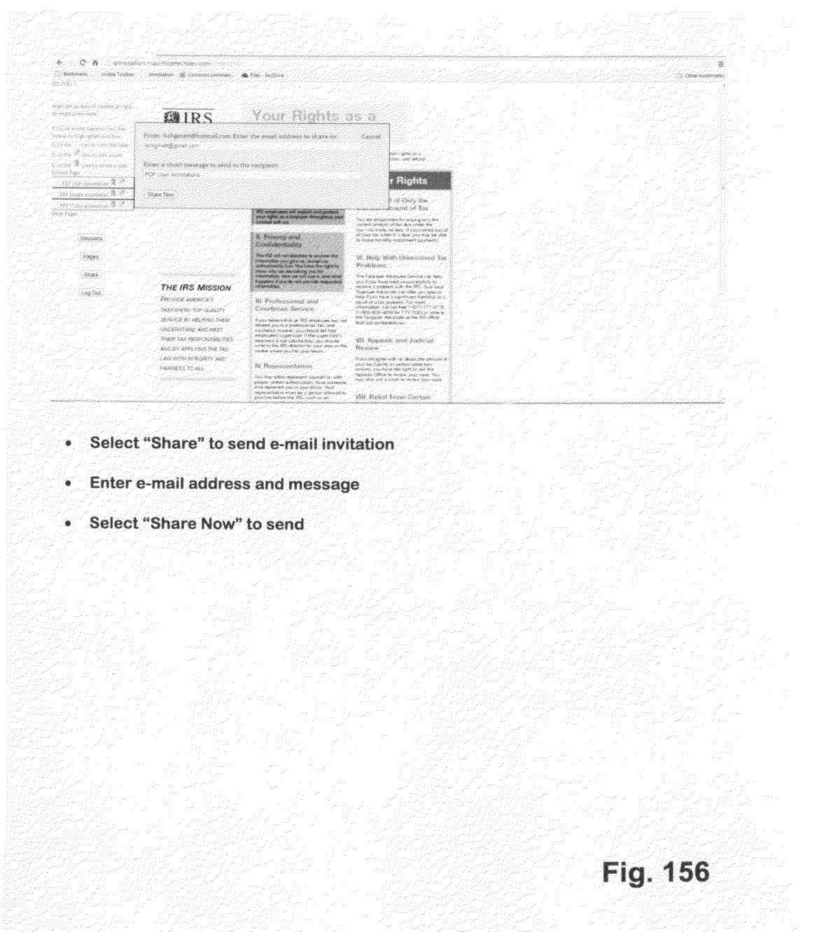

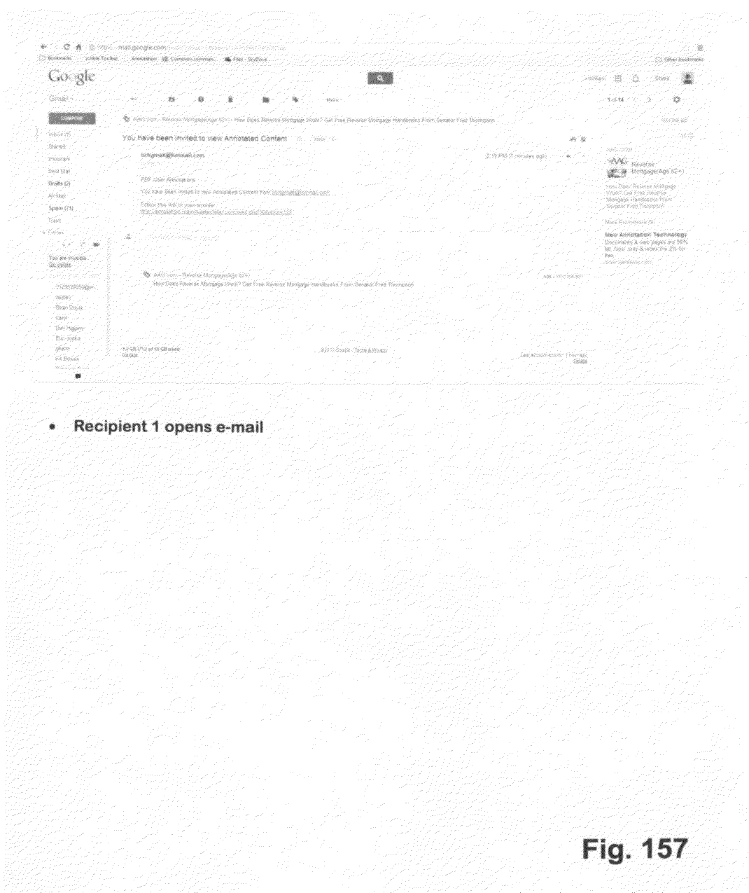

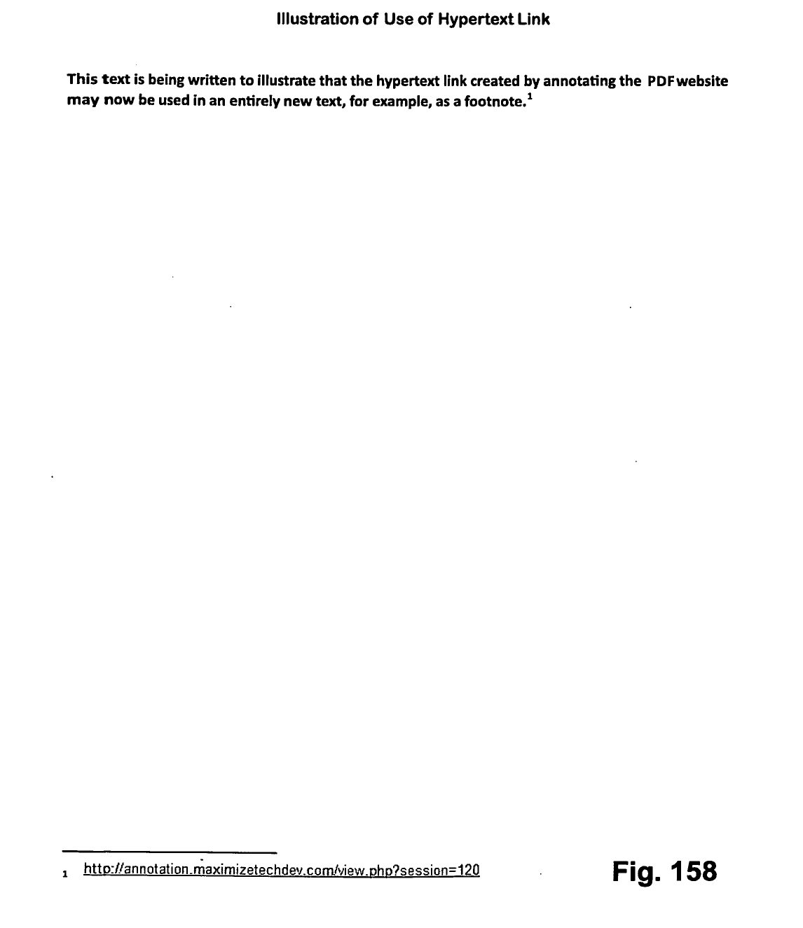

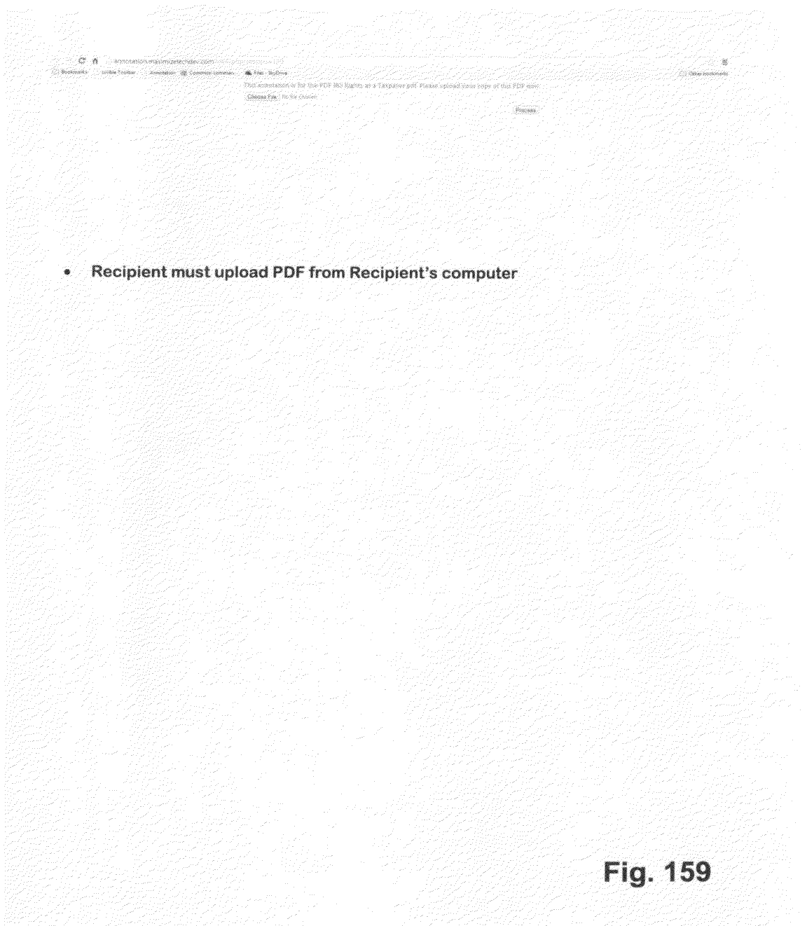

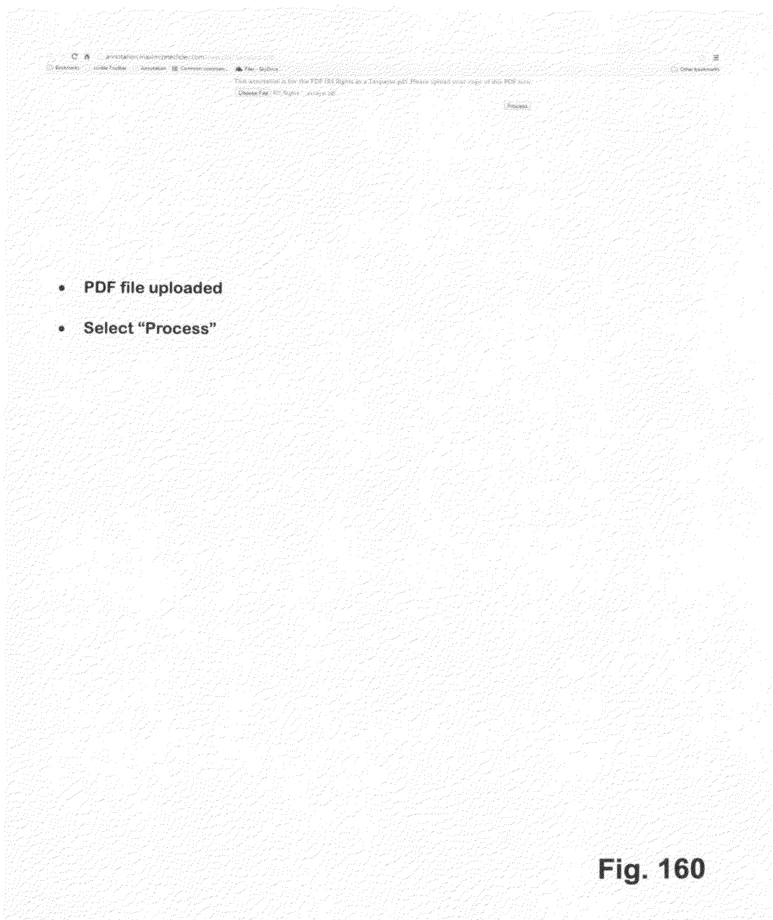

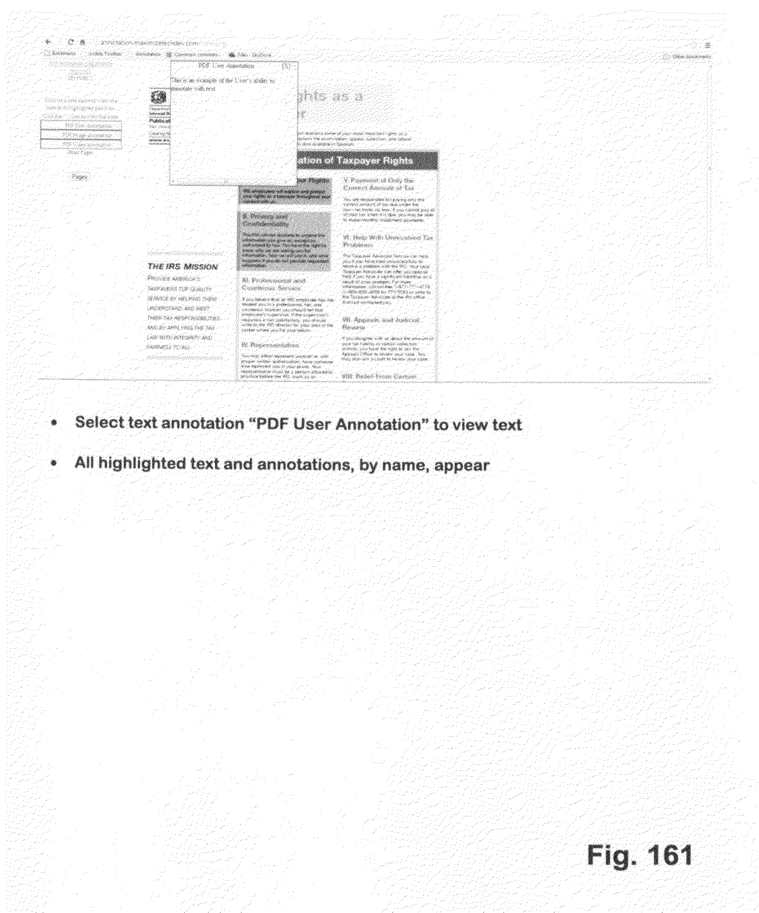

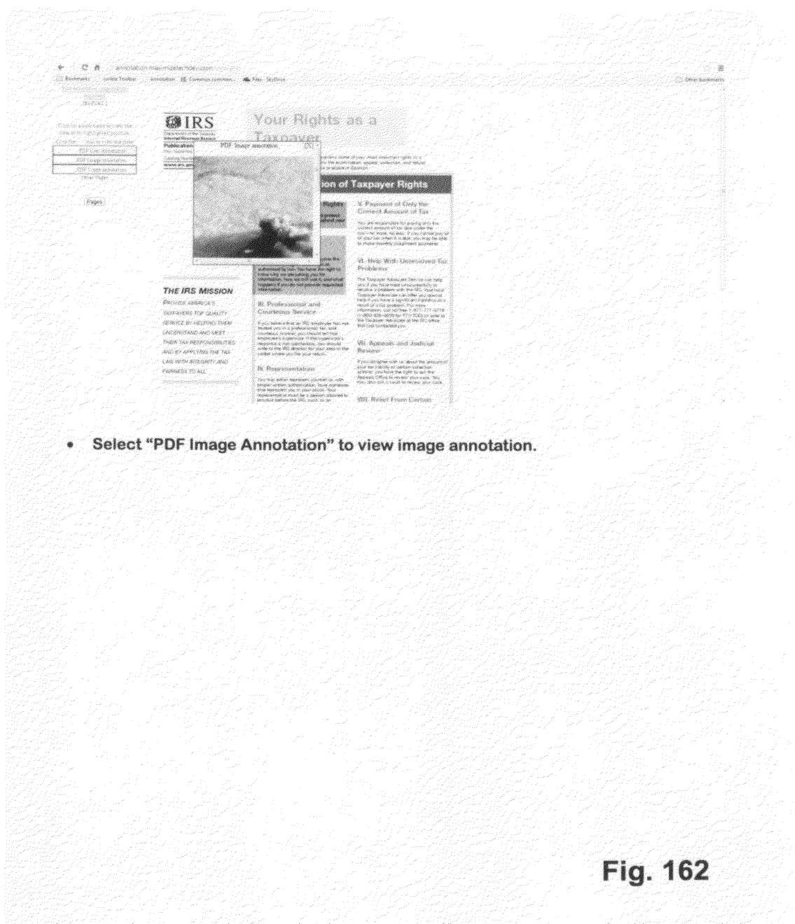

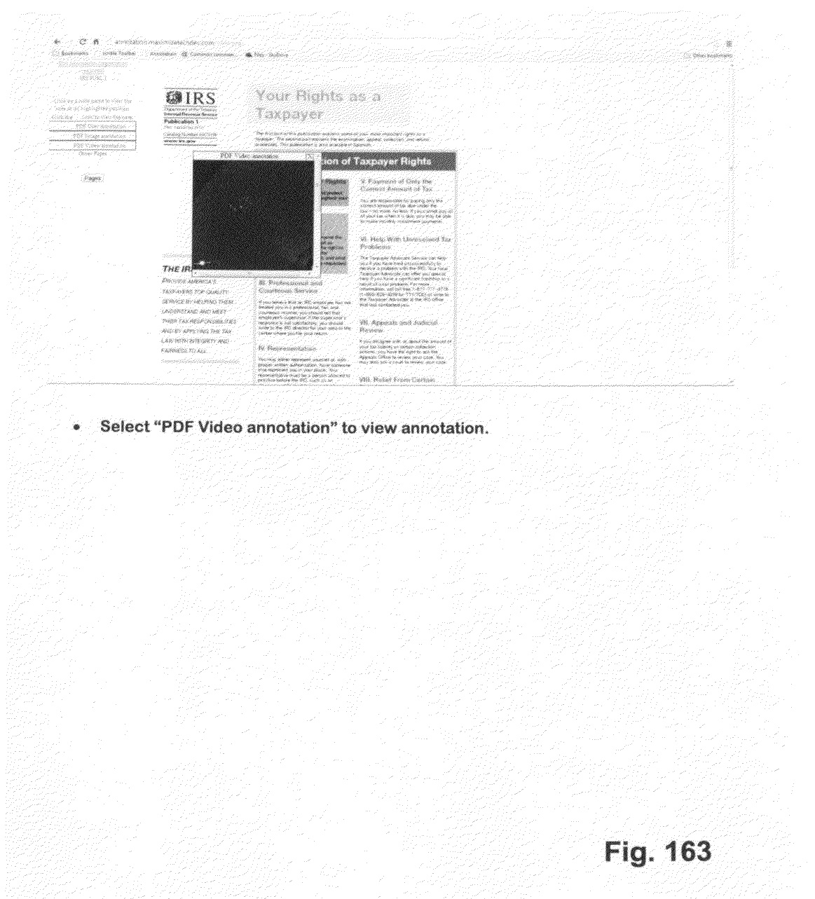

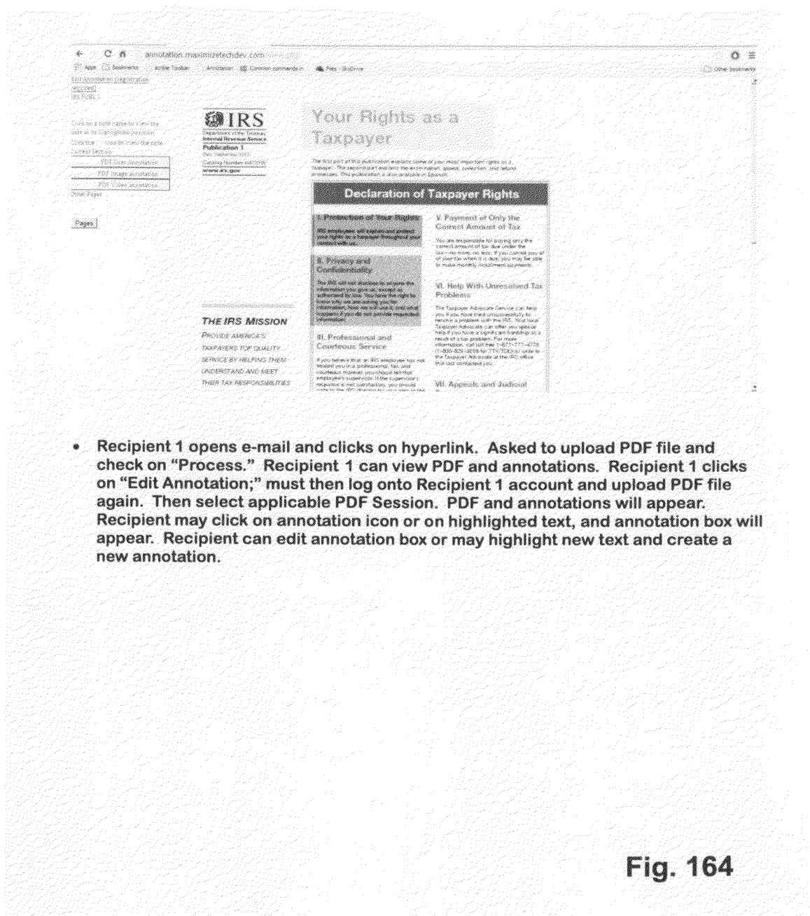

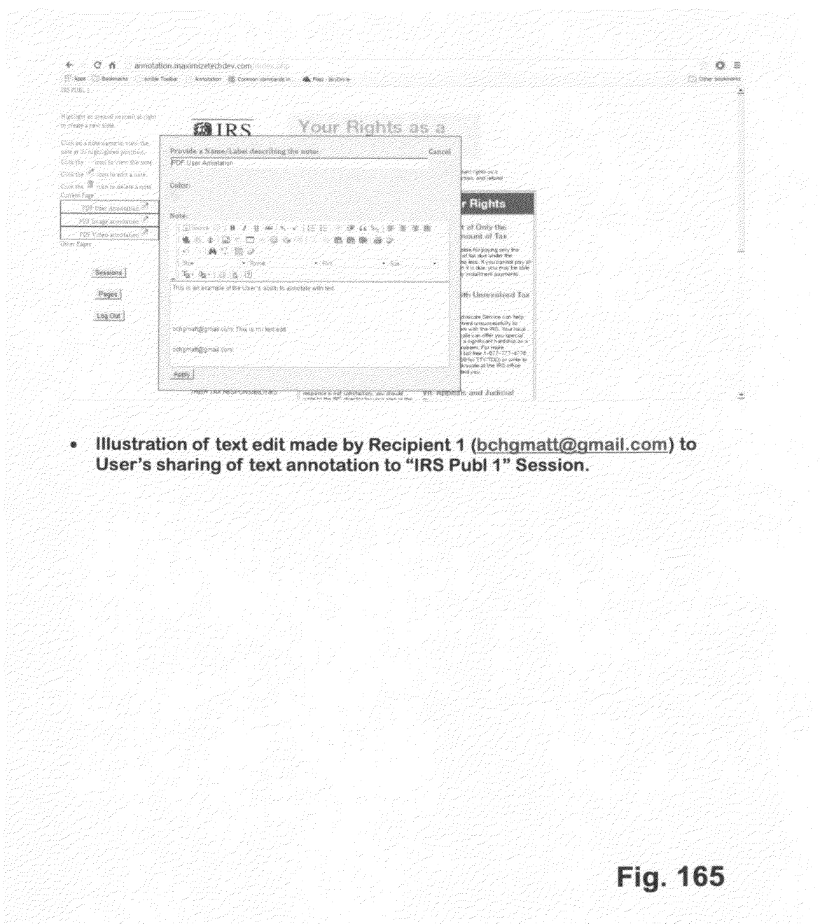

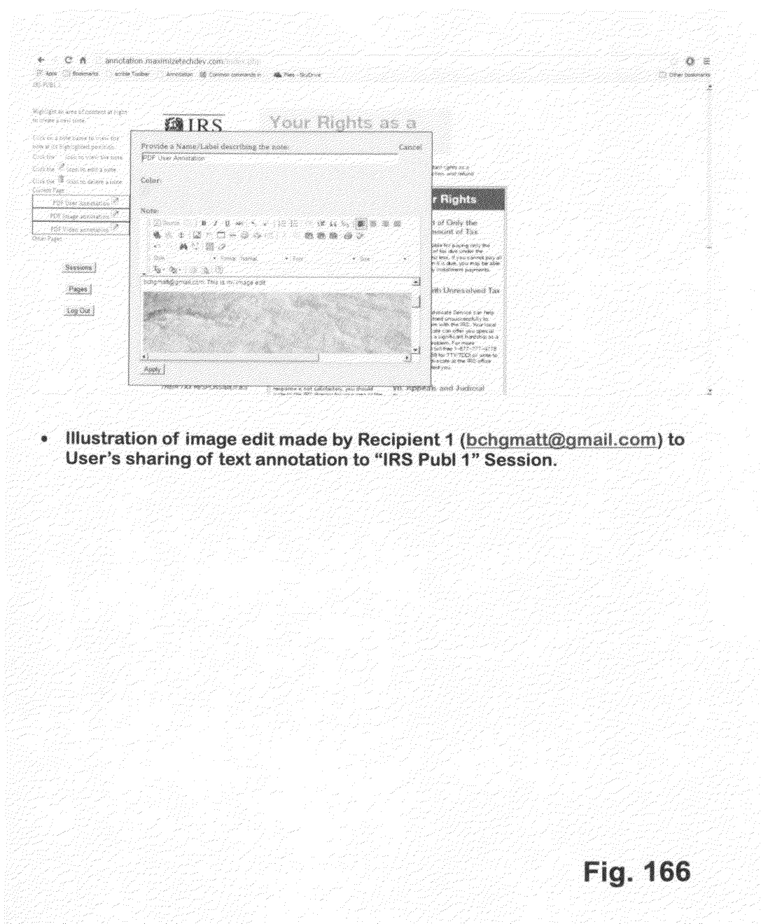

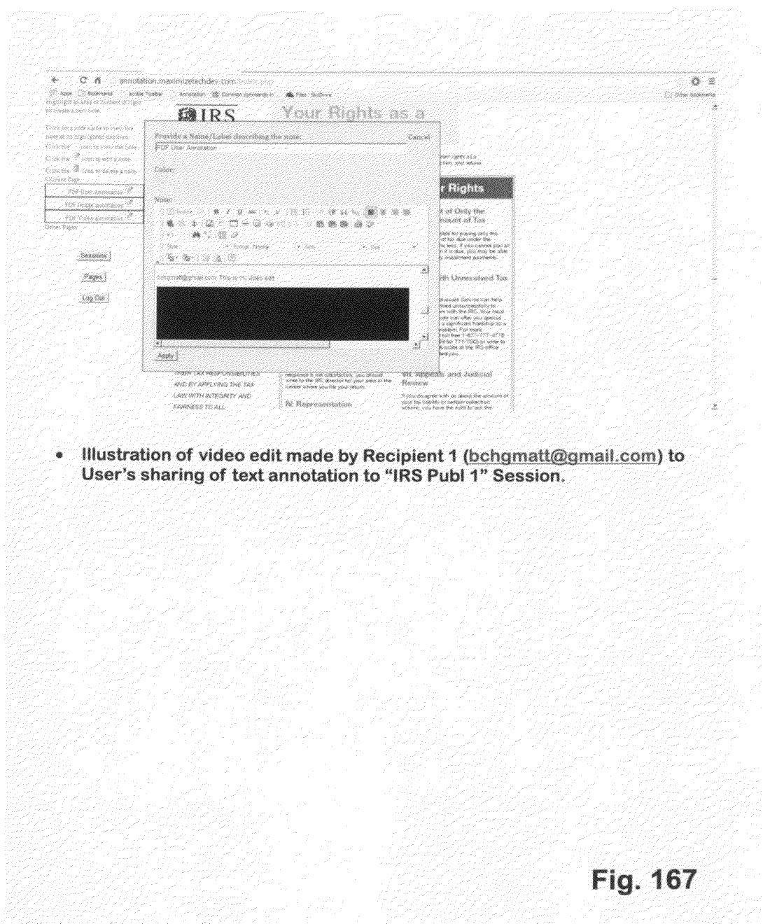

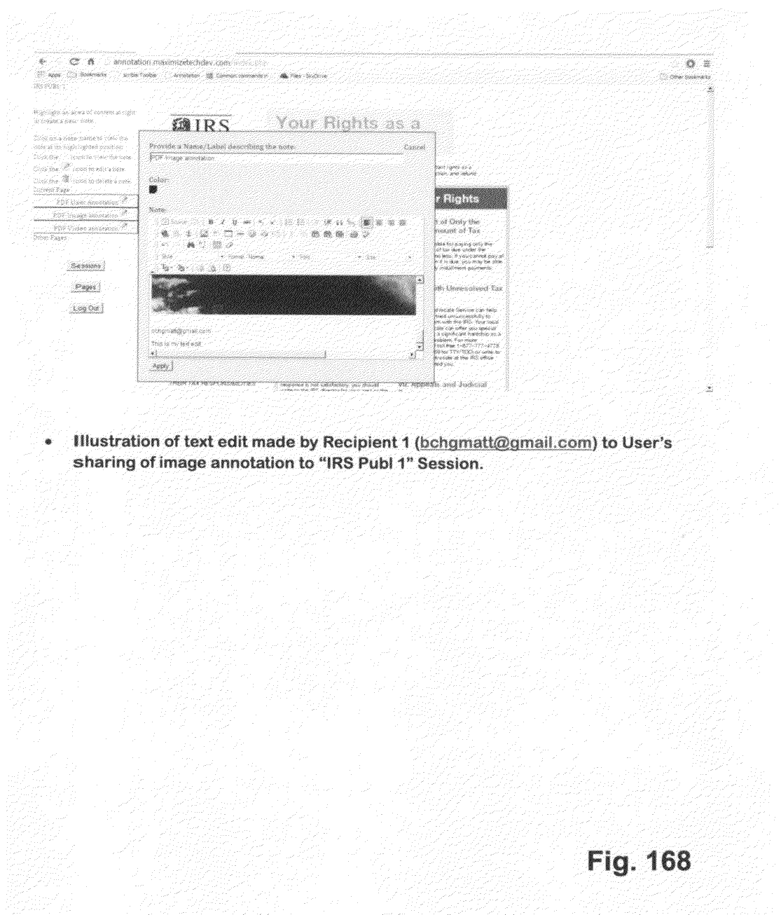

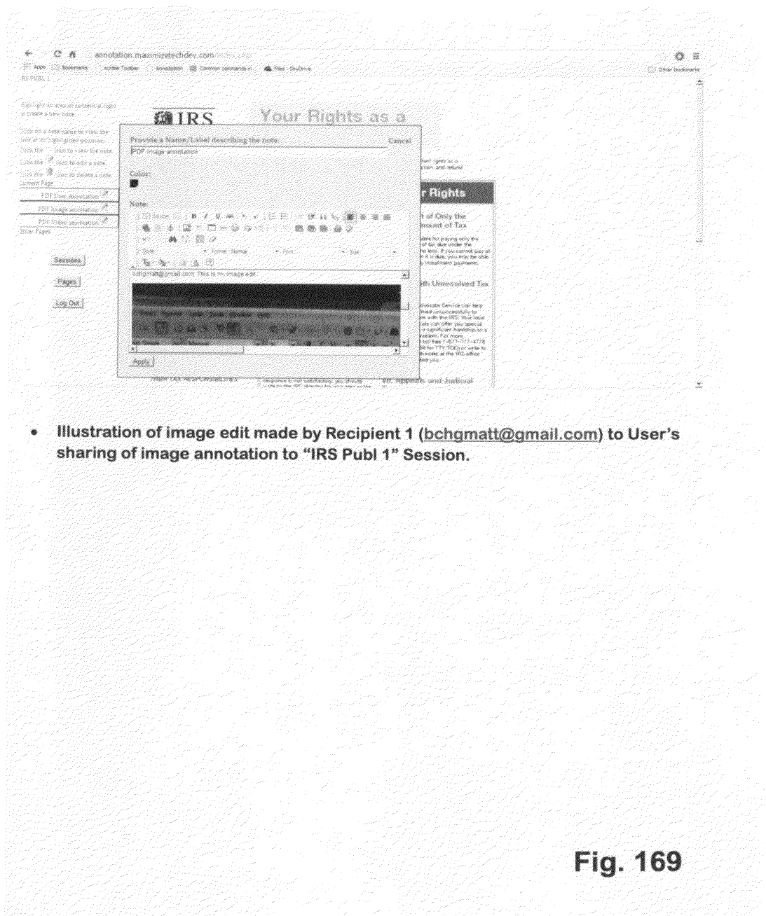

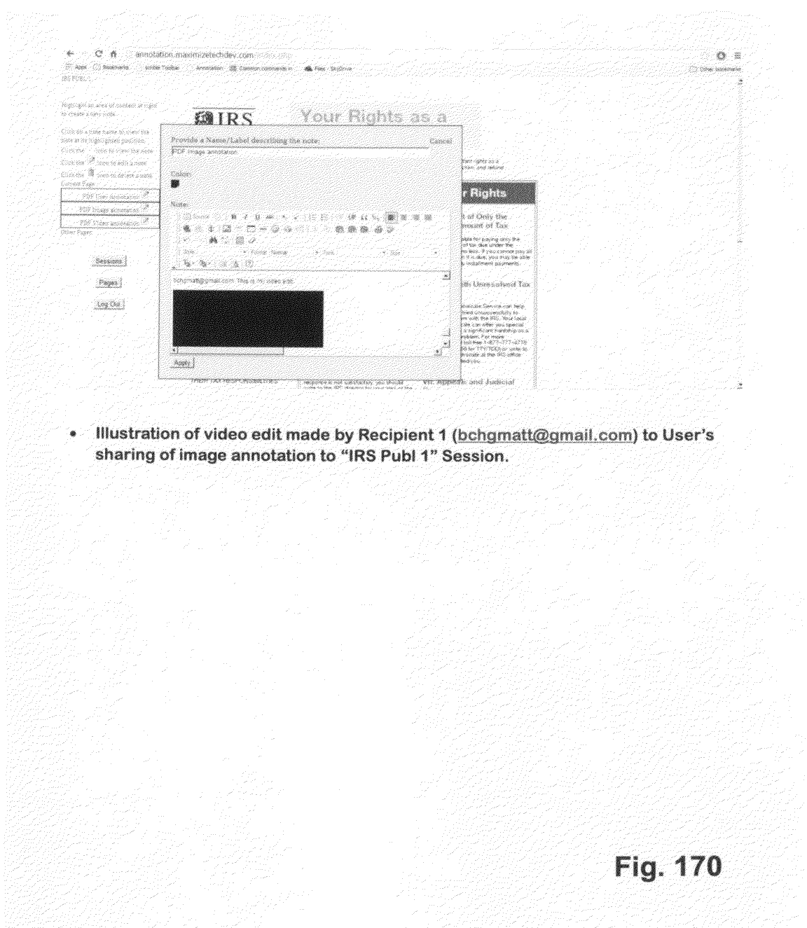

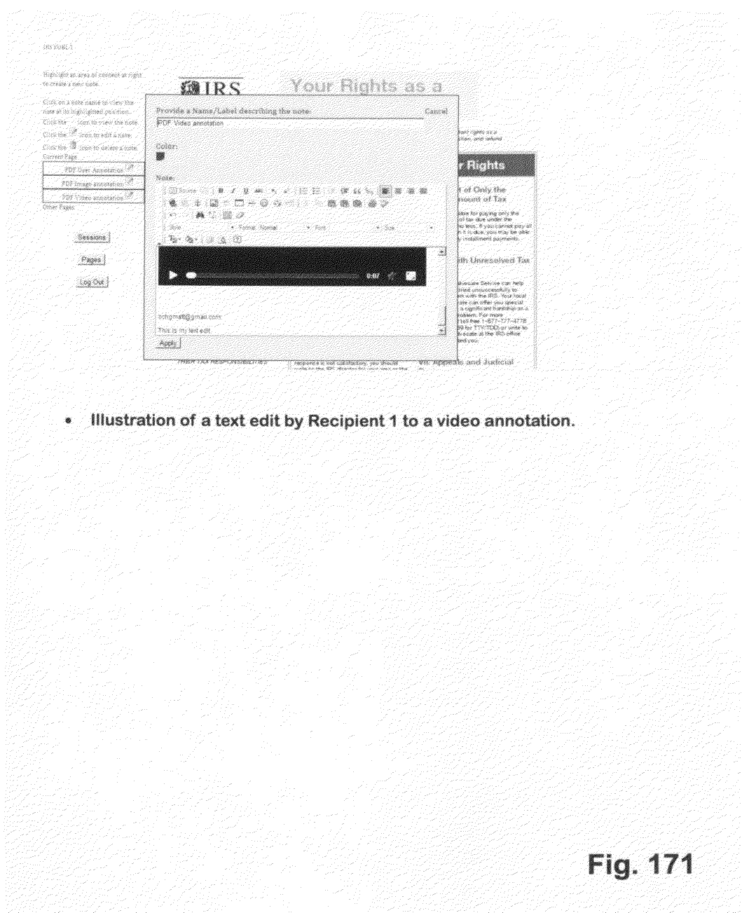

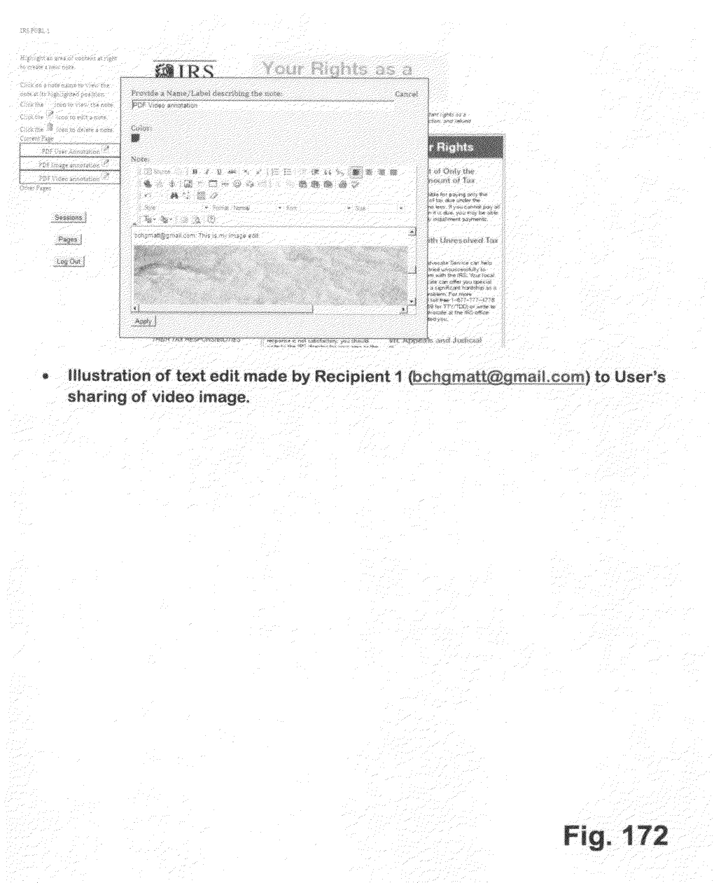

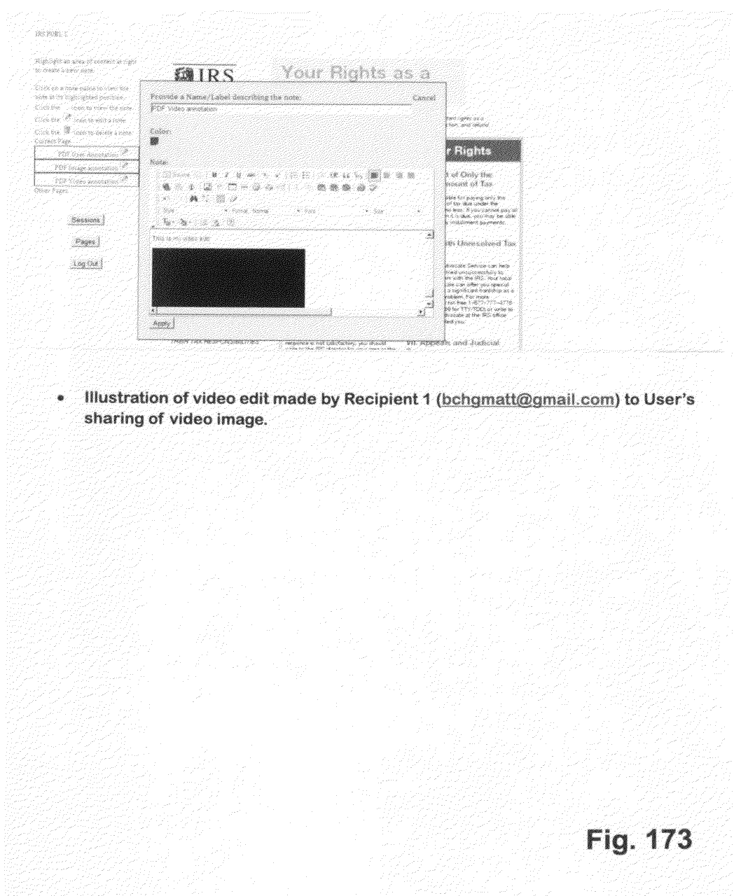

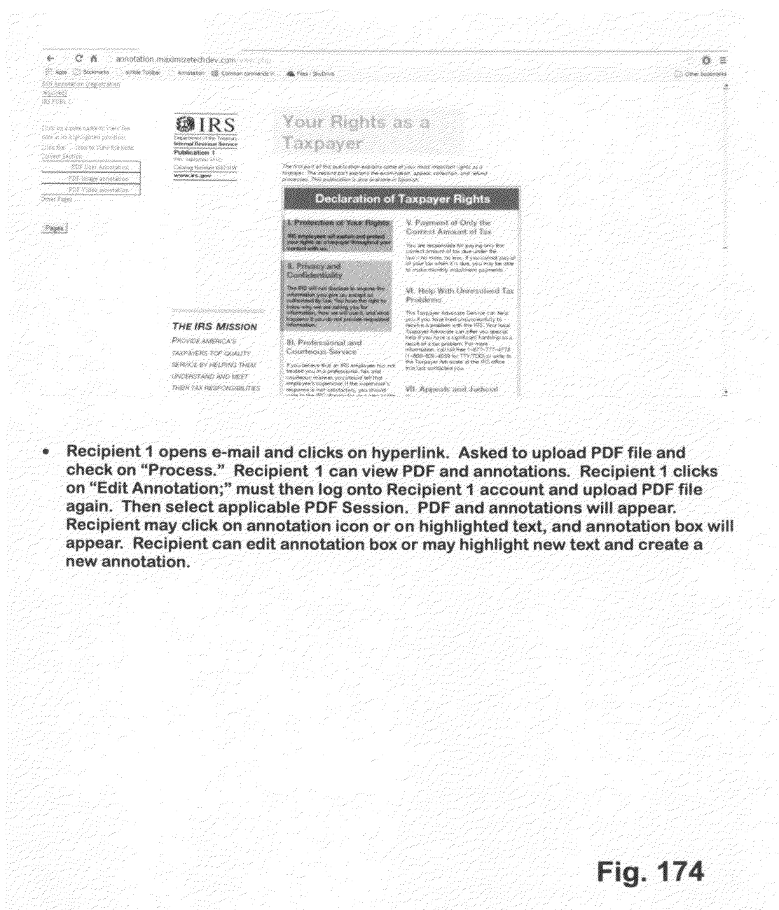

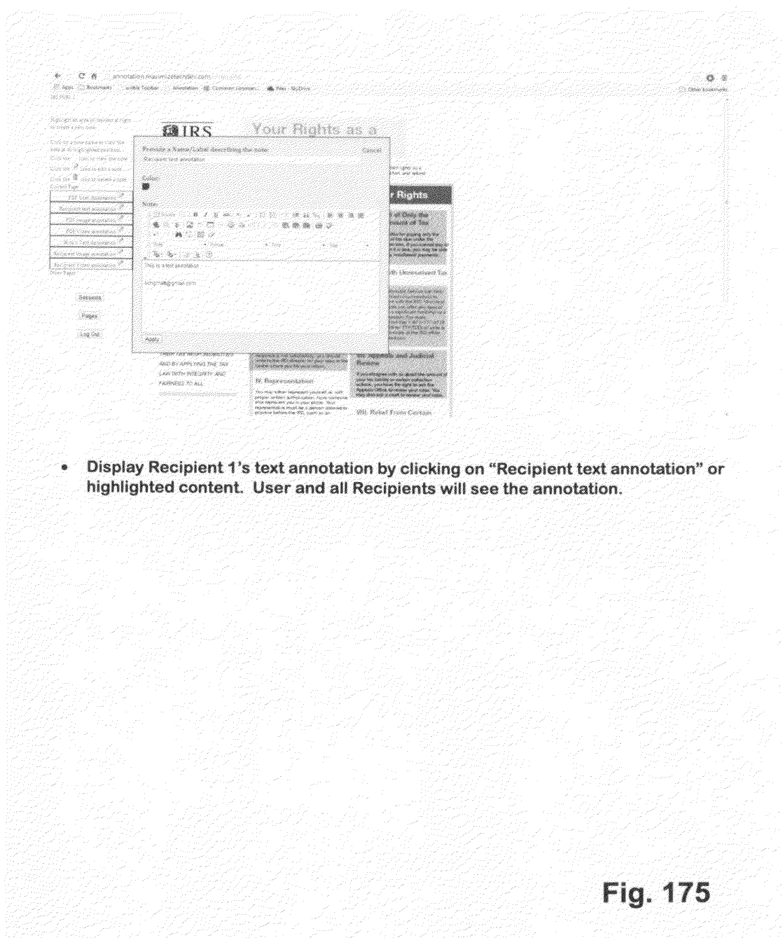

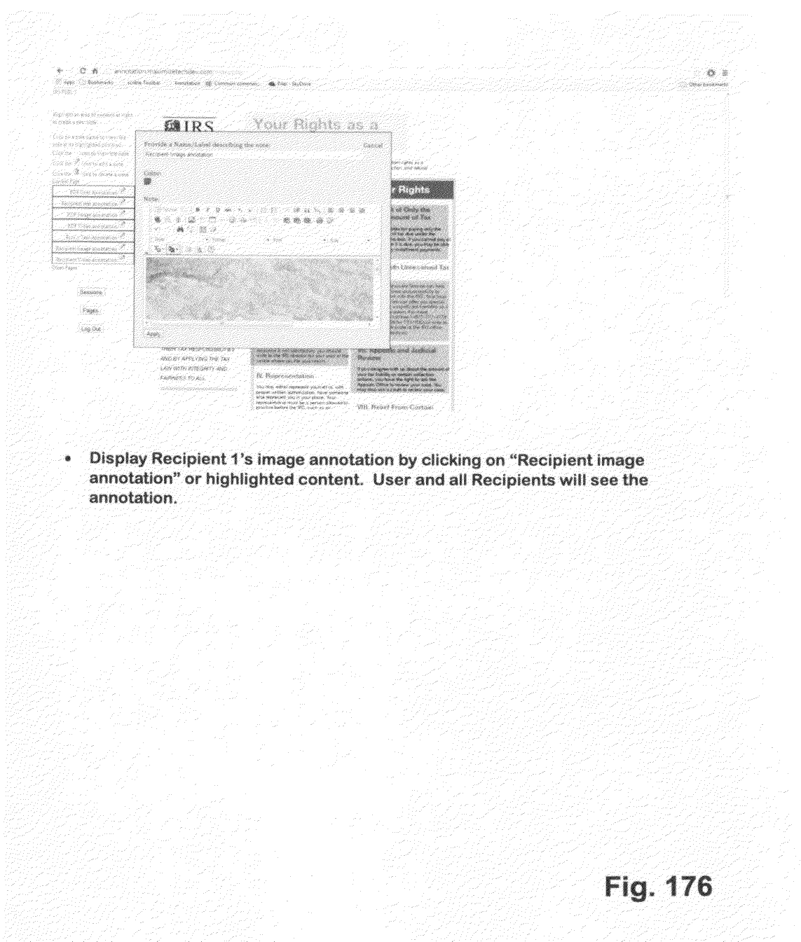

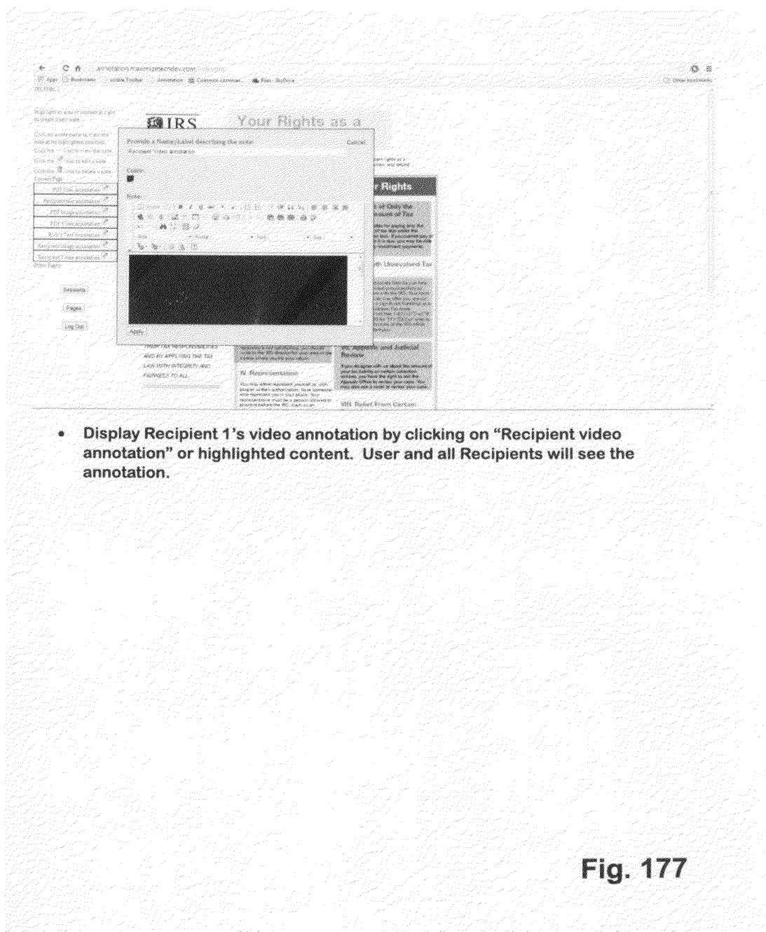

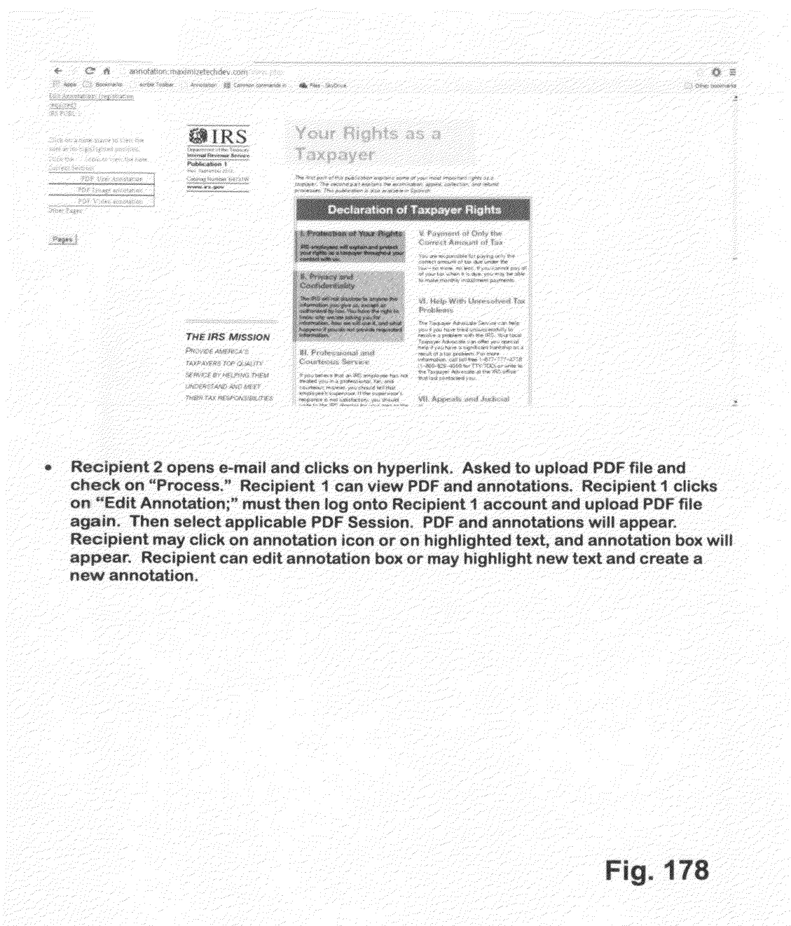

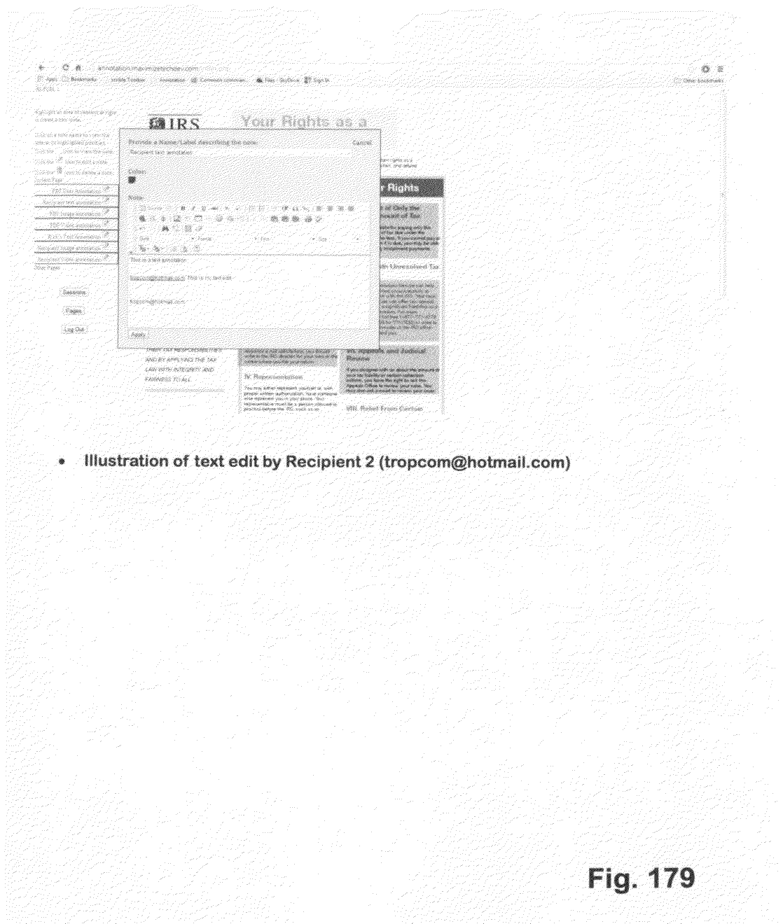

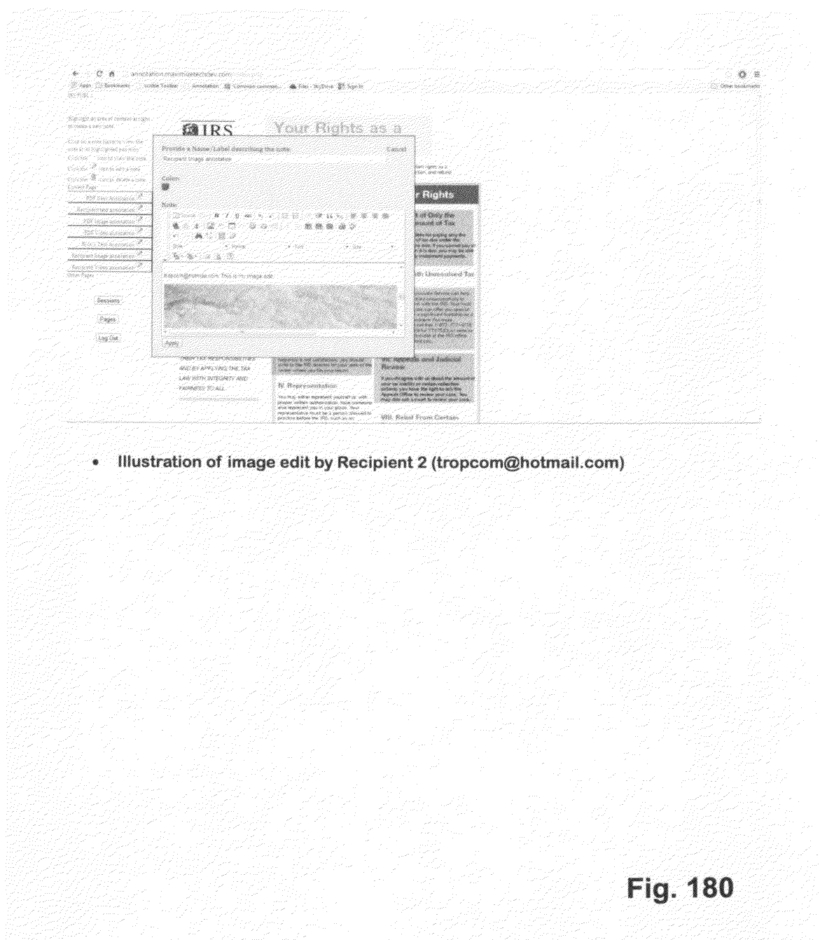

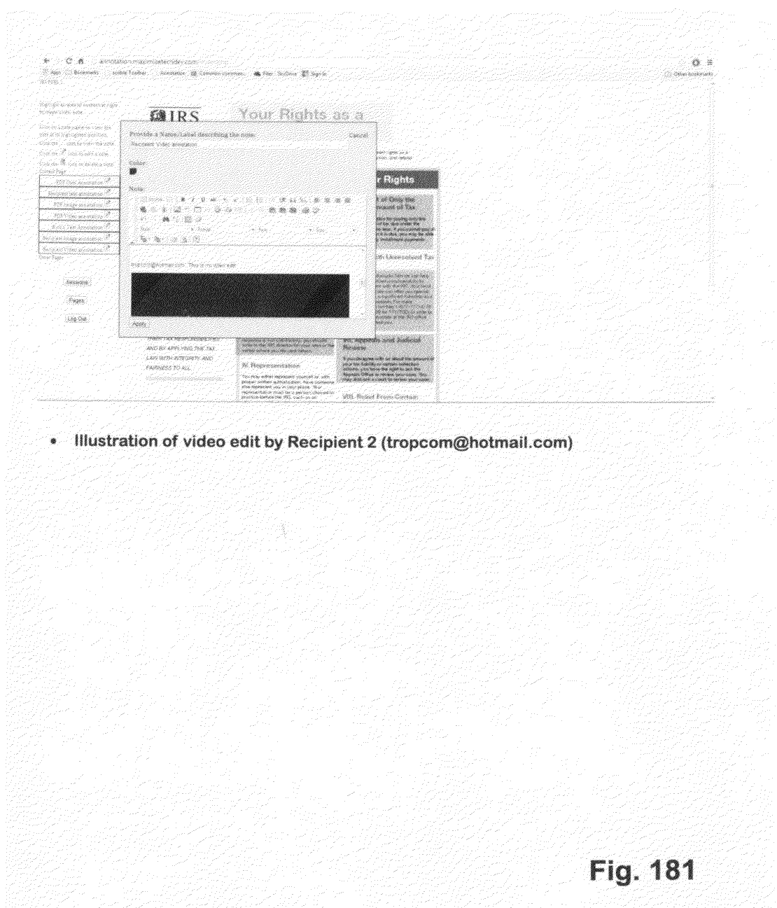

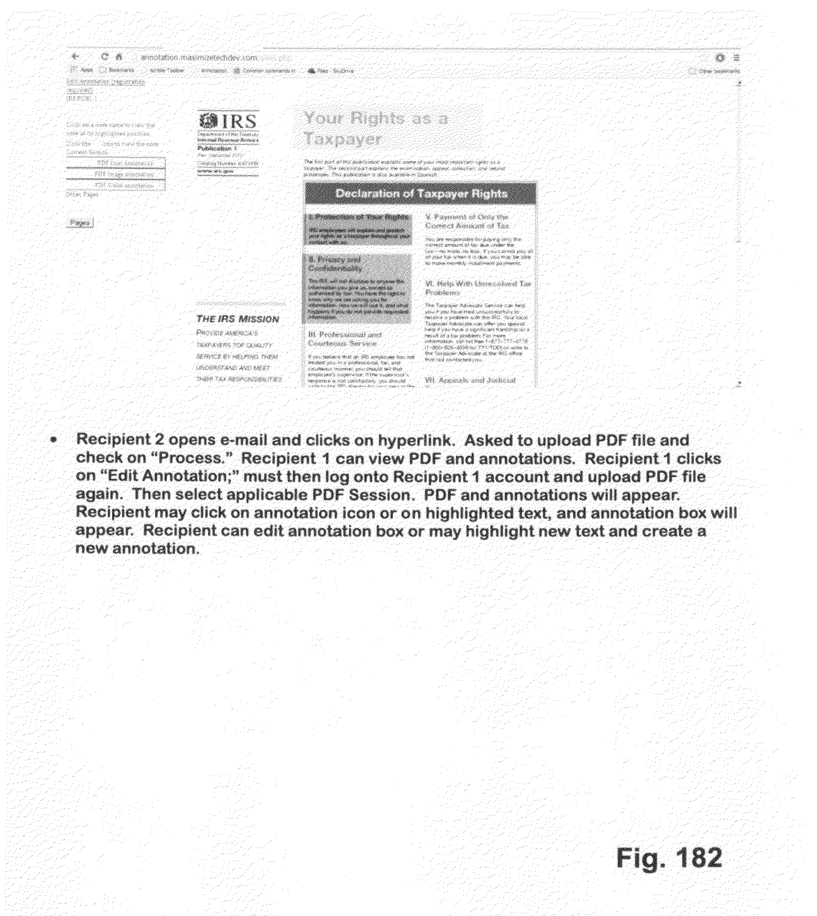

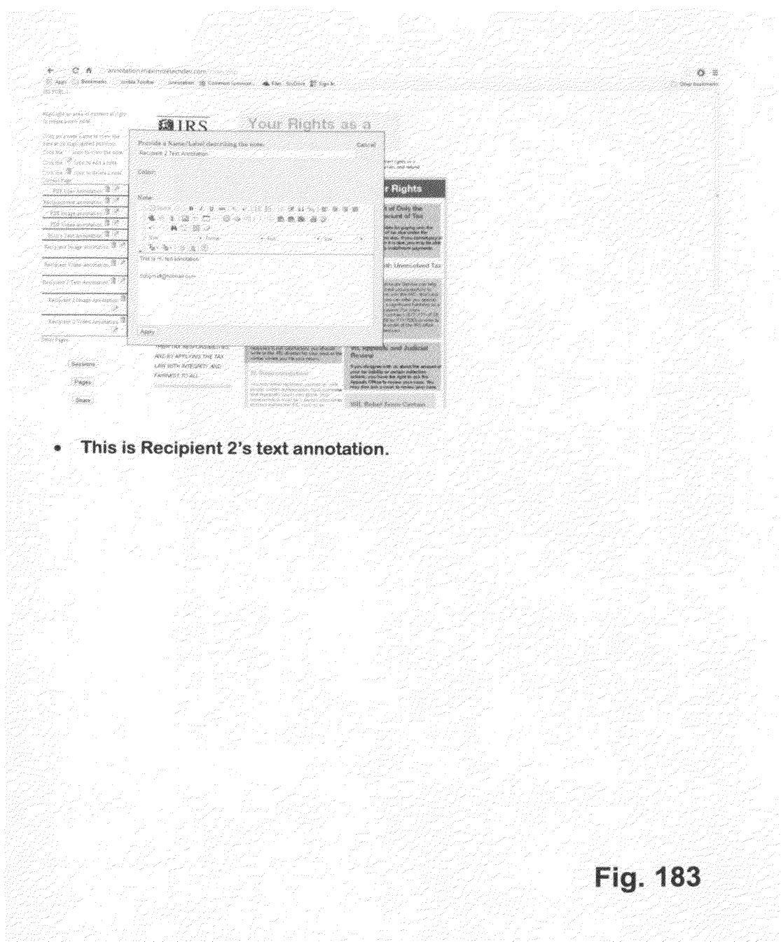

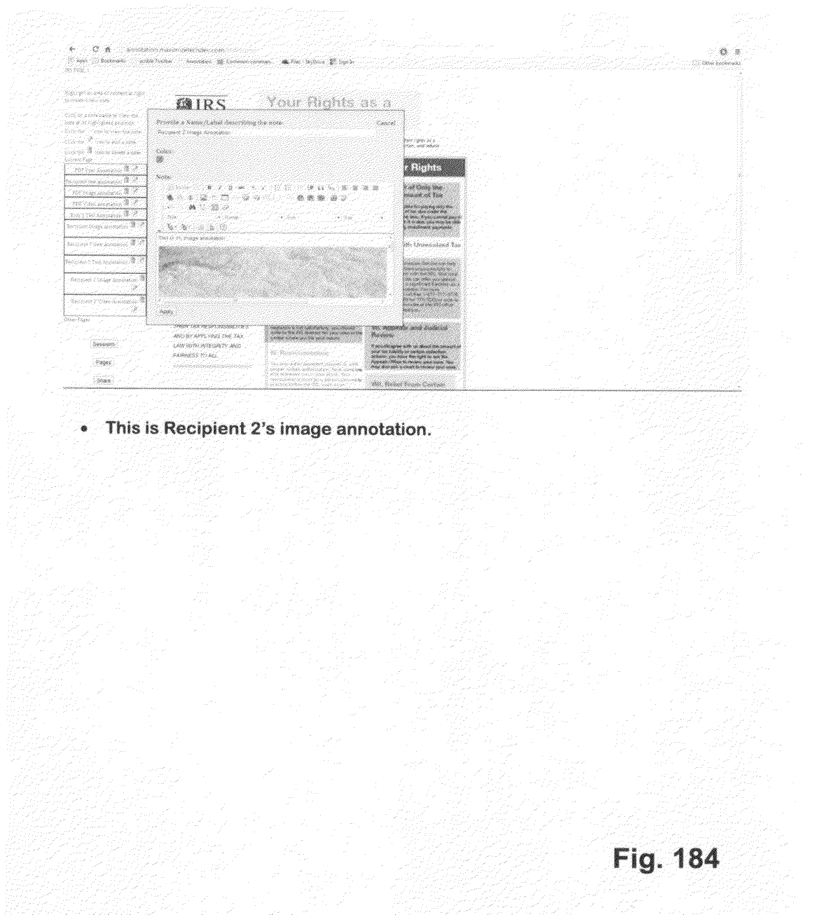

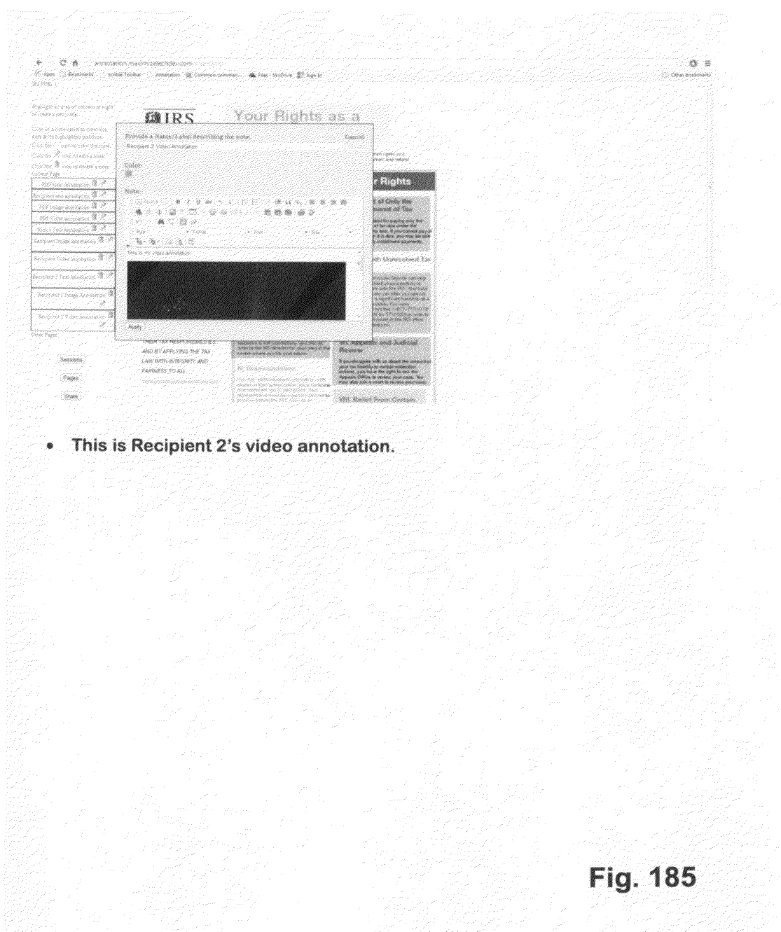

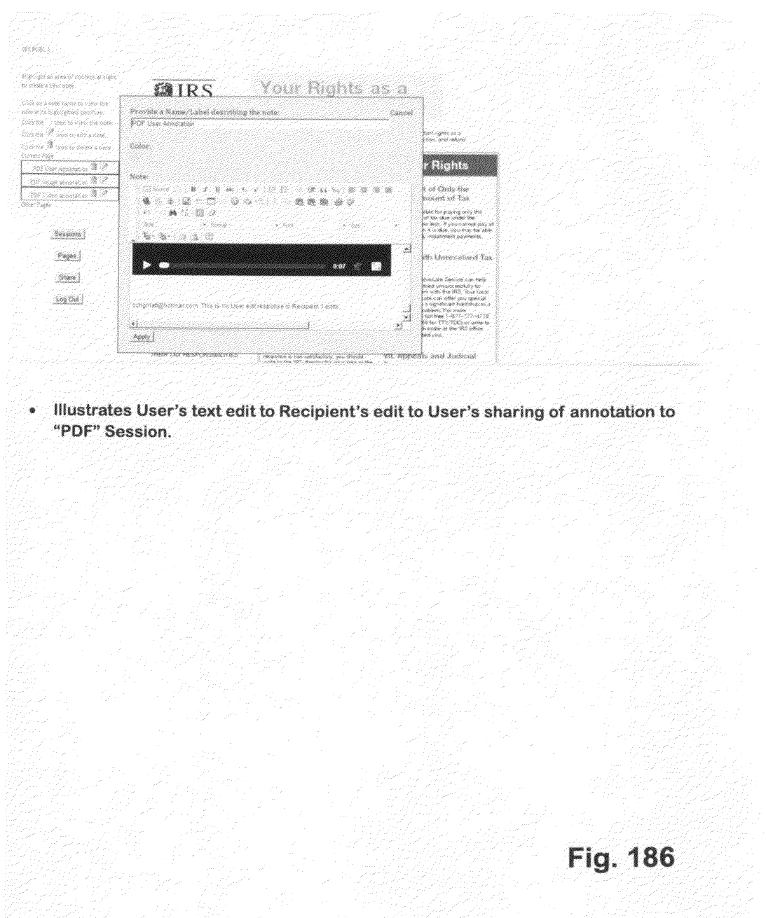

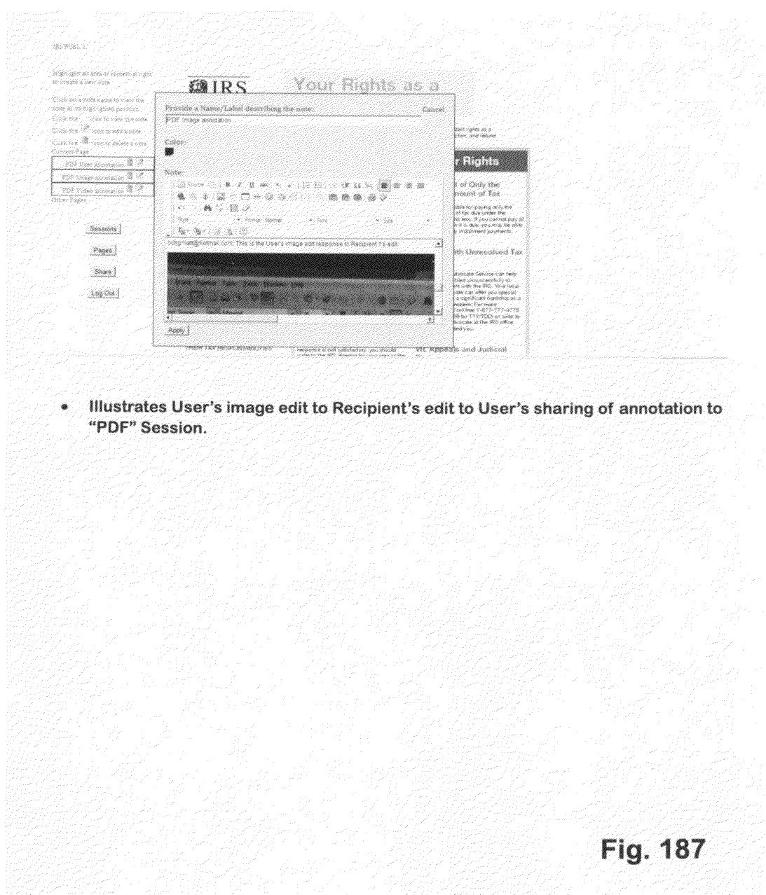

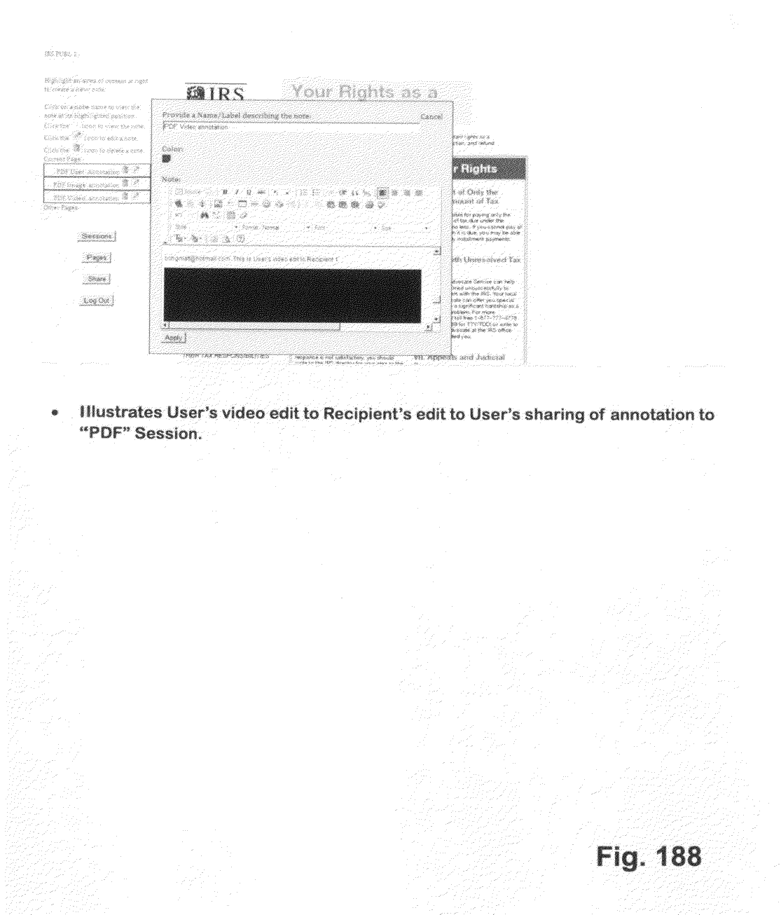

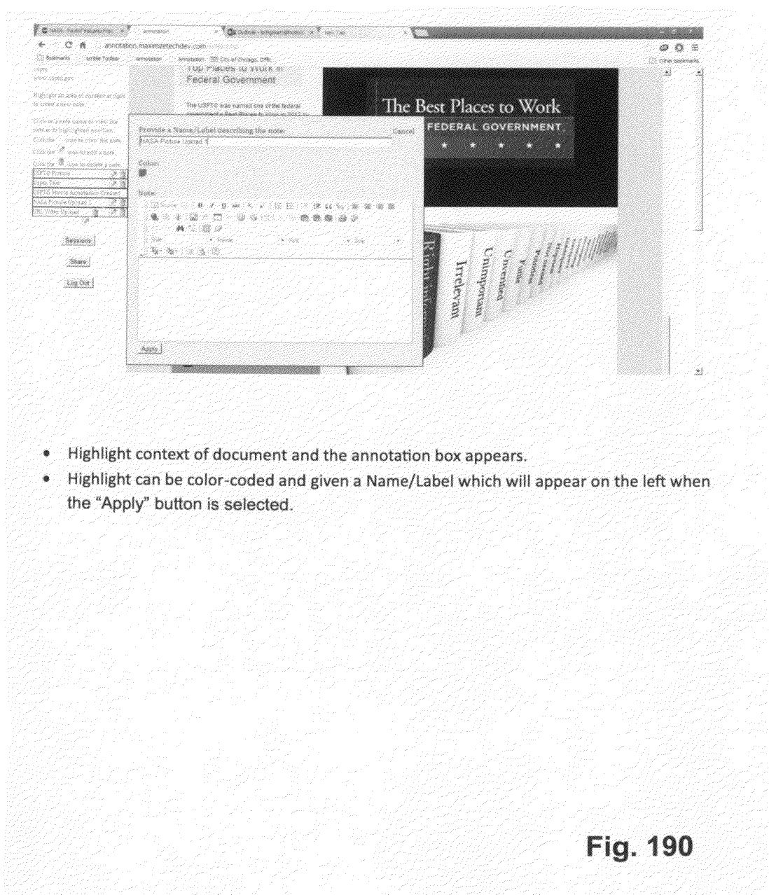

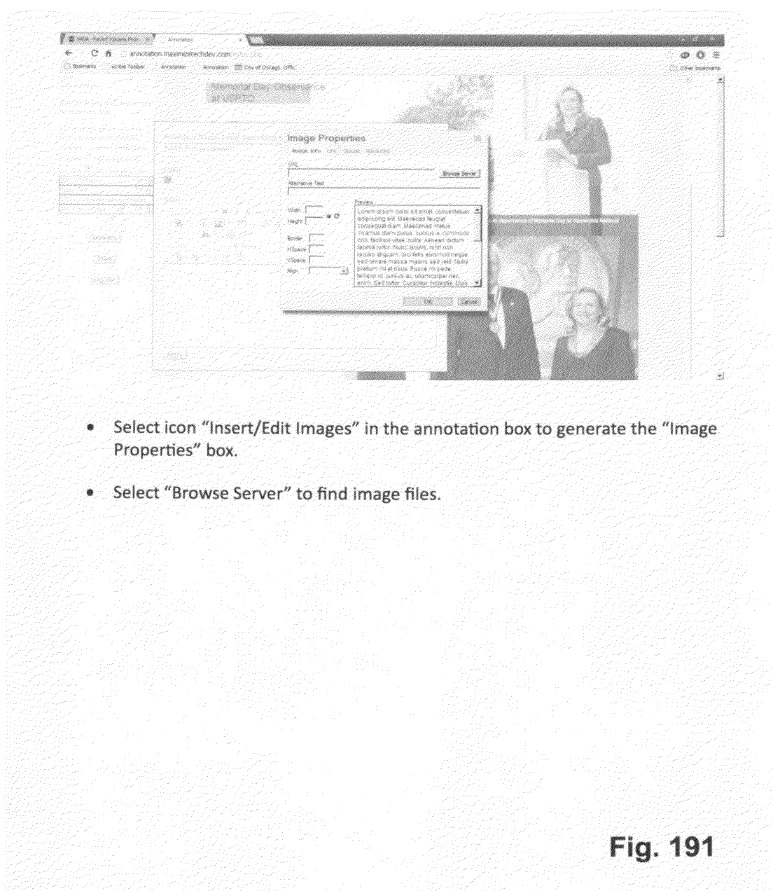

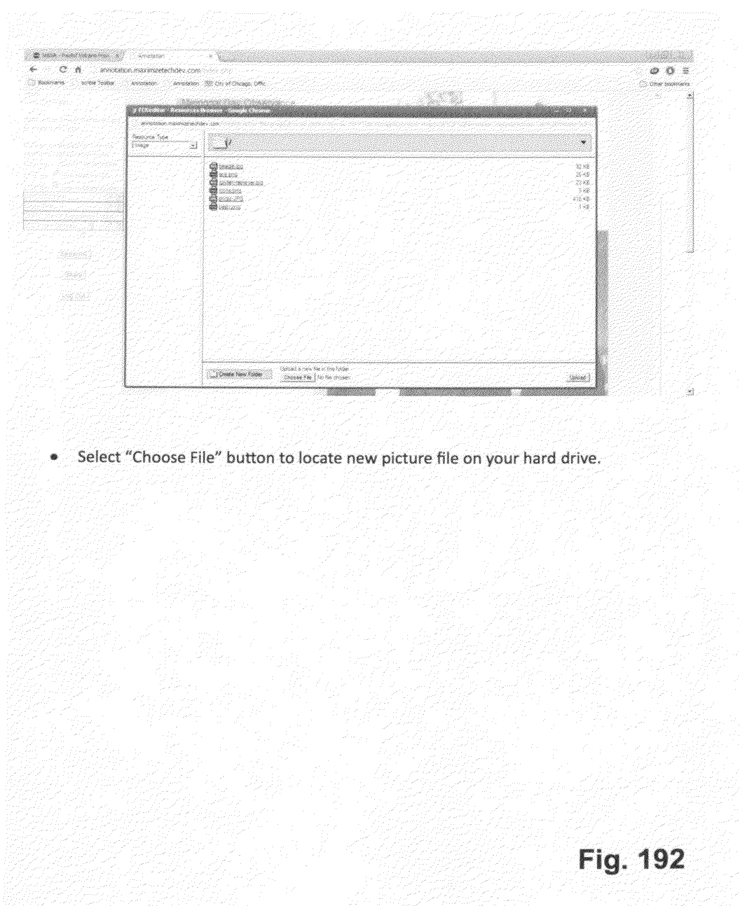

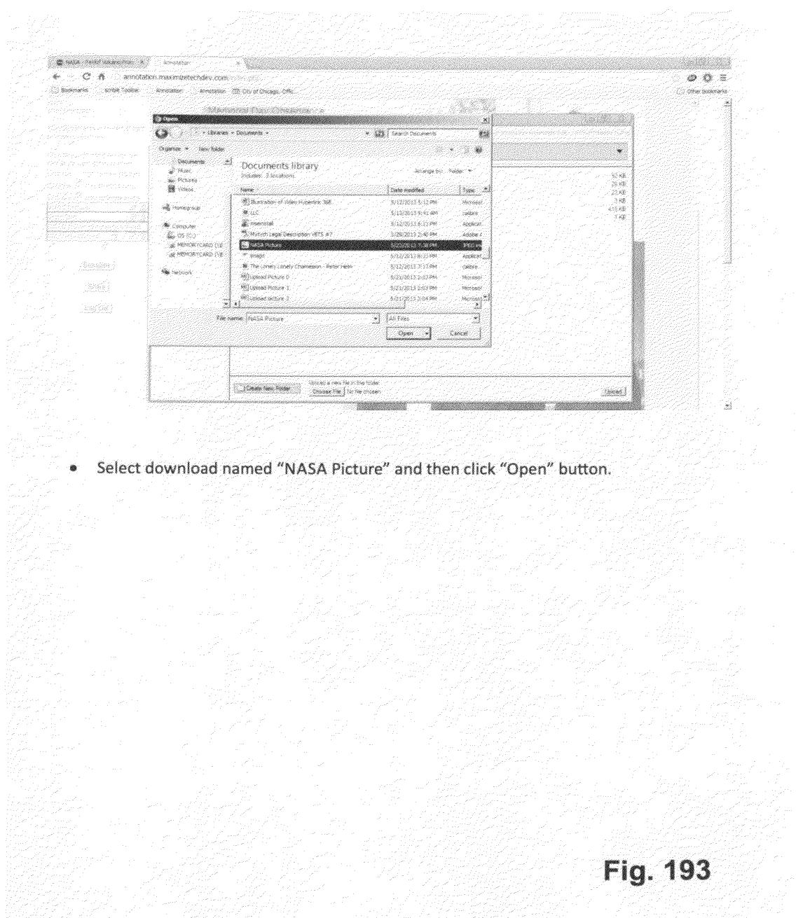

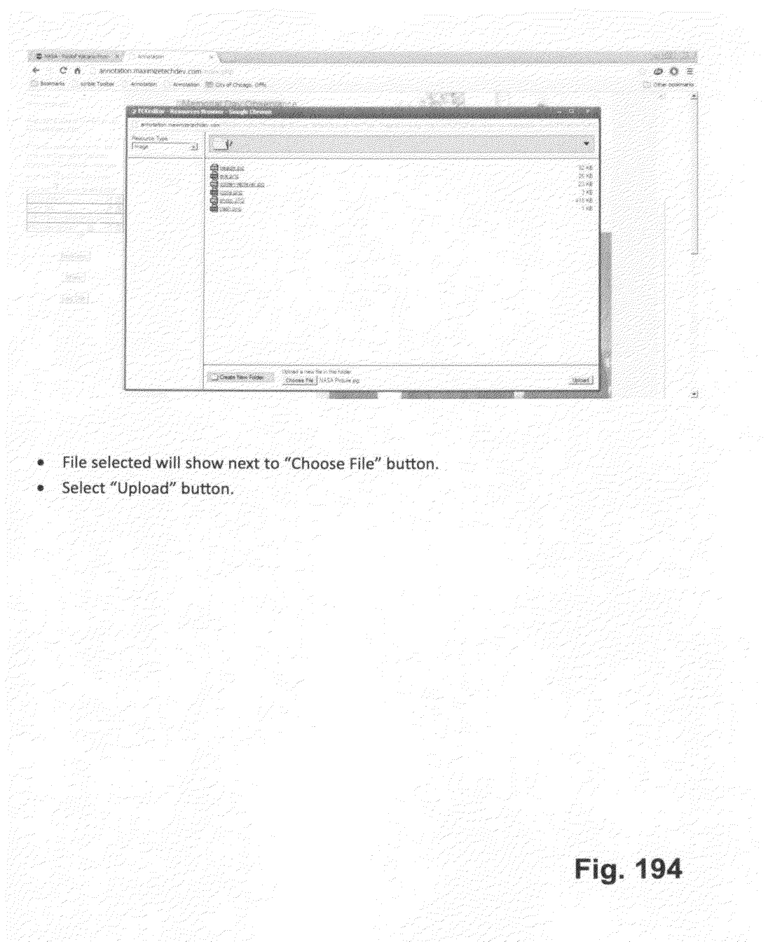

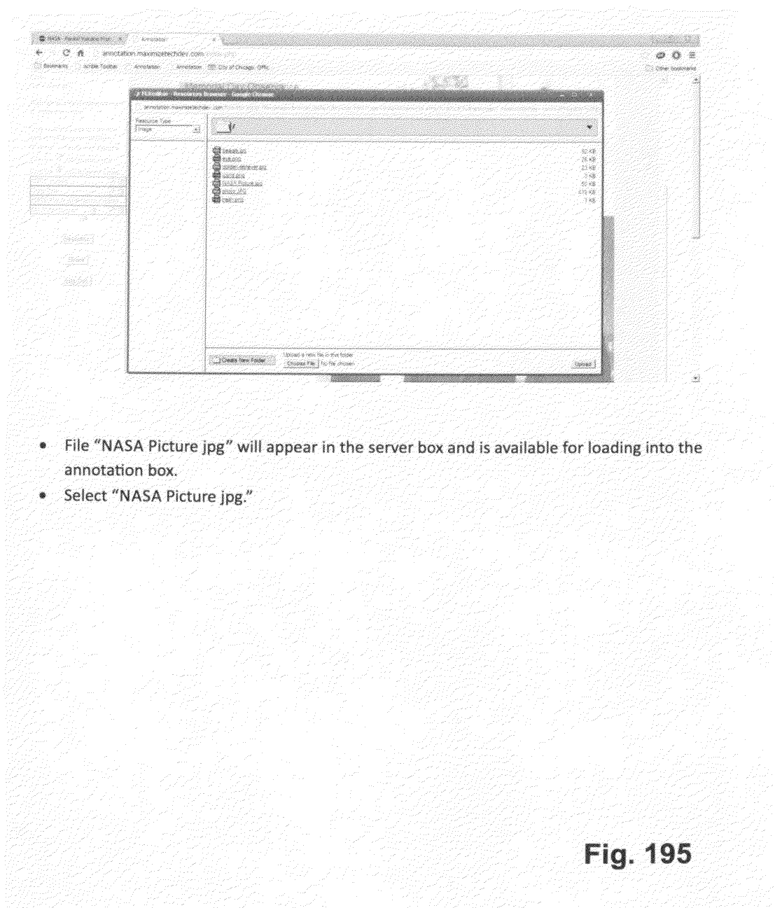

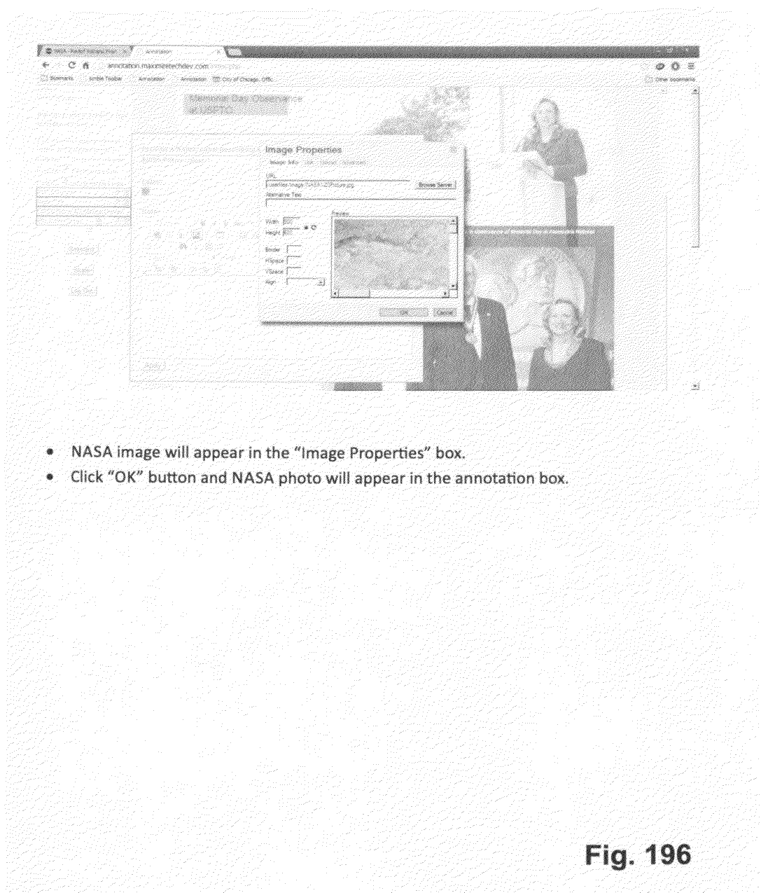

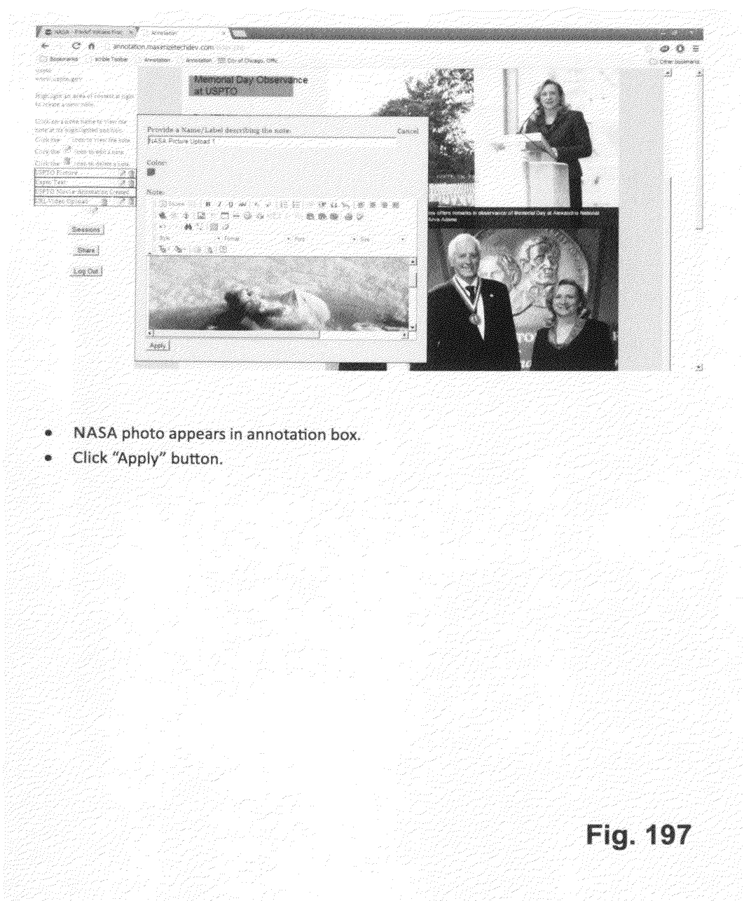

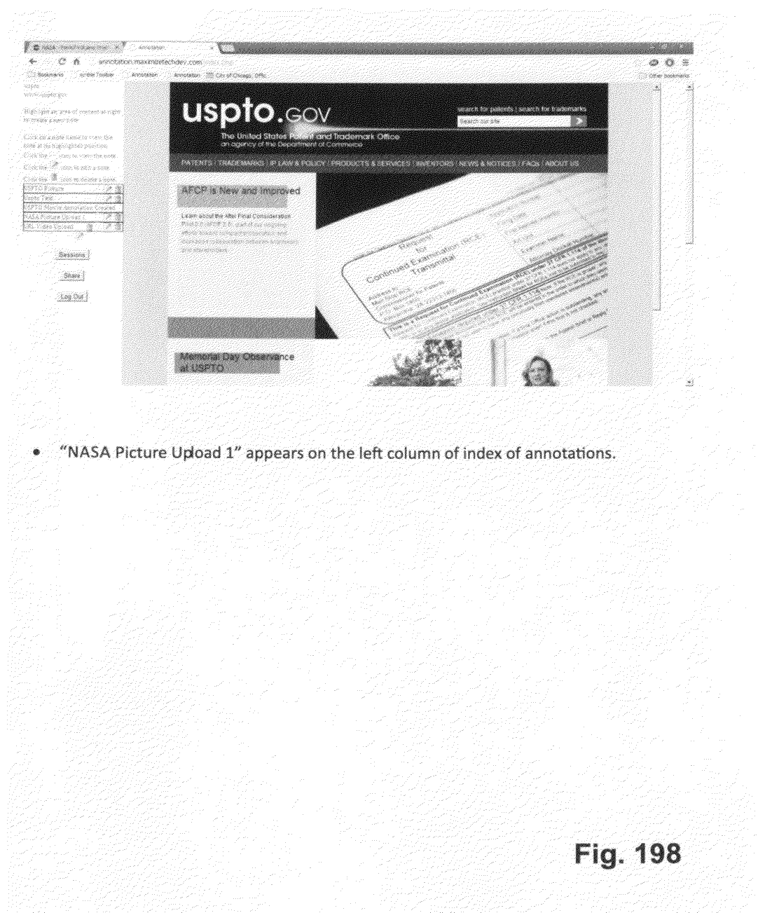

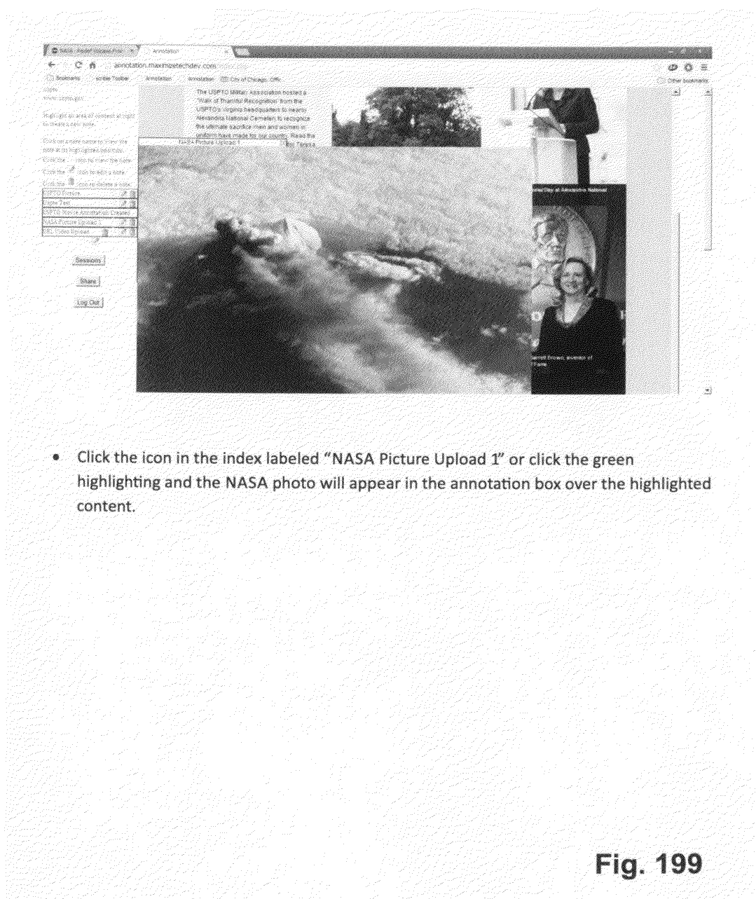

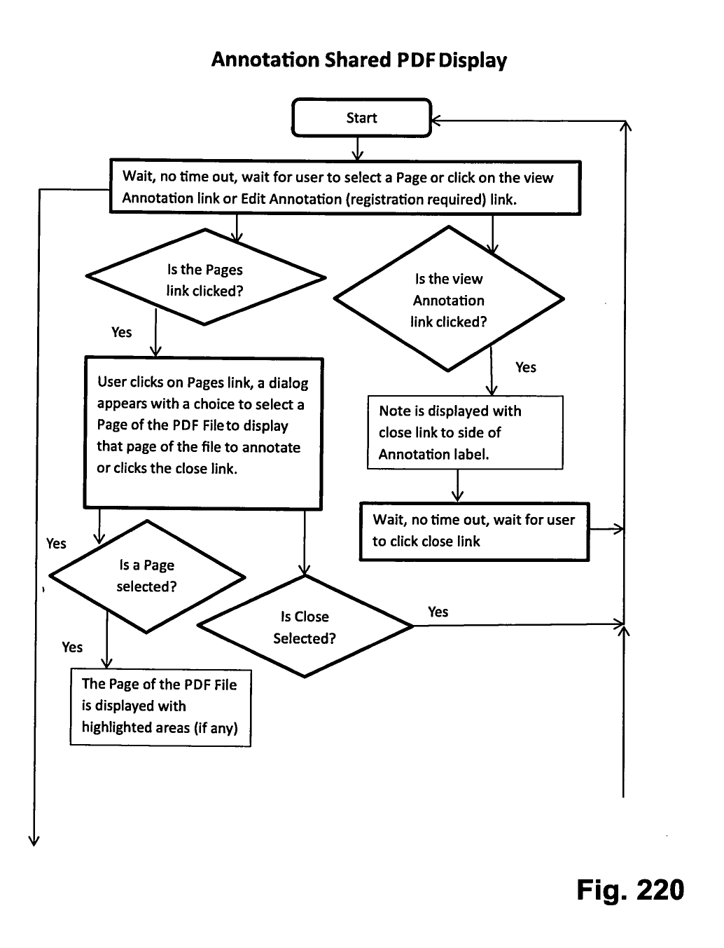

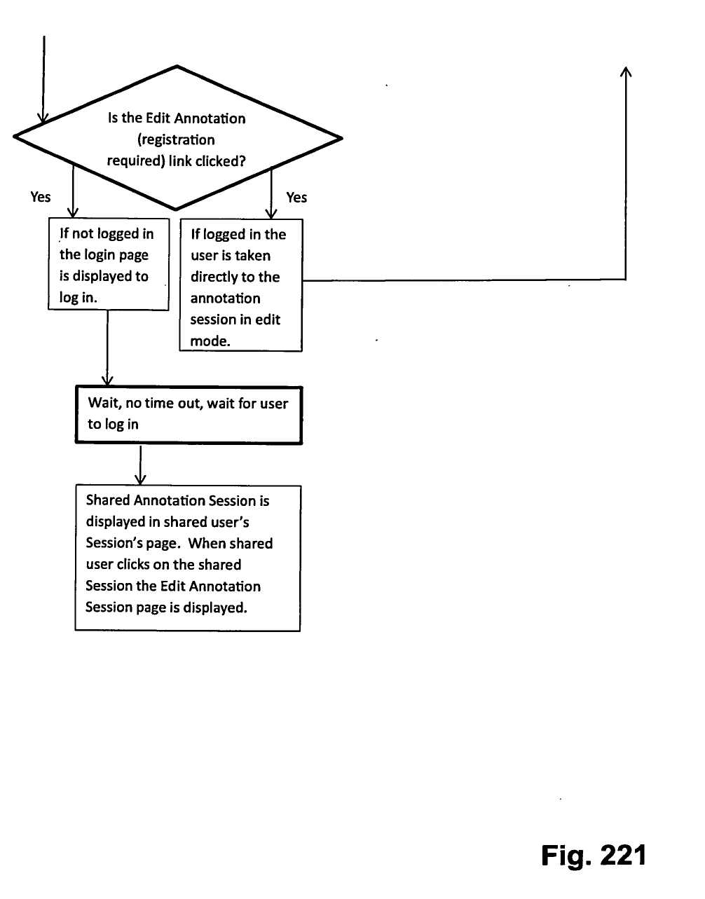

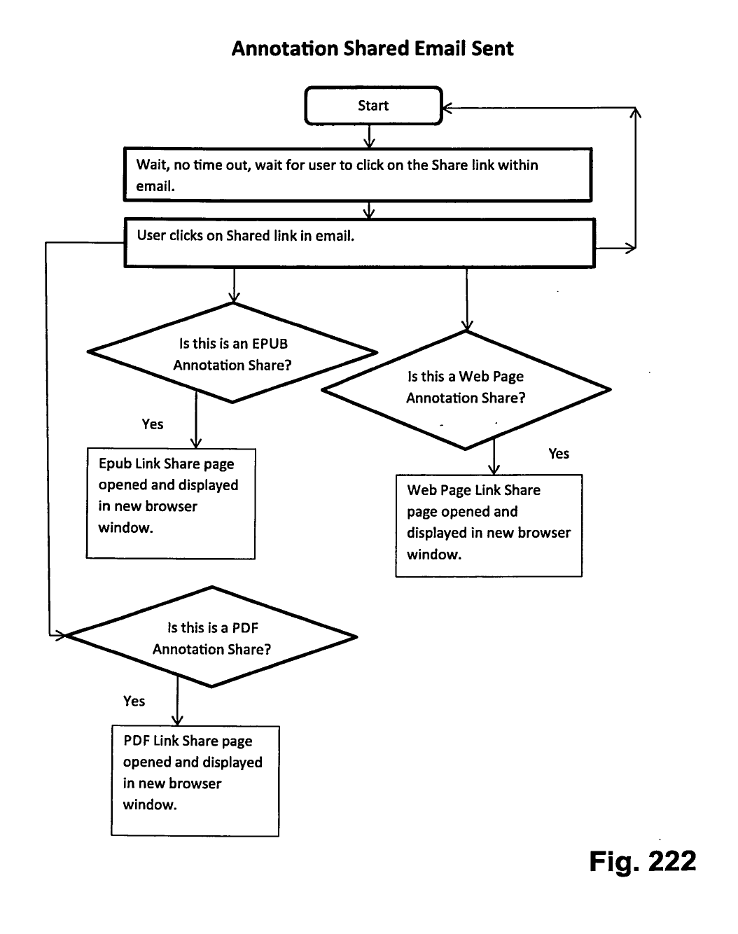

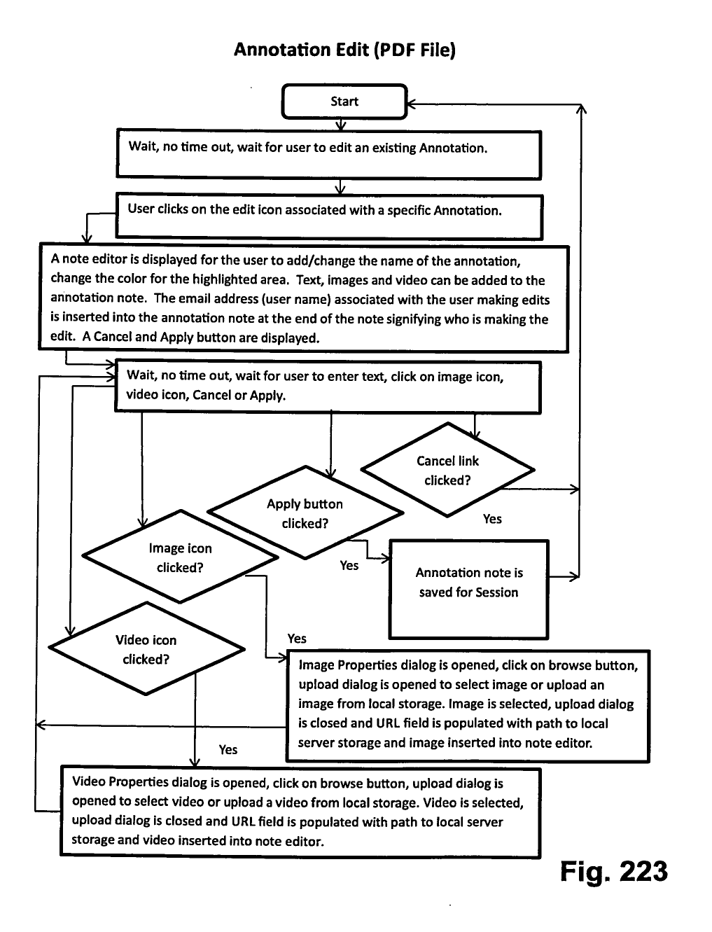

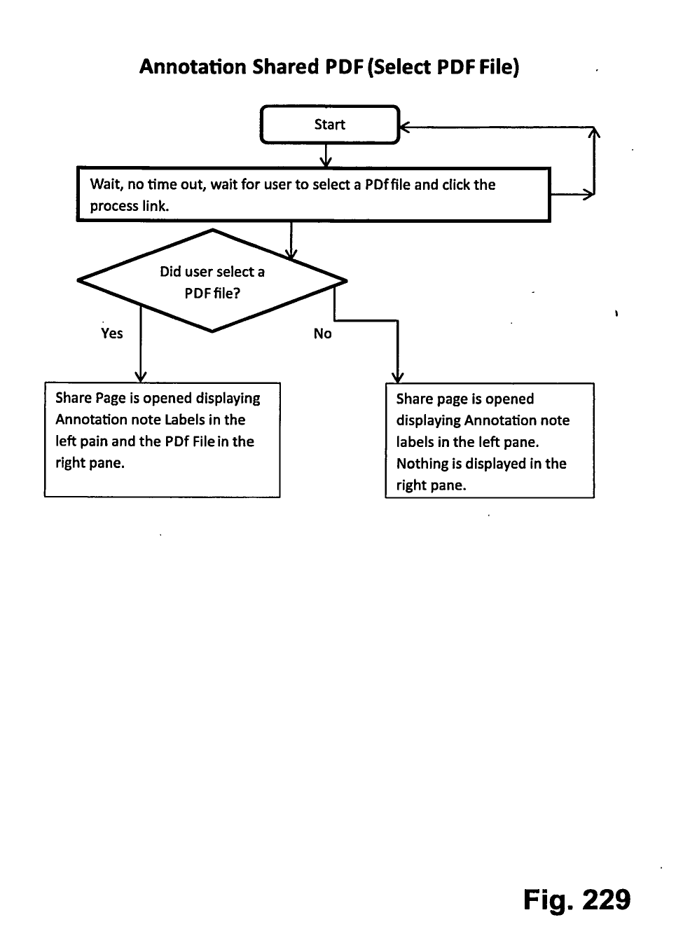

Exemplary screen shots are illustrated for various fixed layout electronic files, such as web pages, epub and pdf files. Embodiments of the invention with web pages are illustrated in FIGS. 4-12, 34-36, 50, 53, 54, 56, 58, 60, 62, 66-68, 70-105 and 209-212. FIG. 48 illustrates an embodiment of the invention of a web page with special coding. Embodiments of the invention with fixed layout files in epub format are illustrated in FIGS. 13-33, 37-47, 49, 51, 52, 55, 57, 59, 61, 63-65, 69, 106-145 and 213-217. Embodiments of the invention with pdf files are illustrated in FIGS. 146-199 and 218-229.

A list of all of the Figures is provided in Table 1 below. Table 2 provides a breakdown of the flow charts sorted by the type of digital content; namely, web page, epub file and pdf file. Table 3 provides a breakdown of the screen shots sorted by the type of digital content; namely, web page, epub file and pdf file

TABLE 1

| | | NAME OF | |
|---|---|---|---|
| | ACTIVITY/NAME OF | ANNO- | FIG. |
| SESSION | FLOW CHART | TATION | # |
| | Annotation System Flow | | 1 |
| | Log-in | | 2 |
| | Home Page/Select Session | | 3 |
| | New Web Page | | 4 |
| | Insert URL | | 5 |
| | Get URL | | 6 |
| | Web Page Content | | 7 |
| | Highlight, Text, and Apply | | 8 |
| | View Annotation Name | | 9 |
| | Share | | 10 |
| | Select Share | | 11 |
| | E-Mail Invitation | | 12 |
| | New EPUB Session 1 | | 13 |
| | LLC EPUB Open | | 14 |
| | LLC Appears | | 15 |
| | Highlight Image | | 16 |
| | Text, Annotation Name | | 17 |
| | Highlight Text | | 18 |
| | Dialog Box | | 19 |
| | Add Text | | 20 |
| | Annotation Notes | | 21 |
| | Annotation Name | | 22 |
| | Two Annotation Names | | 23 |
| | Share Now | | 24 |
| | E-Mail Received | | 25 |
| | EPUB 2 Start Session, | | 26 |
| | Choose File | | |
| | War of Worlds EPUB | | 27 |
| | Appears | | |
| | Select Chapter | | 28 |
| | Highlight/Add Text | | 29 |
| | Annotation Name Appears | | 30 |
| | Annotation View | | 31 |
| | Share | | 32 |
| | E-Mail Received | | 33 |
| | Recipient Opens WEB | | 34 |
| | View Annotation | | 35 |
| | View Annotation Name | | 36 |
| | E-Mail Received EPUB 1 | | 37 |
| | Choose File | | 38 |
| | Process | | 39 |
| | Annotation Name | | 40 |
| | Appears/View | | |
| | Select Annotation | | 41 |
| | Name/View | | |
| | EPUB 2 E-Mail Received | | 42 |
| | Choose File | | 43 |
| | Process File | | 44 |
| | Annotation Name and Book | | 45 |
| | Select Chapter | | 46 |
| | Annotation Name View | | 47 |
| | Special Coding | | 48 |
| | Annotation Add EPUB | | 49 |
| | Annotation Add WEB | | 50 |
| | Annotation Delete EPUB | | 51 |
| | Annotation Delete Session | | 52 |
| | EPUB | | |
| | Annotation Delete Session | | 53 |
| | WEB | | |
| | Annotation Delete WEB | | 54 |
| | Annotation Display Name | | 55 |
| | EPUB | | |
| | Annotation Display Name | | 56 |
| | WEB | | |
| | Annotation Display EPUB | | 57 |
| | Annotation Display WEB | | 58 |
| | Annotation Edit EPUB | | 59 |
| | Annotation Edit WEB | | 60 |
| | Annotation Select Session | | 61 |
| | EPUB | | |
| | Annotation Select Session | | 62 |
| | WEB | | |
| | Annotation Shared Display | | 63 |
| | EPUB | | |
| | Annotation Shared (Select | | 64 |
| | EPUB File) | | |
| | Annotation Shared E-Mail | | 65 |
| | Sent | | |
| | Annotation Shared Display | | 66 |
| | WEB | | |
| | Annotation Share | | 67 |
| | Annotation Sign-On | | 68 |
| | Annotation Start New | | 69 |
| | Session EPUB | | |
| | Annotation Start New | | 70 |
| | Session WEB | | |
| II. New | | | |
| Web Page | | | |
| Session | | | |
| | II.A Starting New Web | | |
| | Page Session | | |
| | II.B. User Annotations | | |
| | (a) Text | | |
| | (b) Share | | |
| | (c) Image | | |
| | (1) Highlight content/ | | 71 |
| | add image to box | | |
| | (2) Annotation created | “USPTO Picture” | 72 |
| | (d) Video | | |
| | (1) Highlight content/ | | 73 |
| | add video to box | | |
| | (2) Annotation created | “USPO Movie” | |
| | (e) Share | | |
| | (1) Select “share” to | | |
| | share all annotations in | | |
| | this session | | |
| | (2) Enter e-mail | | |
| | address for Recipient 1 | | |
| | (3) Recipient 1 | | |
| | receives e-mail | | |
| | invitation | | |
| | (f) Share footnote | | 74 |
| | hyperlink | | |
| | View User Annotations | | |
| | (a) Text | | |
| | (b) Image | | |
| | (i) Open User's | | 75 |
| | Session with hyperlink | | |
| | (ii) Open “USPTO | | 76 |
| | Picture” | | |
| | (c) Video | | |
| | Follow (b) above, open | | 77 |
| | “USPTO Movie Annotation | | |
| | Created” | | |
| | 3: Edits Made By | | |
| | Recipient 1 to User's | | |
| | Annotations | | |
| | Edit and Registration | | 78 |
| | (a) text to text | | 79 |
| | (b) image to text | | 80 |
| | (c) video to text | | 81 |
| | (d) text to image | | 82 |
| | (e) image to image | | 83 |
| | (f) video to image | | 84 |
| | (g) text to video | | 85 |
| | (h) image to video | | 86 |
| | (i) video to video | | 87 |
| | 4. Annotations Made by | | |
| | Recipient 1 | | |
| | Edit and Registration | | 88 |
| | (a) highlight text/upload | | 89 |
| | image or video | | |
| | (b) image and video | | 90 |
| | annotation created | | |
| | (c) text | Recipient | 91 |
| | | Annotation | |
| | (d) image | Recipient picture | 92 |
| | | comment | |
| | (e) video | Recipient video | 93 |
| | | comment | |
| | | | 94 |
| | II.D. Recipient 2 + others | | |
| | 1. Edits Made by | | |
| | Recipient 2 to User's | | |
| | Annotations | | |
| | Edit and Registration | | 95 |
| | (a) text to text | | 96 |
| | (b) image to image | | 97 |
| | (c) video to video | | 98 |
| | 2. Annotations Made by | | |
| | Recipient 2 | | |
| | Edit and Registration | | 99 |
| | (a) text | | 100 |
| | (b) image | | 101 |
| | (c) video | | 102 |
| | II.E. User Edits to Recipient | | |
| | 1's Edits | | |
| | 1. text to text | | 103 |
| | 2. image to image | | 104 |
| | 3. video to video | | 105 |
| III.A. Starting | | | |
| New EPUB/ | | | |
| No Chapters | | | |
| Session | | | |
| | III.B. User Annotations | | |
| | (a) text | | |
| | (b) Share | | |
| | (c) Image | | |
| | (1) Highlight to create | | 106 |
| | “23A Create Picture” | | |
| | account | | |
| | (2) Upload Image | | 107 |
| | (d) Video | | |
| | (1) Highlight to create | | 108 |
| | “Video Demo 1” | | |
| | (2) Upload Video | | 109 |
| | (e) Share | | |
| | (1) Select share | | |
| | (2) Recipient 1's | | |
| | invitation | | |
| | (f) Share footnote | | 110 |
| | hyperlink | | |
| | (e) image | | 111 |
| | (f) video | | 112 |
| | 3. Edits Made by | | |
| | Recipient 1 to User's | | |
| | Annotations | | |
| | Edit and Registration | | 113 |
| | 1. Recipient 1 opens e-mail | | |
| | and clicks on hyperlink. | | |
| | Asked to upload EPUB | | |
| | file and check on | | |
| | “Process.” Recipient 1 | | |
| | can view EPUB and | | |
| | annotations. Recipient | | |
| | 1 clicks on “Edit | | |
| | Annotation;” must then | | |
| | log onto Recipient 1 | | |
| | account and upload | | |
| | EPUB file again. Then | | |
| | select applicable EPUB | | |
| | Session. EPUB and | | |
| | annotations will appear. | | |
| | Recipient may click on | | |
| | annotation icon or on | | |
| | highlighted text, and | | |
| | annotation box will | | |
| | appear. Recipient can | | |
| | edit annotation box or | | |
| | may highlight new text | | |
| | and create a new | | |
| | annotation. | | |
| | (a) text to text | | 114 |
| | (b) image to text | | 115 |
| | (c) video to text | | 116 |
| | (d) text to image | | 117 |
| | (e) image to image | | 118 |
| | (f) video to image | | 119 |
| | (g) text to video | | 120 |
| | (h) image to video | | 121 |
| | (i) video to video | | 122 |
| | 4. Annotations Made By | | |
| | Recipient 1 | | |
| | Edit and Registration | | 123 |
| | (a) text | | 124 |
| | (b) image | | 125 |
| | (c) video | | 126 |
| | III.D. Recipient 2 + others | | |
| | 1. Edits Made by | | |
| | Recipient 2 to User's | | |
| | Annotations | | |
| | (a) text | | 127 |
| | (b) image | | 128 |
| | (c) video | | 129 |
| | 2. Annotation made by | | |
| | Recipient 2 | | |
| | (a) text | | 130 |
| | (b) image | | 131 |
| | (c) video | | 132 |
| | III.E. User Edits to | | |
| | Recipient's Edits | | |
| | (a) text to text | | 133 |
| | (b) image to image | | 134 |
| | (c) video to video | | 135 |
| IV.A Starting | | | |
| new EPUB | | | |
| Chapter | | | |
| Session | | | |
| | IV.B User's | | |
| | Annotations | | |
| | (a) Text | | |
| | (b) Share | | |
| | (c) Image | | |
| | (i) Highlight text/add | | 136 |
| | image to box | | |
| | (ii) Annotation name | | 137 |
| | “Chapter 7, Paragraph | | |
| | 1” created | | |
| | (d) Video | | |
| | (i) Highlight text/add | | 138 |
| | video to box | | |
| | (ii) Annotation name | | 139 |
| | “Chapter 8, Paragraph | | |
| | 1” created | | |
| | (e) Share | | |
| | (i) Complete share | | |
| | Recipient 1 | | |
| | (ii) Recipient 1's | | |
| | invitation | | |
| | (f) Share footnote | | |
| | hyperlink | | |
| | 2: View User's | | |
| | Annotations | | |
| | (d) Text | | |
| | (e) Image | | |
| | Image in box | | 140 |
| | (f) Video | | |
| | Video in box | | 141 |
| | 3.. Edits Made By | | |
| | Recipient 1 to User's | | |
| | Annotations | | |
| | 4. Annotations Made By | | |
| | Recipient 1 | | |
| | Edit and Registration | | 142 |
| | (a) text | | 143 |
| | (b) image | | 144 |
| | (c) video | | 145 |
| | IV.D. Recipient 2 + | SAME AS EPUB | |
| | others | NO CHAPTERS | |
| | IV.E. User Edits | SAME AS EPUB | |
| | | NO CHAPTERS | |
| V. New Filing | | | |
| PDF | | | |
| | V.A. Starting New PDF | | |
| | Session | | |
| | (a) Select PDF File | | 146 |
| | (b) Name Session | | 147 |
| | (c) PDF appears | | 148 |
| | V.B. User Annotations | | |
| | (a) Text | | |
| • | (1) Highlight content/ | | 149 |
| | add text to box | | |
| | (2) Annotation created | “PDF User | 150 |
| | | Annotation” | |
| | (b) Share | | |
| | Select “share”/enter e- | | 151 |
| | mail address for | | |
| | Recipient 1 | | |
| | (c) Image | | |
| | (i) Highlight content/ | | 152 |
| | add image to box | | |
| | (ii) Annotation created | “PDF Image | 153 |
| | | Annotation” | |
| | (d) Video | | |
| | (i) Highlight content/ | | 154 |
| | add video to box | | |
| | (ii) Annotation created | “PDF Video | 155 |
| | | Annotation | |
| | (e) Share | | |
| | (1) Select “share” to | | 156 |
| | share all annotations | | |
| | and enter e-mail | | |
| | address for Recipient 1 | | |
| | (2) Recipient 1 | | 157 |
| | receives e-mail | | |
| | invitation | | |
| | (f) Share hyperlink | | 158 |
| | footnote | | |
| | V.C. Recipient 1 | | |
| | 1. (a) Open E-Mail | | 159 |
| | Invitation | | |
| | (b) Select file | | 160 |
| | 2. View Annotations | | |
| | (a) Text | | |
| | Click on name of | | 161 |
| | annotation or | | |
| | highlighted text to open | | |
| | annotation | | |
| | (b) Image | | |
| | Open “PDF Image | | 162 |
| | Annotation” | | |
| | (c) Video | | |
| | Open “PDF Video | | 163 |
| | Annotation” | | |
| | 3. Edits Made By | | |
| | Recipient 1 to User's | | |
| | Annotations | | |
| | Edit and Registration | | 164 |
| | 2. Recipient 1 opens e-mail | | |
| | and clicks on hyperlink. | | |
| | Asked to upload EPUB | | |
| | file and check on | | |
| | “Process.” Recipient 1 | | |
| | can view EPUB and | | |
| | annotations. Recipient 1 | | |
| | clicks on “Edit | | |
| | Annotation;” must then | | |
| | log onto Recipient 1 | | |
| | account and upload | | |
| | EPUB file again. Then | | |
| | select applicable EPUB | | |
| | Session. EPUB and | | |
| | annotations will appear. | | |
| | Recipient may click on | | |
| | annotation icon or on | | |
| | highlighted text, and | | |
| | annotation box will | | |
| | appear. Recipient can | | |
| | edit annotation box or | | |
| | may highlight new text | | |
| | and create a new | | |
| | annotation. | | |
| | (a) text to text | | 165 |
| | (b) image to text | | 166 |
| | (c) video to text | | 167 |
| | (d) text to image | | 168 |
| | (e) image to image | | 169 |
| | (f) video to image | | 170 |
| | (g) text to video | | 171 |
| | (h) image to video | | 172 |
| | (i) video to video | | 173 |
| | 4. Annotations Made by | | |
| | Recipient 1 | | |
| | Edit and Registration | | 174 |
| | (a) text | Recipient text | 175 |
| | | Annotation | |
| | (b) image | Recipient image | 176 |
| | | annotation | |
| | (c) video | Recipient video | 177 |
| | | annotation | |
| | V.D. Recipient 2 + others | | |
| | 1. Edits Made By | | |
| | Recipient 2 to User's | | |
| | Annotations | | |
| | Edit and Registration | | 178 |
| | (a) text to text | | 179 |
| | (b) image to image | | 180 |
| | (c) video to video | | 181 |
| | 2. Annotations Made By | | |
| | Recipient 2 | | |
| | Edit and Registration | | 182 |
| | (a) text | | 183 |
| | (b) image | | 184 |
| | (c) video | | 185 |
| | V.E. User Edits to Recipient | | |
| | 1's Edits | | |
| | (a) text to text | | 186 |
| | (b) image to image | | 187 |
| | (c) video to video | | 188 |
| VI. Dem- | | | |
| onstration | | | |
| to Upload | | | |
| Pictures | | | |
| | Save image to hard drive | | 189 |
| | Highlight content/create | | 190 |
| | name | | |
| | Select icon “Insert/Edit | | 191 |
| | Image”/select image | | |
| | Select “Choose File” | | 192 |
| | Select “Image” | | 193 |
| | Select “Upload” | | 194 |
| | Select “Image” | | 195 |
| | Select “OK” | | 196 |
| | Select “Apply” | | 197 |
| | Image Annotation | | 198 |
| | Image appears | | 199 |
| VII. Dem- | | | |
| onstration | | | |
| for Uploading | | | |
| Videos | | | |
| | Find and download video | | 200 |
| | Highlight name annotation | | 201 |
| | Select “Embed Movies” | | 202 |
| | Select URA/Video | | 203 |
| | download/open | | |
| | Click “OK” in box | | 204 |
| | Video in Book, check Apply | | 205 |
| | Annotation created | | 206 |
| | Check Highlight | | 207 |
| | Video annotation appears | | 208 |
| NEW FLOW | | | |
| CHARTS | | | |
| WEB | Annotation Display | | 209 |
| | (formerly 58) | | |
| | Annotation Display Name | | 210 |
| | Link (formerly 56) | | |
| | Annotation Edit | | 211 |
| | Annotation Shared Display | | 212 |
| EPUB | Annotation Display | | 213 |
| | (formerly 57) | | |
| | Annotation Display Name | | 214 |
| | Link (formerly 55) | | |
| | Annotation Edit | | 215 |
| | Annotation Shared Display | | 216 |
| | | | 217 |
| PDF | Start New Session | 69 | 218 |
| | Select Session | 61 | 219 |
| | Shared Display | 63 | 220 |
| | | | 221 |
| | Shared E-Mail Sent | 59 | 222 |
| | Annotation Edit | 57 | 223 |
| | Annotation Display | 65 | 224 |
| | Annotation Delete | 51 | 225 |
| | Annotation Add | 49 | 226 |
| | Delete Session | 52 | 227 |
| | Display Name Link | 55 | 228 |
| | Annotation Shared PDF | 68 | 229 |
| | (Select PDF File) | | |

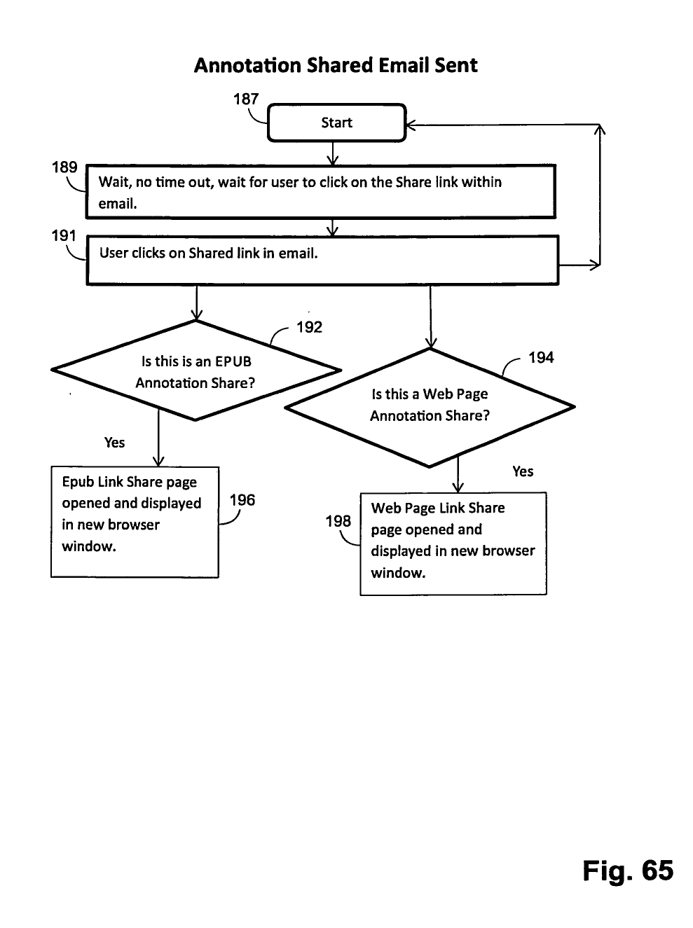

Exemplary logic diagrams illustrating the software flow logic are identified in Table 2. The exemplary logic diagrams are based upon an exemplary web-based application and fall into 4 groups as set forth below. In particular, exemplary logic diagrams are provided for processing three (3) categories of digital content as follows: web pages, epub files and pdf files. The fourth category of logic diagrams relates to logic diagrams that apply generally to the invention. These logic diagrams are illustrated in FIGS. 65, 66, 67 and 68.

TABLE 2

| | | EPUB (No | |
|---|---|---|---|
| | Web | Chapters Session) | PDF |
| Flow Charts | Fig. No | Fig. No | Fig. No |
| Annotation Start New Session | 70 | 69 | 218 |
| System Flow | | 1 | 1 |
| Annotation Add | 50 | 49 | 226 |
| Annotation Delete | 54 | 51 | 225 |
| Annotation Delete Session | 53 | 52 | 227 |
| Annotation Display Name | 56 | 55/214 | 228 |
| Annotation Display | 58 | 57 213 | 224 |
| Annotation Edit | 60 | 59 215 | 223 |
| Annotation Select Session | 62 | 61 | 219 |
| Annotation Shared Display | 66 | 63/216/217 | 220/222 |
| Annotation Shared (Select | N/A | 64 | 229 |
| File) | | | |
| Annotation Shared E-Mail | 65 | 65 | 222 |
| Annotation Share | 67 | 67 | 67 |
| Annotation Sign-On | 68 | 68 | 68 |

A list of screen shots is provided below in Table 3. These screen shots are segregated by web page; epub file and pdf file.

TABLE 3

| | | EPUB (No | |
|---|---|---|---|
| | Web | Chapters Session) | PDF |
| Illustrations | Fig. No. | Figure | Fig. No |
| Log-in | 2 | 2 | 2 |
| New Session | 3/4 | 3/13 | 146 |
| Open Content | 5/6 | 14 | 147 |
| Content appears | 7 | 15 | 148 |
| Highlight | 8 | 16/18 | 149 |
| Note | 8 | 17/21 | 150 |
| Dialogue Box | 8 | 19/22 | 149 |
| Left list of notes | 9 | 23 | 150 |
| Create Image Annotation | 71 | 106 | 152 |
| View Image Annotation | 72 | 107 | 153 |
| Create Video Annotation | 73 | 108 | 154 |
| View Video Annotation | 73 | 109 | 155 |
| Share | 10/11 | 24 | 151, 156, 10 |
| Receipt | 12 | 25 | 157 |
| Open E-Mail | 34/75 | 37 | 159 |
| Choose File | N/A | 38 | 160 |
| Process | N/A | 39 | 160 |
| Content Appears | 35 | 40 | 161 |
| Recipient View Text | 36 | 41 | 161 |
| Recipient View Image | 76 | 111 | 162 |
| Recipient View Video | 77 | 112 | 163 |
| Register | 78 | 113 | 164 |
| Recipient/Edits | 79-87 | 114-122 | 165-173 |
| Register | 88/95/99 | 123 | 174 |
| Recipient/Annotations | 89-94 | 124-126 | 175-177 |
| Recipient 2 Edits | 96-98 | 127-129 | 178-181 |
| Recipient 2 Annotations | 100-102 | 130-132 | 182-185 |
| User's Edits | 103-105 | 133-135 | 186-188 |

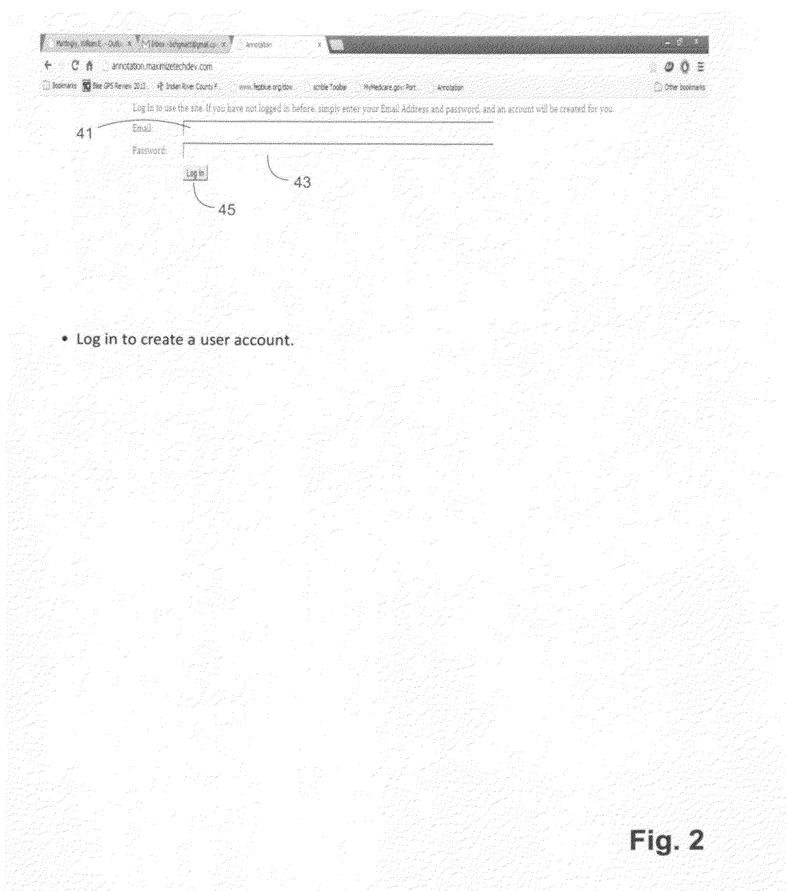

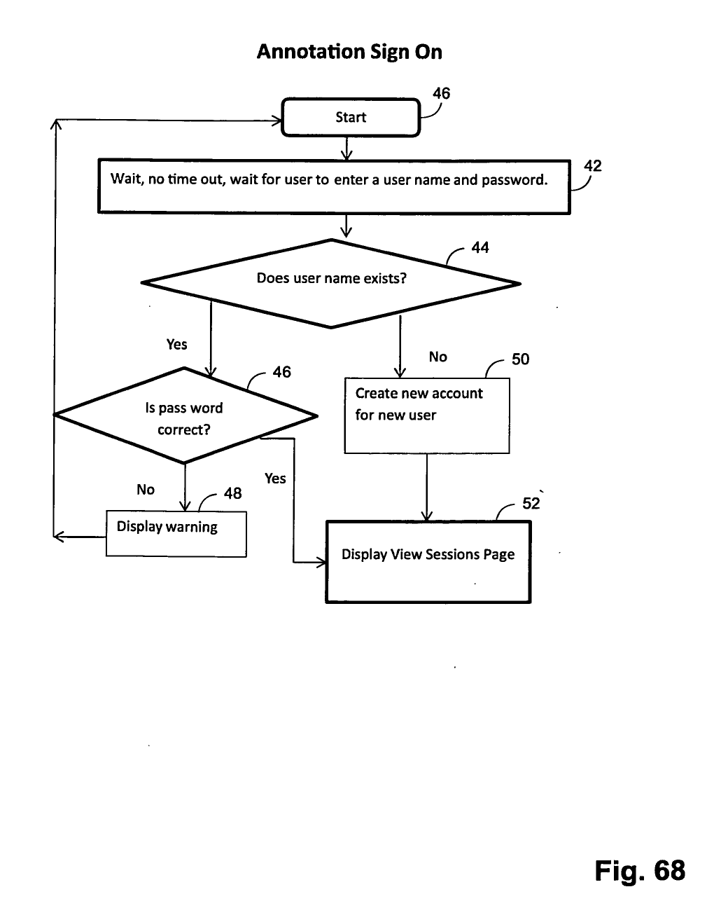

The system 20 (FIG. 1) is described and illustrated as an exemplary web based application. Referring to FIG. 2, an exemplary log-in web page is illustrated. This log-in page enables a user to log in to the application and create a user account. The logic diagram for logging in to the portal is illustrated in FIG. 68. Referring to FIG. 68, once the user is at the log-in page, as indicated by the block 40, the system waits for the user to enter a user name and password in the dialog boxes 41 and 43 (FIG. 2), as indicated by the block 42. After the user enters a user name and password in the dialog boxes 41 and 43, respectively, and selects the “Log In” button 45, the system 20 checks the database 26 (FIG. 1) to determine if the user name exists in step 44 (FIG. 68).

If the user name is found to exist in the database 26 (FIG. 1), the system 20 next checks the database to determine if the correct password was entered by the user in step 46. If the password entered by the user does not match the password associated with the user name stored in the database 26, a warning is displayed to the user in step 48 advising the user of the incorrect password. The system 20 then returns to steps 40 and 42 and waits for a new user name and password to be entered.

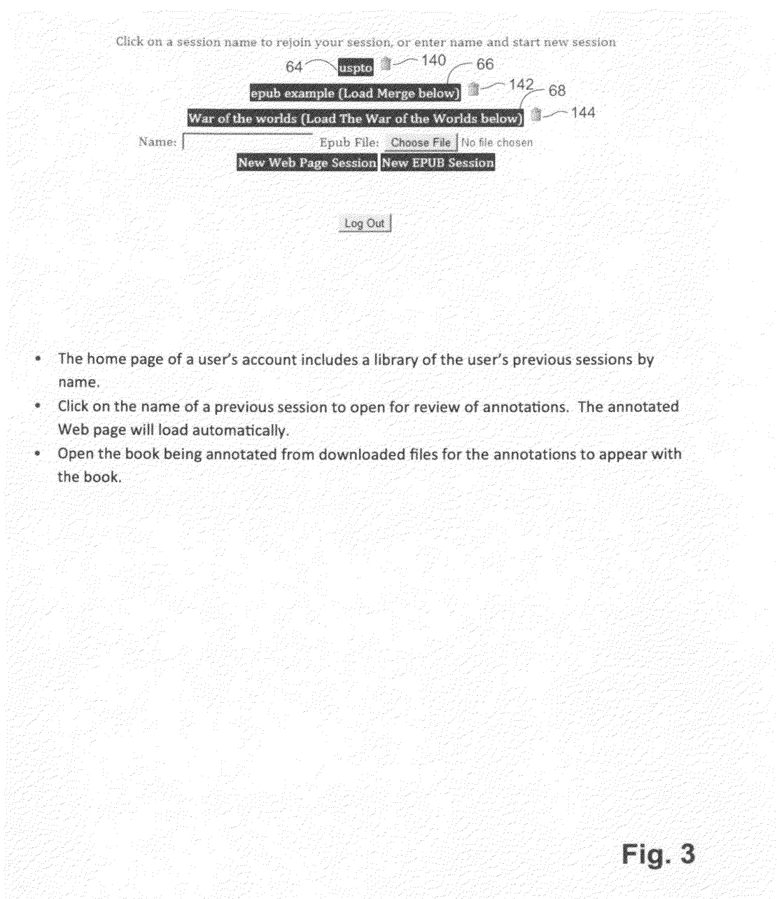

If the system 20 determines in step 46 that the password is correct, the system displays a home page, for example, as illustrated in FIGS. 3 and 4. The home page illustrated in FIG. 4 is for new users and users that do not have stored sessions. The home page illustrated in FIG. 3 is for existing users that have stored previous sessions on the database 26 (FIG. 1).

If the user name does not exist in the database 20 (FIG. 1), as determined in step 44, the system 20 creates a new account for a new user in step 50. After the new user selects a password, the system initiates a session and displays a home page in step 52. Exemplary home pages are illustrated in FIGS. 3 and. 4.

As mentioned above, the home page illustrated in FIG. 4 is used by new users or users that do not have any stored sessions. The home page, illustrated in FIG. 4 includes a dialog box 56 that allows a user to name the new session. In an exemplary embodiment, the user can select between two different types of new sessions, for example, a new web page session or a new epub session. The button 57, entitled: “New Web Page Session” allows a user to select a new web page session. The button 60, entitled” New EPUB Session” allows a user to select a new epub session with respect to digital content on the user's computer, by clicking button 58. Should the user decide to quit the session, a Log Out button 62 is provided. As will be discussed in more detail below, the New Web Page button 57 and the New EPUB button 60 allow a user to annotate web pages and epub books and send and receive annotations to and from third parties without violating any US Copyright rights.

The home page, illustrated in FIG. 3, is similar to the home page illustrated in FIG. 4. The only difference is that a list of the user's previous sessions is listed on the session page. An exemplary group of previous sessions are illustrated and identified with the reference numerals 64, 66 and 68 (FIG. 3).

### WEB PAGE EXAMPLE

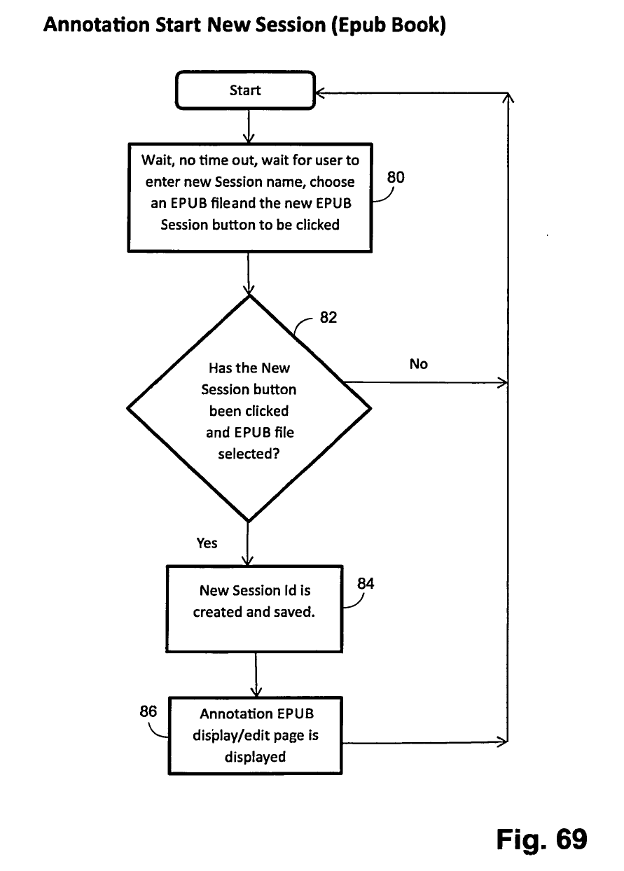

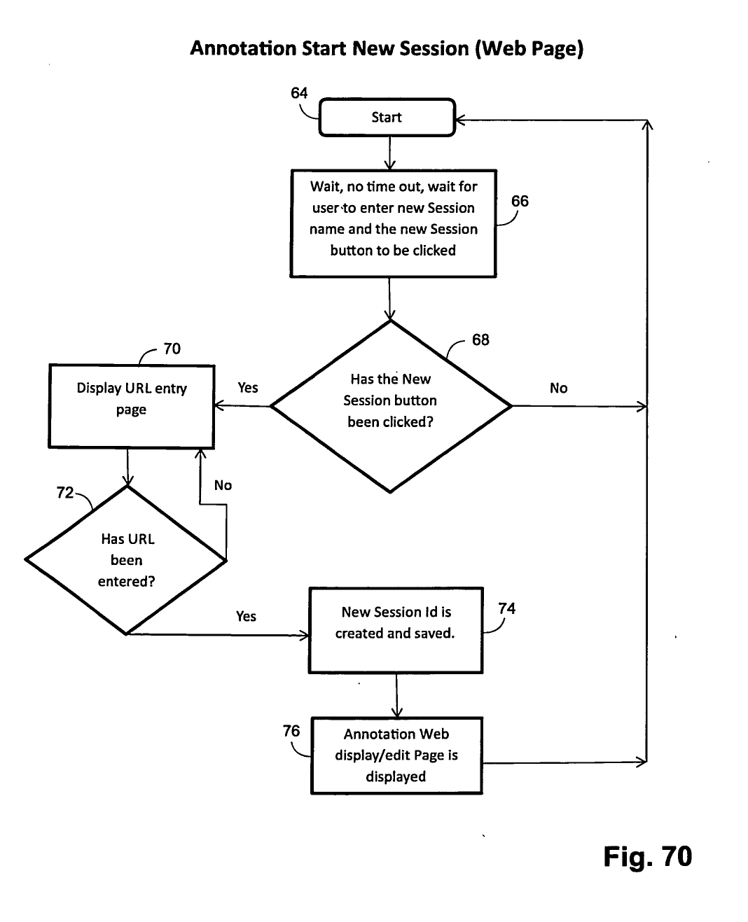

An exemplary flow chart is illustrated in FIG. 70 for starting a new web page session. Similarly, an exemplary flow chart for starting a new epub session is illustrated in FIG. 69. As mentioned above, a new web page session is initiated by selecting the New Web Page Session button 57 (FIG. 4) and a new epub session is started by selecting the New Epub Session button 60.

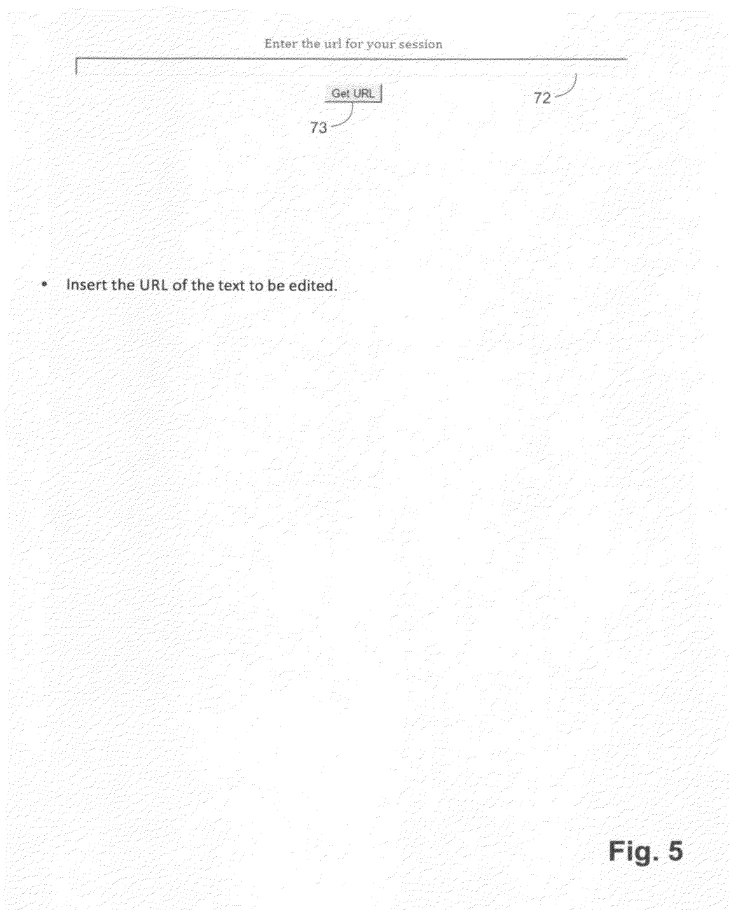

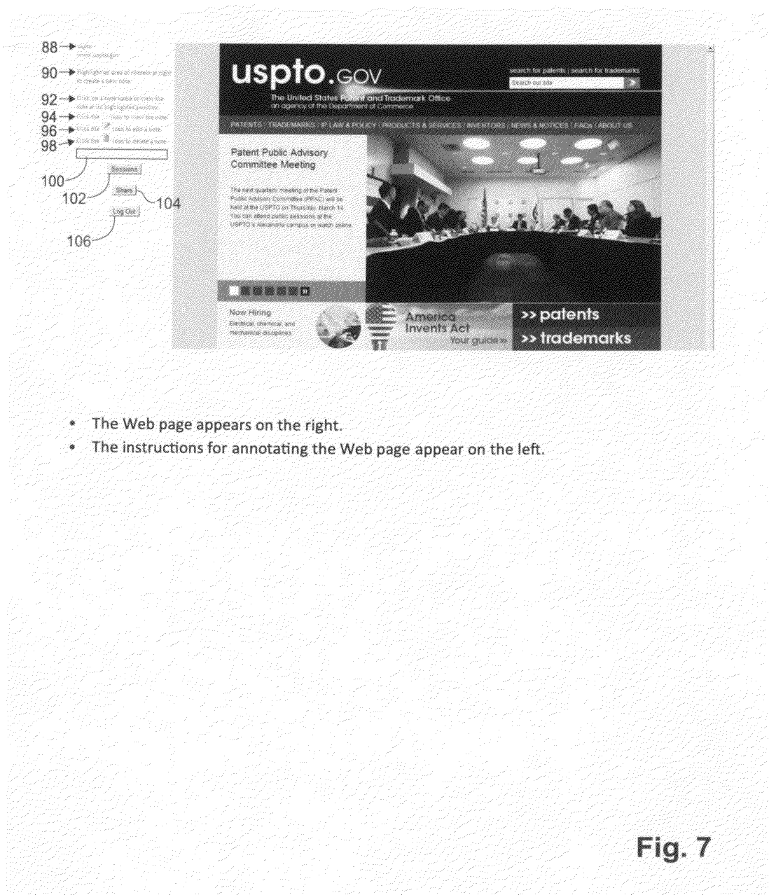

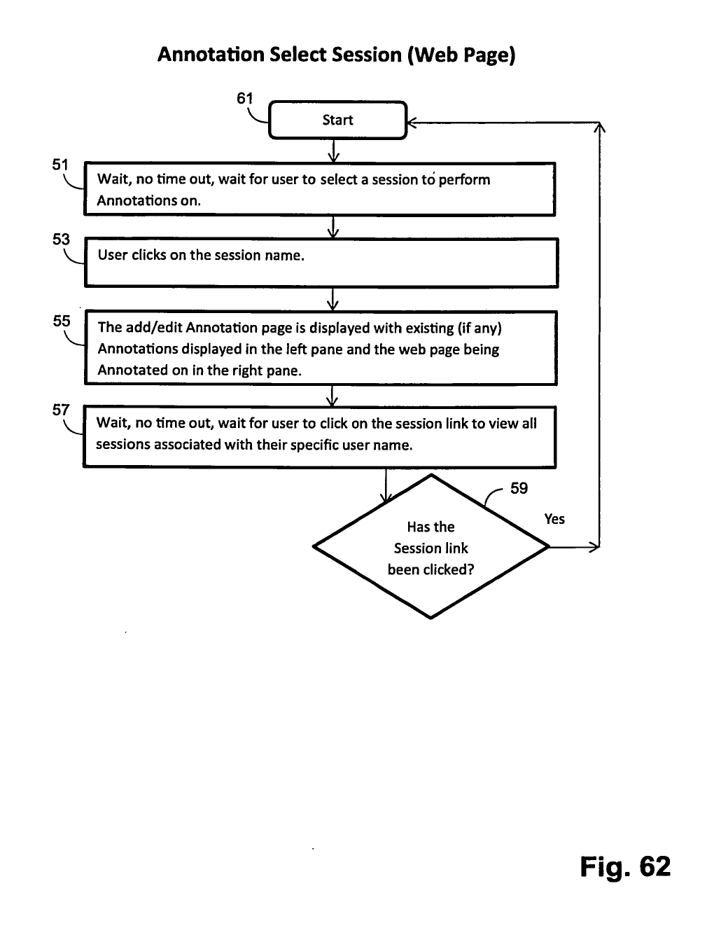

From the home page (FIG. 3), a user can start a new web page session by selecting a New Web Page Session box 57 (FIG. 4); naming the session by typing a
a session name into the text box 56 and entering a URL into the text box 72 (FIG. 5). Alternatively, the user can select an existing session, for example, the session 64 (FIG. 3), on the user's home page. FIGS. 7-9 relate in general to a new web page session while FIG. 62 illustrates the logic for accessing an existing session.

Referring first to FIG. 70, once the user is logged in, the system 20 waits for the user to enter a session name in the dialog box 56 (FIG. 4) and the New Web Page Button 57 to be selected, as indicated by the boxes 64 and 66 (FIG. 70). Specifically, the system 20 checks in step 68 whether the New Web Page Button 57 has been selected. If not, the system returns to step 64 and waits for the user to enter a session name in the dialog box 56 (FIG. 4) and select the New Web Page Button 57. If the New Web Page Button 57 has been selected, as determined in step 68, the system 20 displays a URL entry page, for example, as illustrated in FIG. 5, in step 70 (FIG. 5).

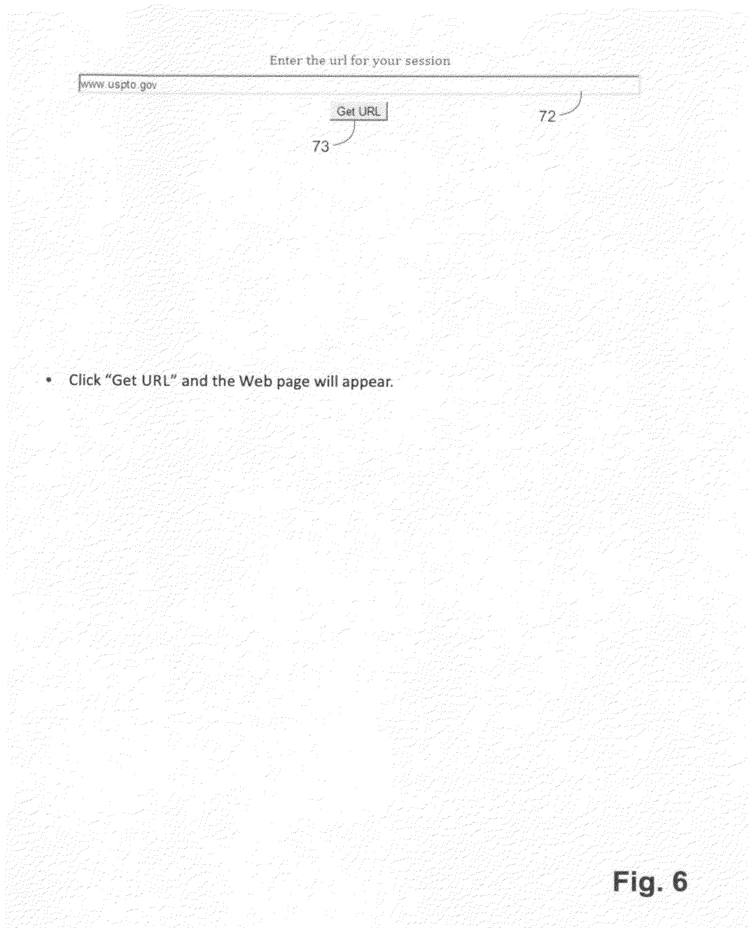

As shown in FIG. 5, the URL entry page includes a dialog box 72 and a Get URL button 73. In order to annotate a web page, the user enters the URL of the web page to be edited. The system continuously checks in step 72 whether a URL has been entered in the dialog box 72 (FIG. 5) and whether the Get URL button 73 (FIG. 6) is selected. After the URL is entered in the dialog box 72 and the GET URL button 73 is selected, a new session ID is created and saved, as indicated in step 74. Next in step 76, the web page to be annotated is displayed, for example, as illustrated in FIG. 7. Instructions for editing the page are also included on the page.

As mentioned above, a user can select an existing session and edit the web page in that session or delete the annotation altogether. Referring to FIG. 62, the system waits in step 51 for the user to select a Session from the various sessions listed on the user's home page (FIG. 3). FIG. 3 lists an existing USPTO session 64. That session or any other existing web page session may be selected by selecting the respective session on the home page, as indicated in step 53 (FIG. 62). As will be discussed in more detail below, once an existing session is selected, the web page is displayed in step 55 in the right pane and the list of annotations is displayed in the left pane. The user can then view an annotation on the web page, create an annotation or close the session. Once the user completes the annotation, the user can close out the existing session by selecting the Sessions button 102 which closes the session and lists all of the sessions associated with the user's name, as determined in step 59. The system then returns to steps 61 and 51.

In order to demonstrate the invention, an exemplary web page is described and illustrated, since works by the US Government are not eligible for US Copyright protection, an exemplary US Government web page is selected for the example. In this example, the URL. www.uspto.gov is shown in the dialog box 72 in FIG. 6. Once the Get URL button 73 shown in FIG. 6 is selected an exemplary government web page is illustrated in FIG. 7. In this example, a web page from the US Patent Office web site is shown. As illustrated in FIG. 7, the web page is shown on the right and instructions for annotating the web page are shown to the left of the web page.

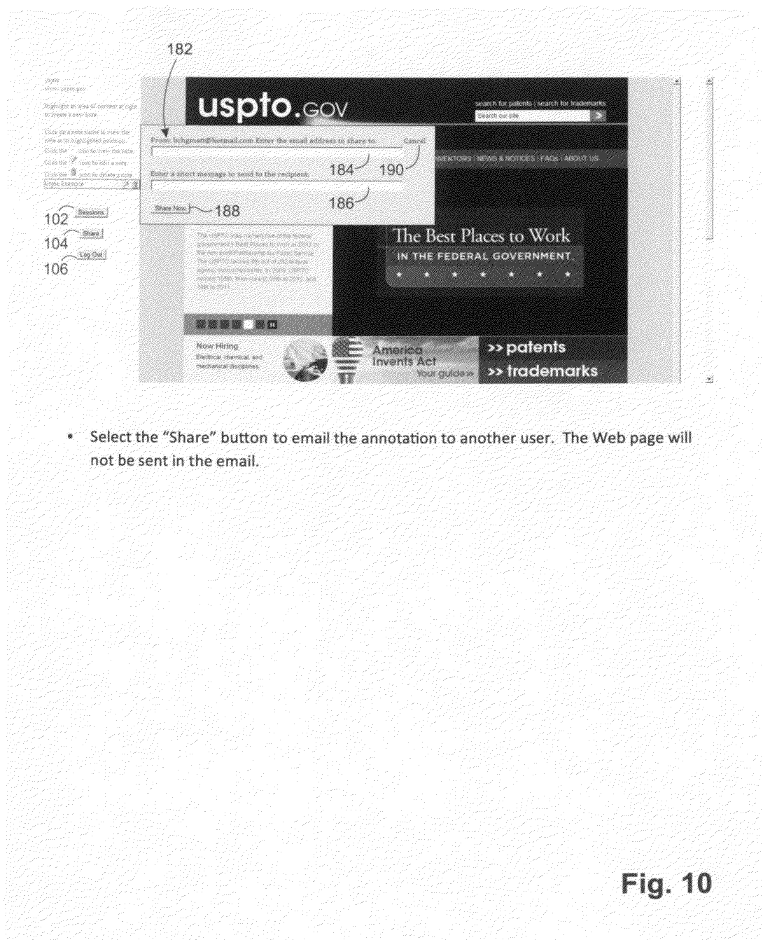

FIGS. 7-9 illustrate annotation of a web page. FIGS. 10-12 illustrate how the annotation can be shared with a third party. Referring first to FIG. 7, a user interface is shown to the left of the web page and will be described in more detail. The user interface may include instructions, one or more dialog boxes and various control buttons. In addition to the user interface, the URL and display name of the web page is displayed next to the web page, as indicated by the reference numeral 88. In this case the display name is illustrated as uspto which stands for the US Patent and Trademark Office having a URL at www.uspto.gov. Below the display name and URL, the user interface is shown.

Exemplary instructions that form a portion of the user interface are set forth below. Reference numbers for each of the instructions are set forth in the column to the left. These instructions provide simplified navigation of the system by the user.

| | |
|---|---|
| 90 | Highlight an area of content at right to create a new note (a/k/a |
| | Annotation Add). |
| 92 | Click on a note name at its highlighted position |
| 94 | Click on the view icon (magnifying glass) to view the note |
| 96 | Click on the edit icon (pen and paper) to edit a note |
| 98 | Click on the delete icon (trash can) to delete a note |

A dialog box 100, which may also form part of the user interface, may be provided beneath the instructions 90-98. As will be discussed in more detail, the dialog box 100 allows the user to name each of the annotations for later use.

As mentioned above, the user interface may also include control buttons. Three exemplary control buttons are shown. These control buttons are identified as: SESSIONS 102; SHARE 104; and LOG OUT 106. The SESSIONS control button 102 allows a user to view all of the sessions associated with a particular user name. Thus, when a user completes a session, the user may select the LOG OUT control button 106 to log out of the application The SHARE control button 104 allows the user to share the annotation with another user.

FIGS. 8, 9 and 50 illustrate the process for annotating a web page. In general, annotations are created by highlighting a section of a page. This causes a note editor to be displayed. The annotations are created by way of the note editor. Annotations can be saved by selecting an apply button on the note editor or deleted by selecting a cancel button on the note editor.

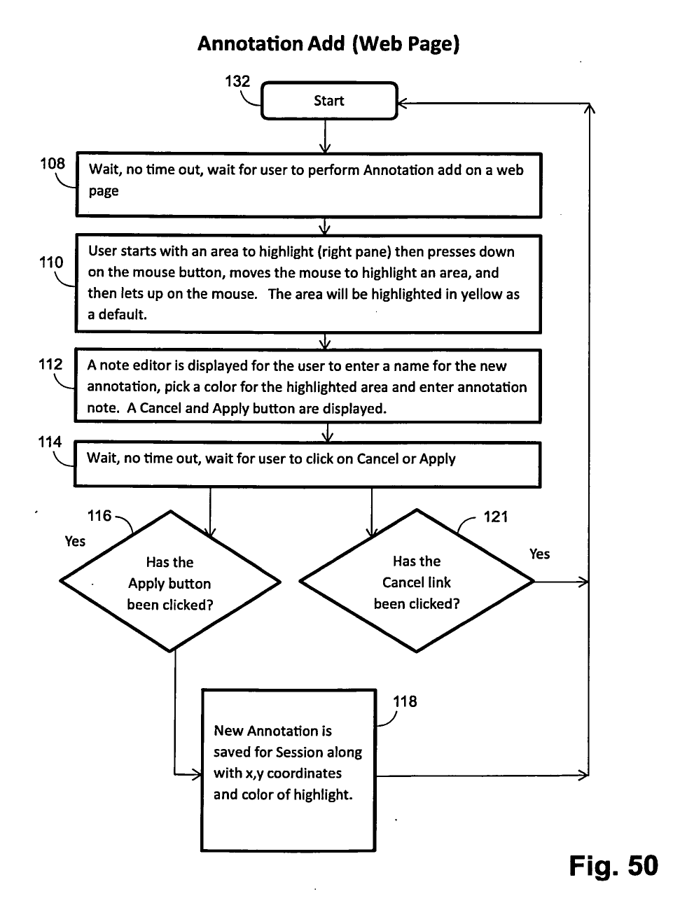

Referring first to FIG. 50, the system waits in step 108 until an Annotation Add instruction 90 is received. The Annotation Add instruction 90 may be implemented by highlighting text on a web page by pressing down on a mouse button and moving the mouse over the area on the web page to be highlighted as indicated in step 110. Once the user releases the mouse button, the area over which the mouse traveled will be highlighted.

Subsequently, a note editor 120 (FIG. 8) will be displayed. As shown, the note editor 120 may include a text box 122, a number of editing tools 124, collectively identified with the reference numeral 124, for editing the text in the text box 122 and dialog boxes. This enables the user to name the annotation and select a color for the highlighting. As mentioned earlier, the name of the annotation will be displayed on the home page (FIG. 3). In this case, “USPTO” is displayed in the box 64 in FIG. 3.

Two control buttons may also be provided on the note editor 122 (FIG. 8). A CANCEL button 130 (FIG. 50) is provided to allow all of the user inputs to the note editor 122 (FIG. 8) to be deleted. An APPLY button 126 is also provided. Selection of the APPLY button 126 causes all of the user inputs to the note editor to be saved and stored under the annotation name provided in the dialog box 128.

The note editor 122 also enables the user to enter a name for the annotation in the dialog box 128, and enter an annotation note in the text box 122 as indicated in step 112 (FIG. 50). A dialog box 130 (FIG. 8) may also be provided to allow the user to select the color of the highlight. The system then waits in step 114 (FIG. 50) for the APPLY button 126 (FIG. 8) or the CANCEL button 130.

If the Apply button 126 is selected, as determined by the decision block 116 (FIG. 50), the new annotation is saved for the session along with the x-y coordinates of the annotation and the color of the highlight in step 118 if a color is specified. Otherwise yellow may be used as the default highlight color.

If the CANCEL button 130 (FIG. 8) is selected, as determined by the decision block 121, the user input on the note editor 120 is not saved and the system returns to START 132 and waits for the note editor 120 (FIG. 8) to be selected.

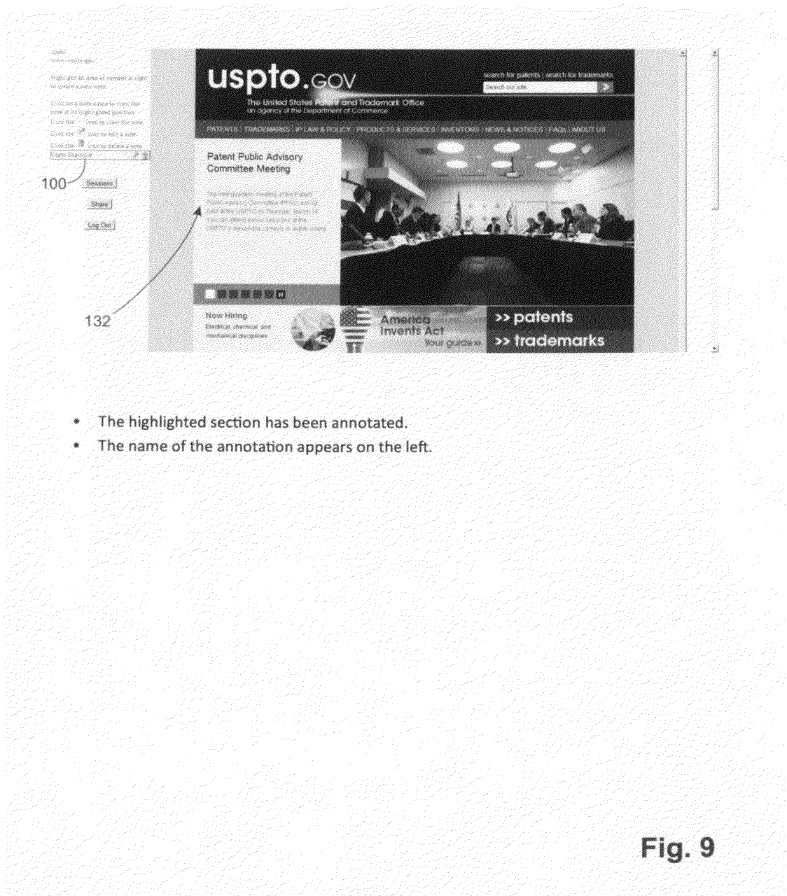

FIG. 9 illustrates an exemplary highlighted web page. For illustration, the highlighted portion is identified with the reference numeral 132. The name of the annotation appears in the dialog box 100. If the APPLY button 126 (FIG. 8) is selected, the annotation is saved and the name of the annotation is saved on the home page (FIG. 3). Referring to FIG. 3, the annotated page illustrated in FIG. 9 is identified in the box 64 as “USPTO Example”.

In accordance with one aspect of the invention, the system allows the originator to edit as well as delete sessions and annotations. As used herein, a session refers to a single web page or epub page. Annotations refer to one or more notes on a single web page or epub page.

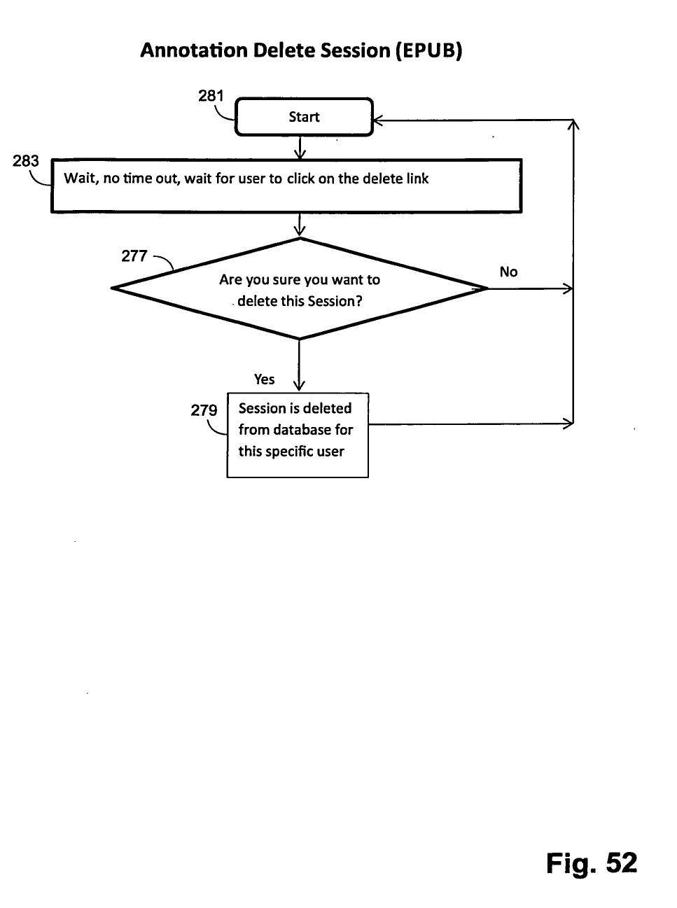

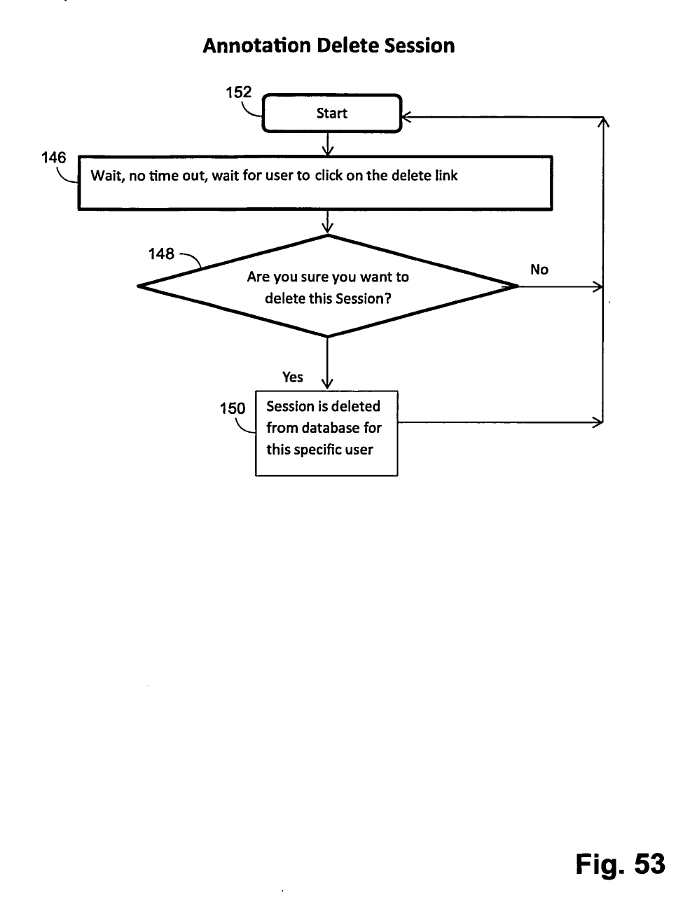

Referring to FIGS. 3 and 53, web page sessions, as well as epub sessions (FIG. 52), can be deleted by the originator of the session. With reference to FIG. 3, all web page sessions as well as epub sessions are identified on the home page, illustrated in FIG. 3. As illustrated, three exemplary sessions are illustrated and identified with the reference numerals 64, 66 and 68. Adjacent each of the session names 64, 66 and 68 are icons 140, 142 and 144 which represent trash cans. In order to delete an entire session, the trash can icon that correlates to the particular session is selected. For example, to delete the session uspto 64, the icon 140 is selected. Referring to FIG. 53, the system waits in step 146 for one of the icons 140, 142 and 144 to be selected. Once one of the icons 140, 142 or 144 is selected, a dialog box (not shown) appears with a query: “Are you sure you want to delete this Session” along with “YES” and “NO” check boxes (not shown) in order to determine if the user is sure that the Session is to be deleted, as indicated in step 148. If the YES check box is selected, as indicated in step 150 (FIG. 53), the session is deleted from the database 26 (FIG. 1). If the “NO” check box is selected, the system returns to steps 152 and 146 and waits for one of the icons 140, 142 or 144 to be selected.

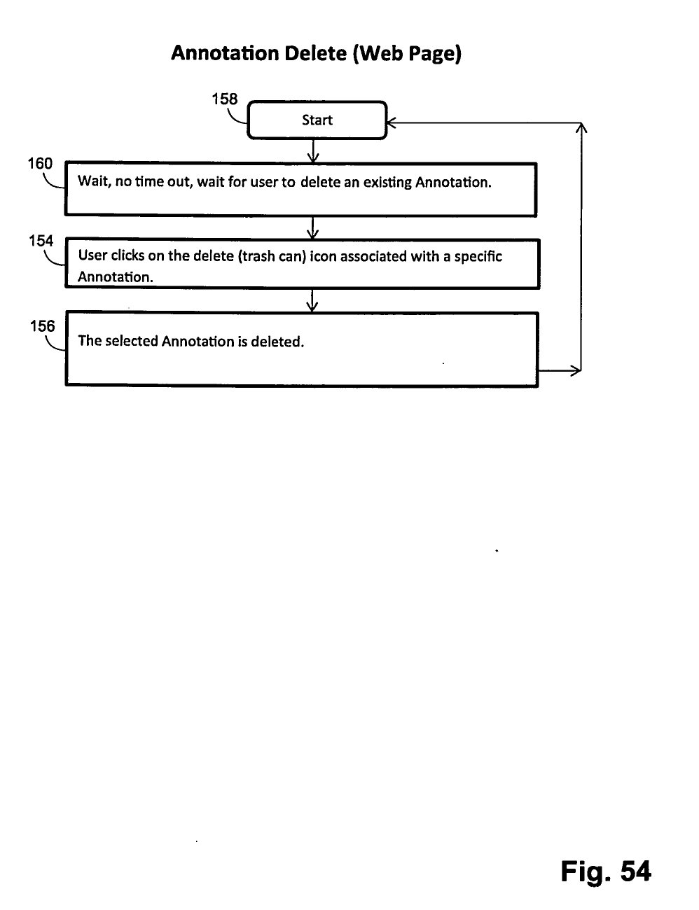

The system also allows the originator to edit or delete the annotation without deleting the Session. As mention above, when a web page session is selected, an edit icon 96 (FIG. 7) and a delete icon 98 is provided adjacent the web page. When the user selects the delete icon 98, as indicated in step 154 (FIG. 54), the annotation is deleted from the database 26 (FIG. 1), as indicated in step 156 (FIG. 54). The system returns to steps 158 and 160 and waits for the delete icon 98 (FIG. 7) to be selected.

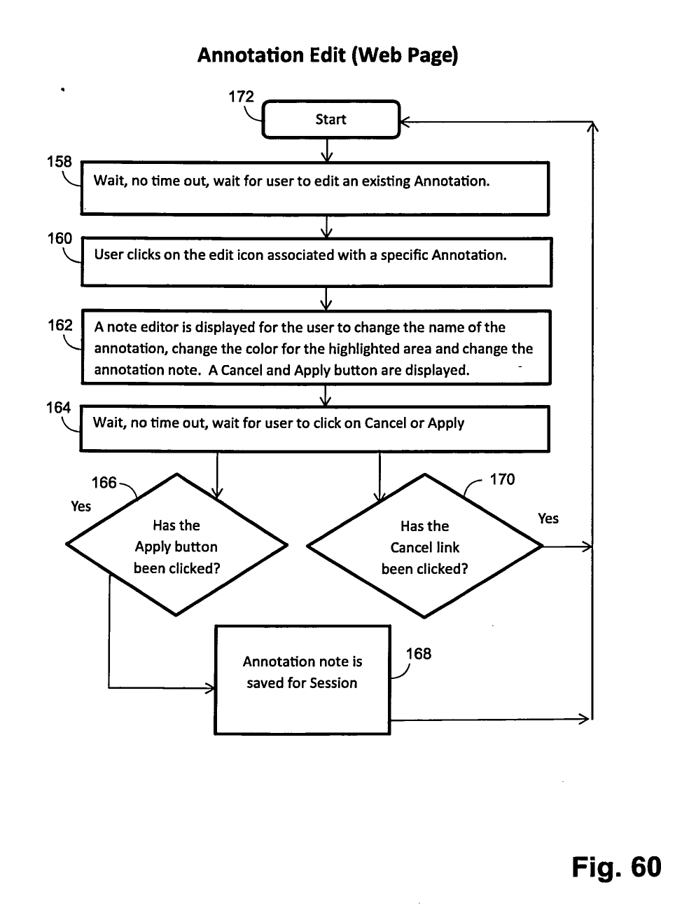

Two methods are provided to enable a user/originator to edit annotations on a web page. In one method, the user/originator is able edit an annotation of a web page during a current session involving that web page. Alternatively, the user can edit annotations of web pages from previous sessions. Editing of a web page annotation from a previous session may be initiated by the originator of the annotation by first selecting a web page session to edit located in the annotation 100 box in FIG. 7 and then selecting the edit icon 96 (FIG. 7). With reference to FIG. 60, the system waits for the user to select the edit icon 96 in steps 158 and 160. After the edit icon 96 is selected, the note editor 120 (FIG. 8) is displayed to enable the user to change one or more of the following attributes of the annotation. As indicated in step, the user can change the name of the annotation, change the color of the highlighted area and change the annotation note, Once the edit is complete, the user can select the APPLY button 126 (FIG. 8) or alternatively the CANCEL button 130. In step 162, the system waits for one of the CANCEL 130 and APPLY 126 buttons to be selected. If the APPLY button 126 is selected, as determined in step 166, the annotation note for the Session is saved in the database 26 (FIG. 1), as indicated by step 168. Alternatively, if the CANCEL button 130 is selected, as indicated by step 170, the system returns to steps 172 and 158 and waits for the edit icon 96 to be selected.

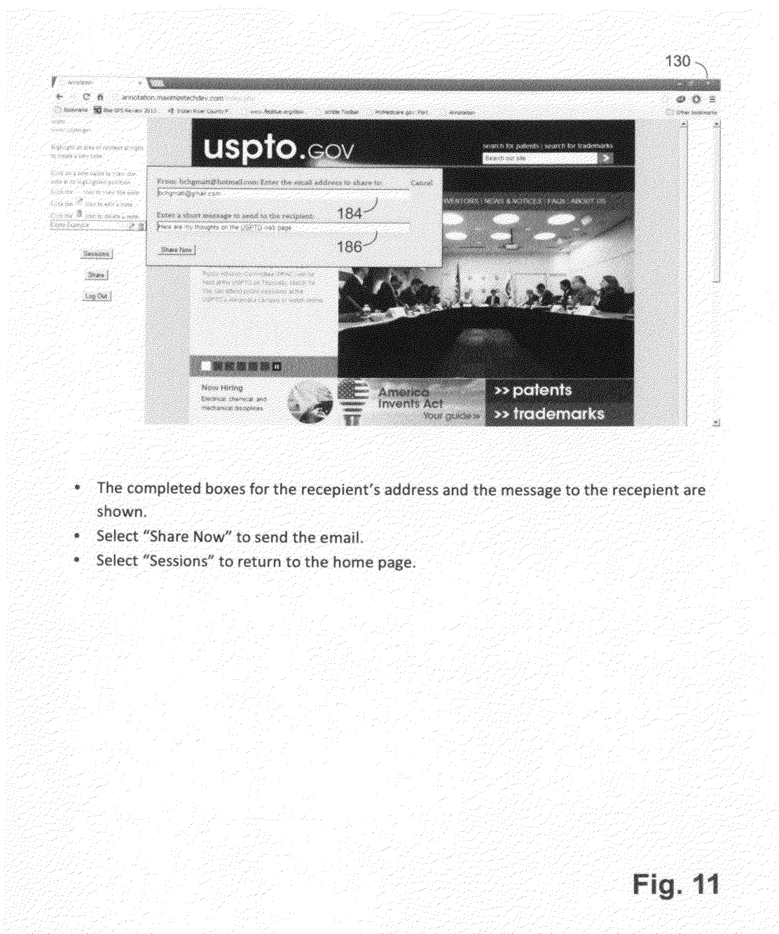

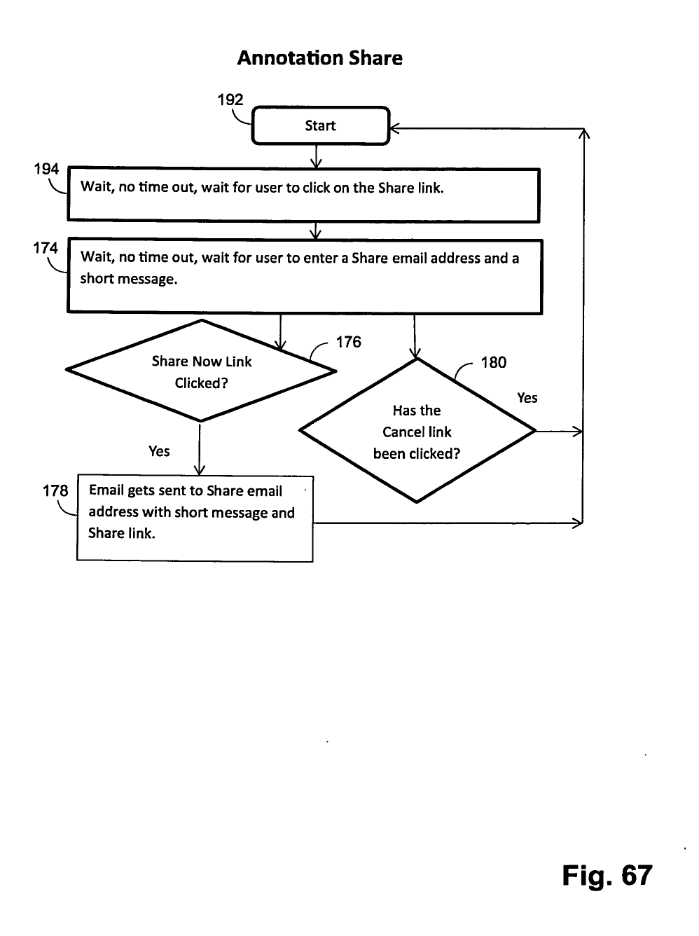

In accordance with another important aspect of the invention, the user/originator can share an annotation originated by the user with one or more third party recipients. In particular, after a web page is annotated, a user can share the annotation—not the content—with a third party recipient by selecting the SHARE button 104 (FIG. 10). With reference to FIG. 65, the system continuously loops waiting for the SHARE button 104 to be selected, as indicated by steps 187, 189 and 193 (FIG. 65). Once the SHARE button 104 is selected, a dialog box 182 pops up. The dialog box 182 has a box 184 for the recipient's email address and an optional box 186 for a short message. The dialog box 182 includes exemplary control buttons, For example, a CANCEL button 190 and a SHARE NOW button 188. With reference to FIG. 67, once the recipient email address is entered into the box 186 (FIG. 11) and optionally a short message is entered into the box 186, as illustrated in FIG. 11, the system checks in step 176 whether the SHARE NOW button 188 (FIG. 67) was selected. Once the system determines that the SHARE NOW button 188 (FIG. 10) was selected, the system automatically sends an email to the address in the box 184 with the short message, as indicated in step 178 (FIG. 10).

The user also has the option to cancel the request to share the annotation. In this case, the user simply selects the CANCEL button 190 (FIG. 10). The system monitors the CANCEL button 190. If the system detects in step 180 (FIG. 67) that the CANCEL button 190 (FIG. 10) was selected in step 180, the system returns to steps 192 and 194 and waits for the SHARE button 104 (FIG. 10) to be selected.

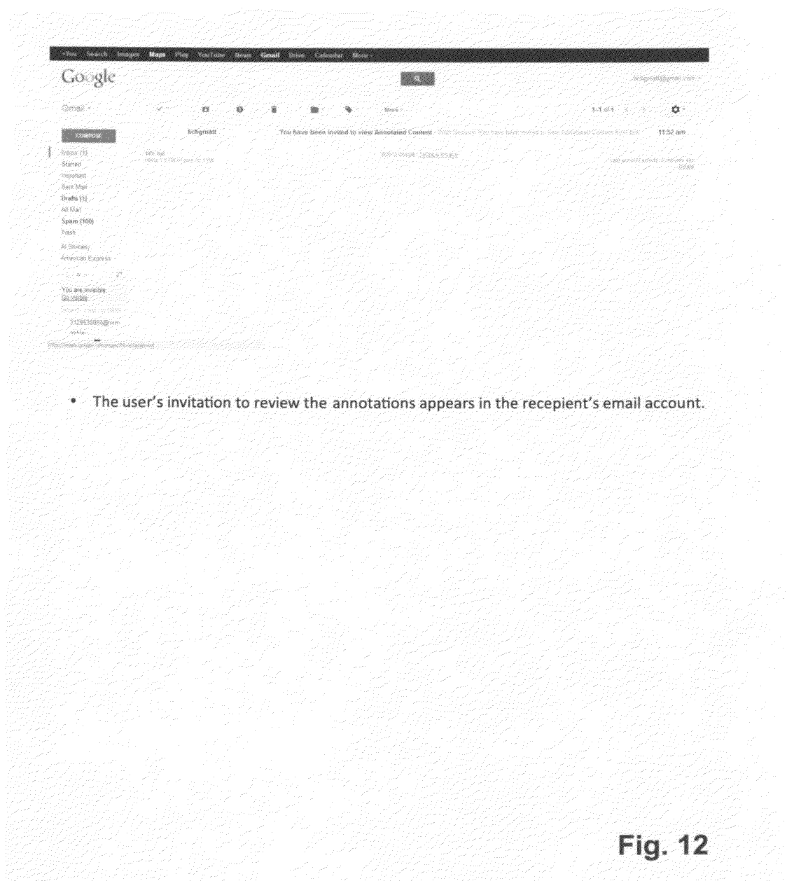

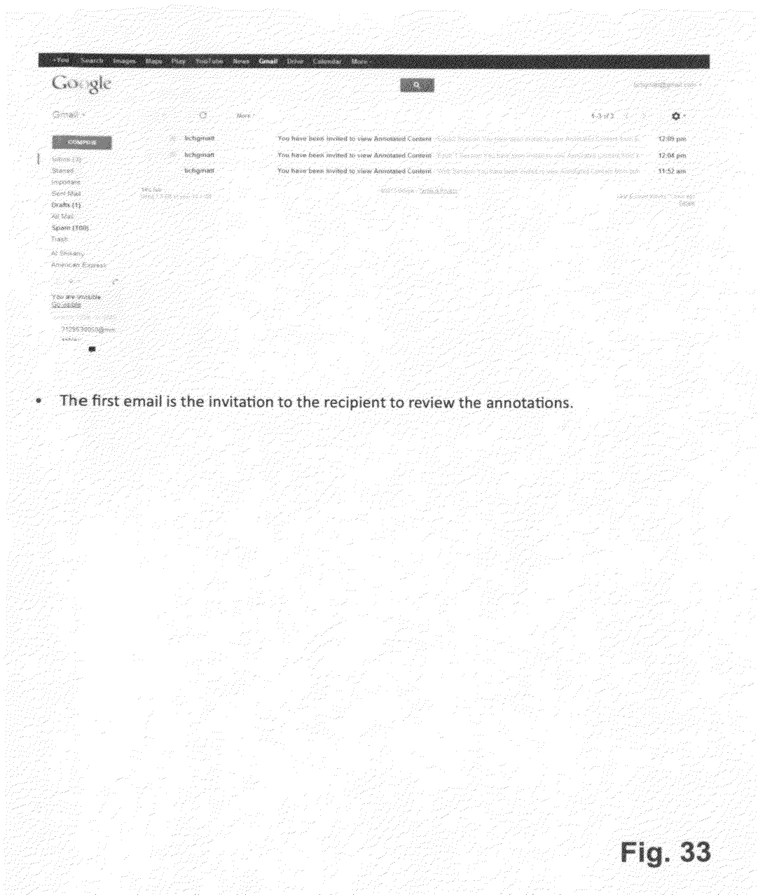

FIGS. 12 and 33 are exemplary representations of a recipient's email account. Referring first to FIG. 12, an exemplary mail from the user is in the form of an invitation to the recipient to view an annotation. The email may be identified in the recipient's InBox in a conventional manner. FIG. 33 is similar to FIG. 12 but illustrates multiple entries in the recipient's InBox.

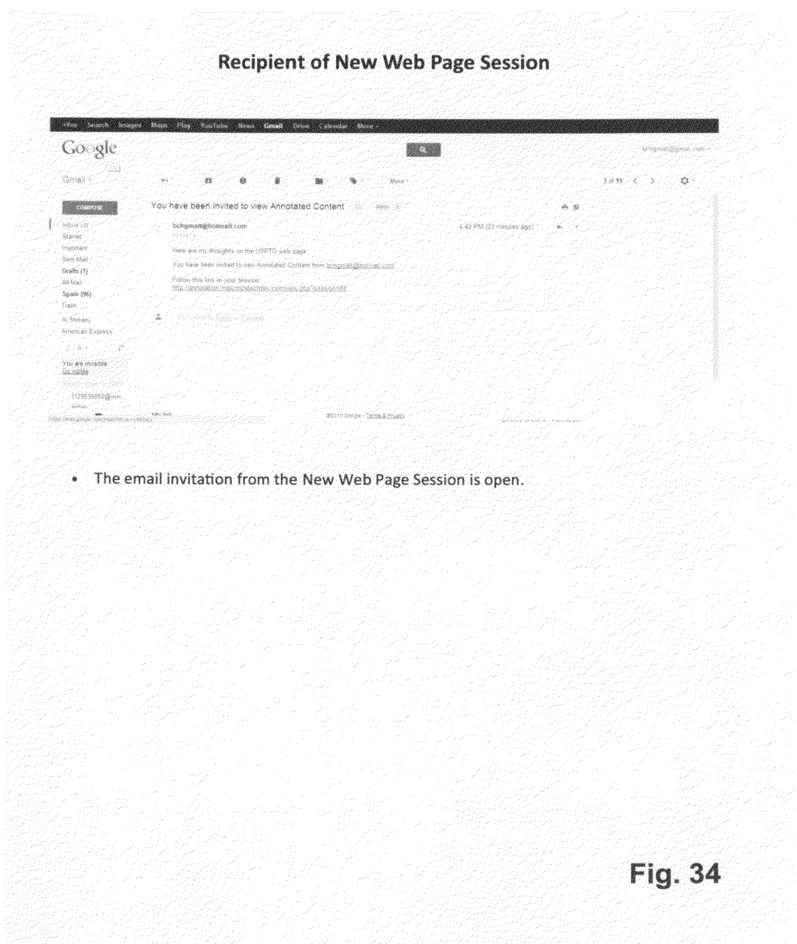

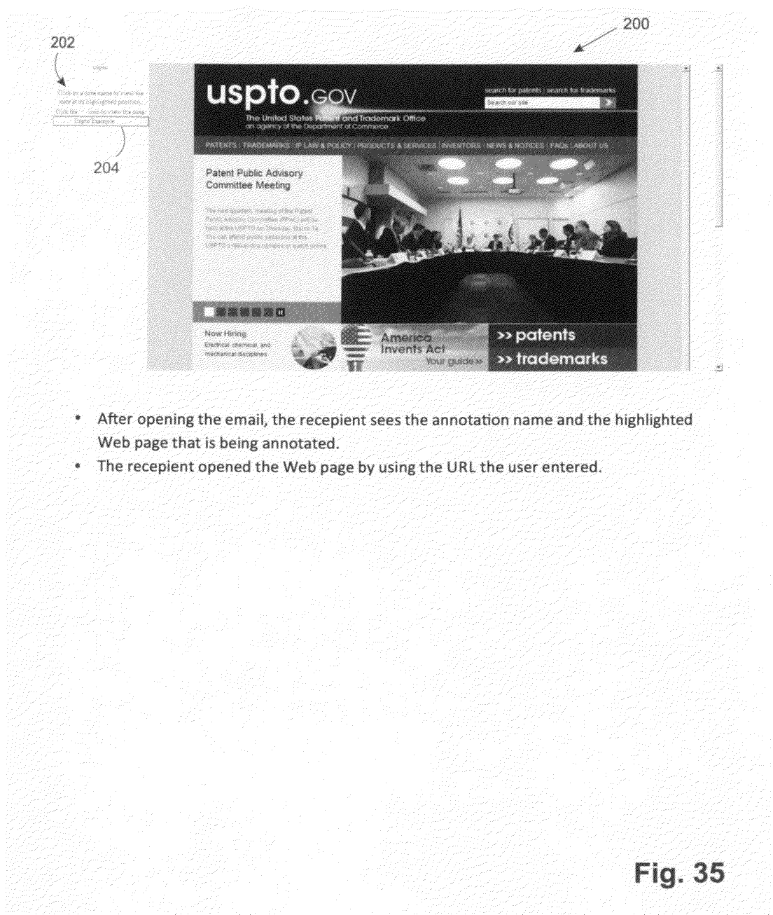

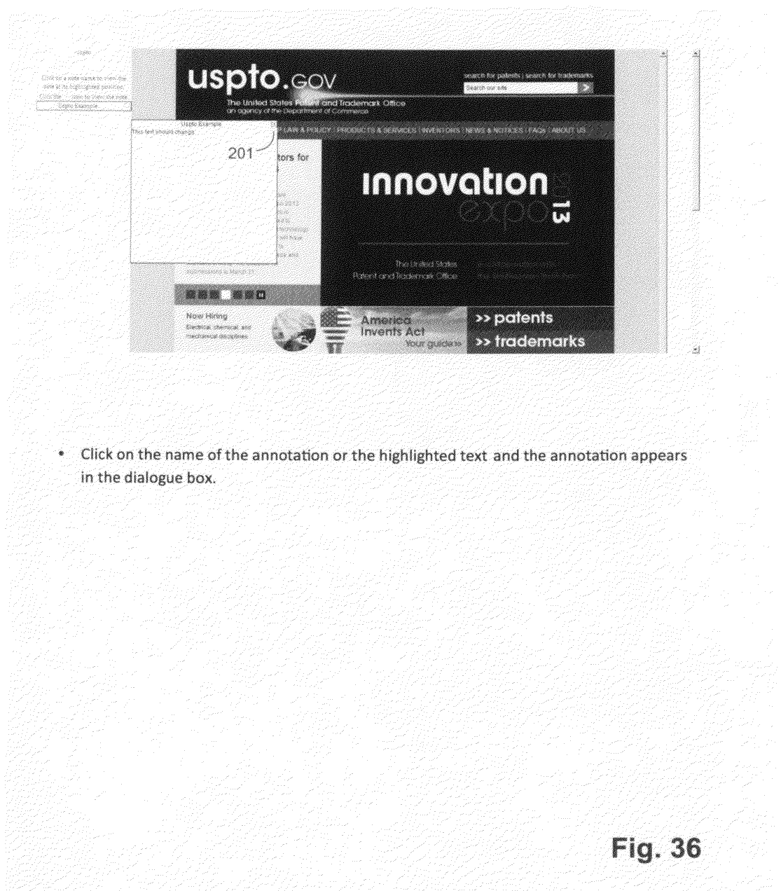

FIG. 34 illustrates an exemplary email after it is opened. Since the SHARE feature is equally applicable to an annotated web page and epub content, the feature is only described with respect to a web page. The open email provides the URL of the content that was annotated. Before opening the page in the recipient's browser, the system checks in steps 192 (FIG. 65) and 194 whether the URL is for an Epub page or a web page in steps 192 and 194 respectively. If the system determines in step 192 that the shared annotation is for an epub, the epub page is opened and displayed in a new browser window in step 196. Similarly, if the system determines in step 194 that the shared annotation is for a web page, the web page is opened in a new browser window, as indicated in step 198. Once the shared URL is copied into the recipient's browser, the content is displayed. It is important to note that the content was not shared. Only the URL for the content is shared. Both the user and the recipient use the shared URL to legitimately retrieve the content. When the recipient retrieves the content, the content is received in the system application, as generally shown in FIGS. 35 and 36. Once the content is retrieved, the web page 200 is in the right pane and the controls 202 are in the left pane. In addition, the annotation name 204 is also displayed. In this example, the annotation name is “USPTO example”.

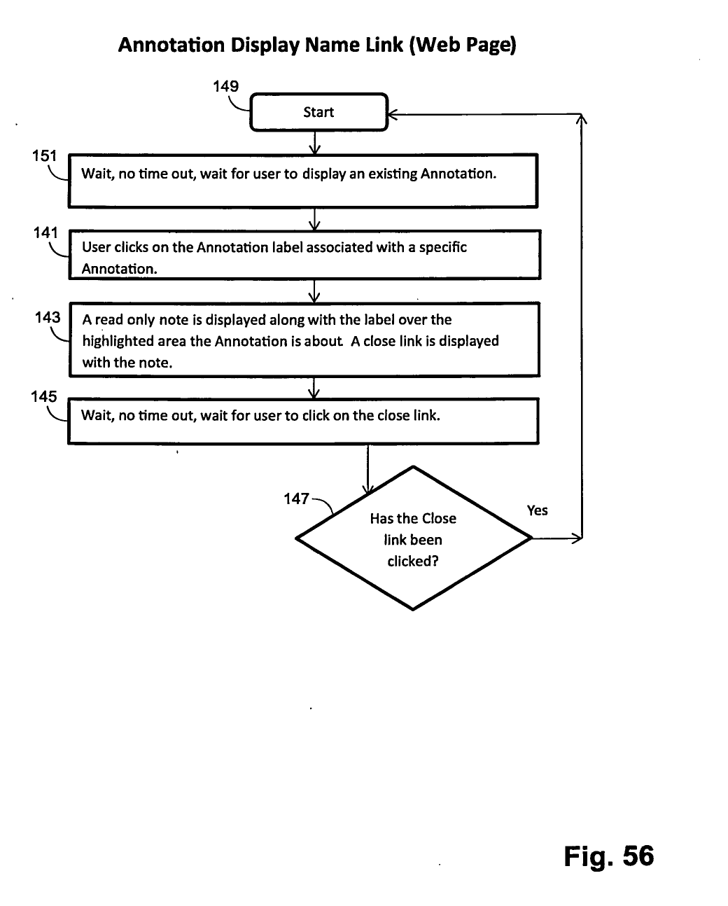

The system also allows the annotation and the content to be reviewed by the originator and/or viewed by a recipient. From the home page (FIG. 3), the user selects a web page session that pertains to a particular annotation of interest. For example, the session “USPTO Example” may be selected by selecting the session identified with the reference numeral 64. The selected web page is displayed, for example, as illustrated in FIG. 9. The user can then click on the highlighted text, illustrated in the box 132, by way of the user interface 92, as discussed above and indicated in step 141 (FIG. 56). A READ only note is displayed along with the highlighted area the note has annotated. The Close button 130 (FIG. 11, for example) is displayed with the note, as indicated in step 143. The system waits in step 145 for the user to select the Close button 130, as indicated in steps 145 and 147. Once the close button 130 is clicked on, as determined in step 147, the note is closed and the system loops back to steps 149 and 151 and waits for a user to select an annotation label 92 (FIG. 7).

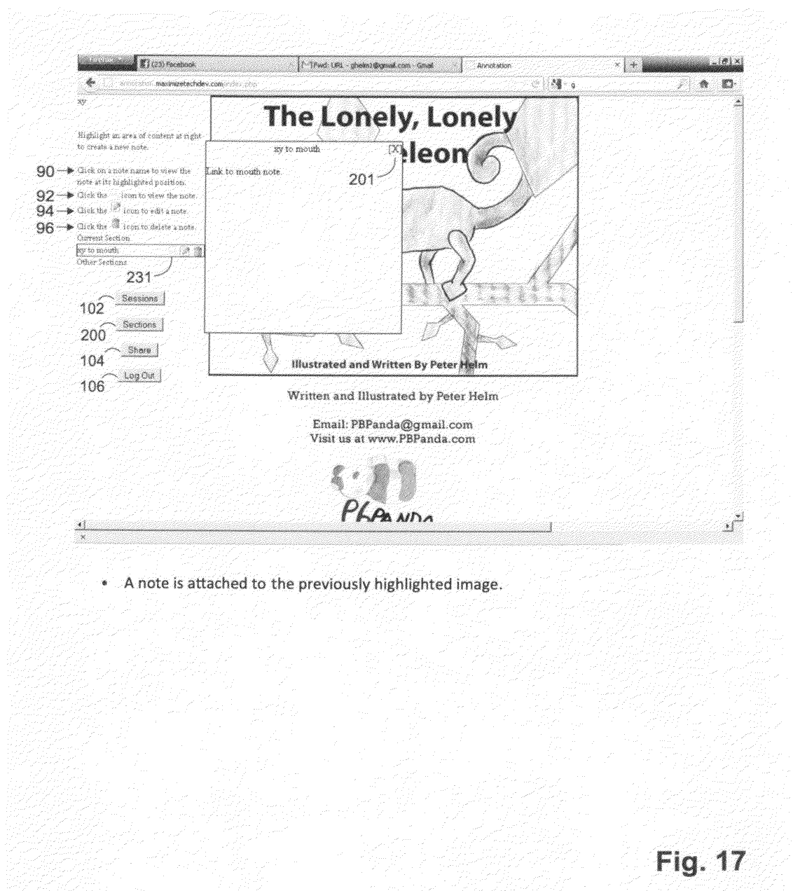

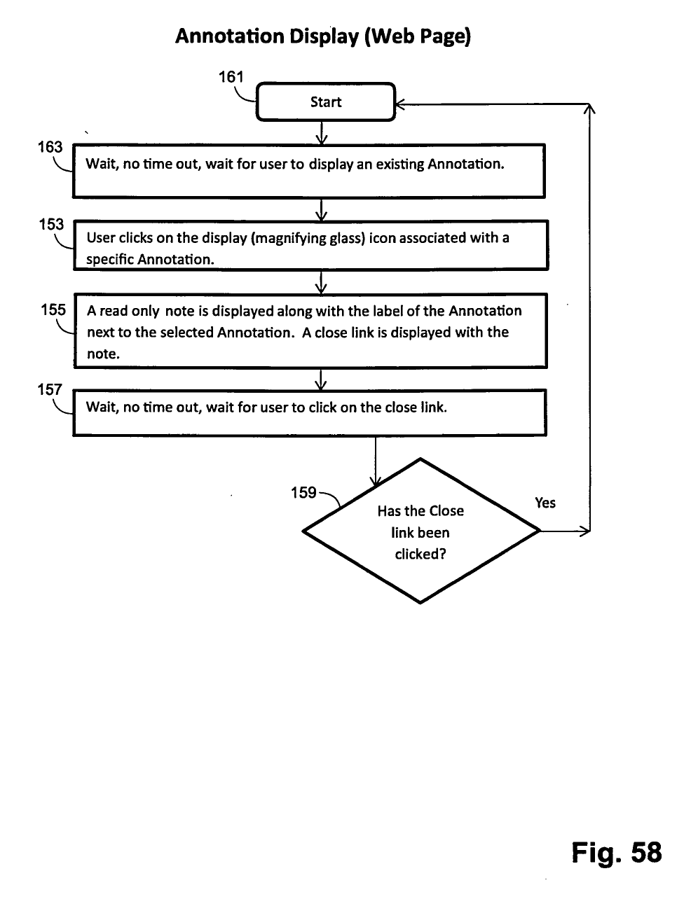

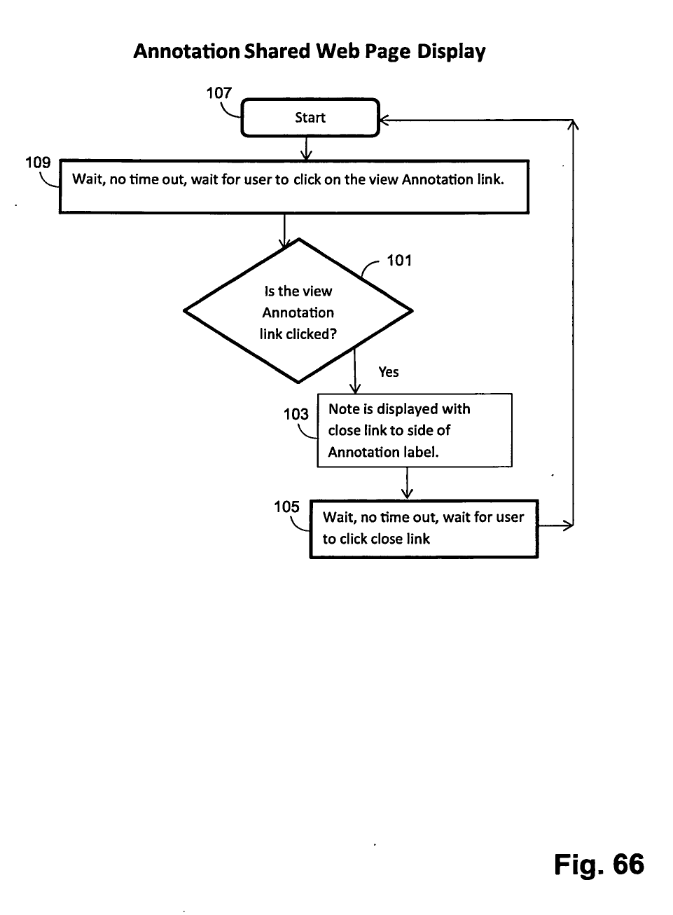

Alternatively, the user can view a note on a shared web page by selecting a Session button 102 (FIG. 7), as discussed above, and selecting the view command 94 in annotation link 100 (FIG. 9), as indicated in step 153 (FIG. 66). The note is displayed, for example, as illustrated in FIG. 8 with a Close button 130, as indicated in step 155 (FIG. 58). The system waits in step 159 for the user to select the CLOSE button 201 (FIG. 17). Once the user closes out the note by selecting the close button 130, as indicated in step 159 (FIG. 58), the system returns to steps 161 and 163 and waits for an annotation link, for example, the annotation link 100 (FIG. 9) to be selected.

A recipient can view an annotation on a web page by selecting a web page session on the home page (FIG. 3), as discussed above, and clicking on the view command 94 in annotation link 100, as indicated in step 153 (FIG. 58). Once the recipient clicks on the view command 94 (FIG. 3), a READ only note is displayed along with the label of the Annotation next to the selected Annotation along with a CLOSE link (not shown), as indicated in step 155. The system waits in steps 157 and 159 for the CLOSE link to be clicked on. Once the close link is clicked on, as determined in step 159, the note is closed and the system loops back to steps 161 and 163 and waits for a user to select an annotation label 92 (FIG. 7).

### EPUB EXAMPLE

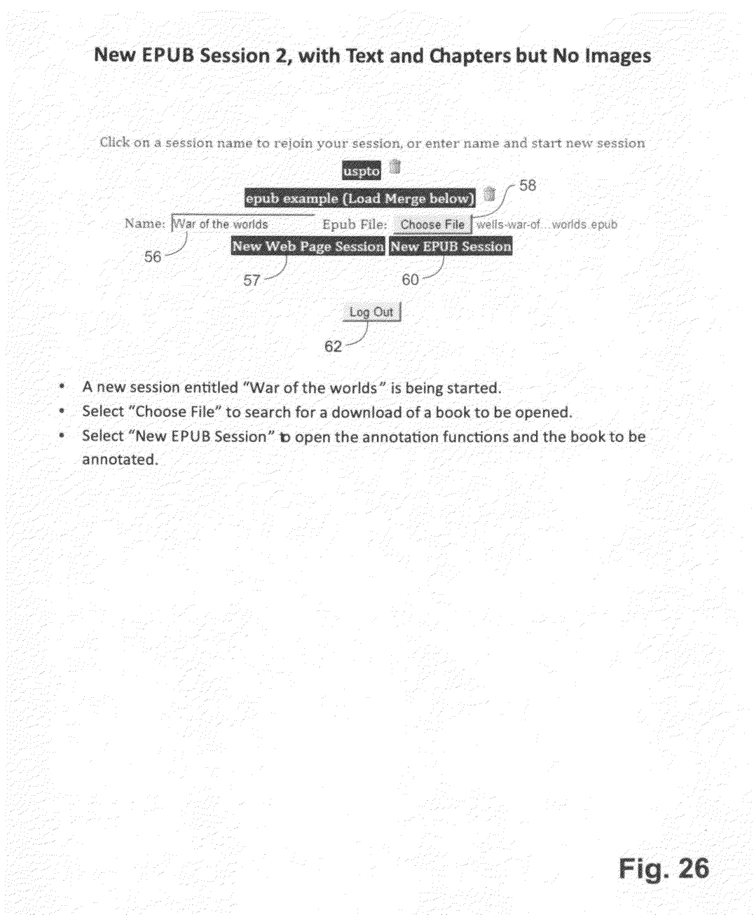

In addition to web pages, the system can also be used to annotate “epub” files formatted in a paginated layout style, as discussed above. FIGS. 13-25 refer to an epub session, referred to as epub session 1, where the epub file to be annotated has text and images but no chapters. FIGS. 26-47 refer to an epub session, referred to as epub session 2, where the epub file to be annotated includes text and chapters but no images.

Referring to FIG. 69, a new epub session can be initiated by highlighting an epub file that has previously been downloaded to the user's computer by selecting the CHOOSE FILE button 58 (FIG. 13). The system 20 waits in step 80 for the user to enter a session name in the dialog box 56 and the NEW EPUB button 60 to be selected. The system 20 continuously loops between steps 80 and step 82 (FIG. 69) until an epub file is selected on the user's computer and the Choose File button 58 (FIG. 69) is selected.

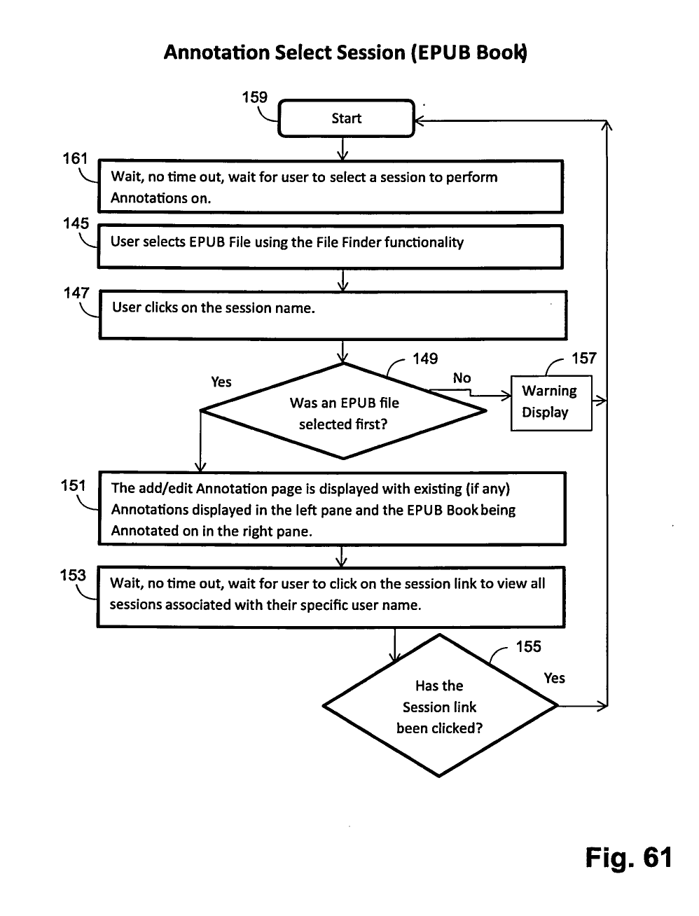

In order to initiate a new epub session, the user selects an epub file from a list of available epub files on the user's computer, as indicated in step 145 (FIG. 61) The system then checks if the user clicks on the session name selected in step 80 (FIG. 69). The system checks in step 149 (FIG. 61) whether the epub file was selected before the user clicked on the session name in step 149 (FIG. 61). If not, a warning is displayed in step 157, indication that the epub file needs to be selected before the session name is clicked on. The system returns to steps 159 and 161 and waits for the user to initiate a session in which to perform annotations, as indicated in steps 159 and 161 (FIG. 61)

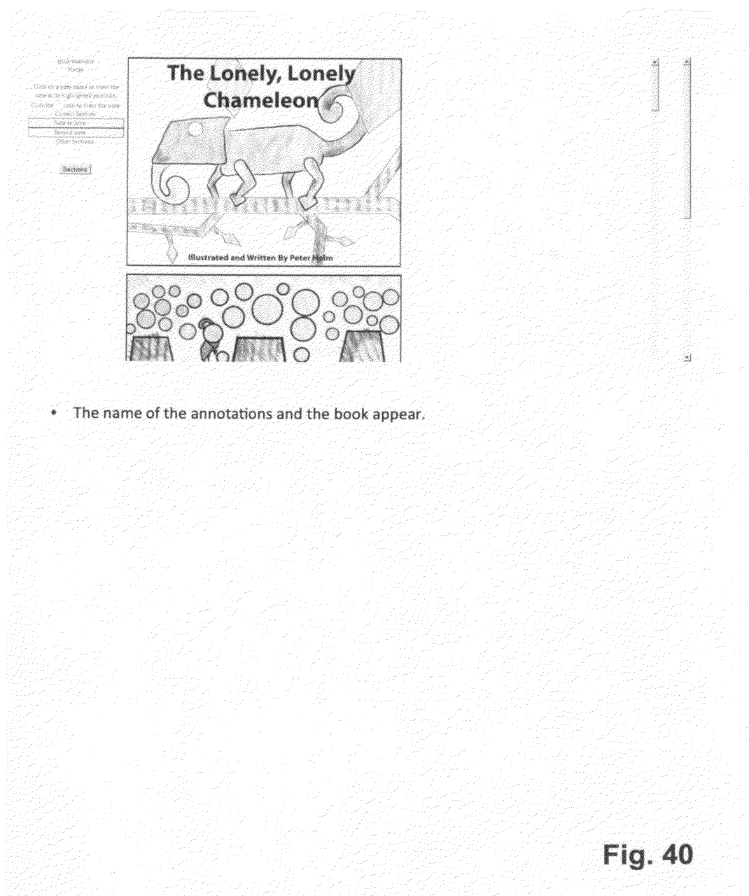

If the epub file was properly selected before the session name was selected, a new session ID is created, as indicated in step 84 (FIG. 69). The epub page to be annotated is displayed in step 86 (FIG. 69). The epub annotation page is displayed with existing annotations names displayed in the left pane and the epub page to be annotated in the right pane, for example, as illustrated in FIG. 40, as indicated in step 151 (FIG. 61). As shown in FIG. 40 two annotation labels are illustrated in the left pane. One annotation label is identified as “Note to John” while the second annotation label is identified as “Second Note”.

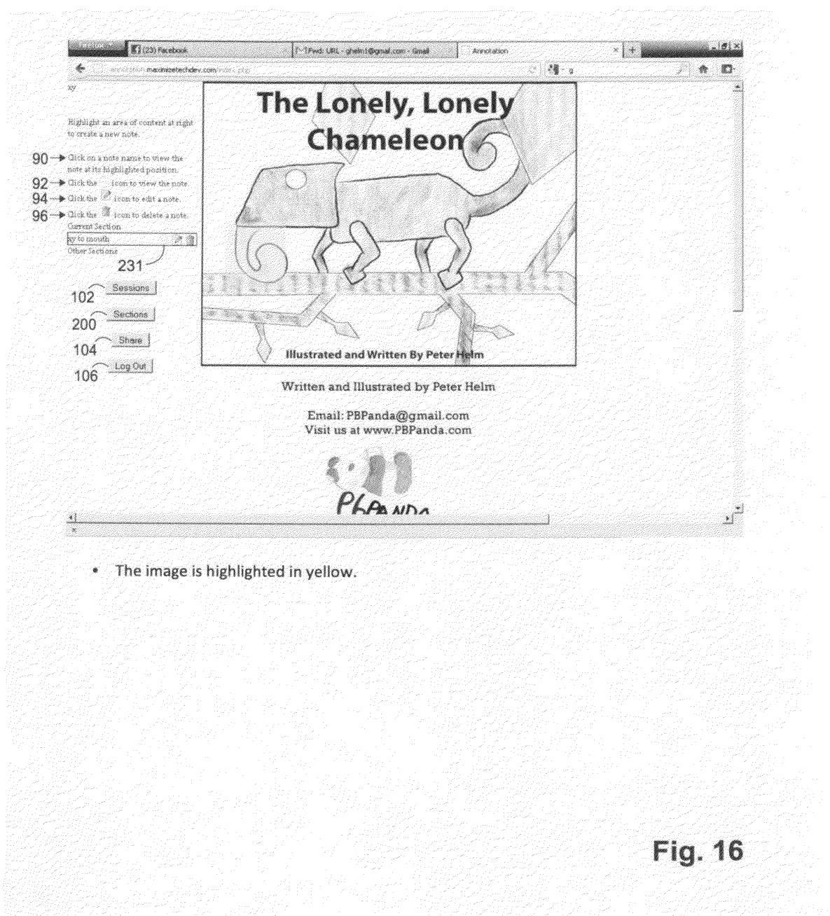

In order to close out the annotation session, the user can select the Sessions button 102 (FIG. 16). As indicated in step 153, the Sessions button, displays all of the sessions associated with a user name. Once the sessions button 102 (FIG. 16) has been selected, the system returns to steps 159 and 161 and waits for the user to initiate another session.

As shown in FIG. 13, a session name of “epub example” has been entered in the dialog box 56 and a note “No File Chosen” is displayed next to the Choose File button 58. Once the Choose File button 58 is selected, various epub files stored on the user's computer are displayed.

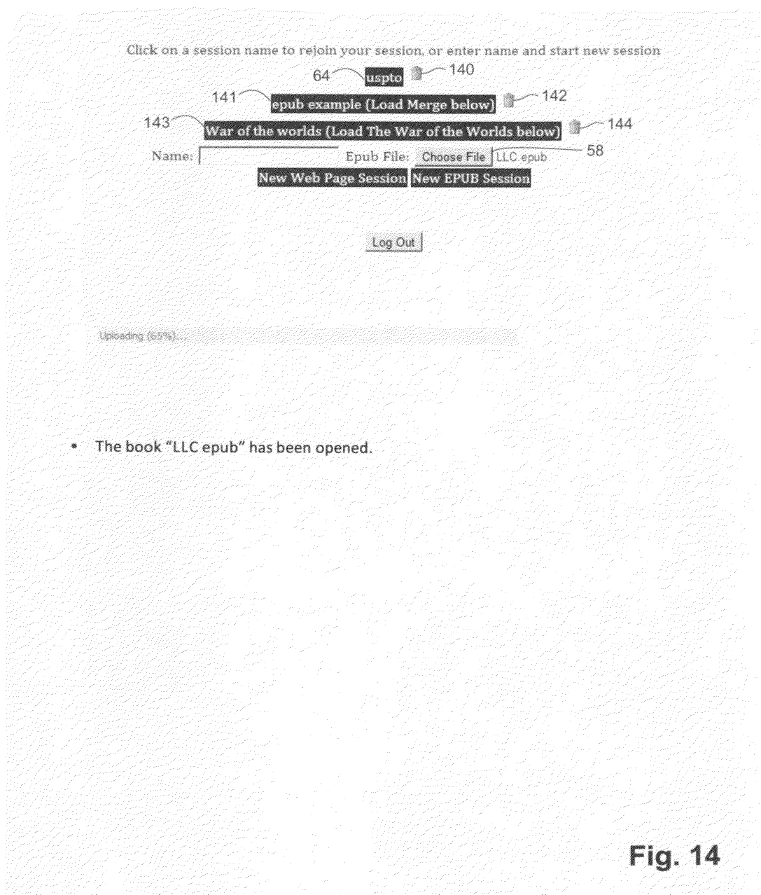

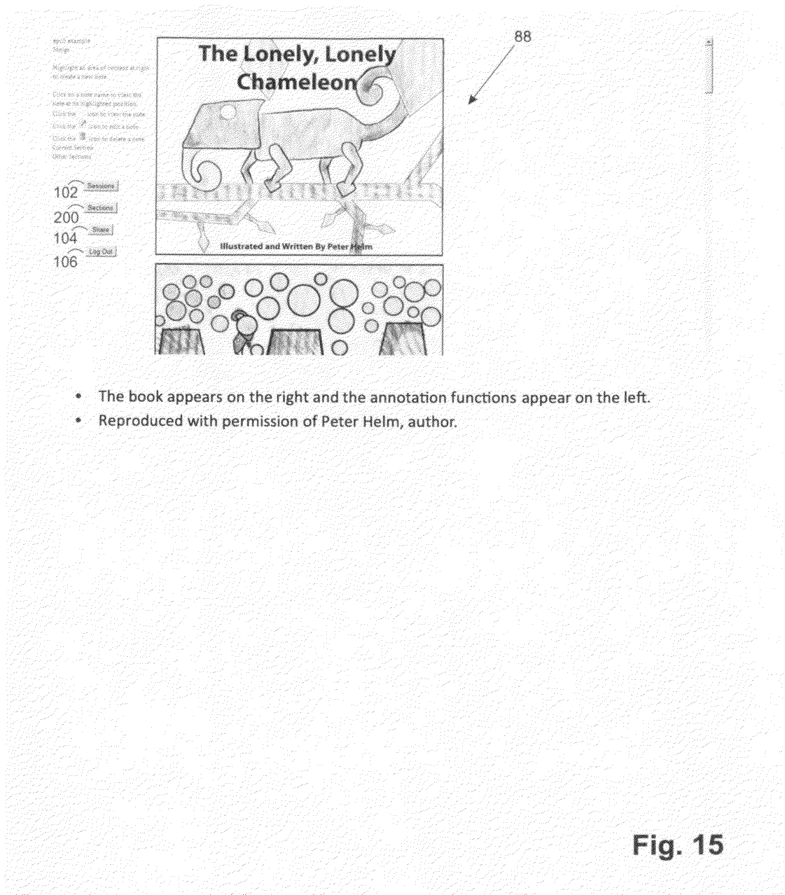

Once the user chooses a file by highlighting the file, the user selects a page of interest and then clicks on the file and selects the NEW EPUB Session button 60. While the page is being opened, the system may indicate in % how much of the page has been loaded into the computer's scratch pad memory. As shown in FIG. 14, the web page indicates that 65% of the page has been loaded. The system 20 proceeds to step 84 (FIG. 69) and creates a new session ID and saves it in the database 26 (FIG. 1) or other memory storage device in step 84. Subsequently, the epub file is displayed in step 86, as illustrated in FIG. 15.

As shown in FIG. 15, an exemplary epub page, generally identified with the reference numeral 88, is illustrated on the right side of the figure and exemplary annotation functions are shown on the left side of the figure. These functions include 4 exemplary buttons 90-96, as discussed above. The control buttons, as shown in FIG. 16, Sessions 102, Share 104 and Log Out 106 buttons function the same as discussed above. However, one additional button, a Sections button 200, is provided. The Sections button 200 (FIG. 16) allows the user to select the section or portion of the epub page with chapters to annotate.

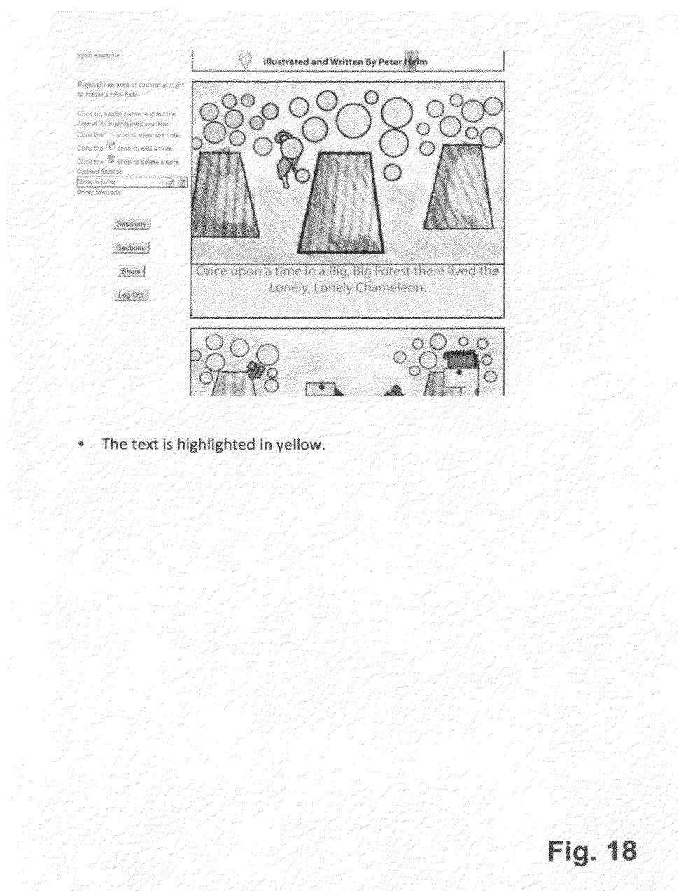

Both text and images on an epub page can be annotated. FIG. 16 is an example of an image on an epub page being highlighted while FIG. 18 is an example of text on an epub page being highlighted.

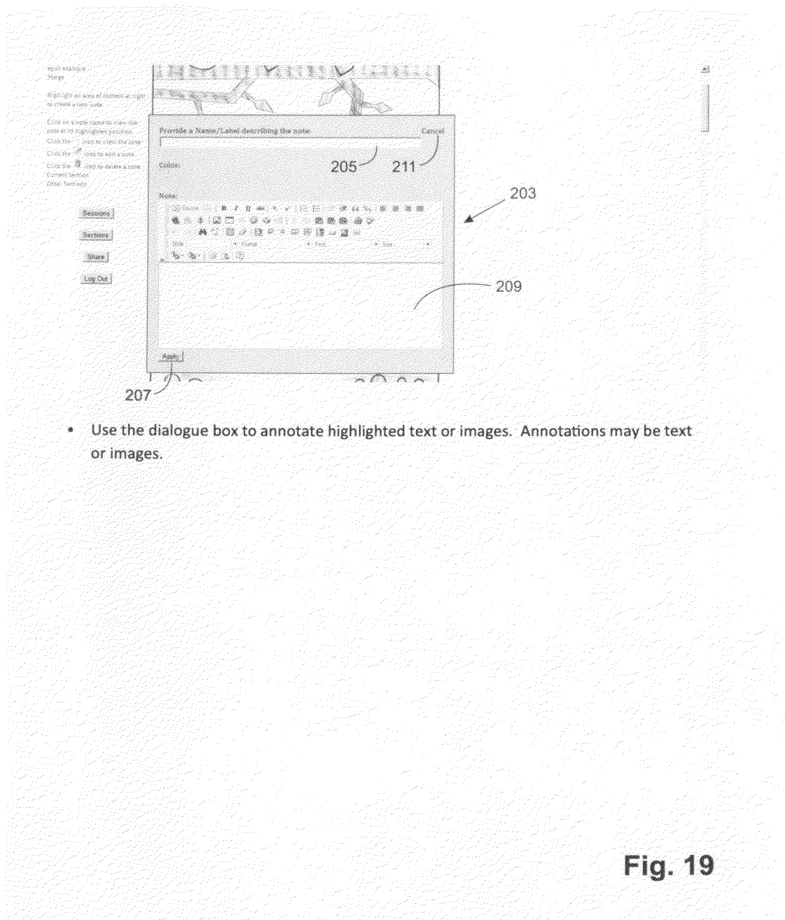

If the epub book is presented with chapters, in order to annotate a particular portion of the epub page, the user clicks on the Sections button 200 and selects a chapter. The user highlights the text or the section of the image to be highlighted. The user then provides an annotation that will correspond to or be displayed in the highlighted box. The user has the ability to select the highlight color by way of the note editor (FIG. 19). No highlight may also be selected, in which case, the user may select a section of the epub book page with the mouse, as discussed below and provide an annotation of that section with no highlight.

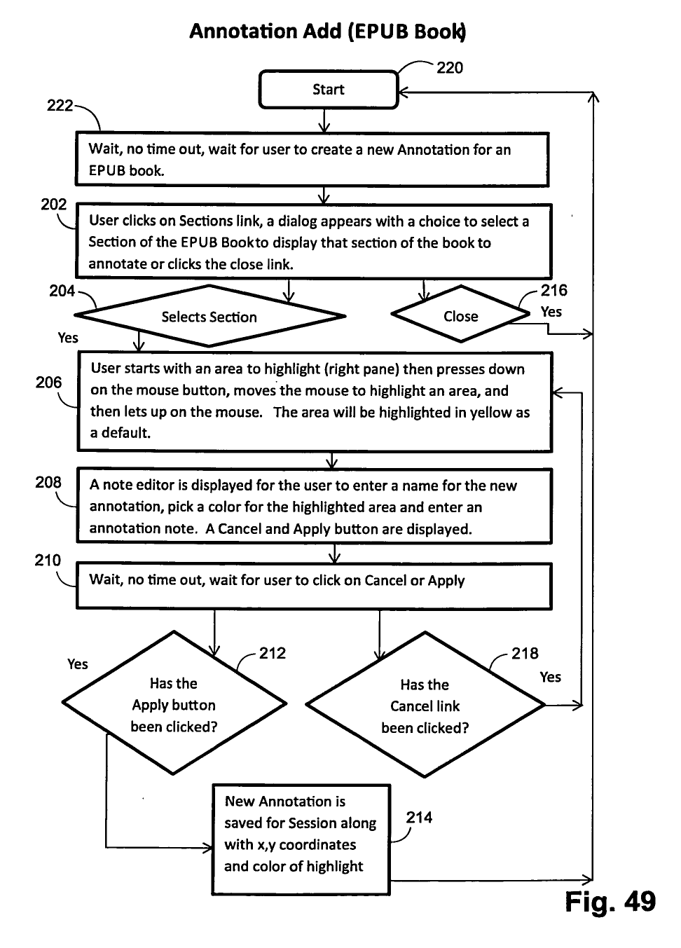

More particularly, in order to select a section of the epub page to highlight, the user uses the mouse to highlight a portion of interest. In particular, the user may press down on a mouse button to highlight an area of the epub page to be annotated, for example, as demonstrated in FIG. 16 and as indicated in steps 202, 204 and 206 (FIG. 49). Once the section to be annotated is selected, a note editor 203 (FIG. 19) pops up to allow an annotation to be applied to text or an image on the epub page as indicated in steps 206 and 208. After the annotation is provided in the annotation text box 209, the annotation is named in the text box 205 for the annotation name.

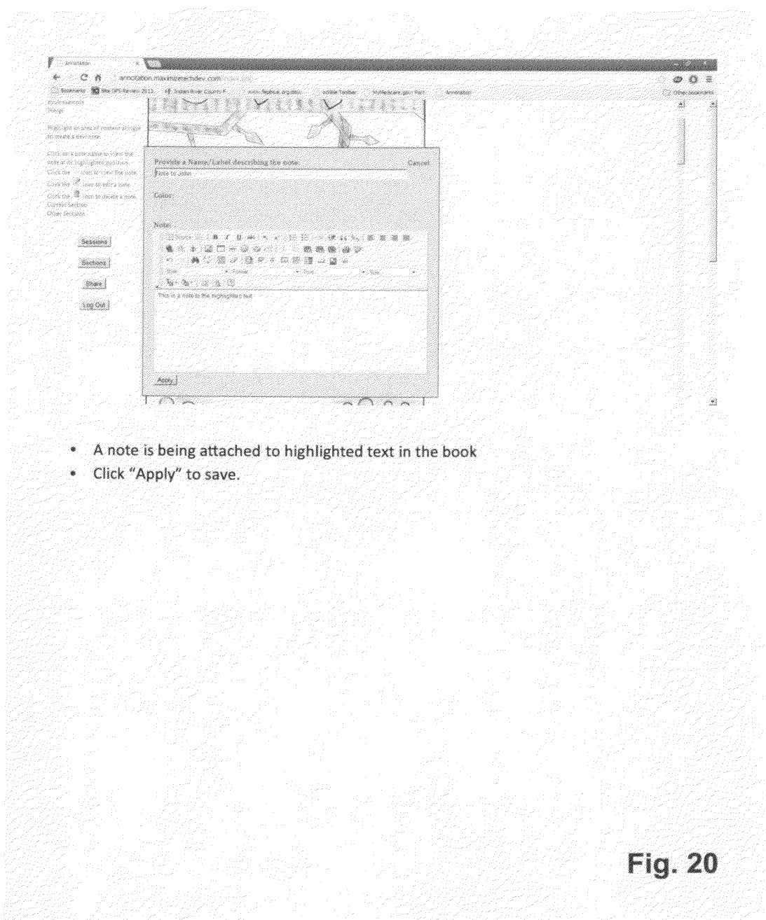

“Apply” 207 and “Cancel” 211 buttons are displayed by way of the note editor 203. The system then waits in step 210 for the user to select the Apply button 207 or the Cancel button 211 in steps 210 and 212 (FIG. 49) as illustrated in FIG. 20.

Once the user selects the Apply button 207, the Annotation is saved in the database 26 (FIG. 1) for the session along with x, y coordinates and the color of the selected highlight, as indicated in step 214 (FIG. 49). The system then returns to steps 220 and 222 and waits for the Section button 200 to be selected. At any time, the user selects the Cancel button 211 (FIG. 19), the systems returns to steps 220 and 222 (FIG. 49) and waits for the Sections button 200 (FIG. 16) to be selected.

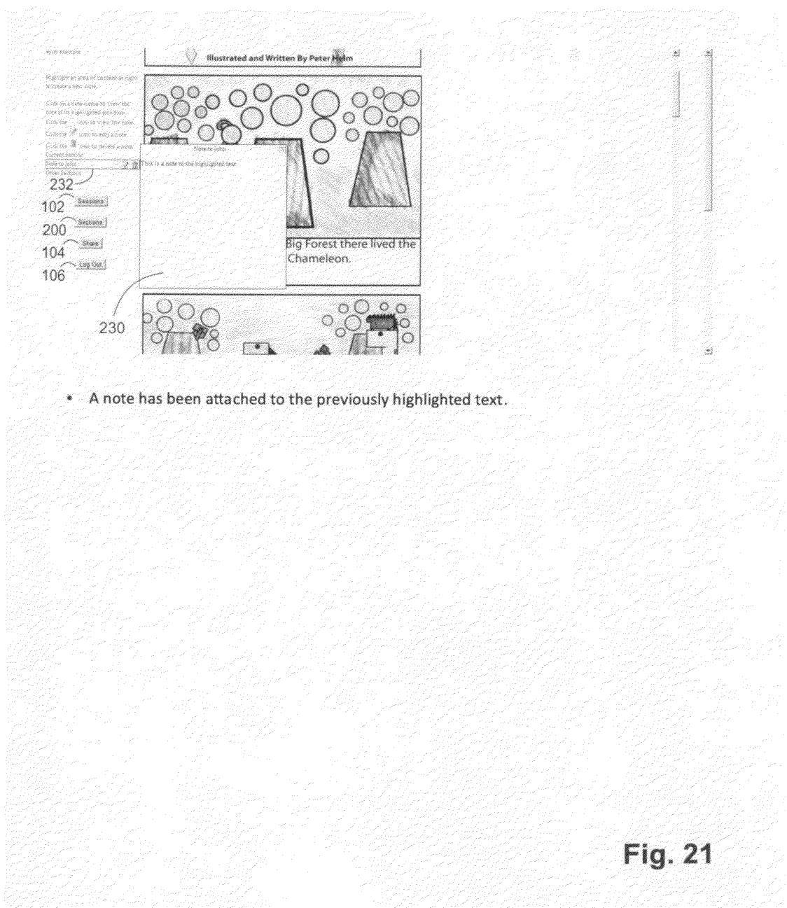

FIG. 21 illustrates a note being attached to a previously highlighted portion. In this example. The highlighted portion is identified with the reference numeral 230. The note is displayed within the highlighted portion. In this case the annotation is text as follows: “This is a note to the highlighted text”. The name of the annotation is displayed in an annotation name box 232. The text displayed in the annotation name box 232 corresponds to the name in the text box 205 (FIG. 19) on the text editor 203. In this example, an exemplary annotation name of “note to John” is displayed in the annotation text box 232 adjacent the annotation illustrated in FIG. 19.

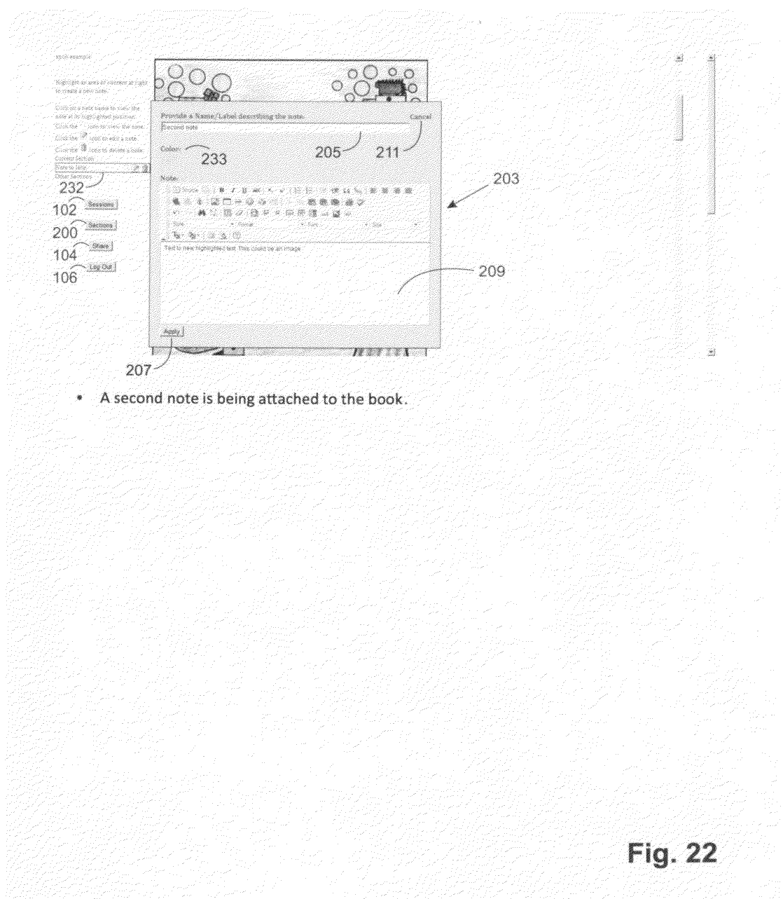

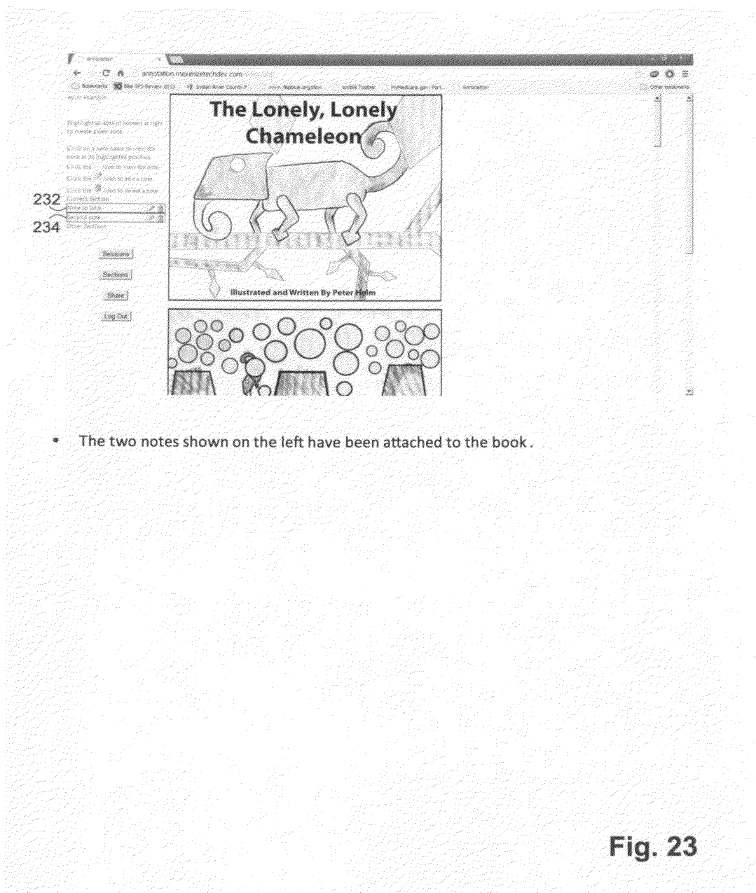

FIGS. 22 and 23 illustrate an application in which a second section of an epub page is annotated. In this example, after an annotation is added to a first highlighted section of an epub page, a second annotation can be added to same epub page during the same session. After the first annotation on the first section is completed, one or more additional annotations can be added by selecting the Sections button 200 (FIG. 22). Similar to the manner discussed above, a note editor 203 is selected. The name of the first annotation is displayed in the annotation text box 232.

In order to create one or more additional annotations, the user can select the color of the highlight by clicking on the color button 233 on the note editor 203 and selecting a highlight color. If no color is selected, a default highlight color, for example, yellow is automatically selected. The user then highlights a new section and provides an annotation and names the section in the manner discussed above. After the user completes the additional annotation and selects the Apply button 207 in the text editor 203, the name of the second annotation is displayed in the annotation text box 234 (FIG. 23) adjacent the annotation text box 232 for the first annotation. In this example, the second annotation is labeled; “Second note”

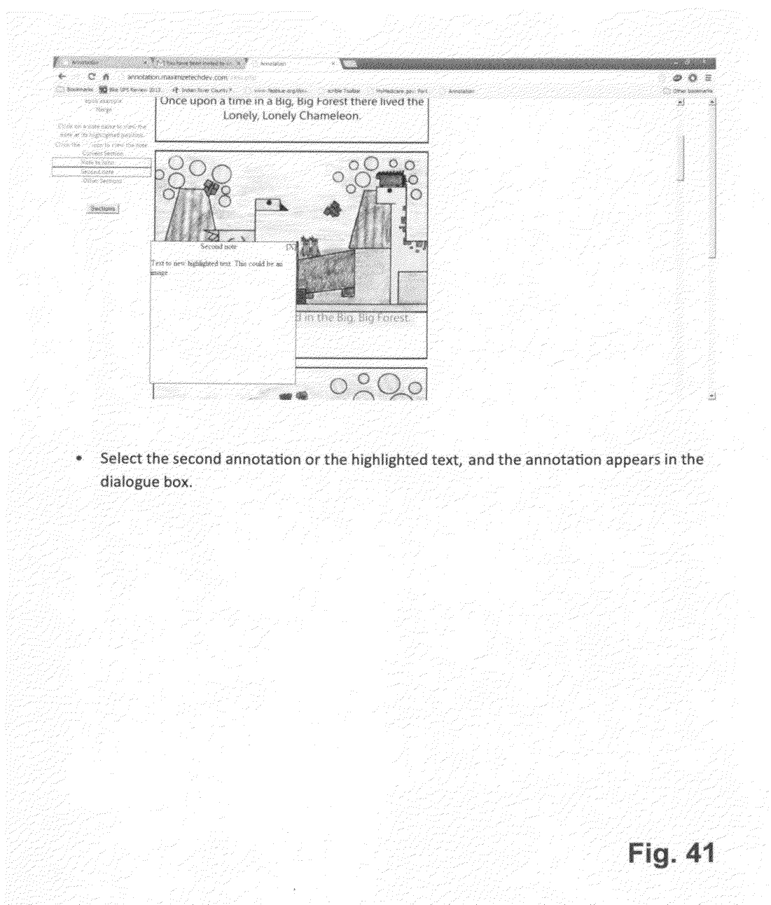

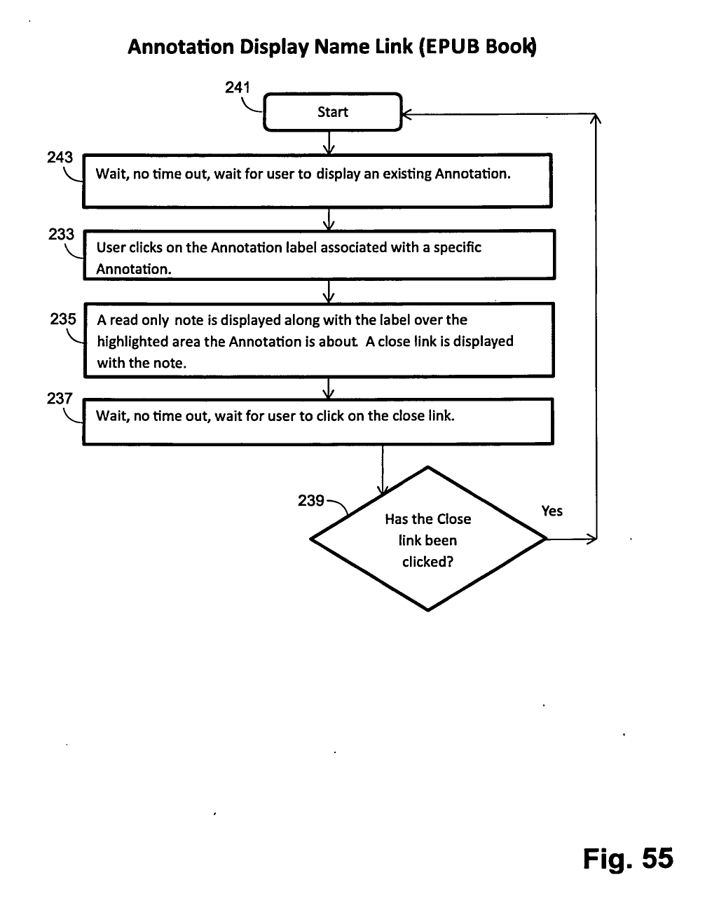

Annotations and content can be viewed by a user in two ways. The annotation to be viewed can be selected from an epub page being displayed, for example, as illustrated in FIG. 16. In this case, the annotation can be viewed by selecting the highlighted content associated with a specific annotation. For example, with reference to FIG. 16, an annotation label 231 is displayed in the left pane adjacent to the highlighted epub page. In this example, the epub annotation label is identified as “xy to mouth”. If the highlighted text for annotation label 231 is selected, as indicated in step 233 (FIG. 55), a read only note is displayed along with the label over the highlighted area of the annotation, as illustrated in FIG. 17, as indicated in step 235 (FIG. 55). FIG. 41 is another example that illustrates an exemplary web page with two annotations identified in the left pane. One annotation is labeled as “Note to John”, while the other annotation is identified as “Second Note”. In this case, the “Second Note” was selected and a read only note appears in a dialogue box, as shown.

After the user views the note, the user can close out of the note. The system waits in step 237 for the user to select the CLOSE button 201 (FIG. 17). Once the user selects the CLOSE button 201, the note is closed, as indicated in step 239 (FIG. 55), and the system returns to steps 241 and 243 for the user to view an existing annotation.

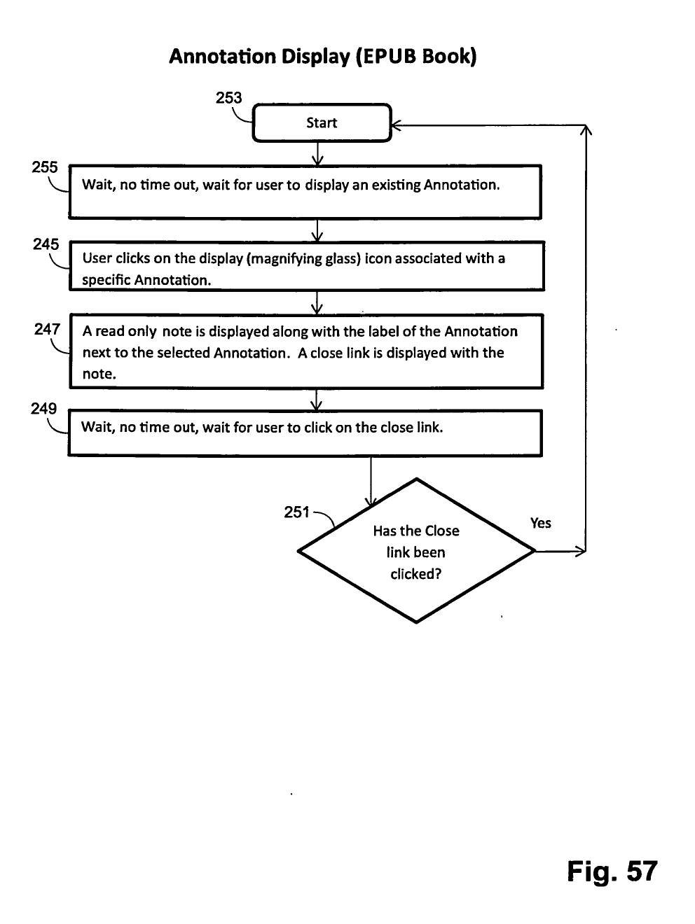

An annotation can also be viewed directly from an epub page by selecting the view command 94 in annotation label 231 (FIG. 16), as indicated in step 245 (FIG. 57). As illustrated in FIG. 17. A read only note is displayed along with the annotation label, i.e. label, next to the annotation, as indicated in step 247 (FIG. 57). A CLOSE button 201 (FIG. 17) is provided. Once the user is done viewing the note, the CLOSE button 201 (FIG. 17) is selected to close out the note. Once the CLOSE button 201 (FIG. 17) is selected, as determined in step 251, the note is closed and the system returns to steps 253 and 255 and waits for the user to select another existing annotation.

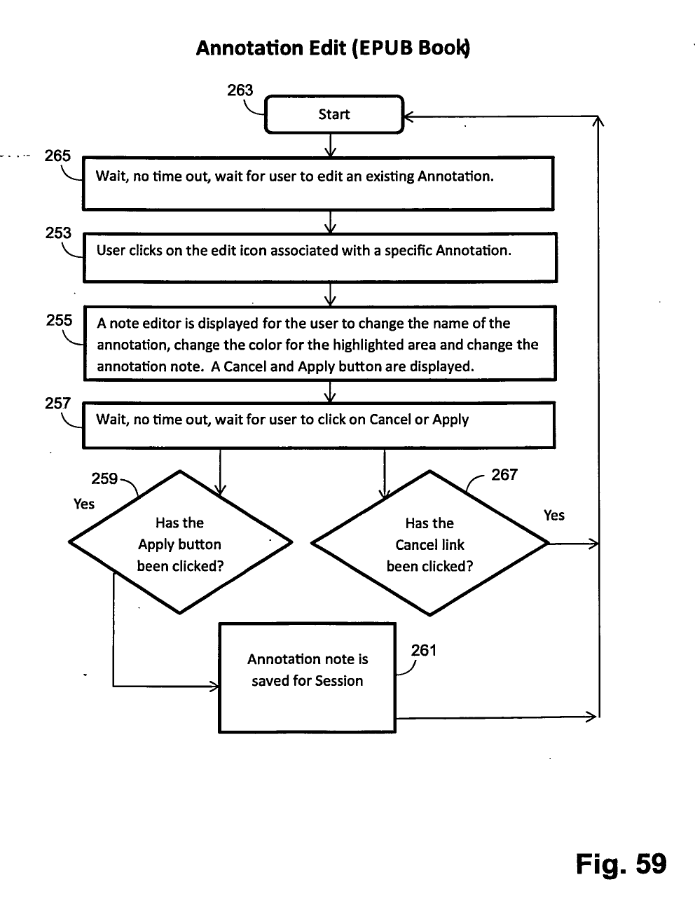

The user also has the ability to edit an epub annotation. In order to edit an annotation, the user selects an epub annotation in the manner discussed above. The epub page is displayed in the right pane while the control buttons are displayed in the left pane, for example, as illustrated in FIG. 16. In order to edit an existing annotation, the user selects the edit icon 96 in annotation label 231, as indicated in step 253 (FIG. 59). A note editor 203 (FIG. 19) is displayed which enables the user to change the name of the annotation, the color of the highlight as well as the annotation text, as indicated by the step 255 (FIG. 59). After the edits are made, the user can select an Apply button 207 (FIG. 19) or a Cancel button 211 to apply or alternatively cancel the edits. The system waits in step 257 (FIG. 59) for one or the other of the Apply button 207 (FIG. 19) or the Cancel button 211 to be selected. If the system determines in step 259 (FIG. 59) that the Apply button 207 (FIG. 19) was selected, the annotation note is saved for the session in step 261 (FIG. 59) and the system returns to steps 263 and 265 and waits for the user to initiate editing of an existing session. Alternatively, if the user selects the Cancel button 211 (FIG. 19), as determined in step 267, the system deletes the edits from the computer's scratch pad memory and returns to steps 263 and 265.

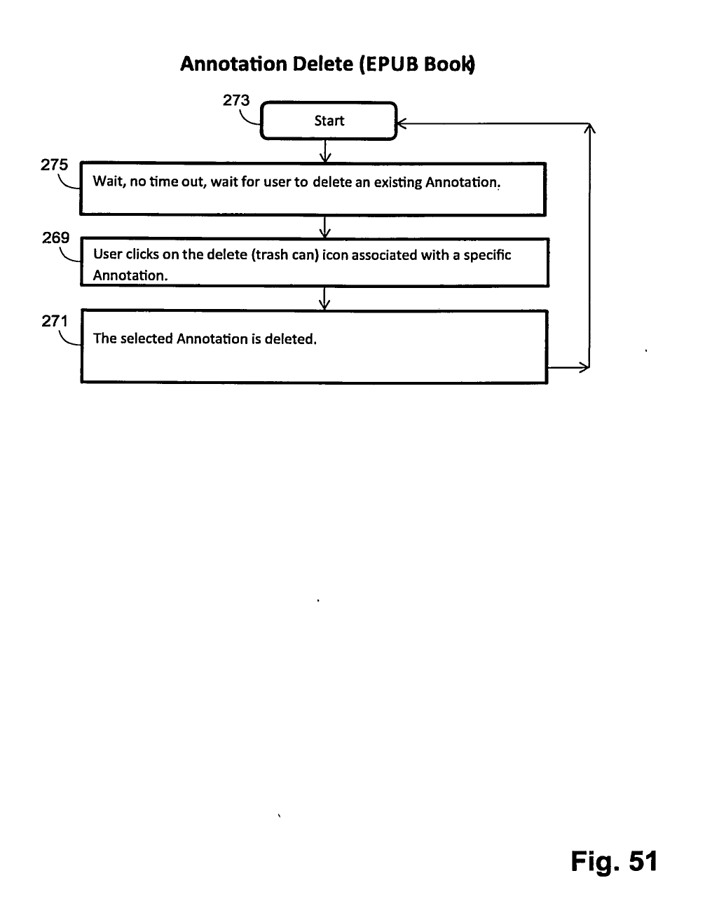

Epub annotations can be deleted in a similar manner, as discussed above, For example, with reference to FIG. 3, the trash can 142 next to the annotation 66 of interest can be selected, as indicated in step 269 (FIG. 51), which deletes the annotation, as indicated in step 271. The system then returns to steps 273 and 275 and waits for another annotation deletion.

Similarly, a session can also be deleted. With reference to FIG. 16, a session can also be deleted by selecting the delete button 96. The system checks in 277 (FIG. 52) whether the user is sure that the session is to be deleted. If so, the session is deleted from the database 26 (FIG. 1), as indicated in step 279 (FIG. 52). The system returns to 281 and 283 and waits (FIG. 52) and waits for the delete button 94 (FIG. 16).

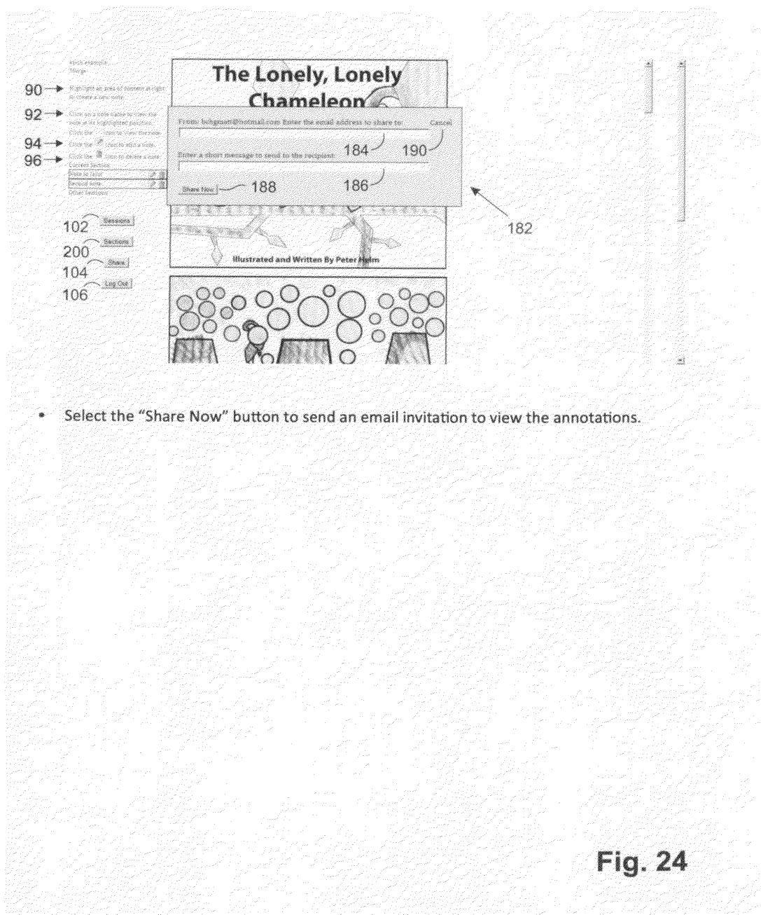

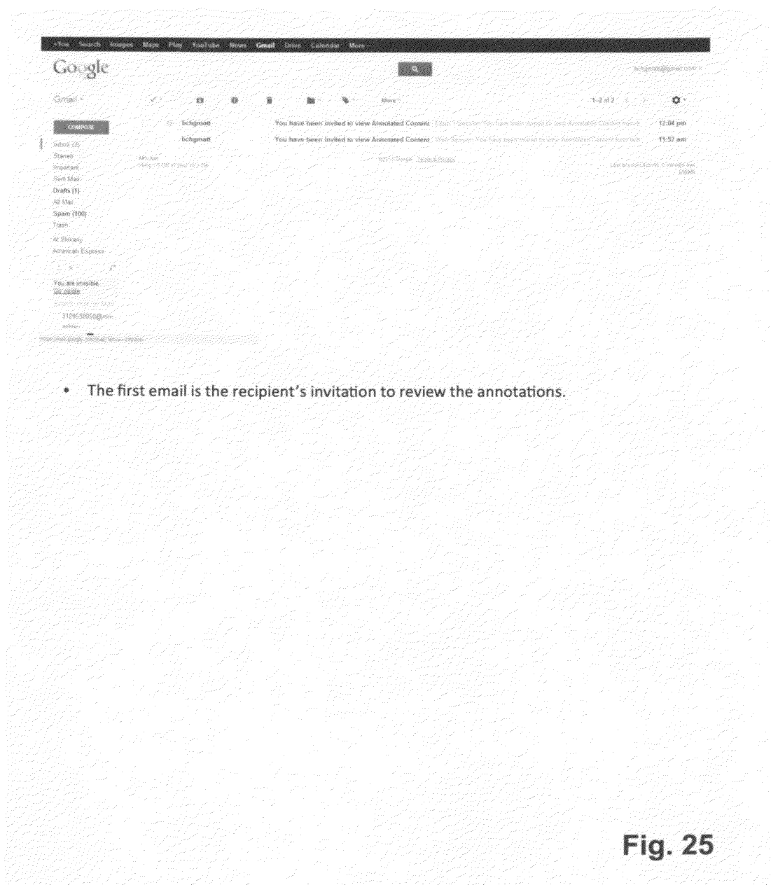

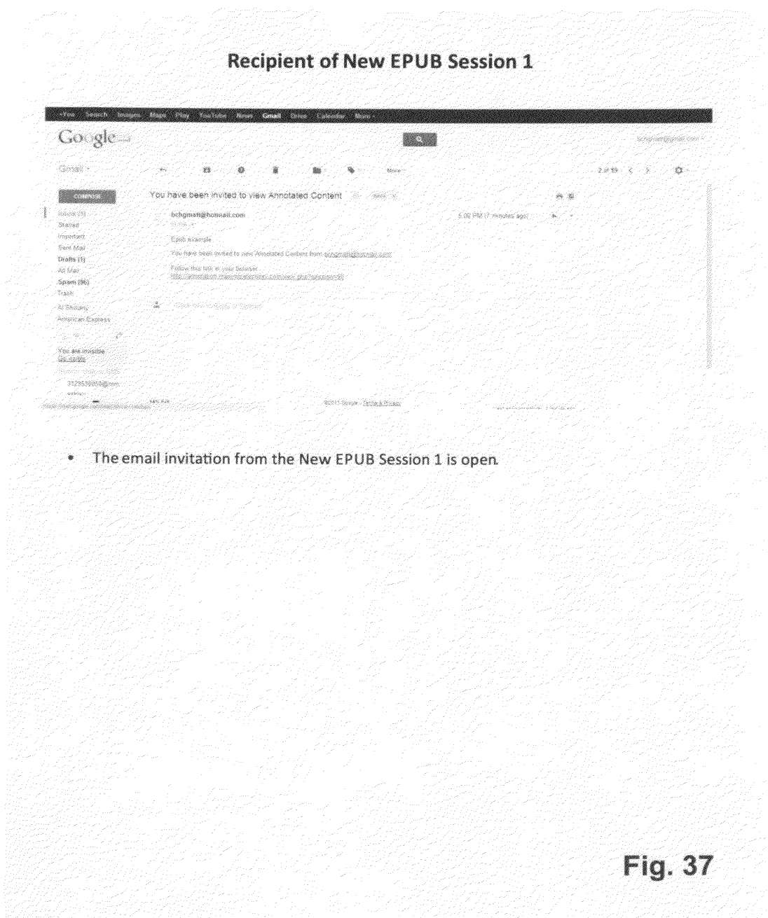

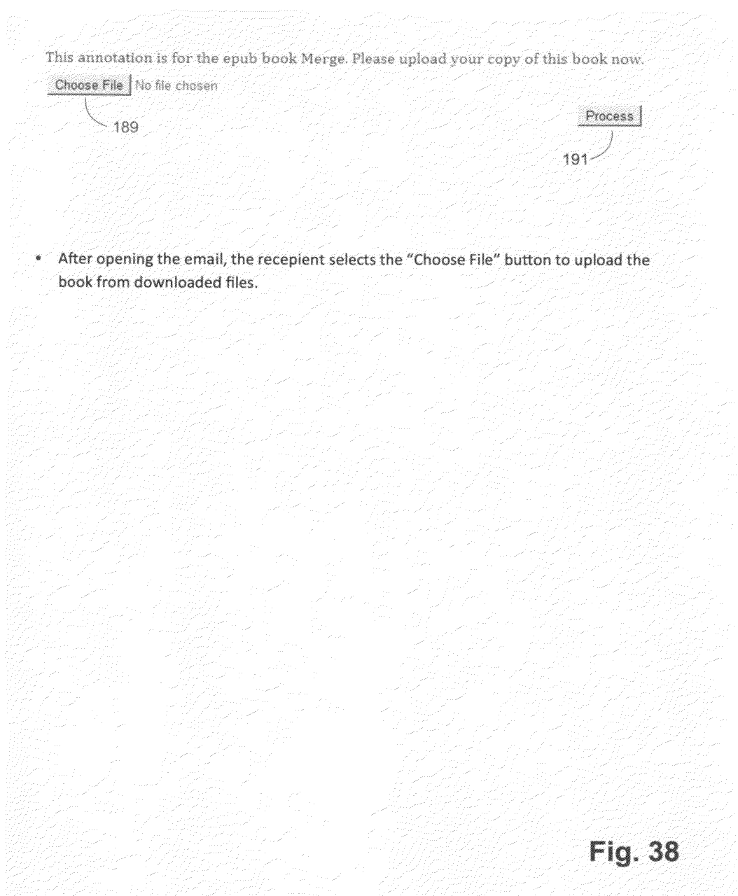

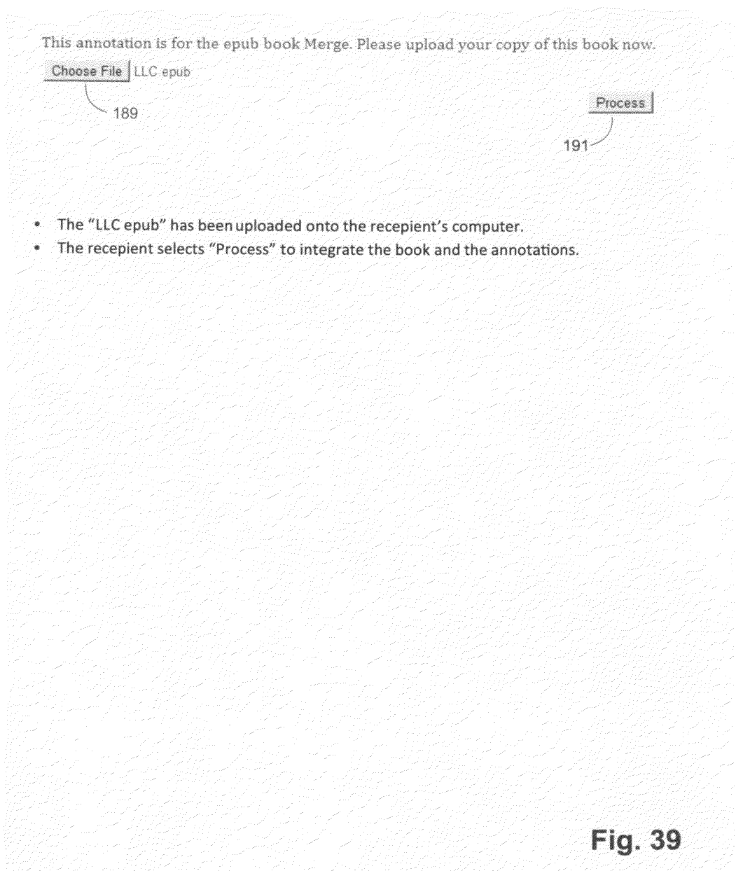

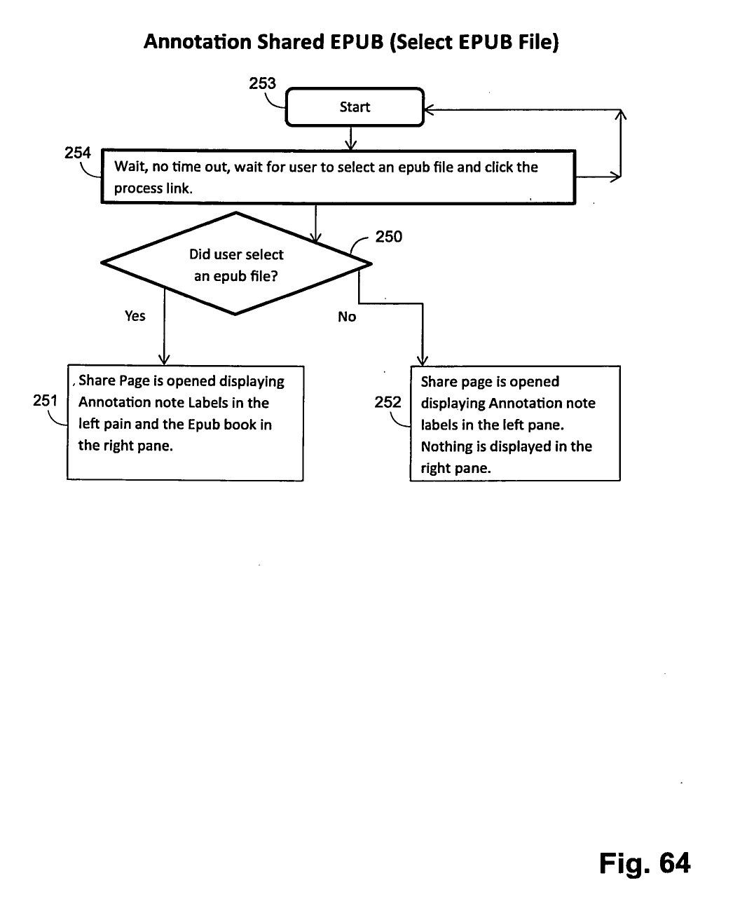

A user can also share an annotation of an epub page in the same manner as discussed above. For example, the SHARE button 104 (FIG. 24) is selected. Once the SHARE button 104 is selected, a dialog box 182 (FIG. 10) pops up. The dialog box 182 has a box 184 for the recipient's email address and an optional box 186 for a short message. The dialog box 182 includes exemplary control buttons, For example, a Cancel button 190 and a Share Now button 188. With reference to FIG. 67, once the recipient email address is entered into the box 186 (FIG. 24) and optionally a short message is entered into the box 186, as illustrated in FIG. 24, the system checks in step 176 whether the Share Now button 188 (FIG. 67) was selected. Once the system determines that the Share Now button 188 (FIG. 10) was selected, the system automatically sends an email to the address in the box 184 with the short message, as indicated in step 178 (FIG. 10), as indicated in FIGS. 25 and 37. After opening the email, the recipient is invited to upload the recipient's copy of the book by selecting a Choose file button (FIG. 38). The user then has the opportunity to select a file from a list of files stored on the user's computer. Once the selection is made and the user selects the process button 191, the system determines in step 250 (FIG. 64) whether an epub file was selected. If the user selected an epub file, the share page is opened and displayed with the annotation notes in the left pane and the epub page in the right pane, as indicated in step 251 and illustrated in FIG. 39. Alternatively, if an epub file was not selected, the share page is opened displaying the annotation note labels in the left pane and nothing in the right pane, as indicated in step 252.

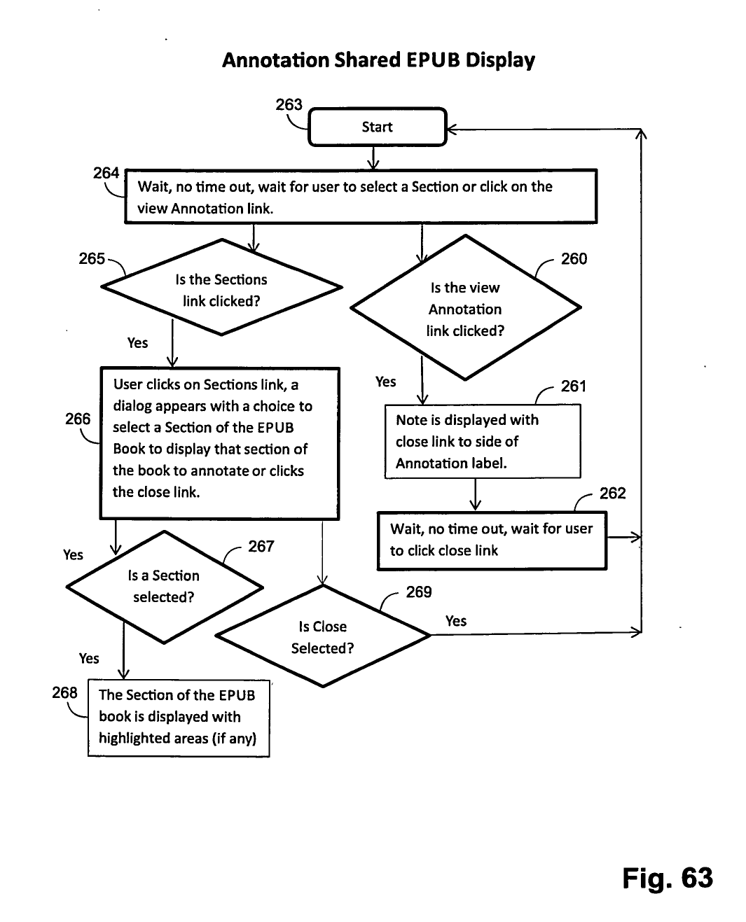

Upon receipt of an annotation, the recipient/user has an option to simply view the annotation or provide a new annotation that may be sent to the original user. With reference to FIG. 35, after opening the email, the recipient will see the annotation name 204 and the highlighted page that is being annotated. The system checks in step 260 (FIG. 63) whether the view button 202 (FIG. 35) was selected. If so, the note is displayed in step 261 (FIG. 63) with a CLOSE button 201 (FIG. 36). The system waits for the user to select the Close button 201 in step 262 (FIG. 63). Once the Close button 201 (FIG. 36) is selected, the system returns to steps 263 and 264 and waits for the view annotation button 202 (FIG. 35) to be selected.

The system also checks in step 265 whether the Sections button 200 (FIG. 16) has been selected in step 265 (FIG. 63). Once the Sections button 200 (FIG. 16) is selected the page can be annotated in the manner discussed above in steps 267 and 268. When the annotation is complete, the recipient/user selects the Close button 201 (FIG. 17) which causes the annotation to be saved in the database 26 (FIG. 12). The system then returns to steps 263 and 264.

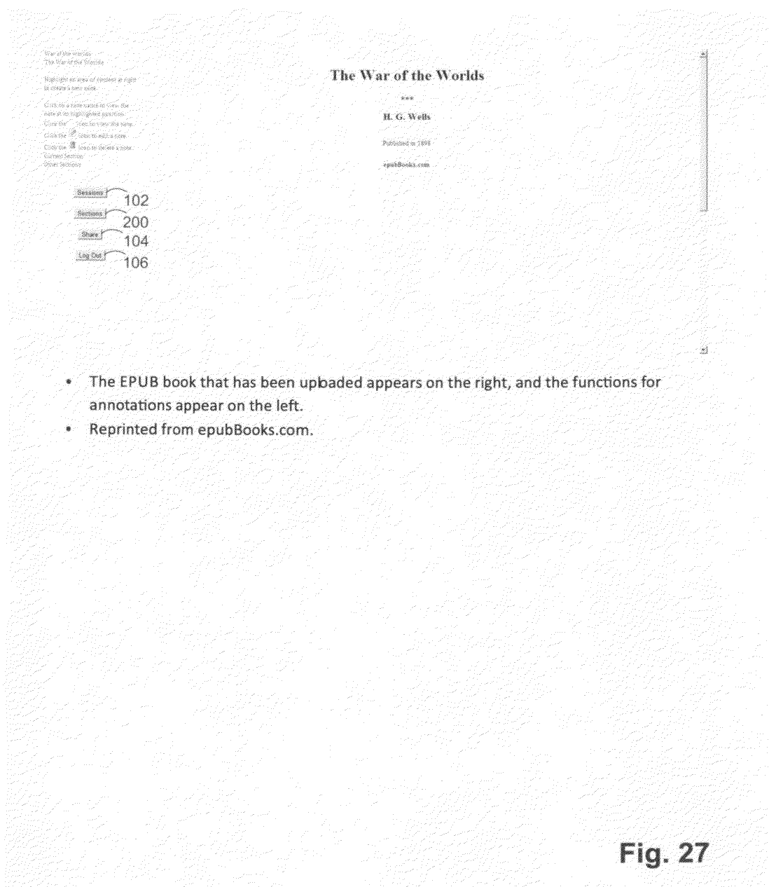

FIGS. 26-32 and 42-47 illustrate an epub session for an epub book that includes text and chapters but no images. An exemplary home page is illustrated in FIG. 26. As shown, a session title “War of the worlds” is entered into the session title dialog box 56. The Choose File button 58 is selected to search for a download of the epub book of interest. Once the book of interest is selected, the New EPUB Session 60 button is selected. This causes the epub book to be uploaded and the annotation buttons 102, 200, 104 and 106 to be displayed. As shown in FIG. 27, the annotation functions are shown on the left and the epub book is shown on the right.

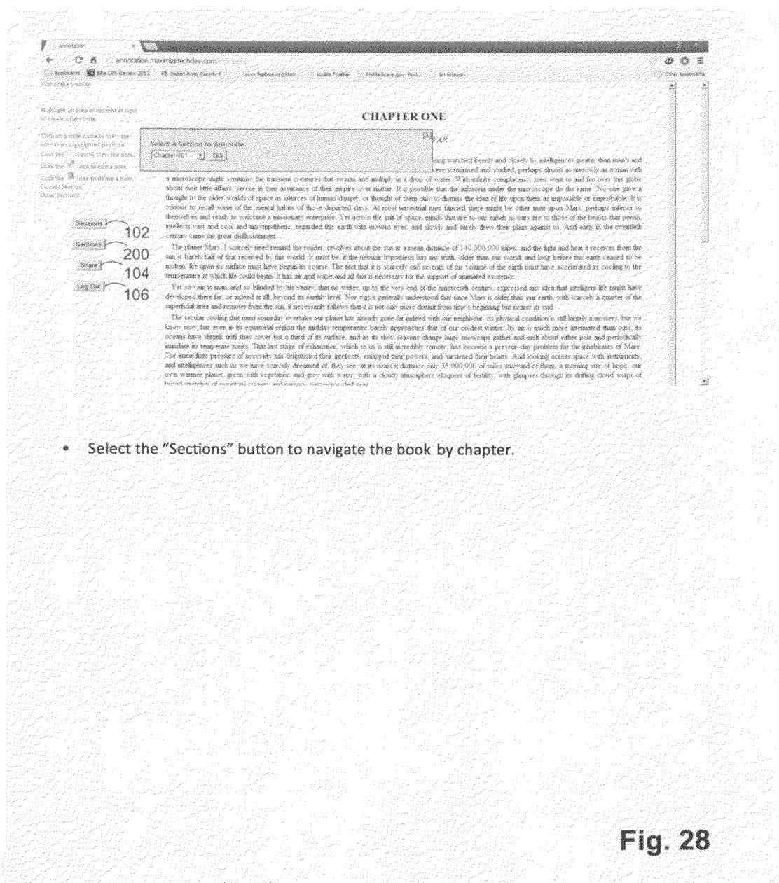

In order to navigate the epub book by chapter, the Sections button 200 may be used, as illustrated in FIG. 28. Pages can be navigated using the controls provided with the epub file.

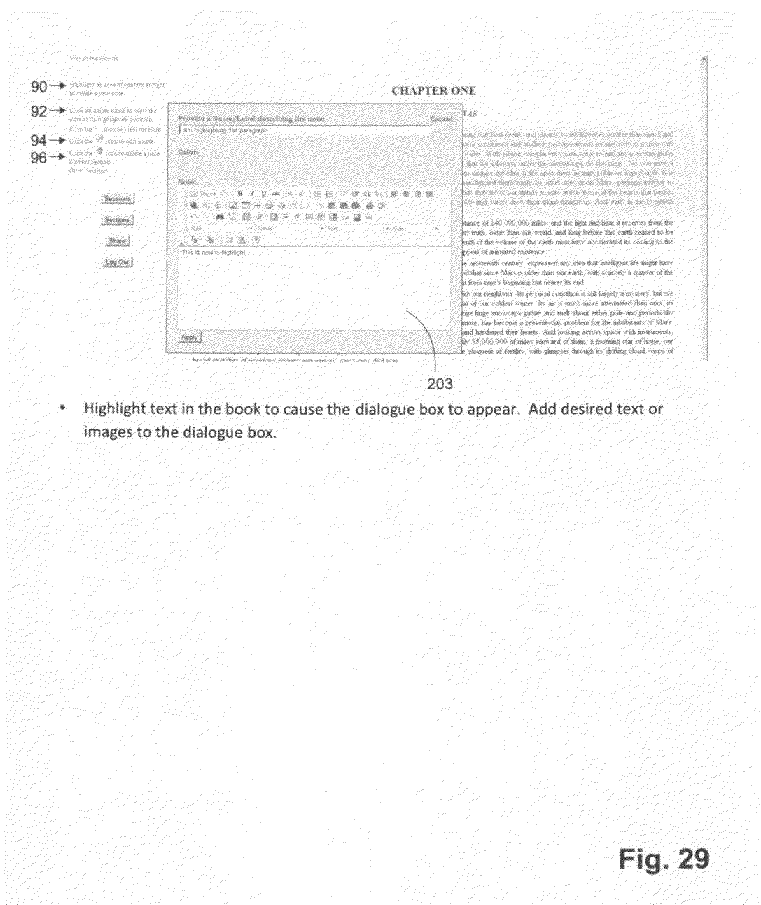

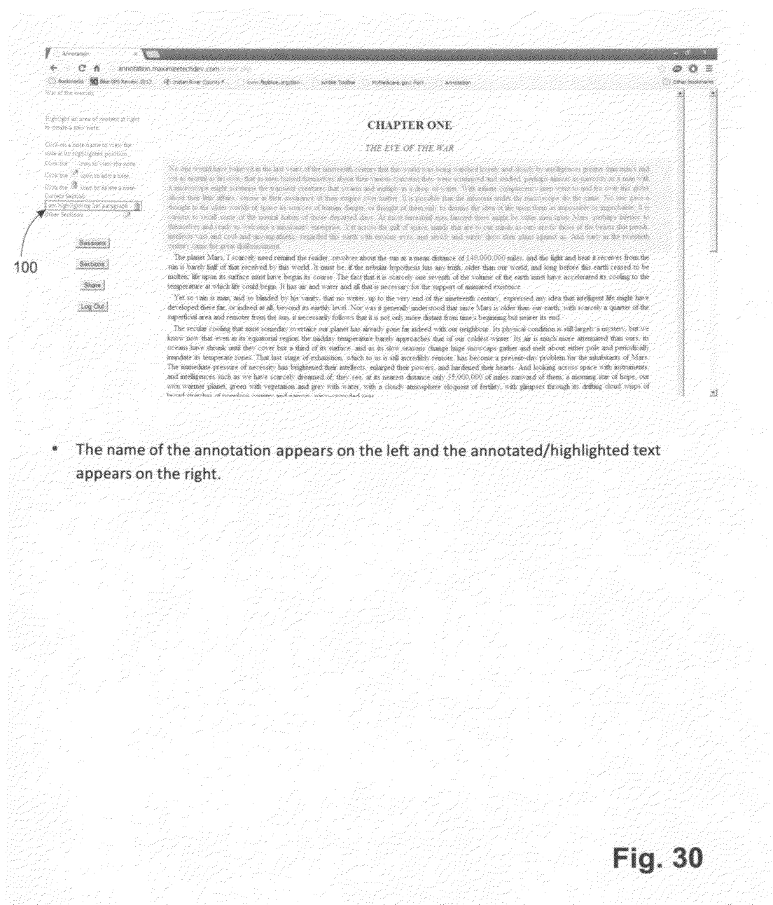

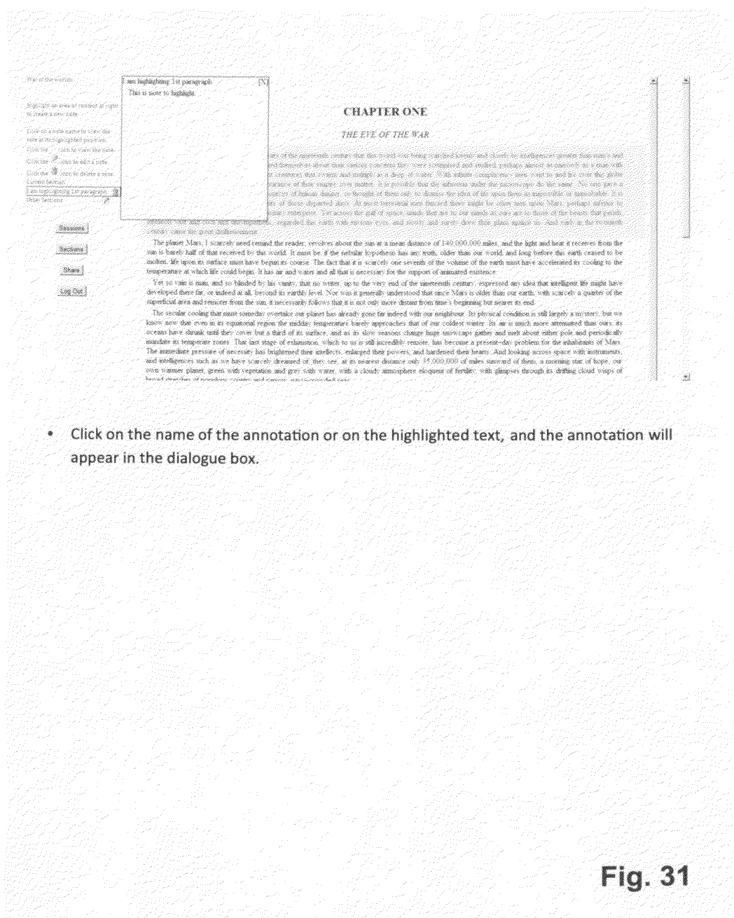

In order annotate a page, the highlight control 90 (FIG. 29) is selected and the desired sections of the page are highlighted. This causes the note editor 203 to be displayed, as illustrated in FIG. 29. The annotation is created and saved in the manner discussed above. The annotation name is then displayed in a dialog box 100, as illustrated in FIG. 30. As shown in FIG. 31, selecting the annotation name in the dialog box 100 causes the annotation note to be displayed.

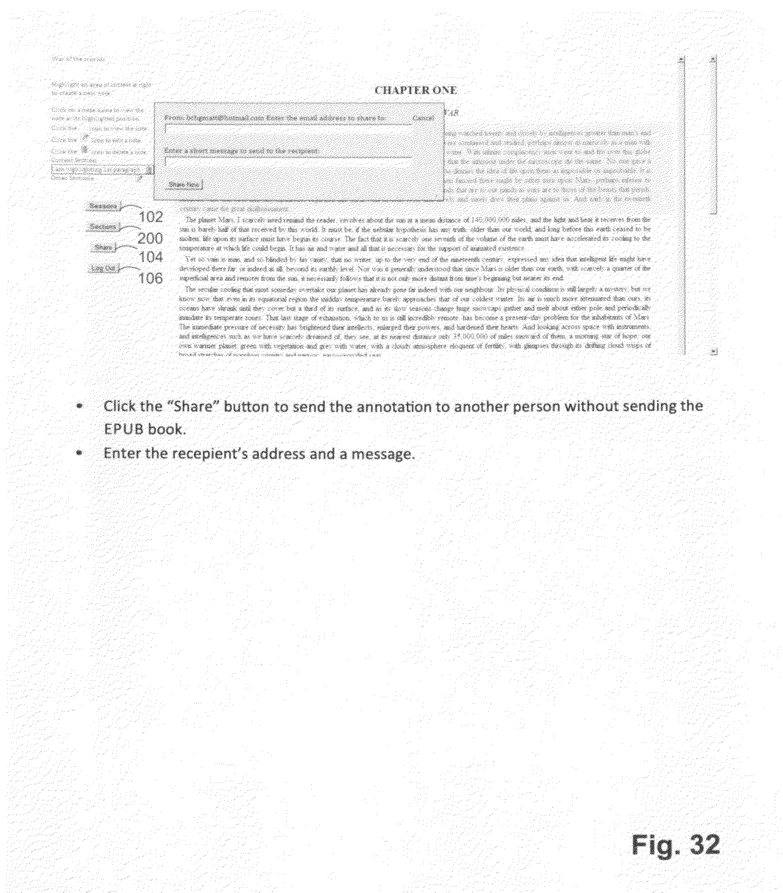

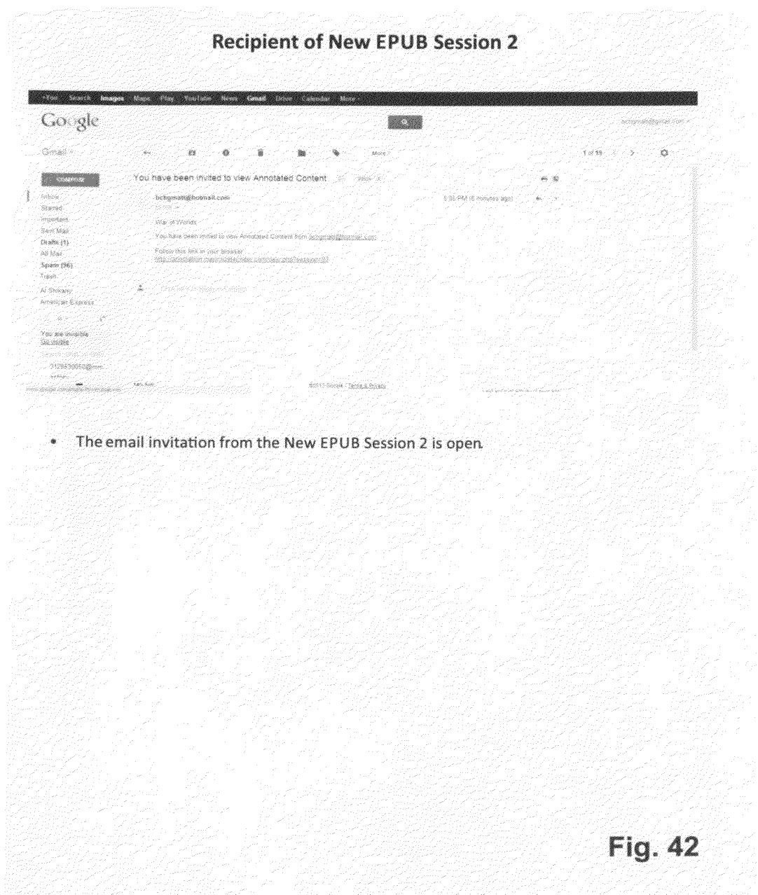

The annotation can be shared in the same manner as discussed above by selecting the Share button 104 (FIG. 32). As illustrated in FIGS. 42-47, the annotated page is received and viewed by a recipient as illustrated in FIGS. 42-47.

### PDF EXAMPLE

As mentioned above, text annotations of web pages and epub files are described and illustrated. Text annotations of pdf files are done in virtually the same manner as epub files and are discussed below. In order to simplify the application, Table 3 above provides a list of figures that pertain to pdf files that correspond to epub files that operate in the same manner. As such, only a brief discussion of the process of annotating pdf files with text is provided below.

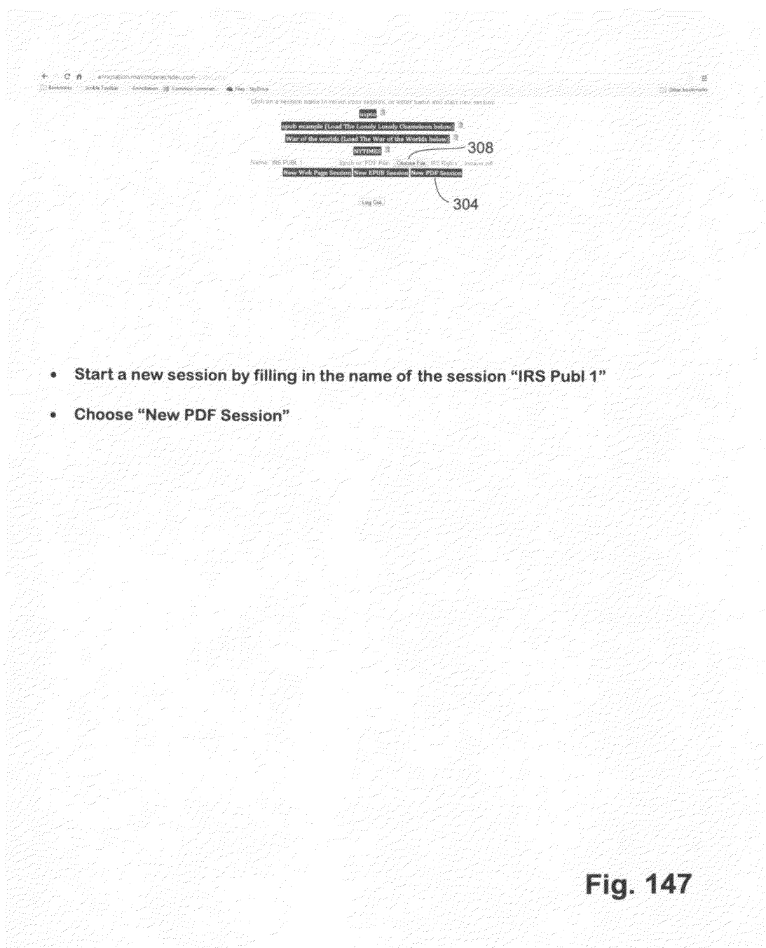

In order to annotate a pdf file, a user 28, 30 or 32 (FIG. 1) can access the system 20 by accessing the web application 24 by logging into the system 20 at the URL for the system and creating an account, in the manner as discussed above. After sign in, the system checks in FIG. 68 whether the user 28, 30 or 32 is already registered in step 44 (FIG. 68) and, if not, create a new user account, as indicated in step 50. If the user 28, 30 or 32 (FIG. 1) is previously registered and provides the correct password, as indicated in step 46 (FIG. 68), a new session is created, as indicated in step 52. Alternatively, if the user 28, 30 or 32 (FIG. 1) is not previously registered, as indicated in step 44 (FIG. 68), a new user account is created in step 50 and a new session is created. The new sessions page, for example, as illustrated in FIG. 147 is displayed, as indicated in step 52. (FIG. 68).

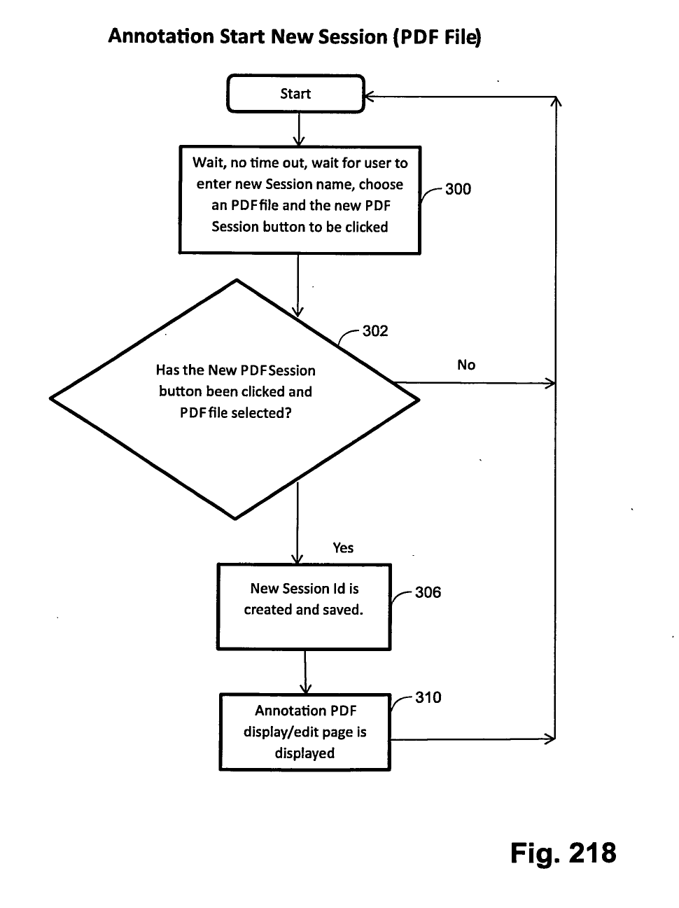

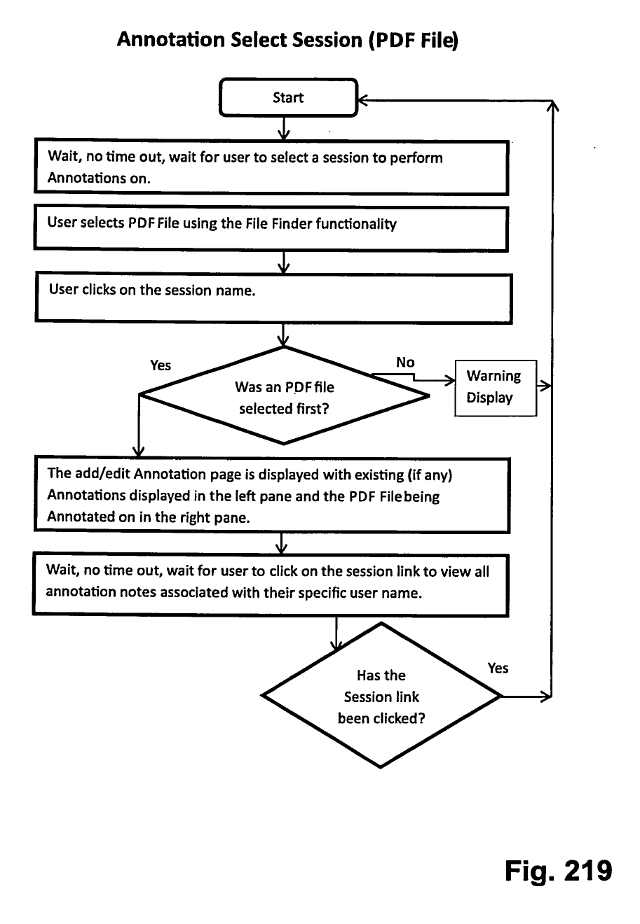

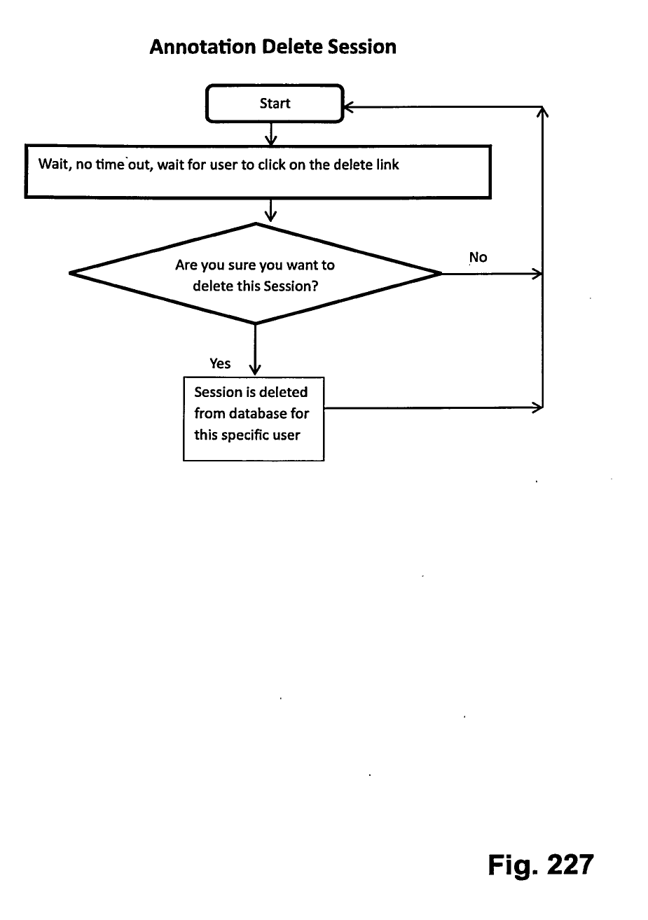

Once the new sessions page (FIG. 147) is displayed, the system checks in steps 300 and 302 whether the “New PDF Session “button 304 (FIG. 147) is selected. If so, a new session ID is created and saved in step 306 (FIG. 218). The user can then select a “Choose file” button 308 to display a list of files stored on the user's hard drive. Once the user selects a file, the pdf page to be edited is displayed, as indicated in step 310 (FIG. 218). Alternatively, the user can select an existing session as illustrated in FIG. 219, which is similar to FIG. 61, discussed above, and is not discussed further. The user can also elect to delete a session, as illustrated in FIG. 227, which is similar to FIG. 52, discussed above, and is not discussed further.

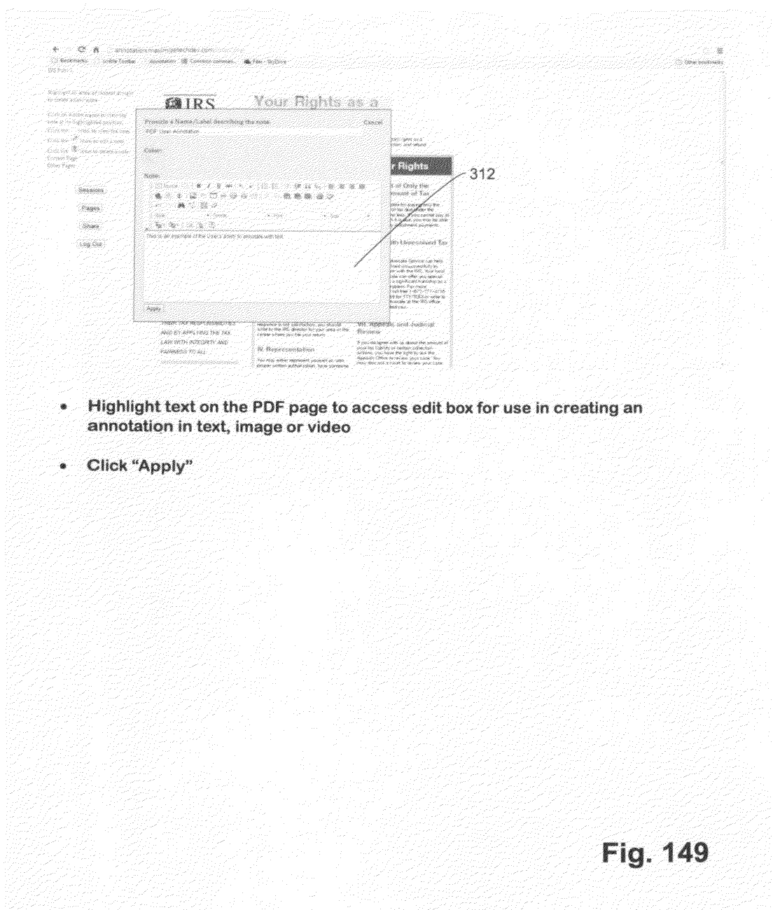

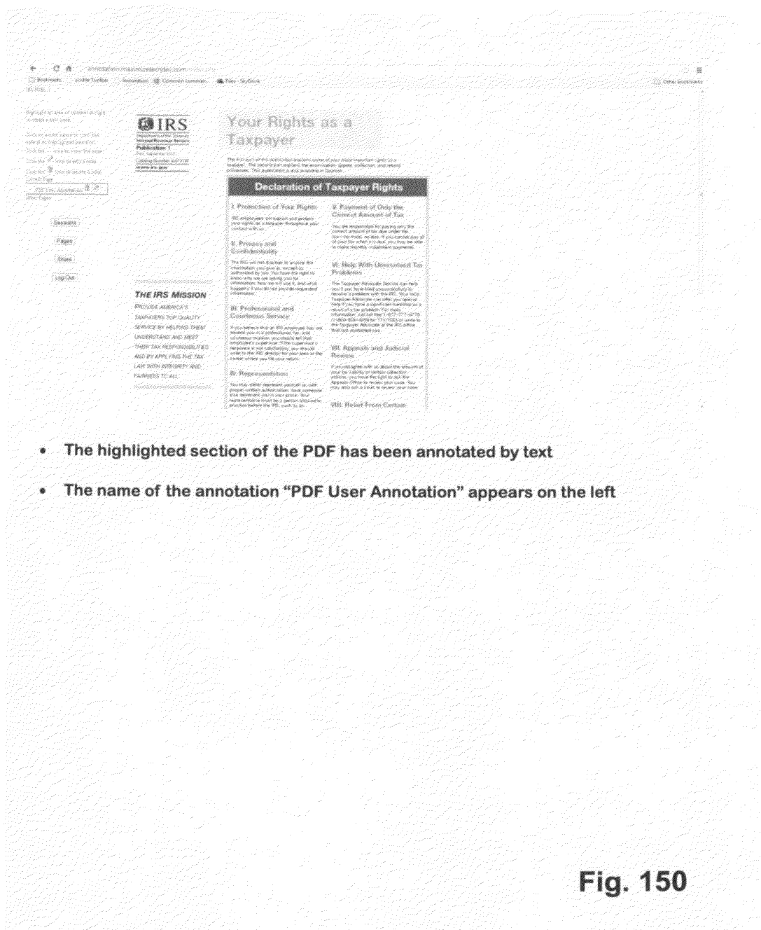

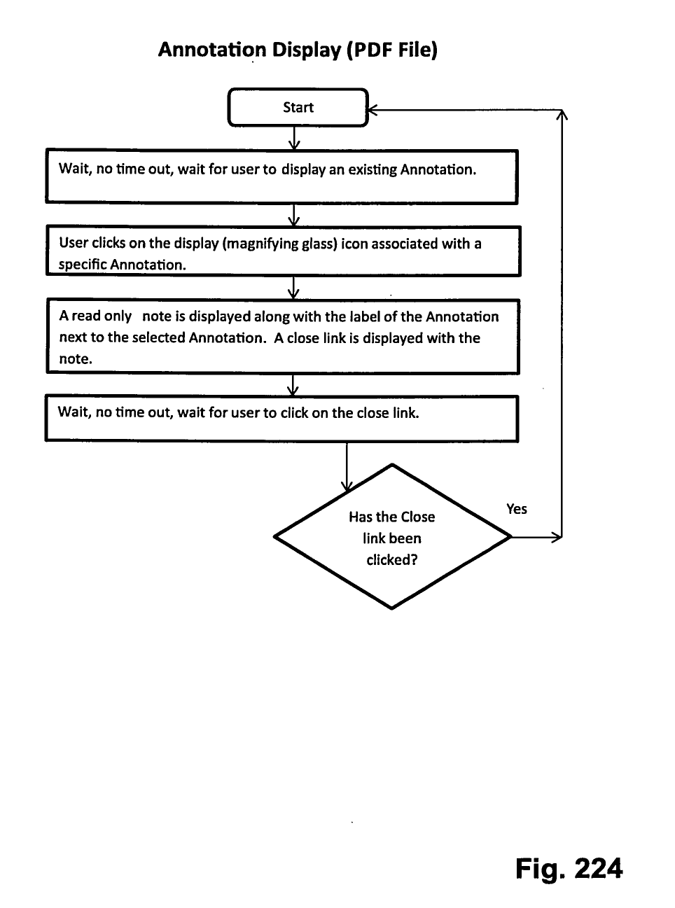

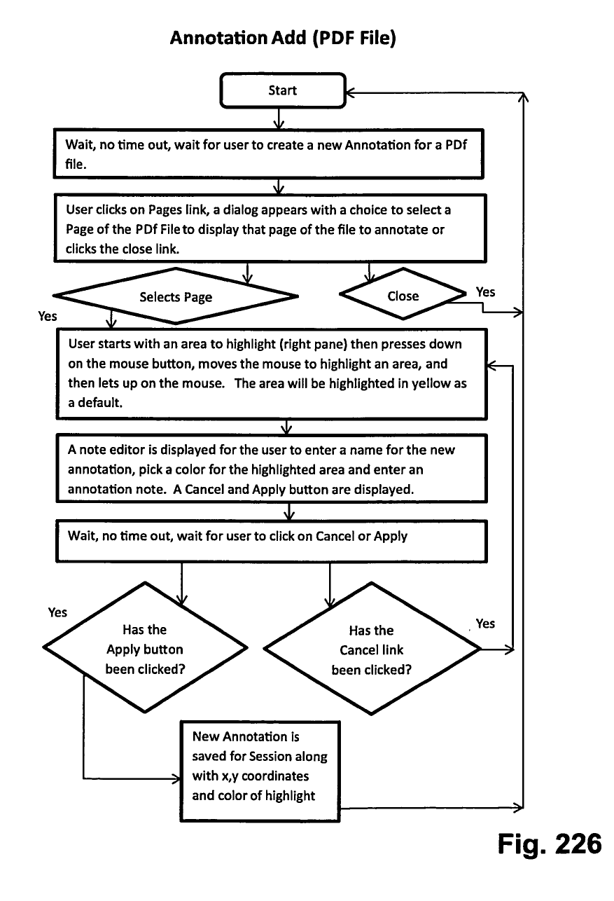

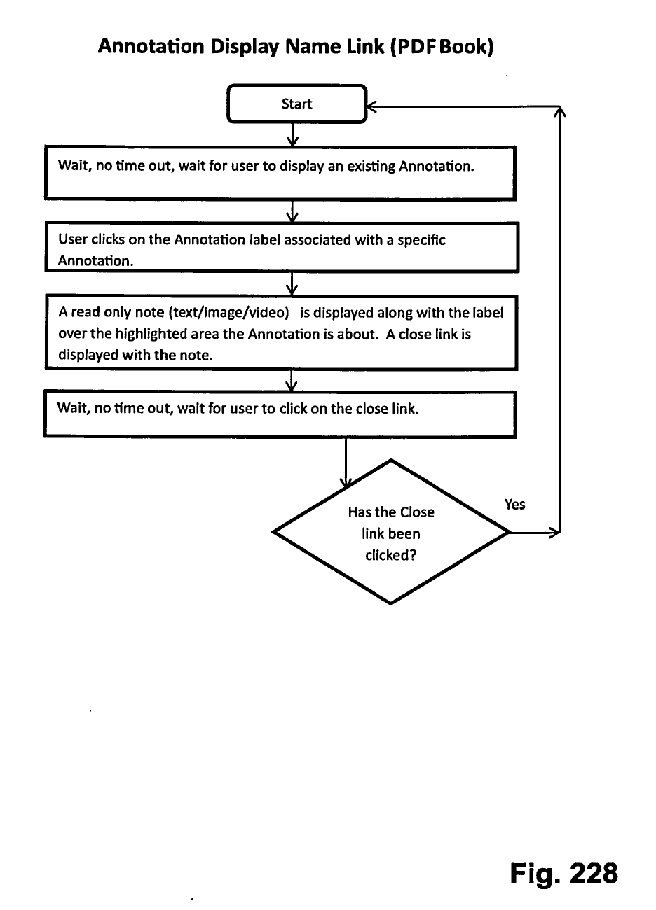

In a similar manner as discussed above, the user can create text annotations of a pdf file, as illustrated in FIG. 226, in a similar manner as discussed in connection with FIG. 49. The user can then view the text annotations, for example, illustrated in FIGS. 149 and 150, by way of the steps illustrated in FIGS. 224 and 228 in a similar manner, as discussed in connection with FIGS. 57 and 55, respectively.

Sites With Special Coding

Because of the unique characteristic of the system, it can be used with content with special coding. An example of content with special coding. Since the content is copyrighted, the content cannot be legitimately copied and distributed. However, a user with a legitimate electronic copy can open the electronic copy in the application.

### Features Common to all Digital Content

Various features described below are common to all types of digital content; namely, web page, epub file and a pdf file. These features include:
Images and Videos Annotations of images or video can be generated and applied to a web page, or epub file.
Annotation Edit. All annotations can be edited by way of text, images or video by the account owner or the recipient.
View or Register An account owner and all recipients can view all annotations and edits to an account owner' session, a recipient can register onto the account owner's session to add an edit to an annotation or create a new annotation.
Hyperlink Footnote

### Images and Videos

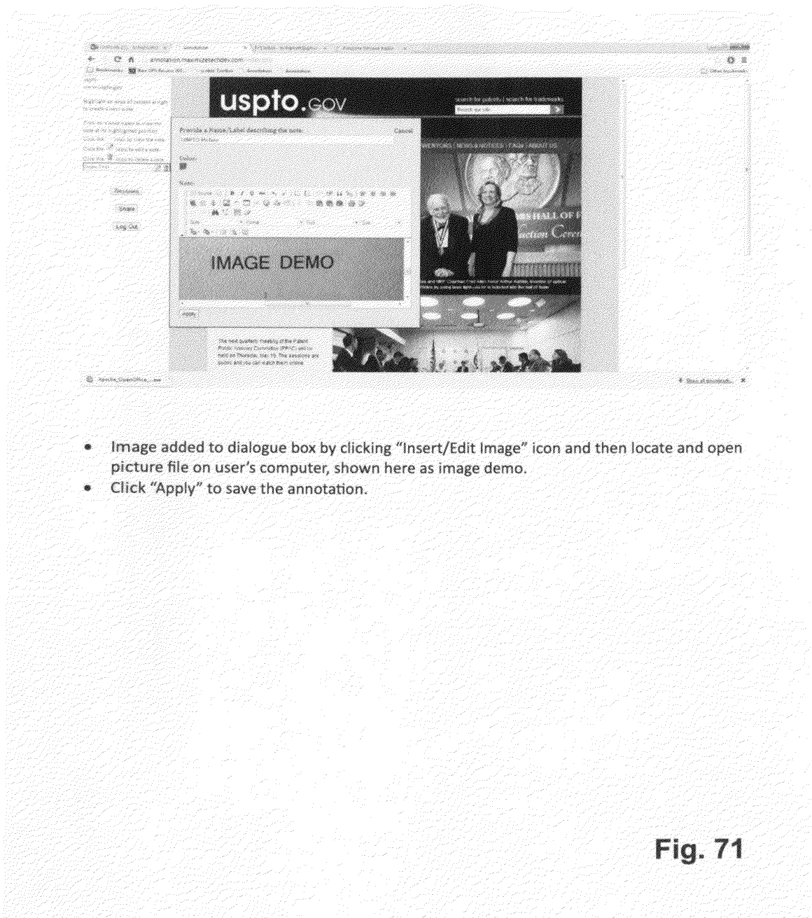

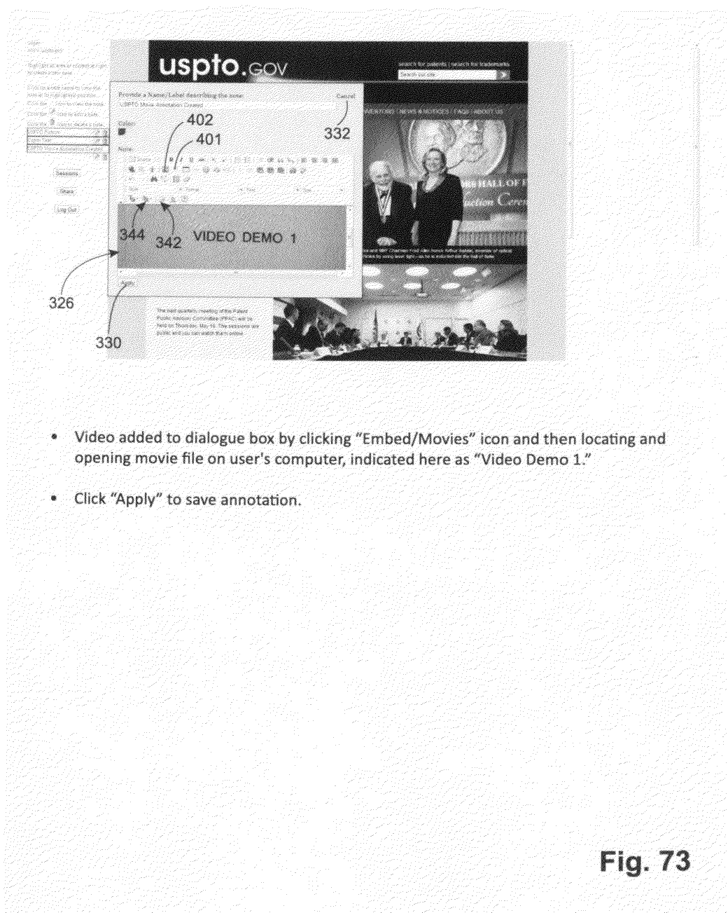

Account owners can add annotations of an image or a video to a web page. This feature is illustrated in FIGS. 71-73, 106-109 and 136-139. Referring first to FIG. 50, this flow chart refers to web page annotation. The note editor 112 (FIG. 50) includes a video icon 401 (FIG. 73) and an image icon 402 (FIG. 73). As previously discussed with respect to FIG. 50 a video annotation may be saved by selecting an apply button on the note editor or deleted by selecting a cancel button on the note editor. Adding an annotation of an image with the image icon 402 is similar to adding an annotation of a video.

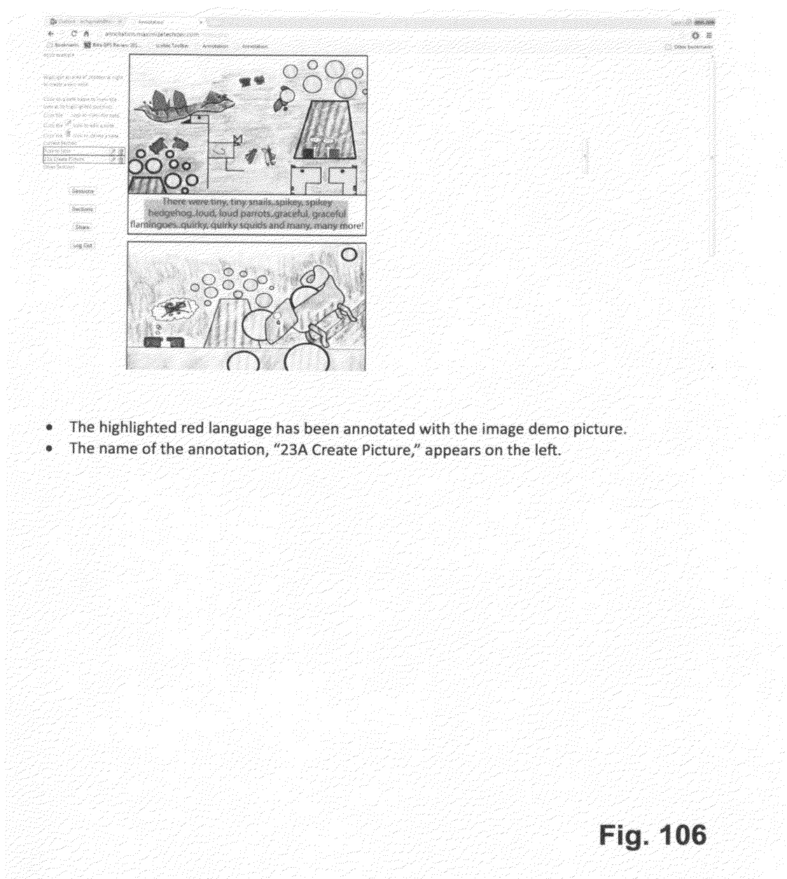

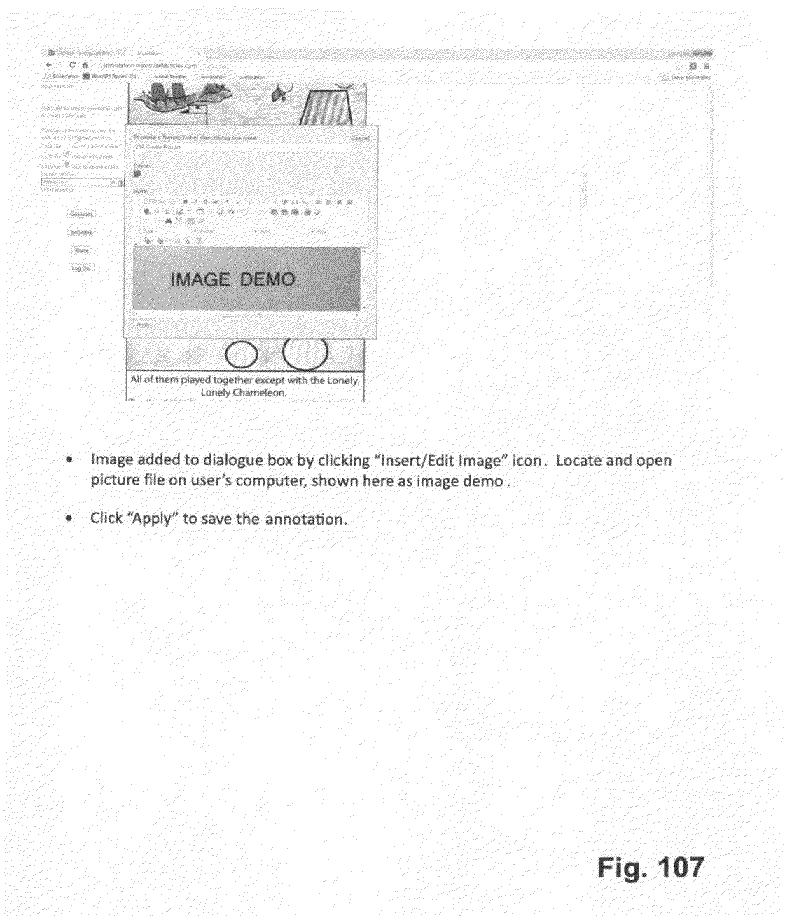

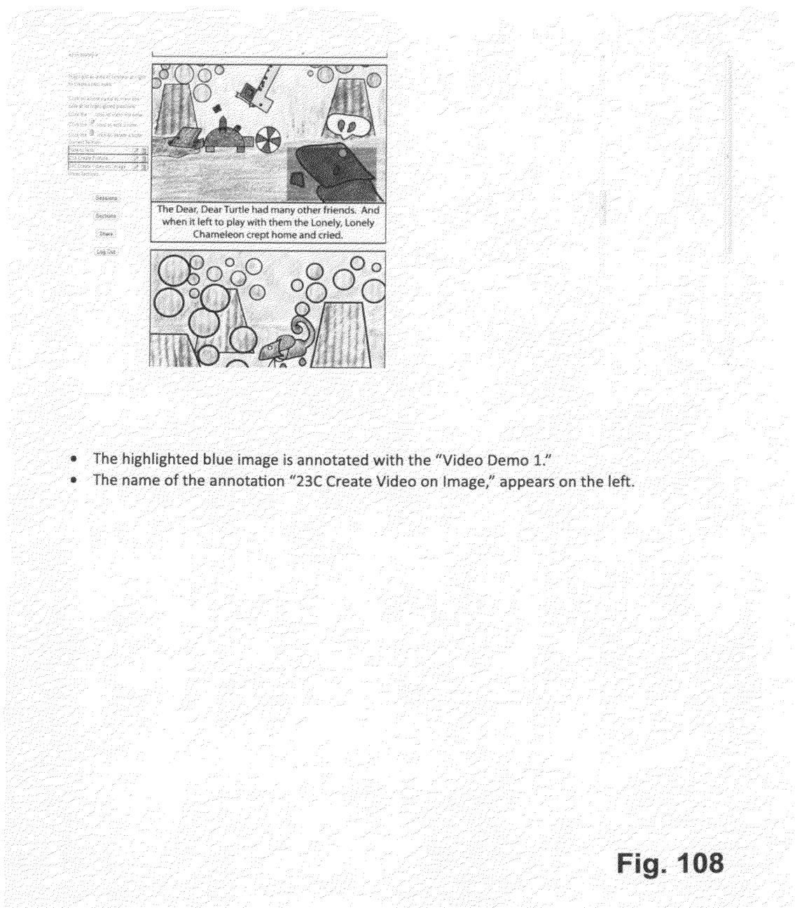

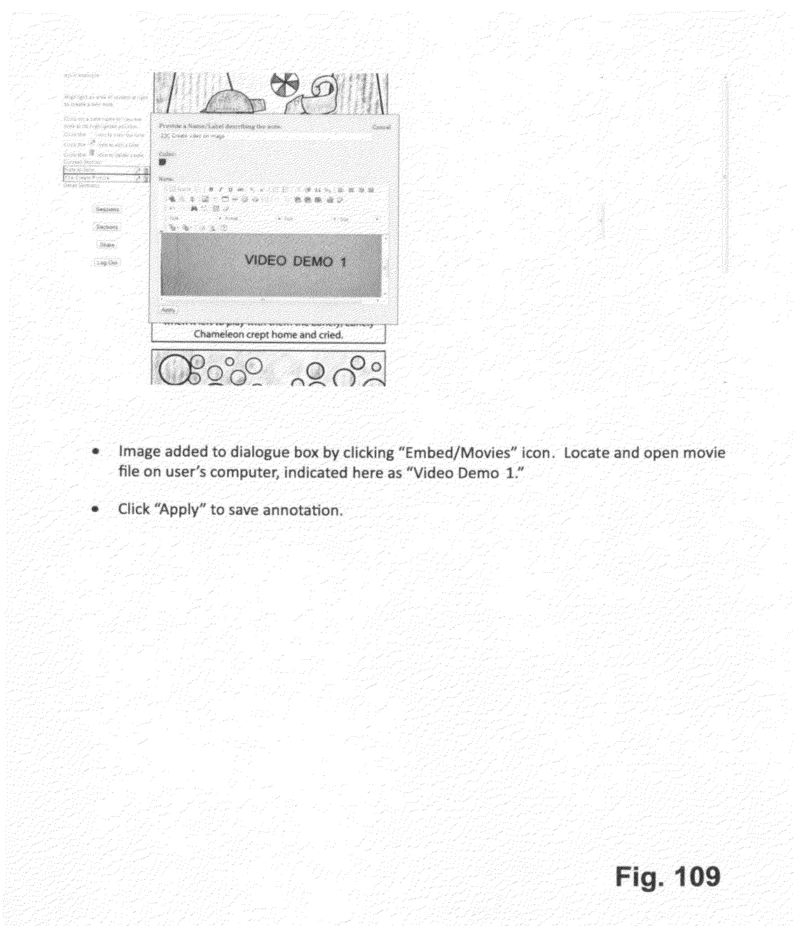

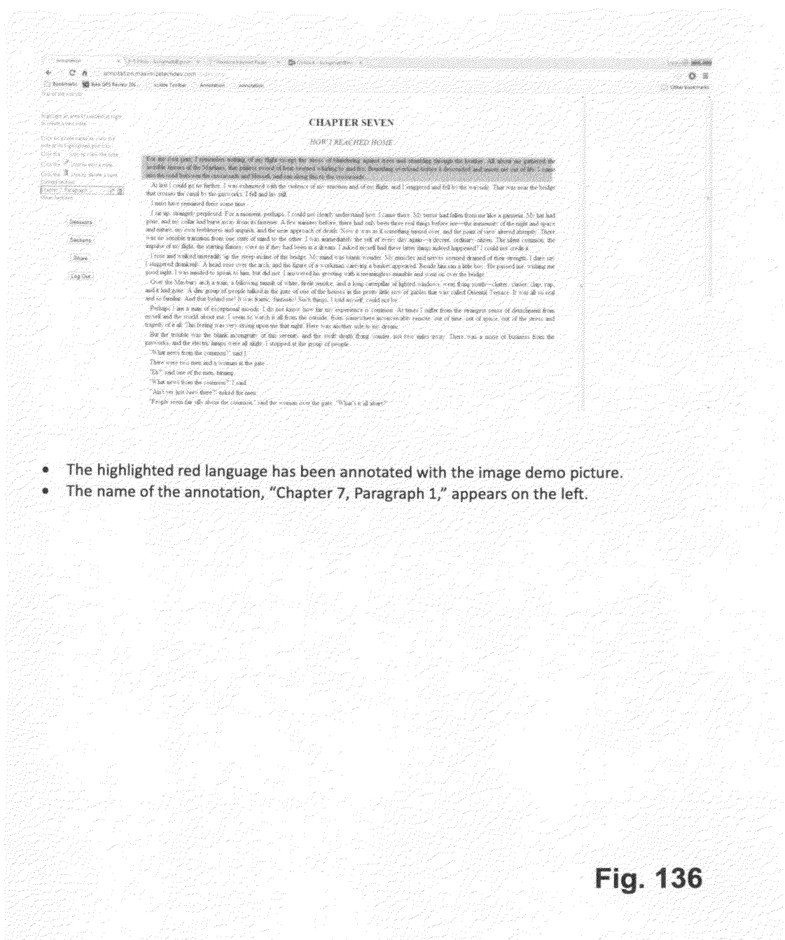

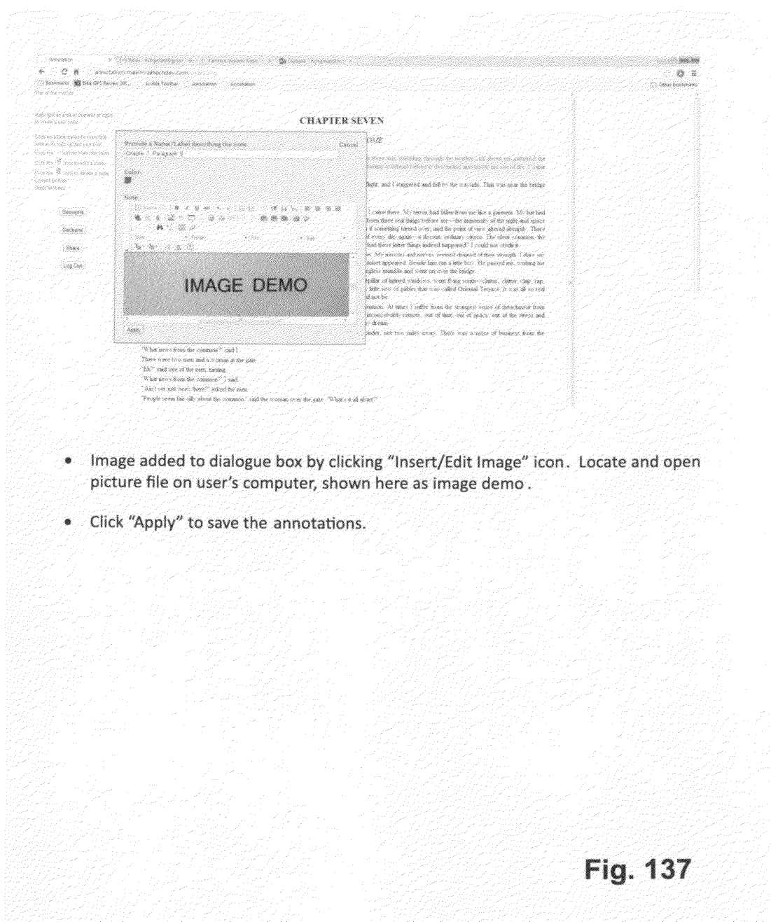

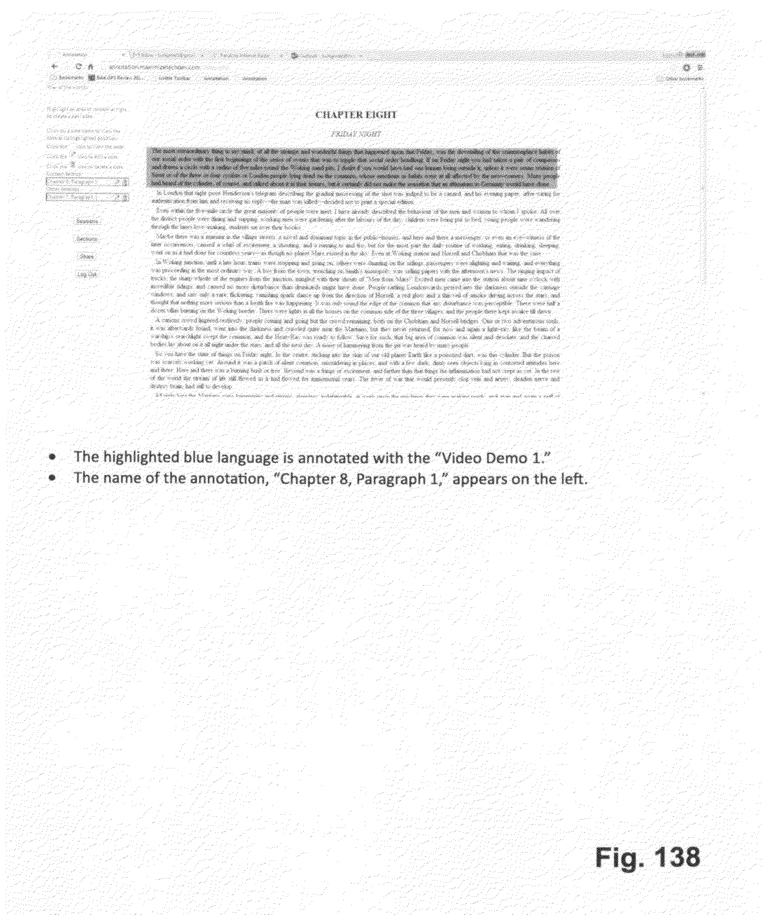

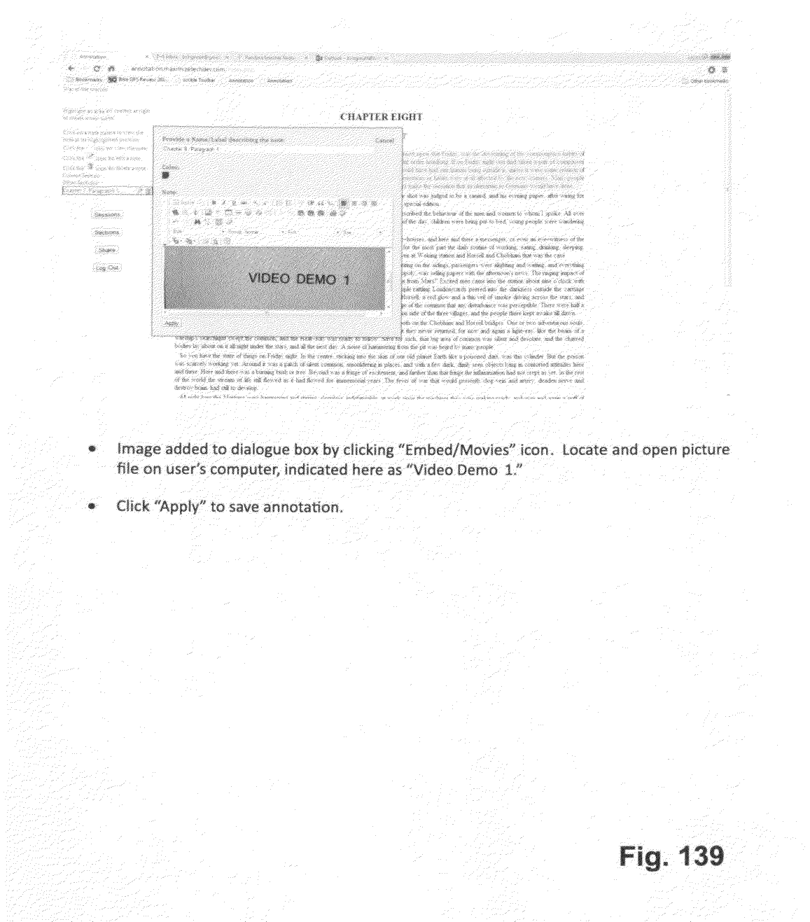

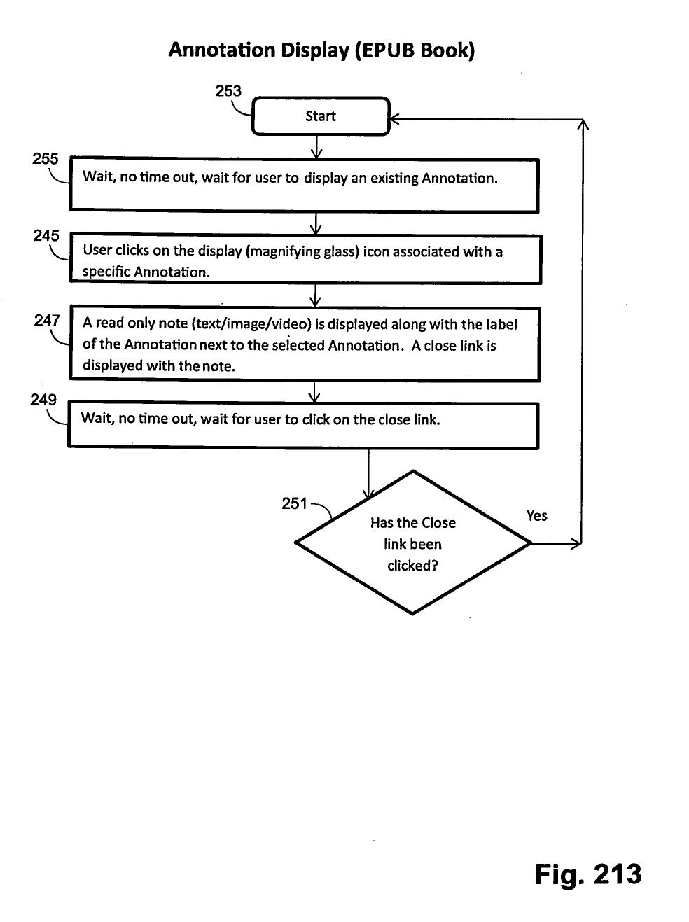

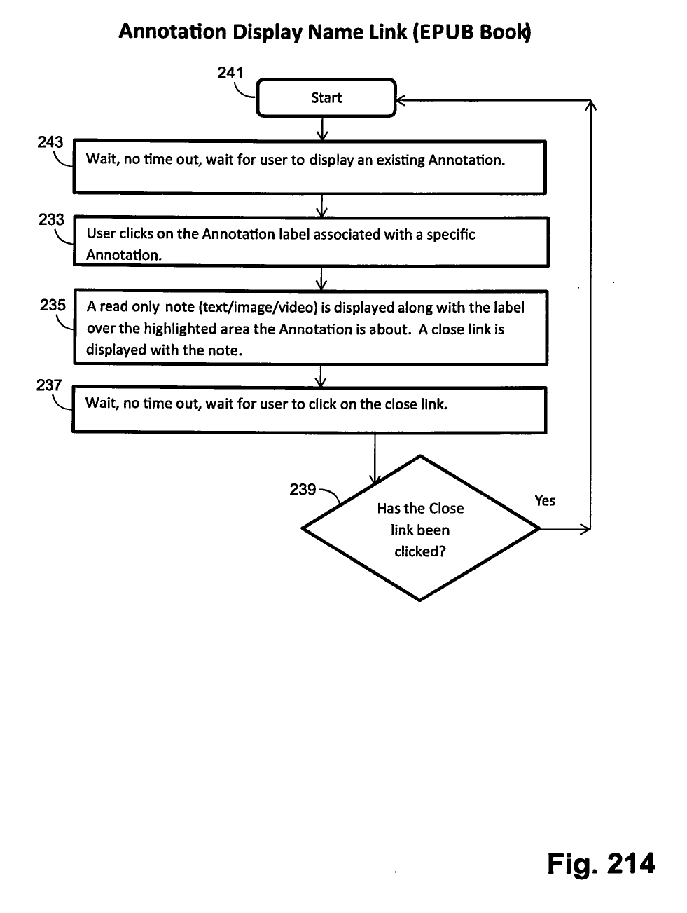

Annotation of EPUB files with images and video is illustrated in FIGS. 106-109 and described in connection with the flowcharts for Annotation Add (FIG. 49), Annotation Display (FIG. 213/57), and Annotation Display Name Link (FIG. 214/55). More specifically, illustrations of creating an image and viewing an image by the user for EPUB files (no chapters) are illustrated in FIGS. 106 and 107 and for EPUB files with chapters are illustrated in FIGS. 136 and 137. Illustrations of creating a video and viewing a video by the user for EPUB files (no chapters) are illustrated in FIGS. 108 and 109 and for EPUB files (chapters) are illustrated in FIGS. 138 and 139.

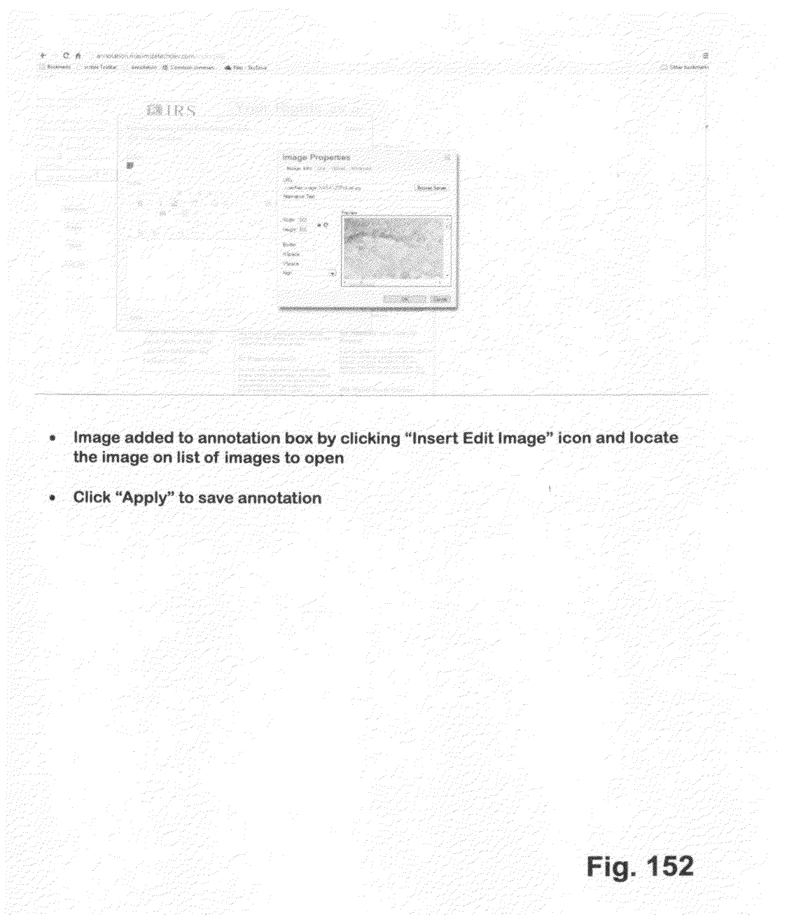

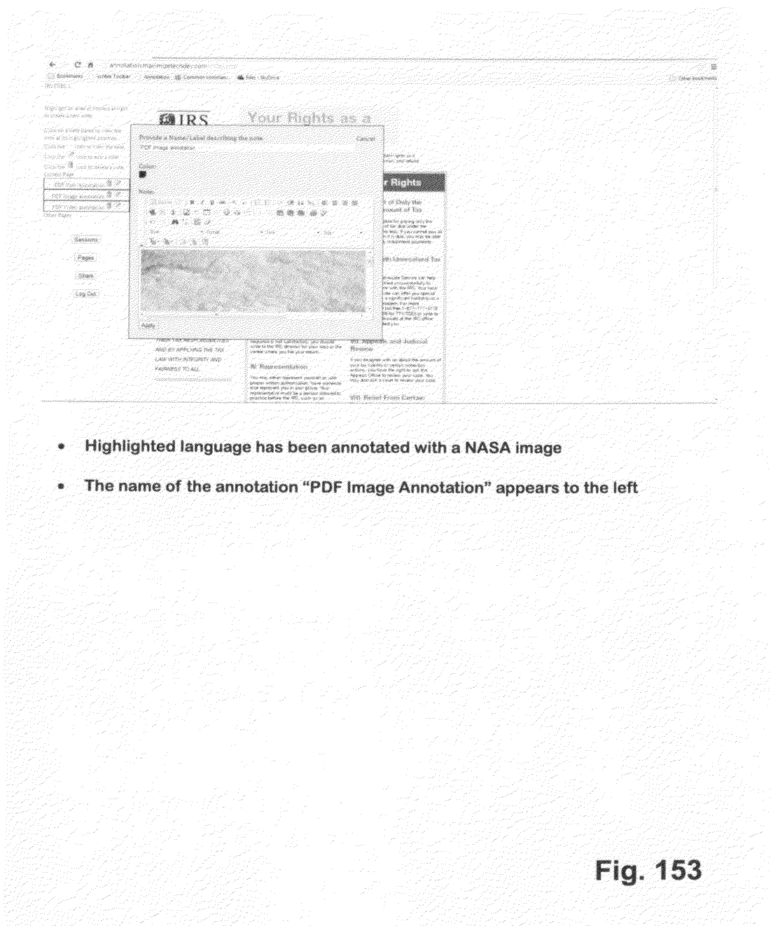

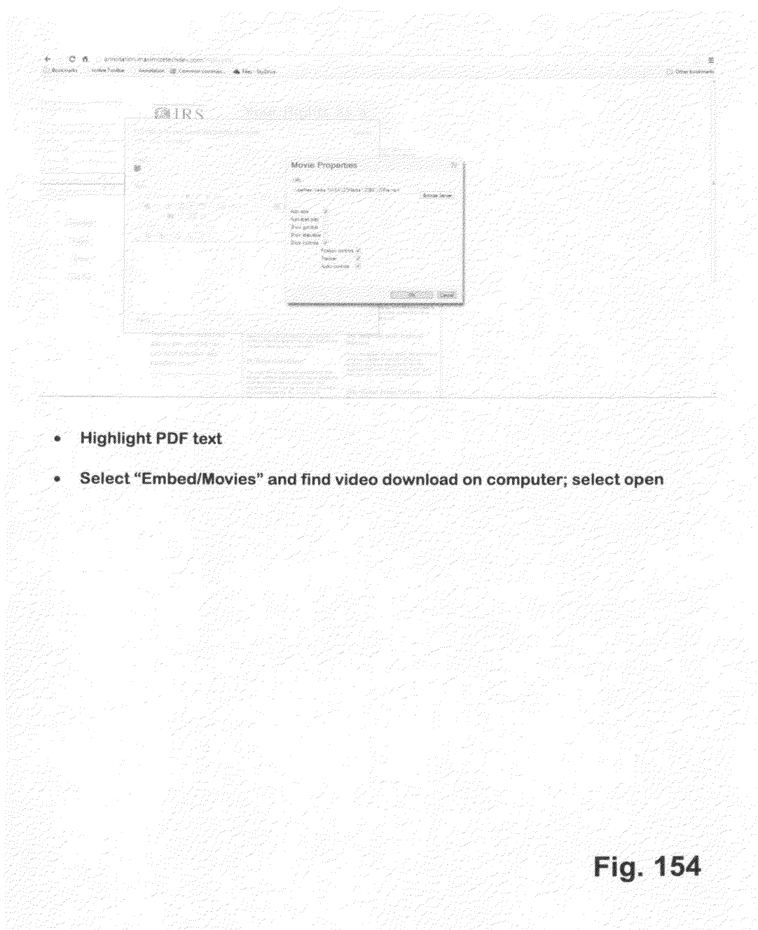

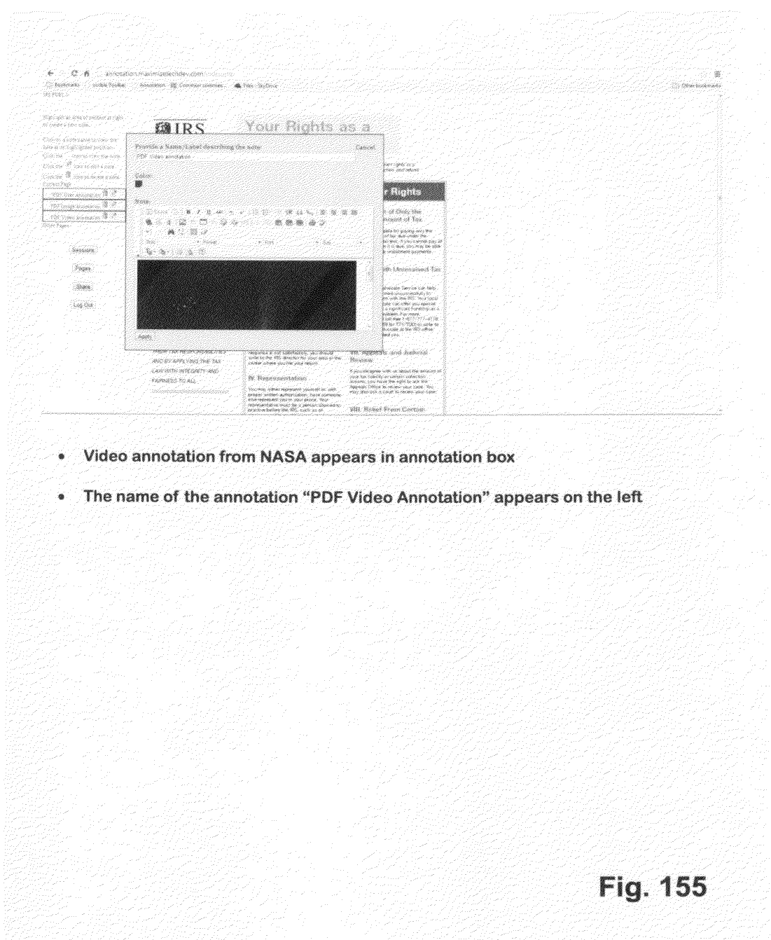

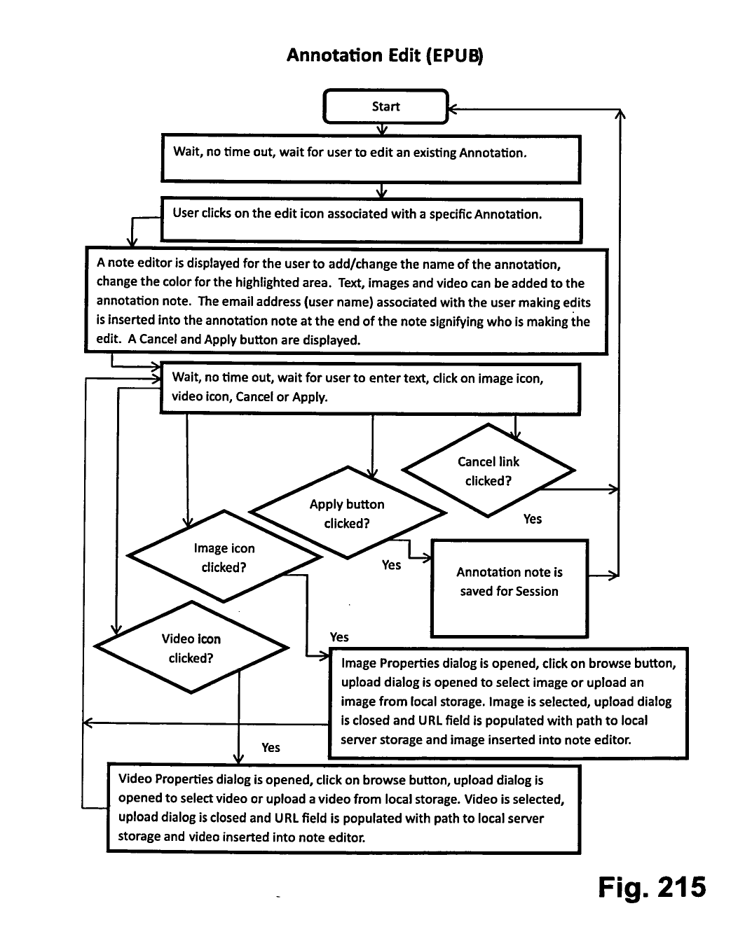

PDF files can also be annotated with image and video files. FIGS. 152 and 153 illustrate the annotation of an image to a pdf file while FIGS. 154 and 155 illustrate a video annotation of a pdf file as set forth in FIG. 215, similar to FIG. 59.

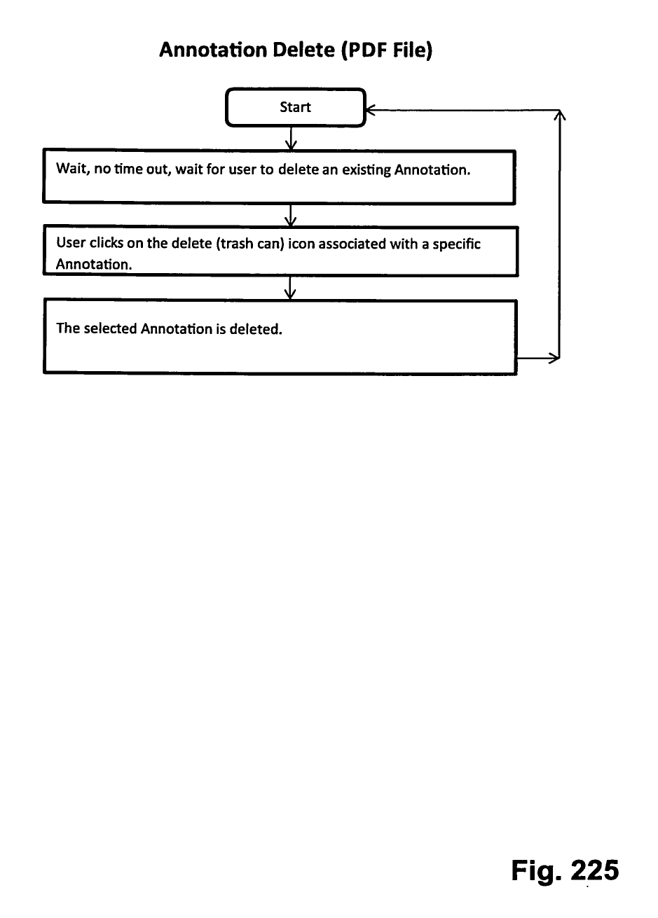

FIG. 225 illustrates how a user can delete an annotation. FIG. 225 is similar to FIG. 51 and thus is not discussed further.

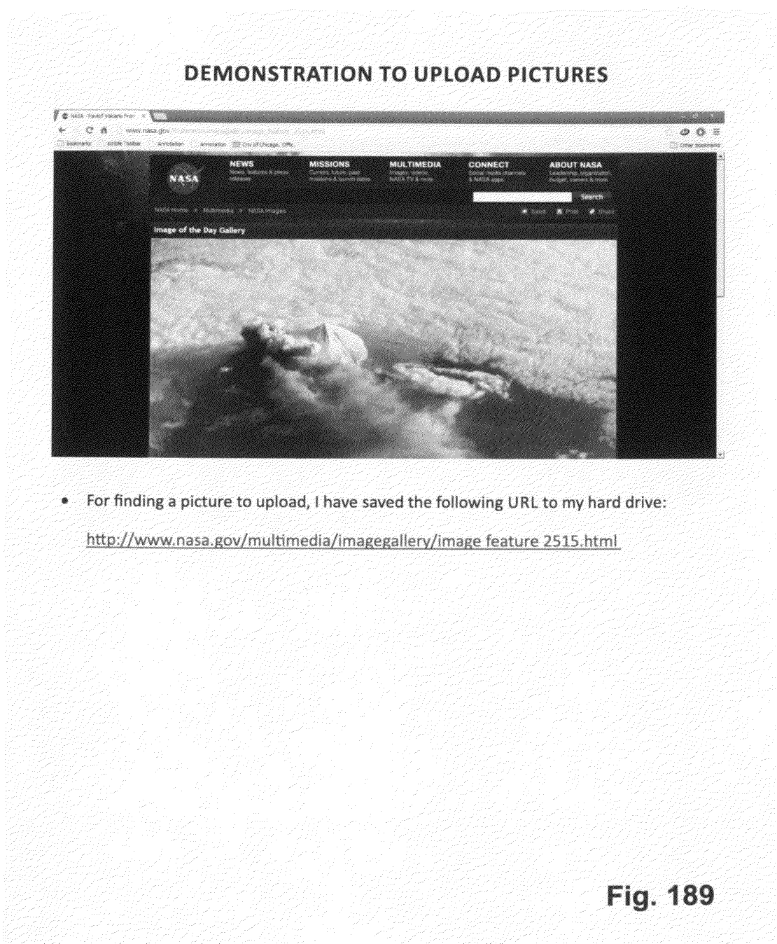

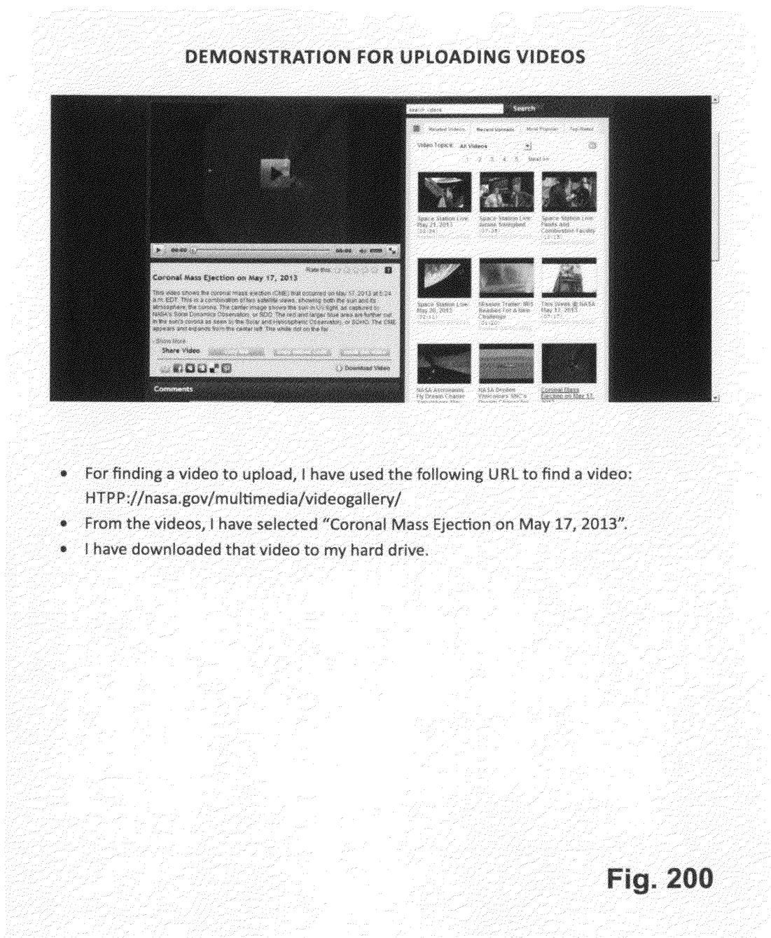

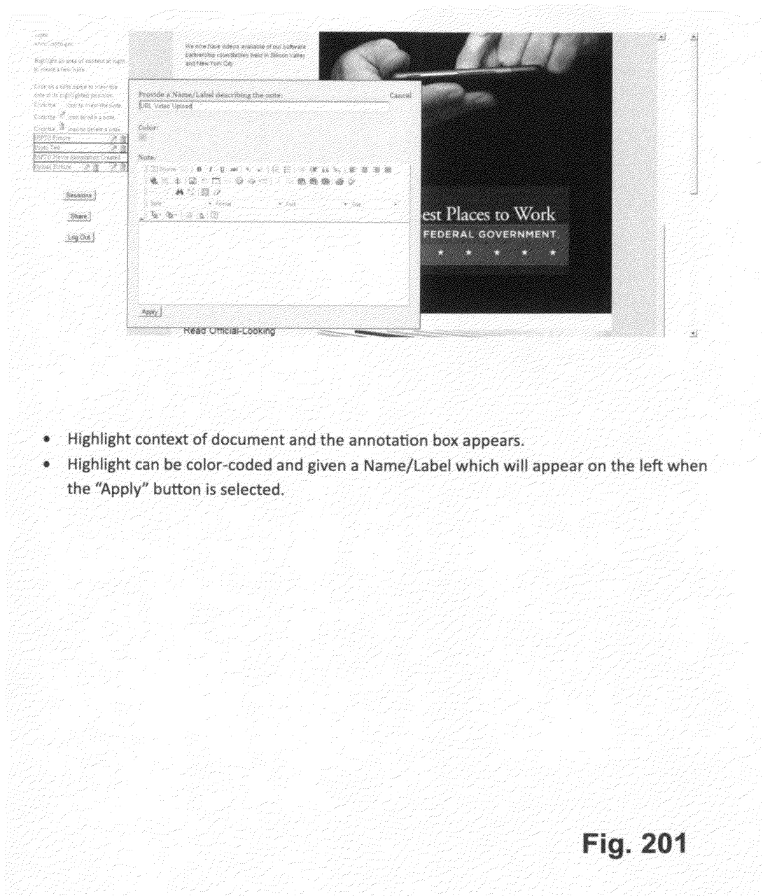

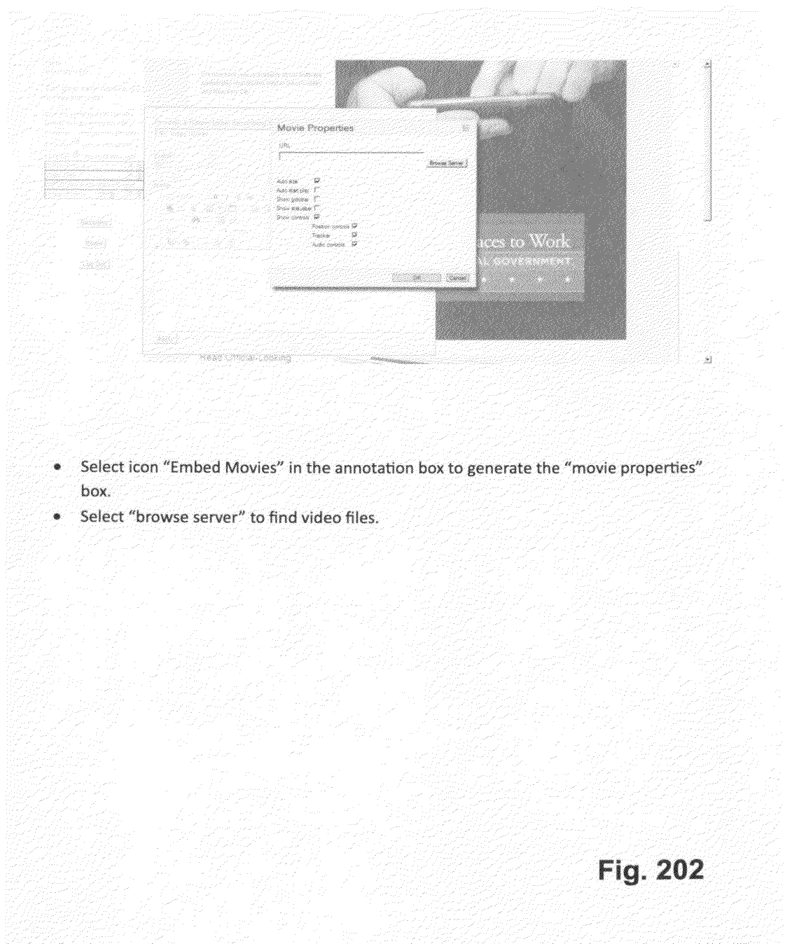

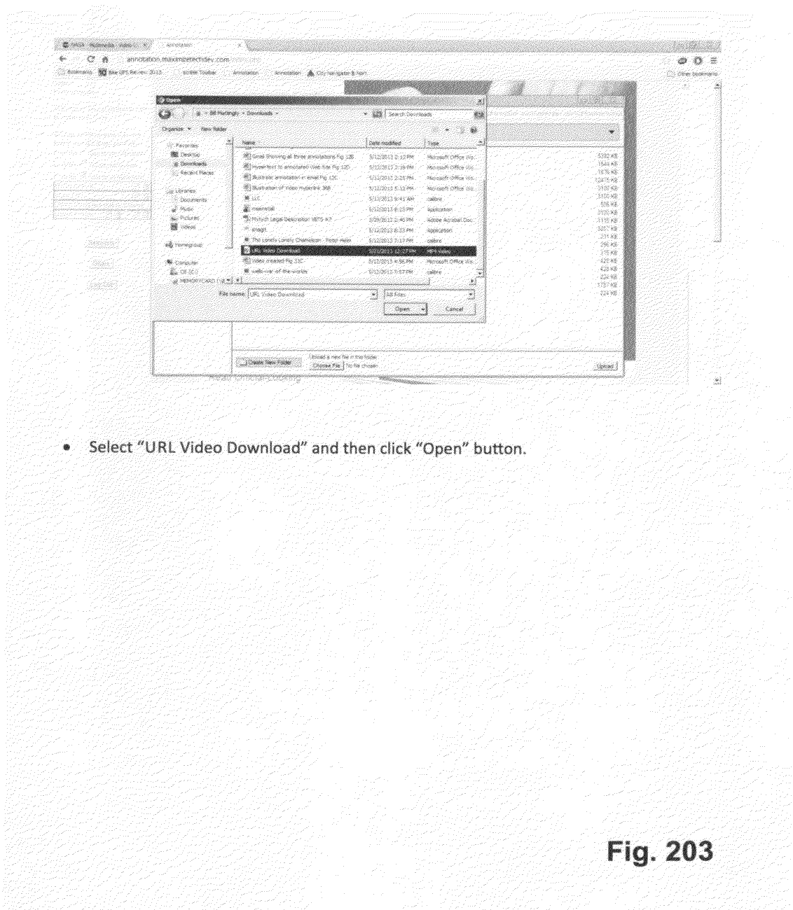

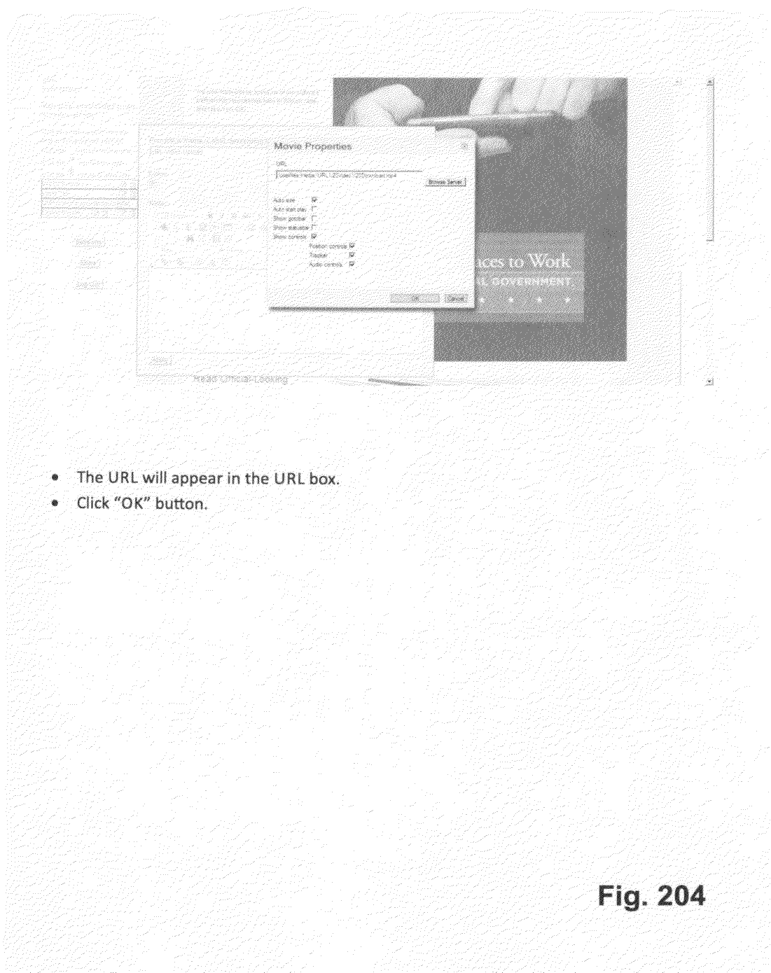

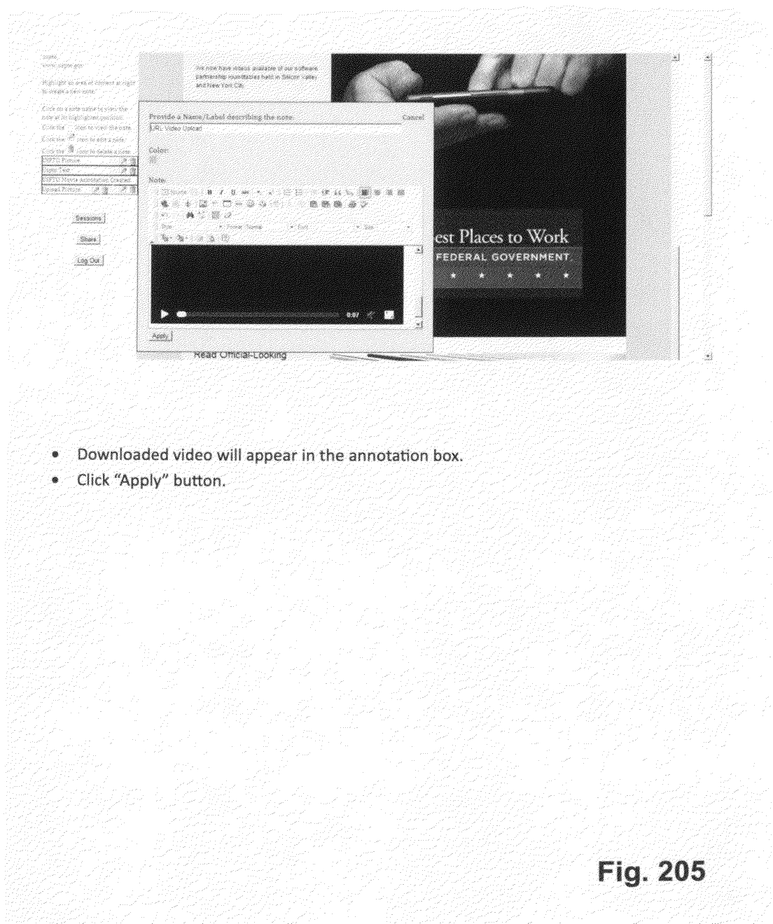

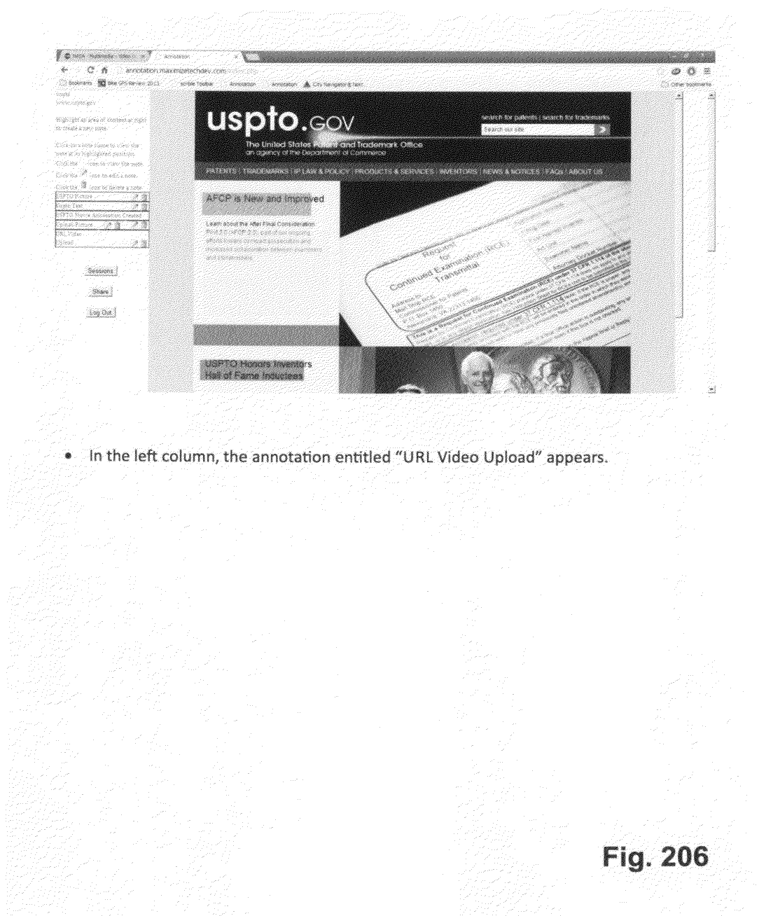

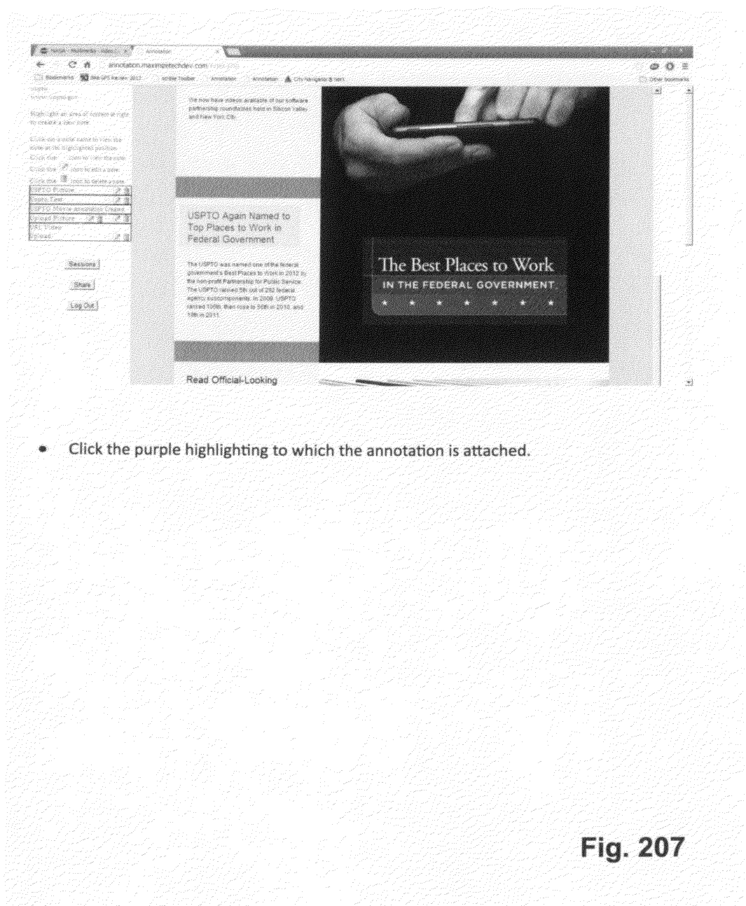

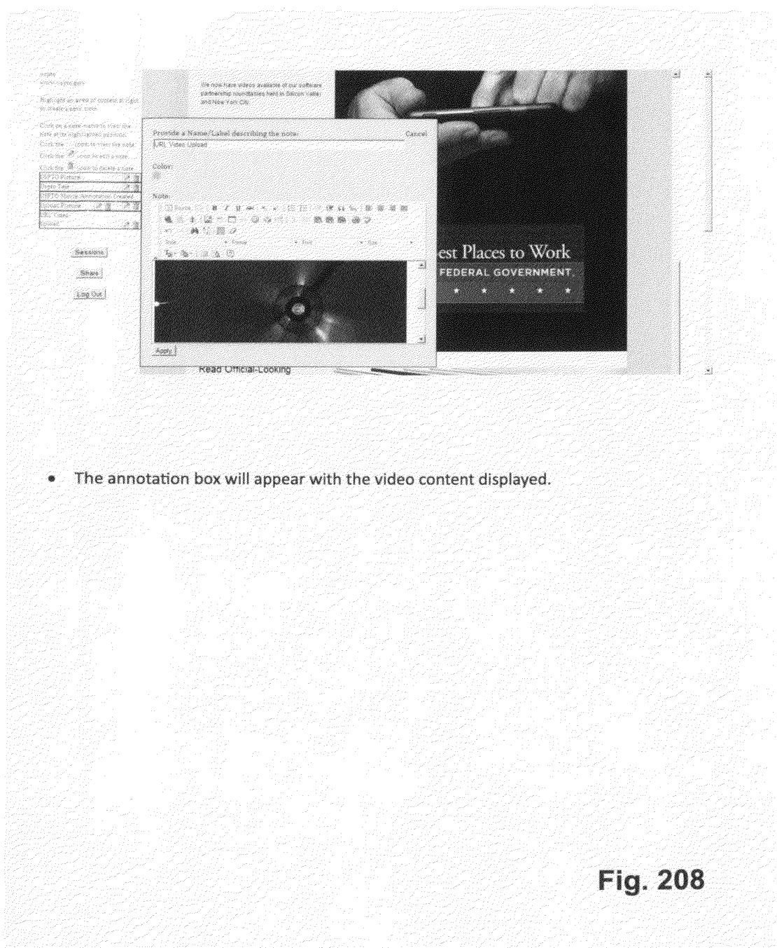

An account owner may create and view an annotation of an image or video in the annotation label box by uploading the image as illustrated in FIGS. 189-199 or a video as illustrated in FIGS. 200-208.

### Annotation Edit

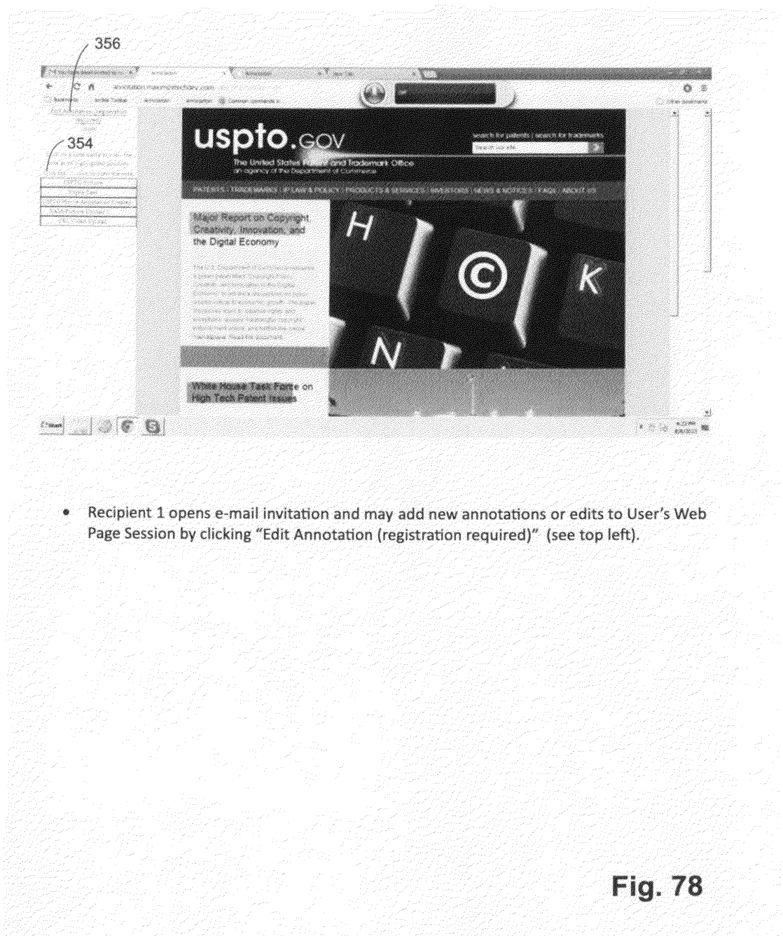

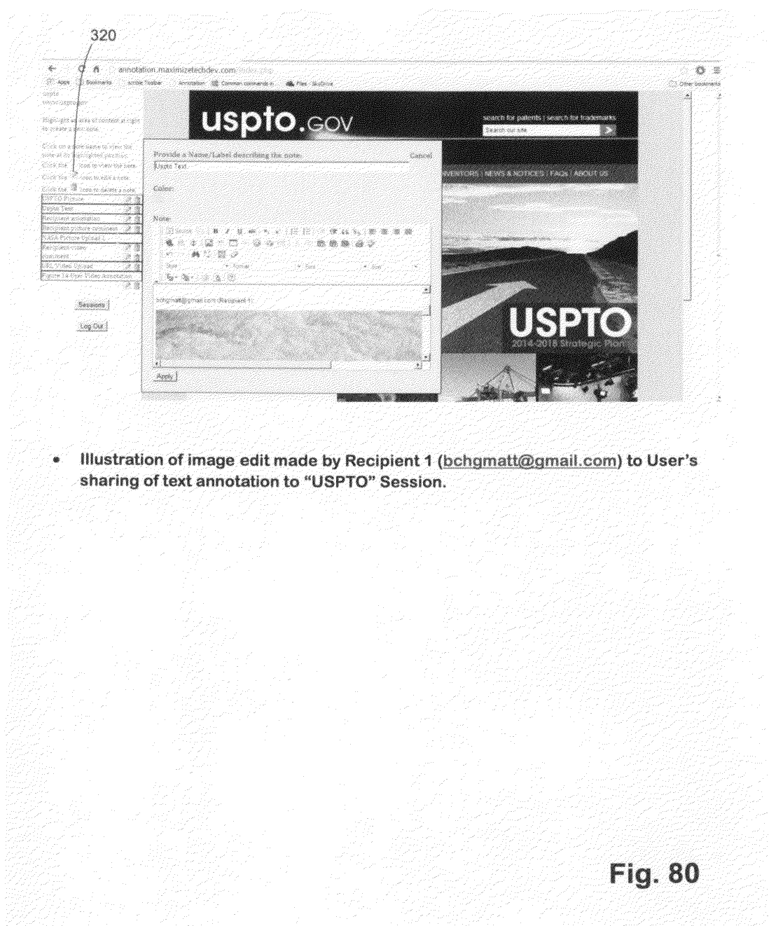

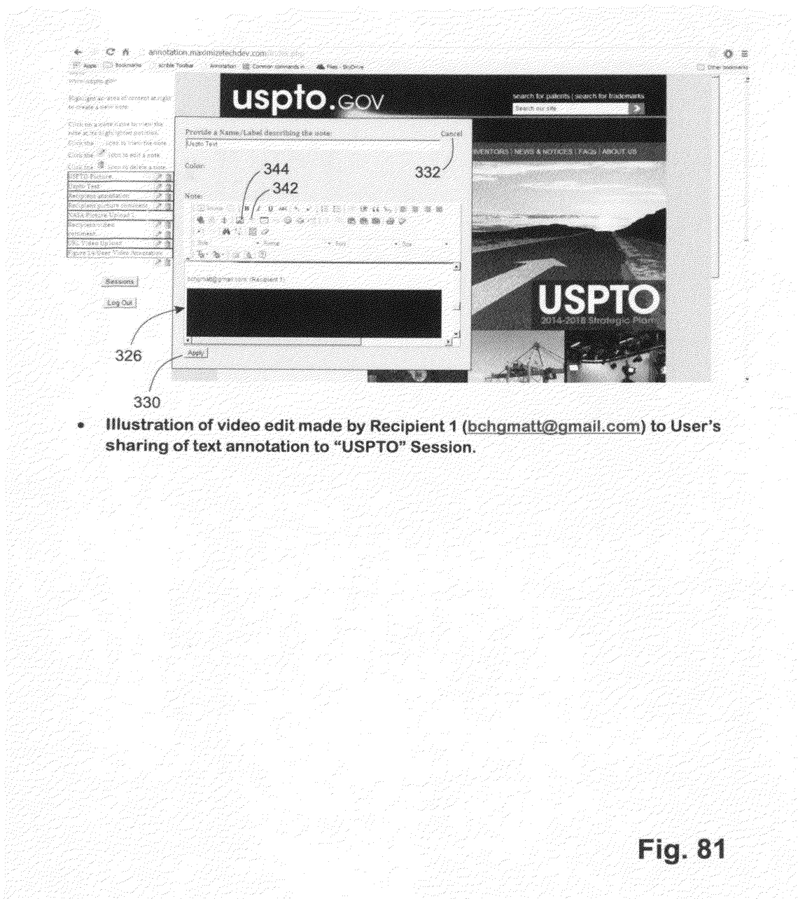

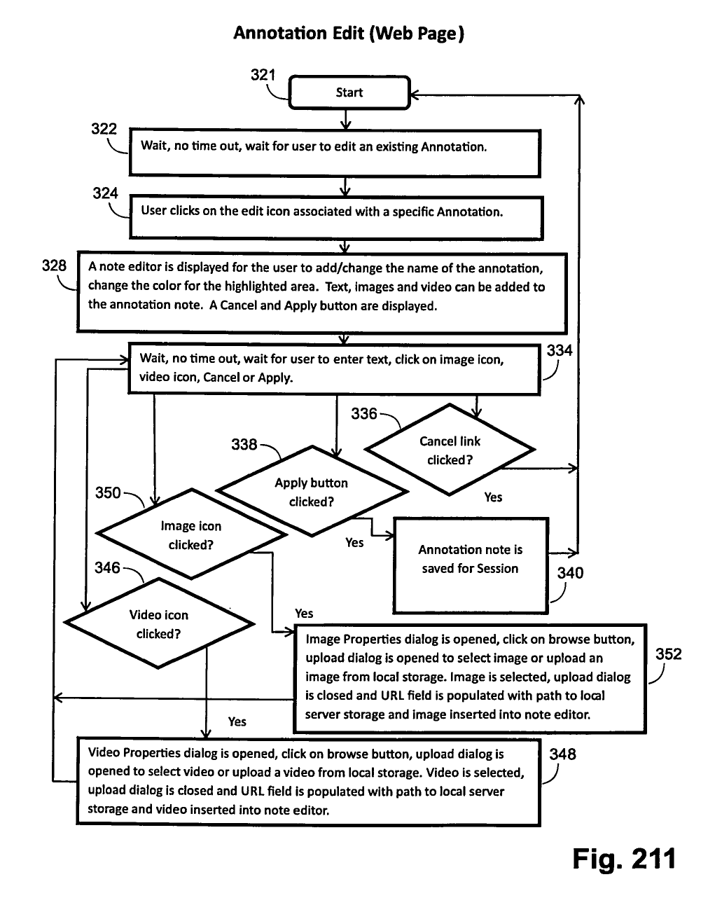

User's and recipients can edit prior annotations by the user or another recipient by way of text, image or video. This feature is illustrated for a web page annotation in FIGS. 78-105. Referring first to FIG. 211, this flow chart relates to edits of an existing web page annotation. In order to edit an annotation with a video, an edit icon 320 (FIG. 80) is selected as illustrated in steps 322 and 324. In response thereto, a note editor 326 (FIG. 81) is displayed, as indicated in step 328 (FIG. 211) in order to enable the user add or change the name of the annotation, change the color, for example, of the highlighted annotation and to allow text, images or video to be added to the annotation note. “Cancel” and “Apply” buttons 332 and 330 (FIG. 81), respectively, are provided on the note editor 326. In step 334, the system checks in step 334 (FIG. 211) whether the Apply 330 (FIG. 81) or Cancel 332 buttons have been selected if the “Cancel” button is selected, as indicated in step 336, the system loops back to steps 321 and 322 and waits for the Edit icon 320 (FIG. 80) to be selected. If the “Apply” button 330 (FIG. 81) is selected, as determined in step 338 (FIG. 211), the edit is saved for the session, as indicated in step 340.

The note editor 326 (FIG. 81) includes a video icon 342 and an image icon 344. If the video icon 342 is selected, as determined in step 346 (FIG. 211), a list of videos on the user's hard drive is displayed. The user then selects a video by highlighting and clicking on the highlighted selection in order to upload the file path of the video to a local server in order to insert the video into the note editor 326 (FIG. 81), as indicated in step 348 (FIG. 211). Editing of an existing annotation with an image is similar to editing with a video, as indicated in steps 350 and 352 (FIG. 211).

FIG. 215 relates to text, image and video edits of an existing annotation for an epub file. The logic for the epub file is similar to the logic for the web page, illustrated in FIG. 211. As such, FIG. 215 is not discussed.

### View or Register

Upon receipt of an annotated web page or epub file, the recipient has the ability to (a) view all annotations including edits to an account owner's session or (b) register onto the account owner's session to add an additional edit to existing annotations or to create new annotations. Referring first to FIG. 78, a screen shot of a highlighted web page is illustrated, as viewed by a recipient. The web page contains a “View” icon 354 (FIG. 78) and an “Edit Annotation” button 356. If the “View” icon 354 is selected by the recipient, the recipient will have the ability to view all annotations, including edits, added by the account owner and other recipients, however, the recipient will not have the ability to add annotations or edits or to change or delete annotations or edits made by the account owner or other recipients. If the recipient registers by selecting the “Edit Annotation” button 356, the recipient may add annotations, such as text, images or video or, may similarly edit annotations of the account owner or other recipients and may share with the account owner or other recipients. In either case, a recipient may not share an owner's account with a new recipient.

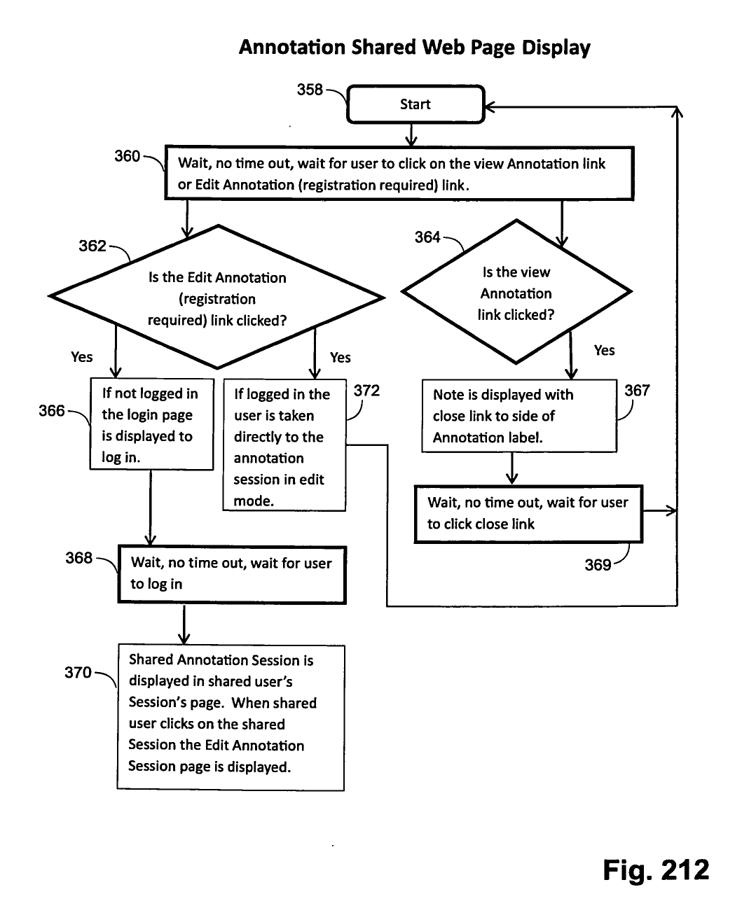

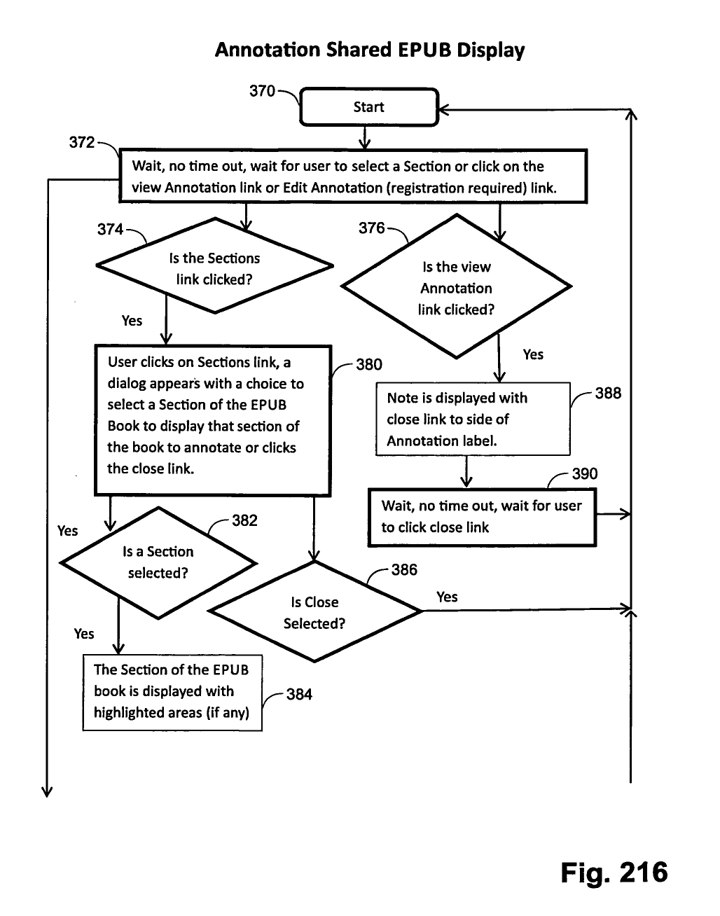

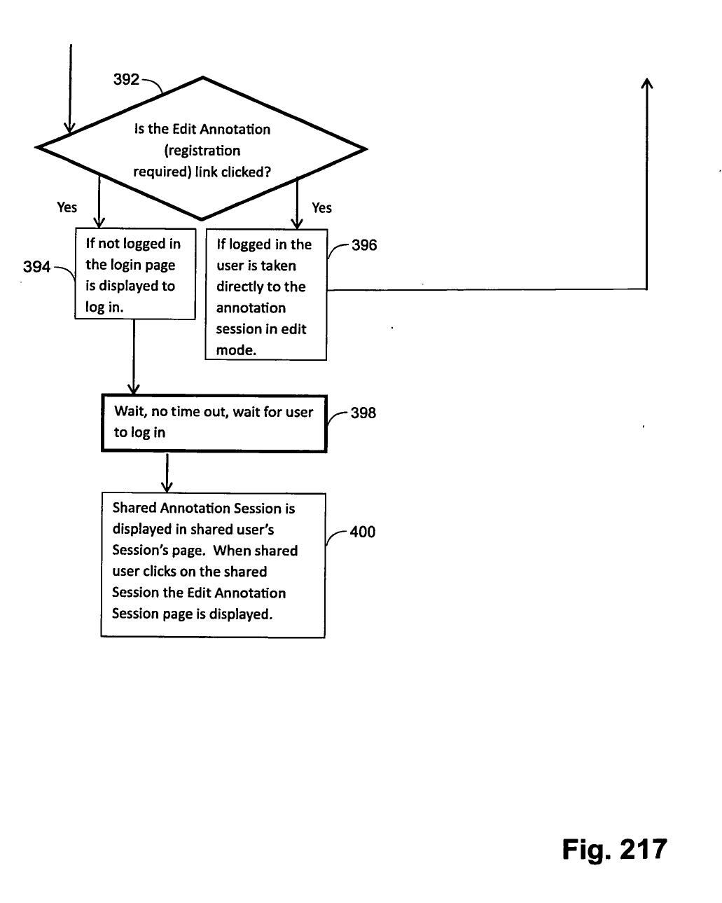

FIG. 212 relates to a shared web page display while FIGS. 216 and 217 relate to a shared epub file. Referring first to FIG. 212, once an account owner sends an annotated web page to a recipient and the recipient opens the email invitation, an Annotation shared Web Page is displayed, as illustrated in FIG. 78. The shared annotation web page enables a recipient to choose to view the annotation from the user by selecting the “view” icon 354 or to register onto an account owner's session by selecting the “Edit Annotation” button 356.

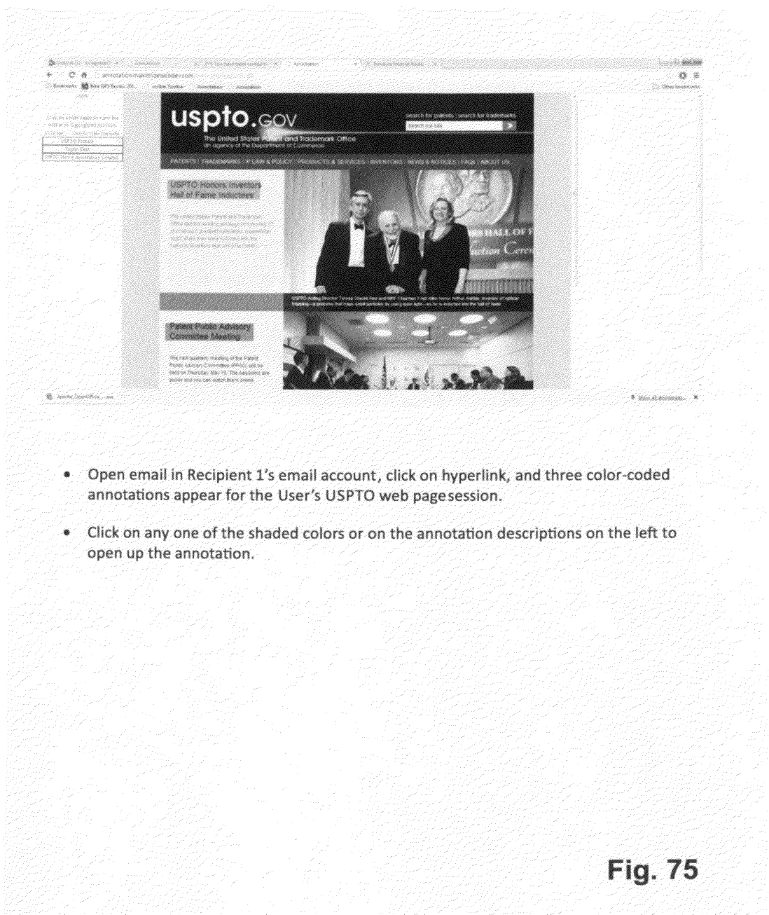

When the recipient selects to view, i.e. by selecting the “view ” icon 354,the recipients view rights are the same as described in FIGS. 1 to 70 for viewing text and as illustrated in FIGS. 75, 76 and 77 for viewing images and video, respectively. As mentioned above the recipient can only view annotations in this mode and cannot edit any of the annotations. As such, the system waits in step 368 until the close link is selected at which time the system loops back to step 358 and waits.

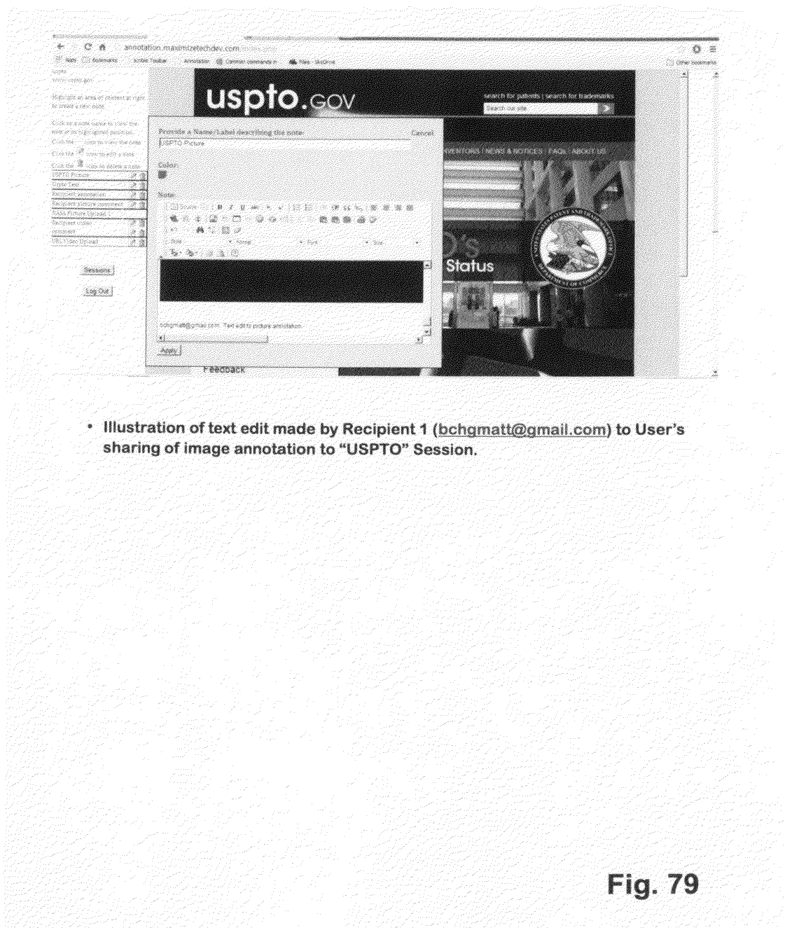

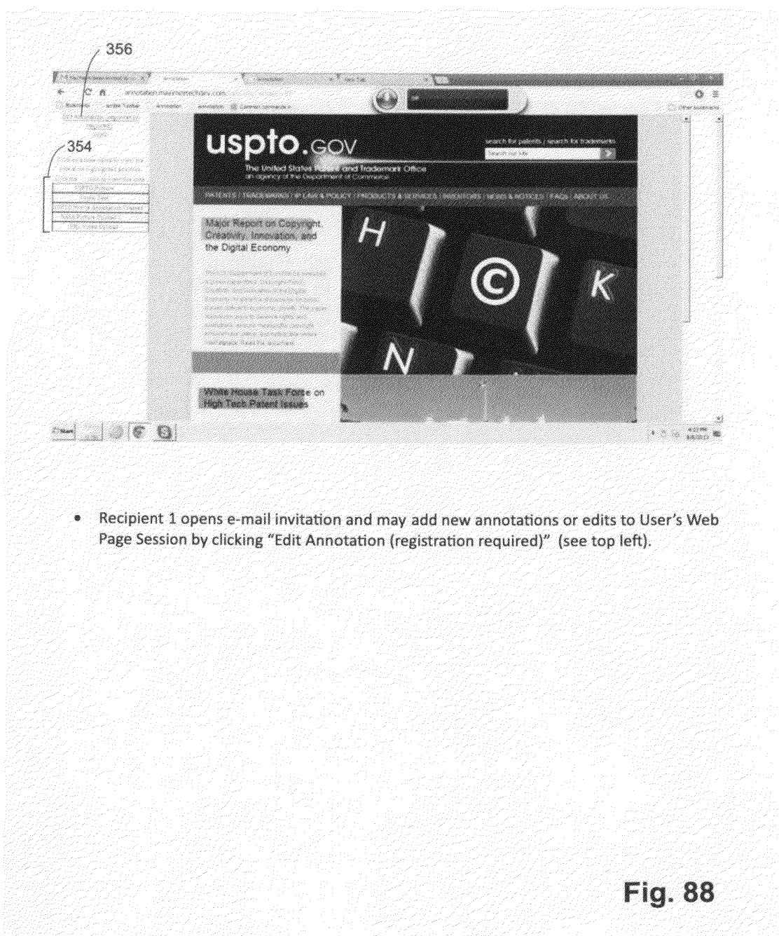

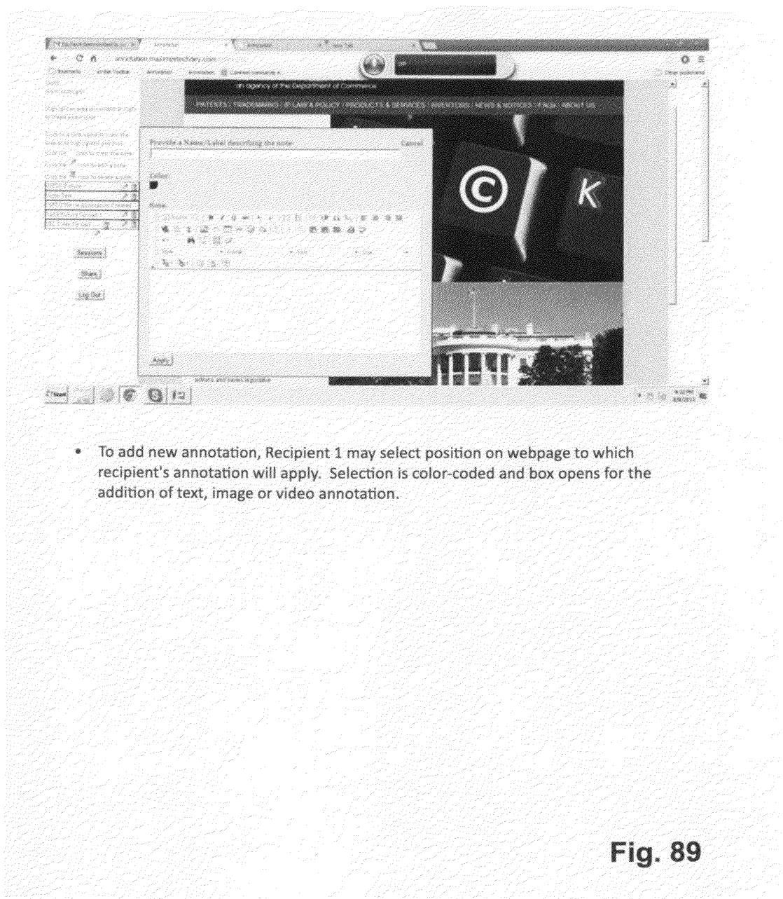

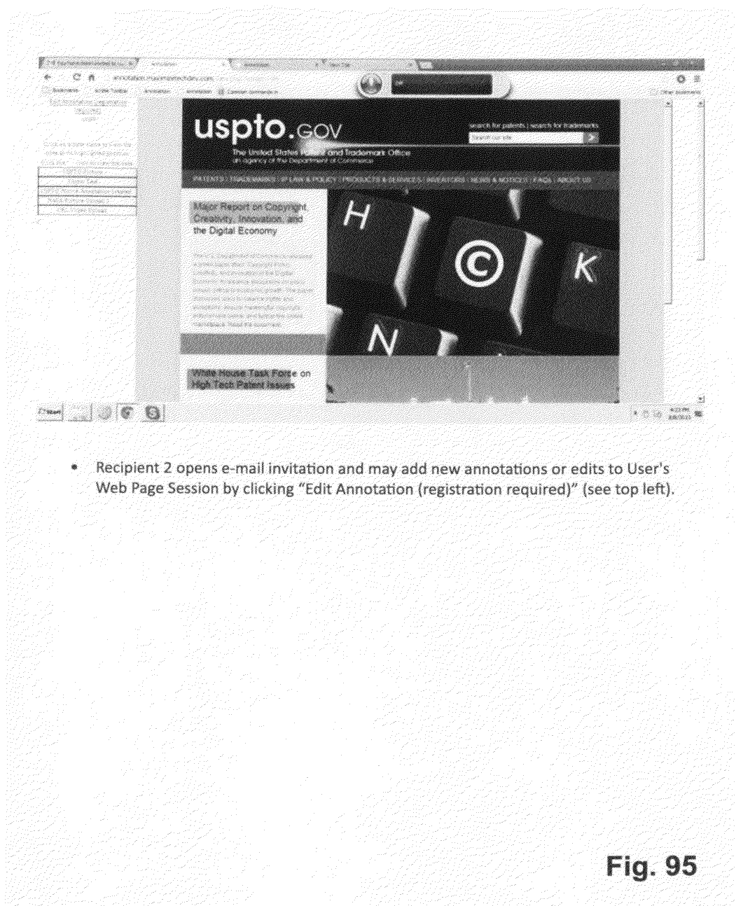

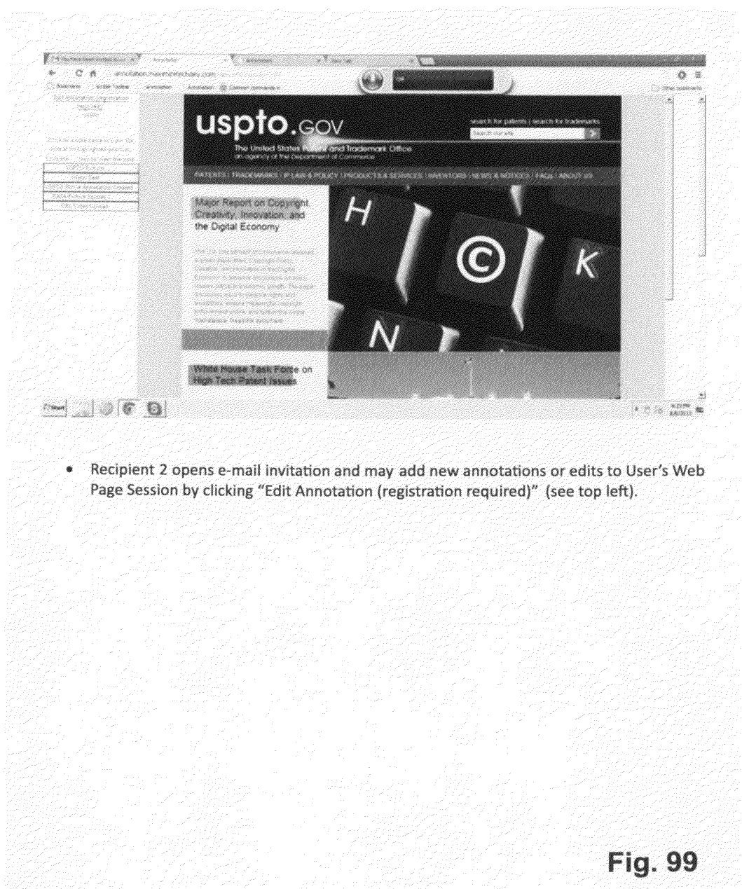

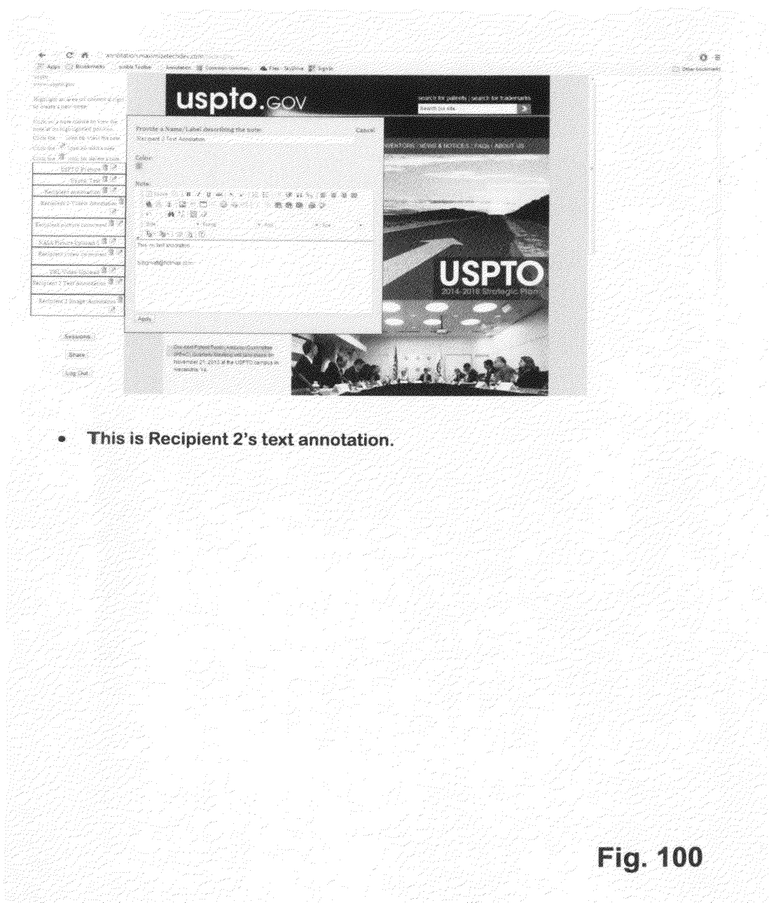

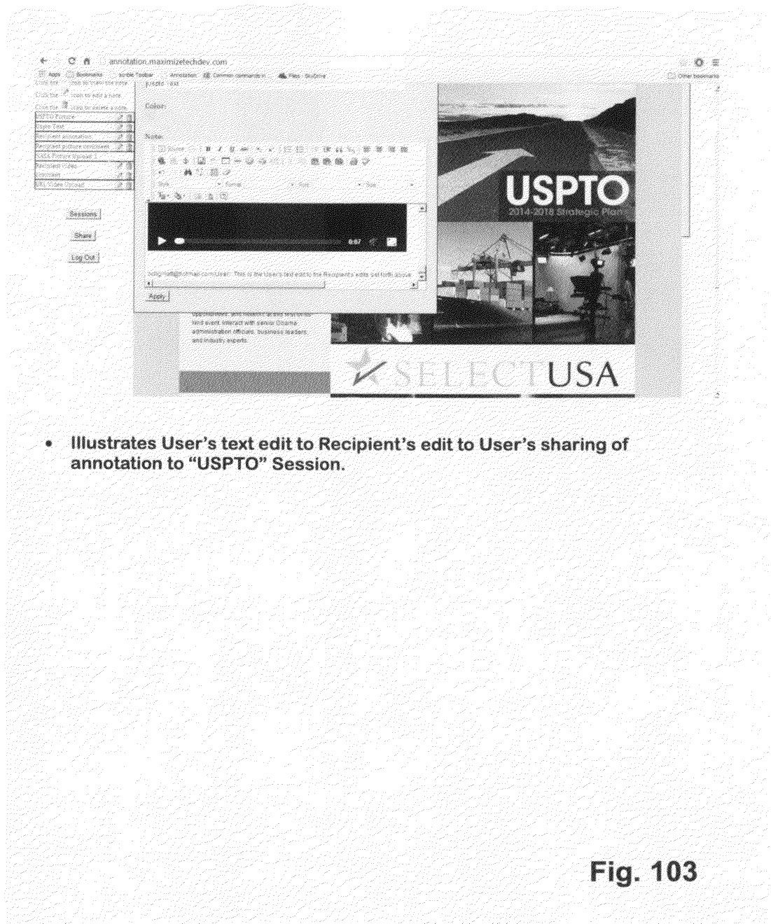

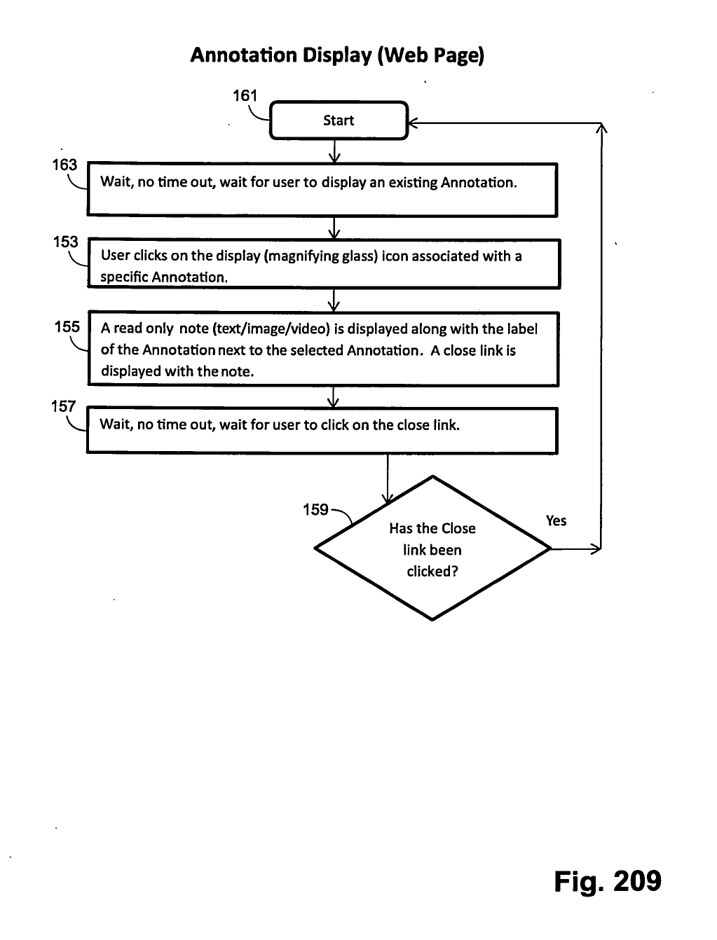

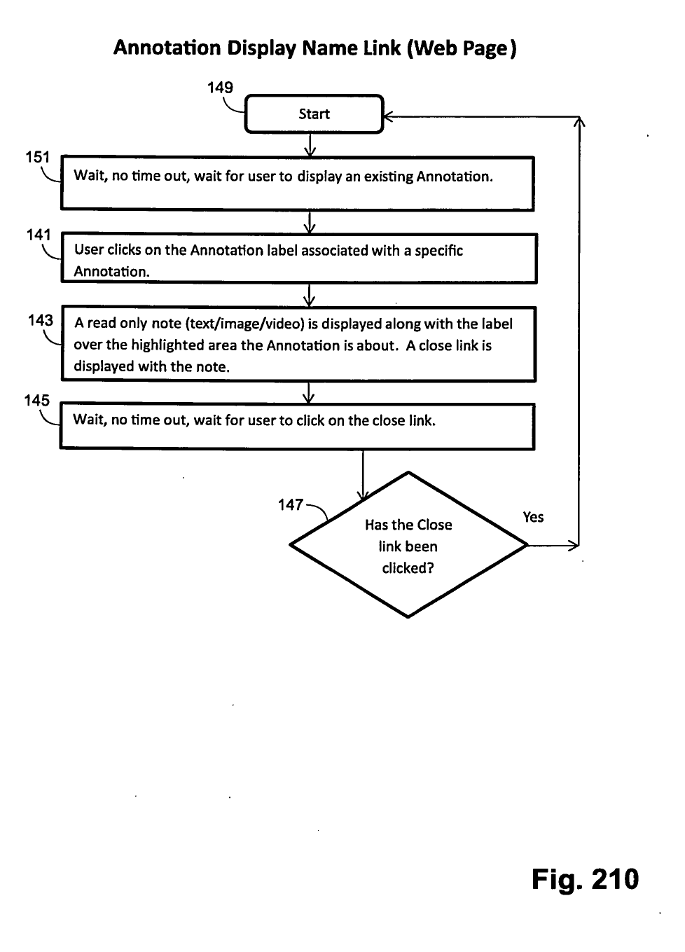

When recipient clicks on the “Edit Annotation (registration required)” (FIGS. 78 and 88), the recipient is required to log on, in the same manner as the account owner, as illustrated in FIG. 2 and to select a session, as illustrated in FIG. 3. Thereafter, a Shared Annotation session is displayed and the Annotation Edit feature (FIG. 211) (FIGS. 78-87) (FIGS. 95-98) and (FIGS. 103-105) is available as well as Annotation Add (FIG. 50) (FIGS. 88-94) (FIGS. 99-102) and (FIGS. 103-105), and viewing (FIGS. 209 and 210) as described above. Illustrations where the recipient 1 edits various combinations of text, image and video are illustrated in FIGS. 79 to 87 as viewed by the recipient. Illustrations of a new annotation created by the recipient 1 in the form of text, image or video are illustrated in FIGS. 89 to 94 as viewed by the account owner. Illustrations of an edit in text, image or video added by the second recipient are illustrated in FIGS. 95 to 98 as viewed by the recipient. Illustrations of annotations in text, image and video added by the second recipient are at FIGS. 100 to 102 as viewed by the account owner. Illustrations of the account owner's edit of text, image or video to the recipient's edit or annotation are at FIGS. 103 to 105, as viewed by the account.

A flow chart for an annotation shared web page display is illustrated in FIG. 212. The system initially checks whether either the “Edit Annotation” button 356 (FIG. 78) or the view icon 354 have been selected in steps 358, 360, 362 and 364. The system checks in step 362 whether the recipient is logged in, i.e. registered. If not, a log-in page is displayed in step 366. The system waits in step 368 for the recipient to log-in. Once the recipient logs in, a shared annotation session is displayed in step 370 (FIG. 212).

If the user is already logged in, the user is directed to an annotation session, for example, as illustrated in FIG. 79. as indicated in step 372. Once in the annotation session, the system loops back to step 358 and waits.

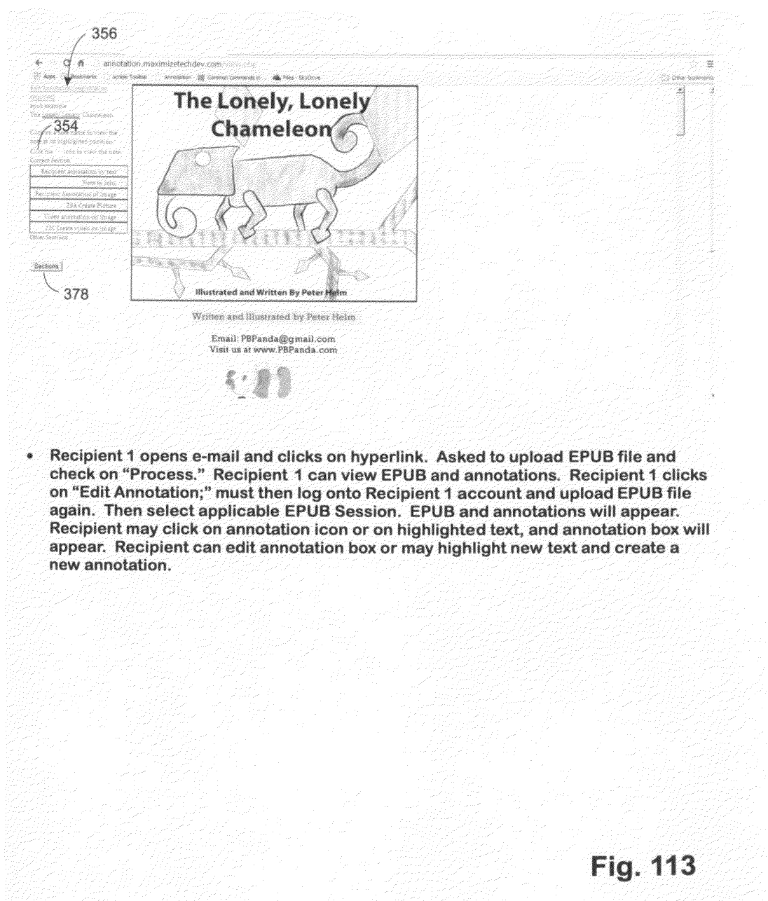

FIGS. 216-217 relate to a shared epub file. display while FIGS. 216 and 217 relate to a shared epub file. Referring to FIGS. 216-217, once an account owner sends an annotated epub file to a recipient and the recipient opens the email invitation, as illustrated in FIG. 113, and uploads the EPUB, as illustrated in FIGS. 38 and 39 or FIGS. 43 and 44, an Annotation shared epub file is displayed. The shared annotation epub file enables a recipient to choose to view the annotation from the user by selecting the “view” icon 354 or to register onto an account owner's session by selecting the “Edit Annotation” button 356.

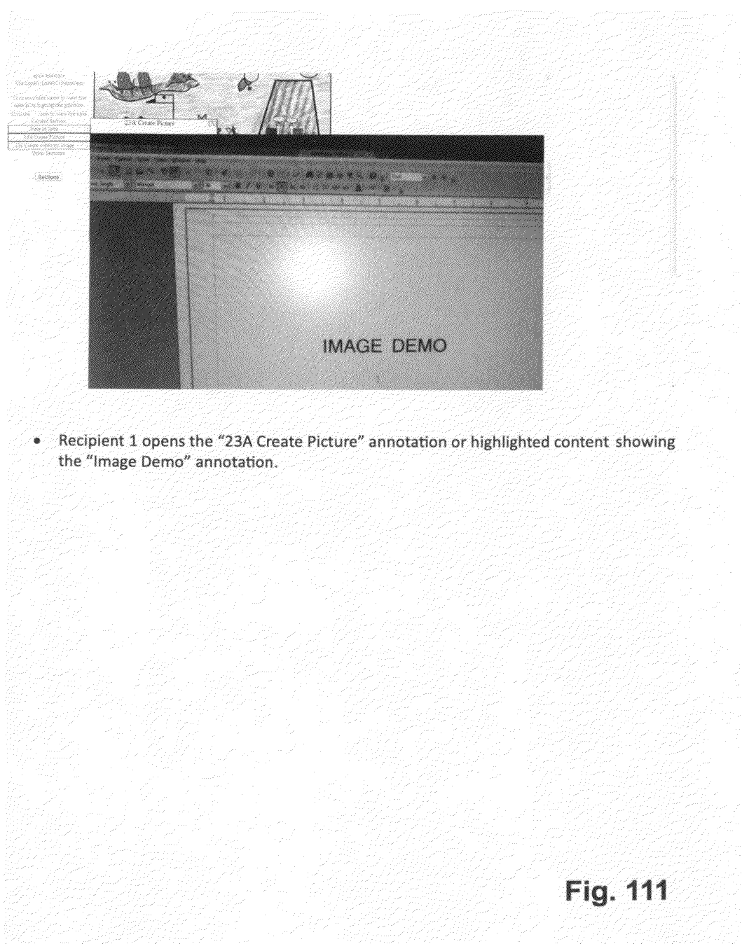

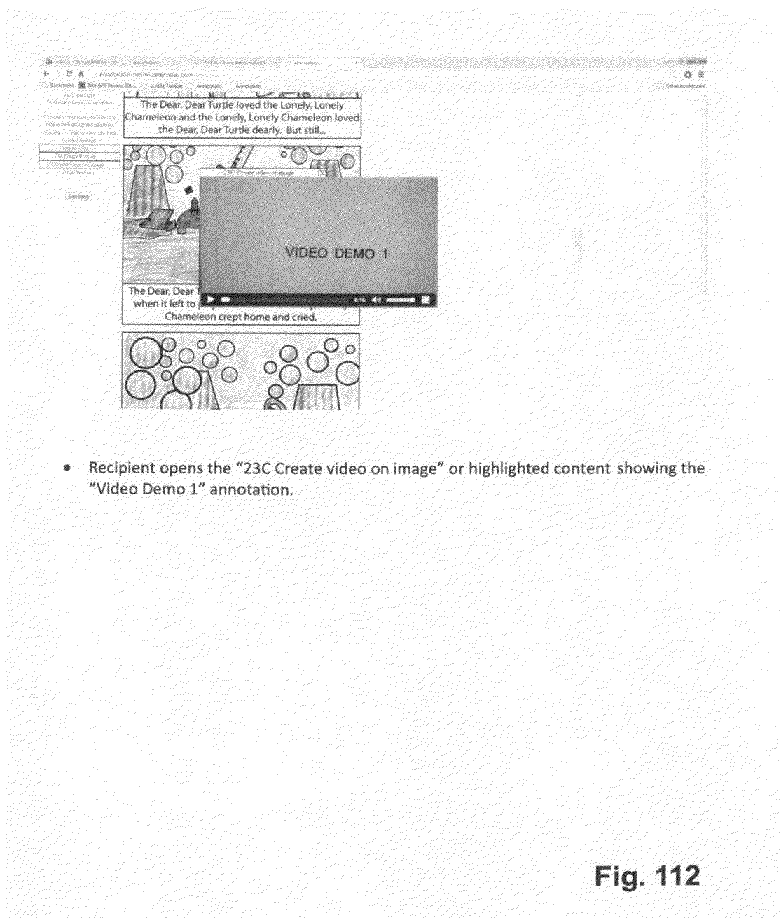

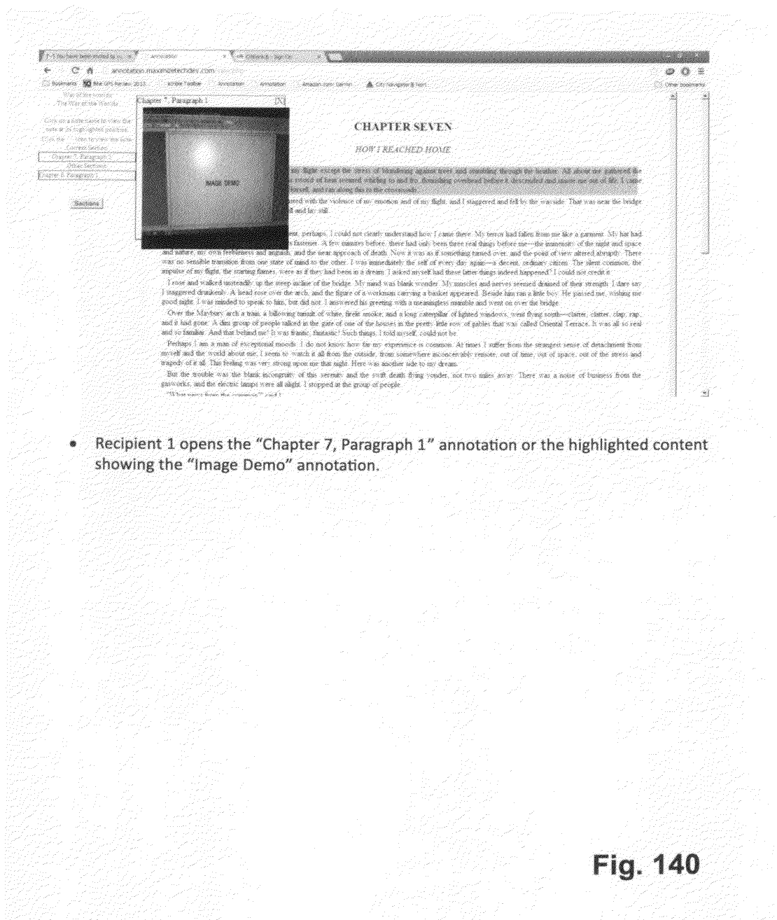

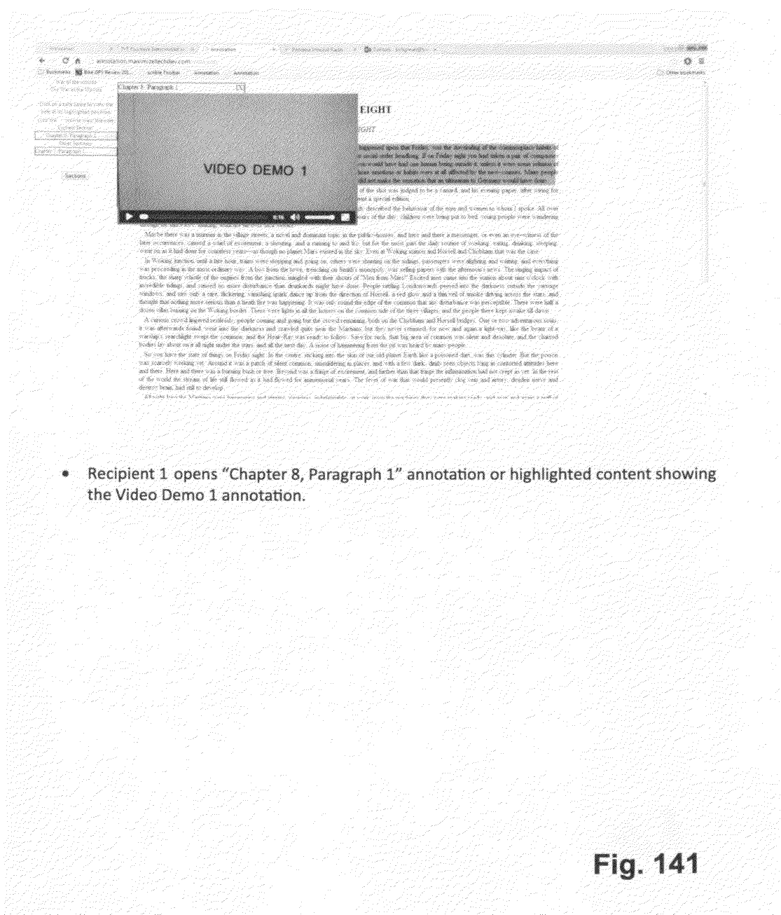

When the recipient elects to view, i.e. by selecting the “view ” icon 354,the recipients view rights are the same as described in FIGS. 1 to 70 for viewing text and as illustrated. in FIGS. 111 and 112 for viewing images and video, respectively for EPUB no chapters and FIGS. 140 and 141 for EPUB files with chapters

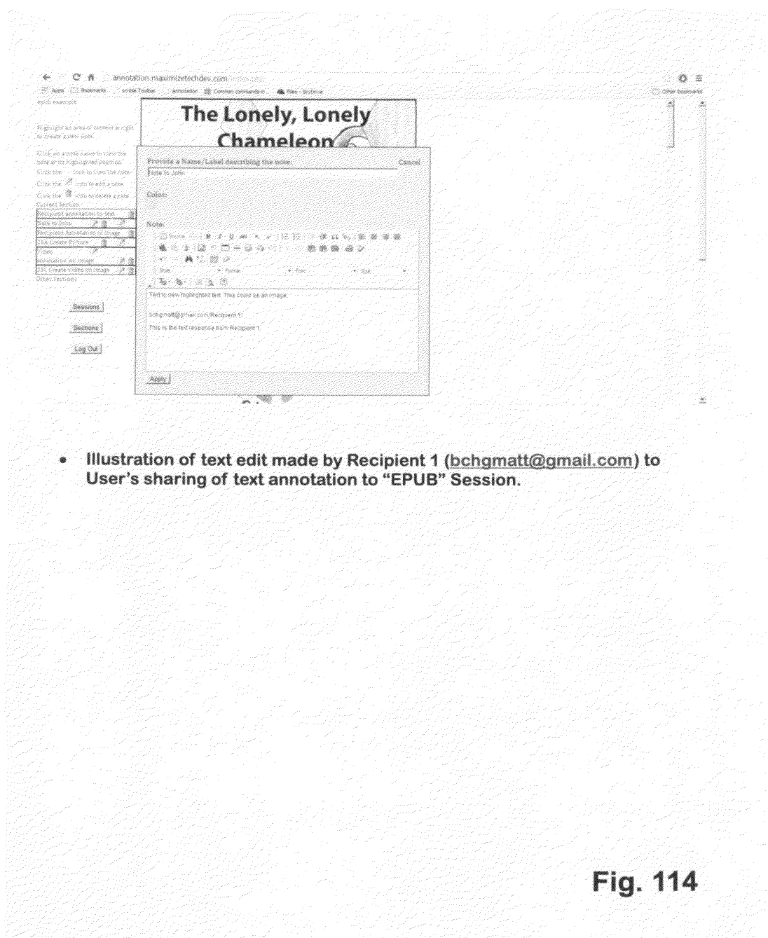

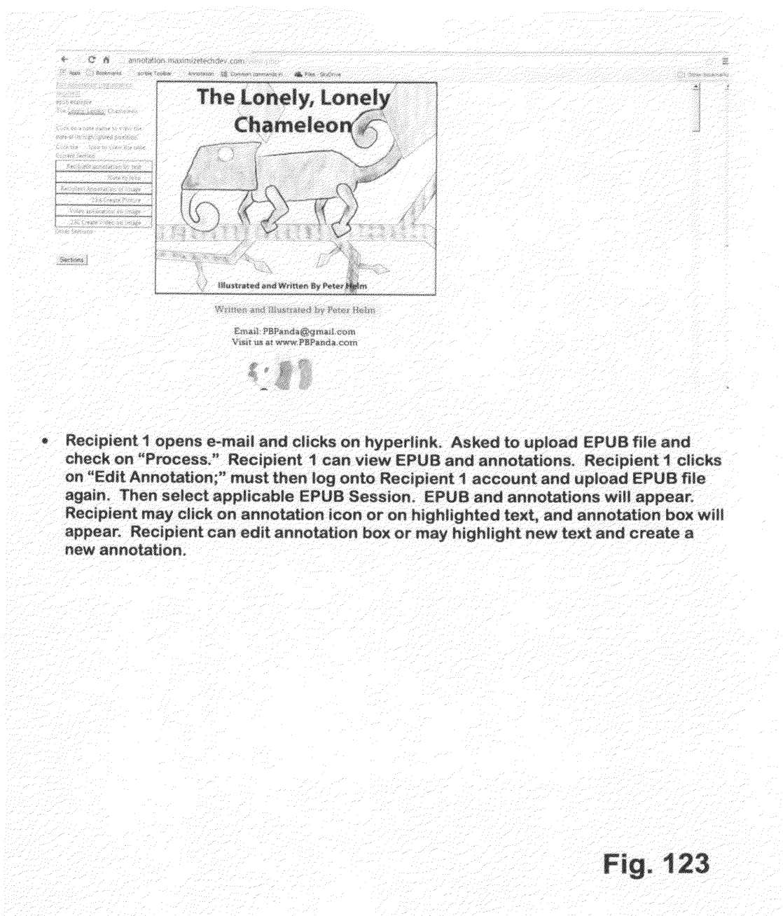

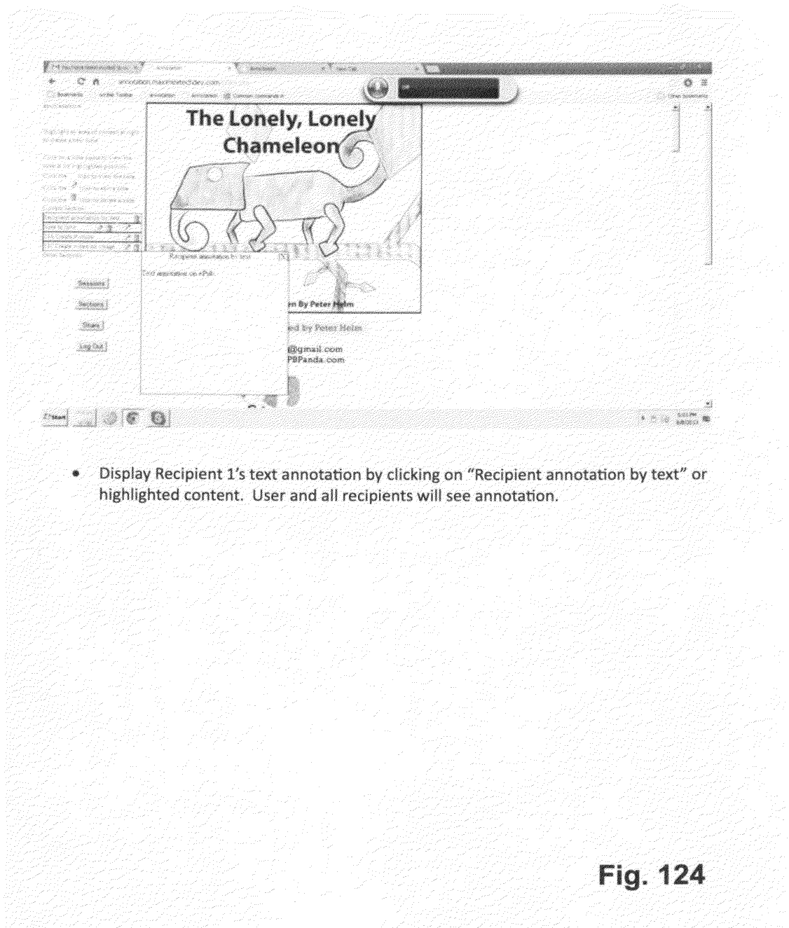

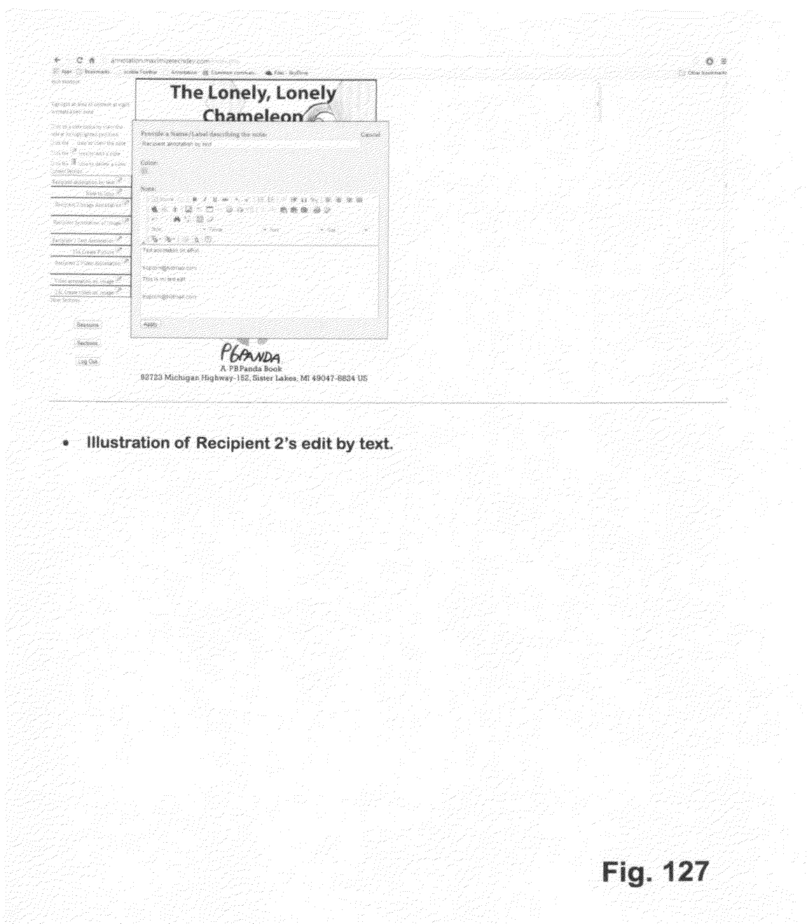

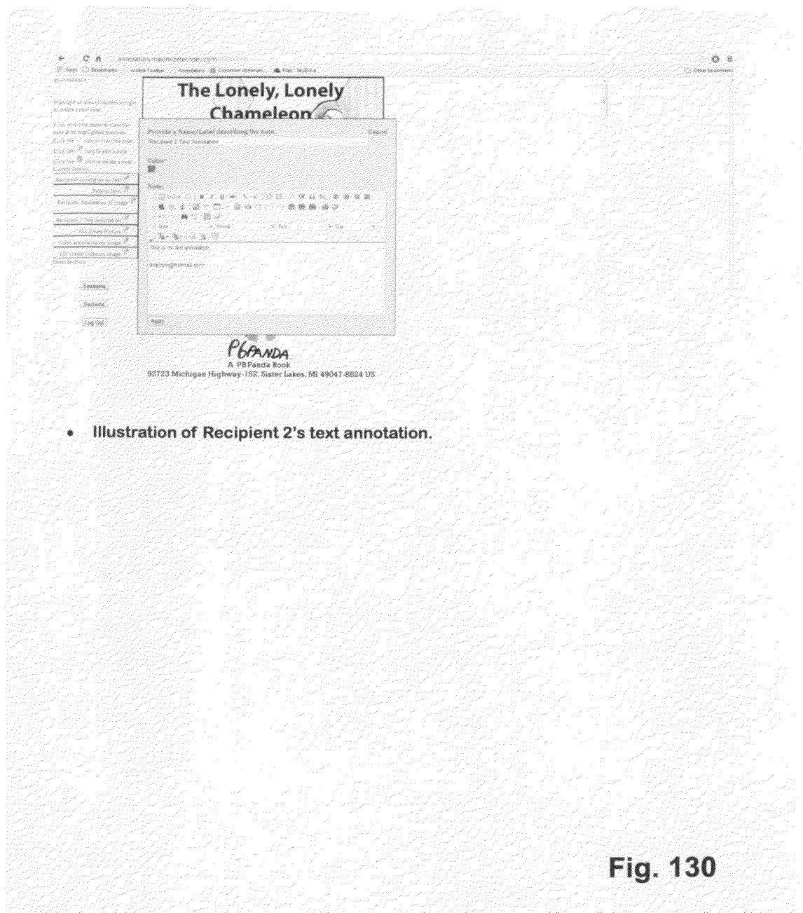

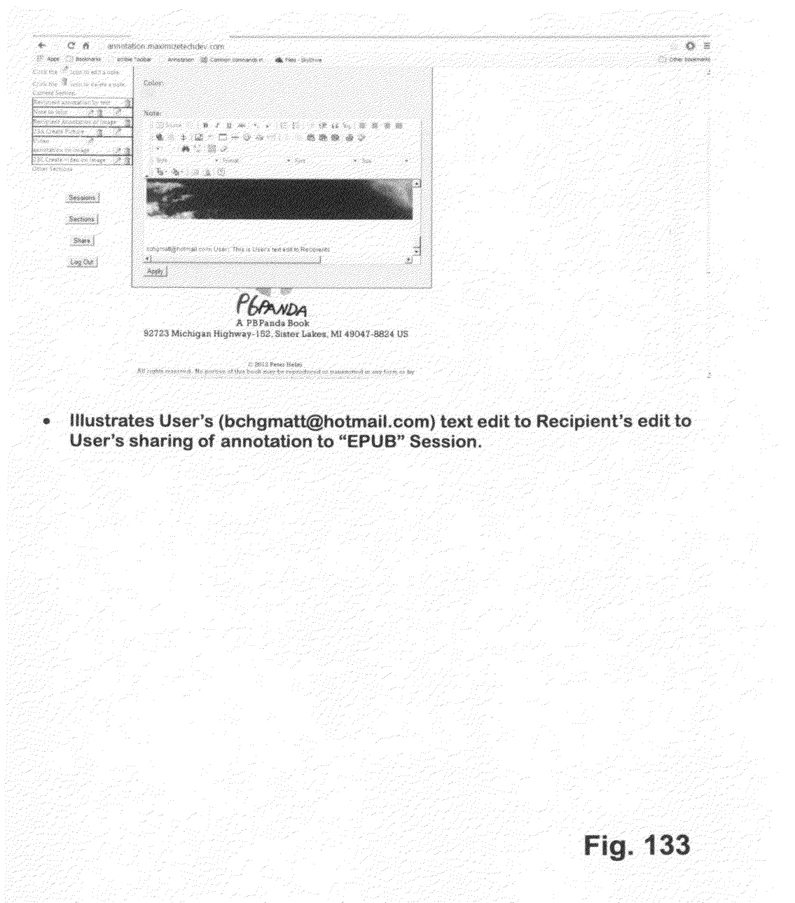

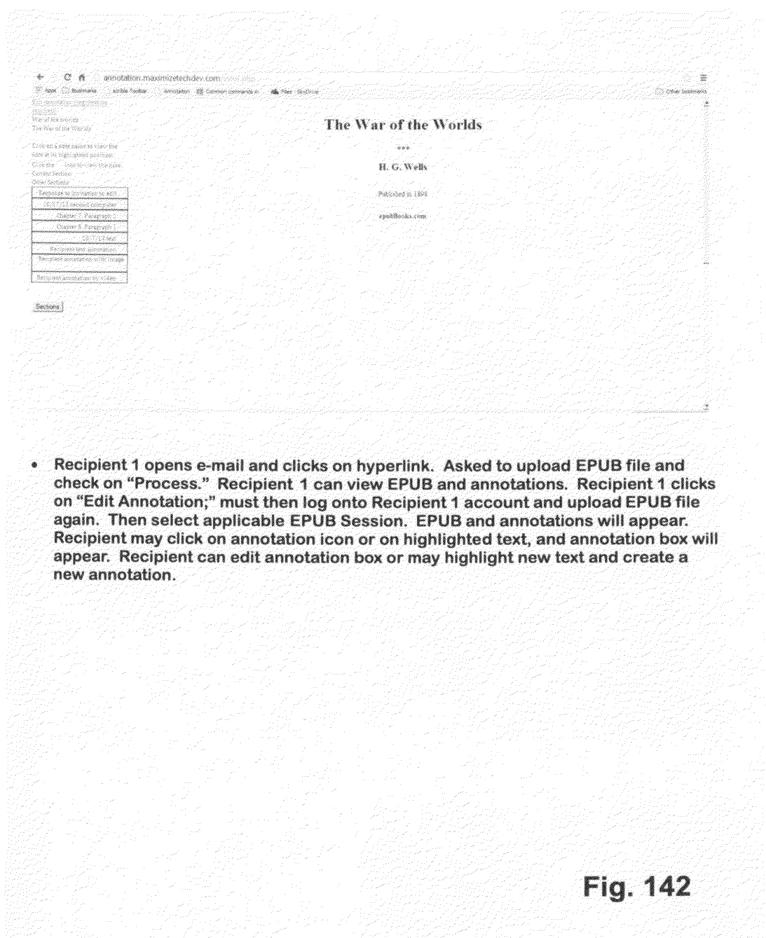

The Flowchart entitled Annotation Shared EPUB Display at FIGS. 216/217 enables a recipient to choose to view or to register onto an account owner's session in EPUB content. When the recipient clicks on the “Edit Annotation (registration required)” (FIG. 113 and FIG. 123 for EPUB no chapters) (FIG. 142 for EPUB chapters) the recipient is required, in the same manner as the account owner, to log on as illustrated in FIG. 2. And to select a session, select “Choose File” to locate the EPUB file and “Process” to upload it, as illustrated in FIG. 3. Thereafter, the Shared Annotation session (FIGS. 114 to 135) is displayed and the Annotation Edit feature (FIG. 215) is available as well as Annotation Add (FIG. 49), and viewing (FIGS. 213 and 214) described above. For EPUB no chapters, illustrations where the recipient 1 edits various combinations of text, image and video are illustrated in FIGS. 114 to 122 as viewed by the account owner. Illustrations of a new annotation created by the recipient 1 in the form of text, image or video are at FIGS. 124, 125 and 126, respectively as viewed by the account owner. Illustrations of an edit in text, image or video added by the second recipient are at FIGS. 127, 128 and 129, respectively. As viewed by the account owner. Illustrations of annotations of text, image and video added by the second recipient are at FIGS. 130, 131 and 132, respectively, as viewed by the account owner Illustrations of the account owner's edit of text, image or video to the recipient's edit or annotation are at FIGS. 133, 134 and 135, respectively, as viewed by the account owner.

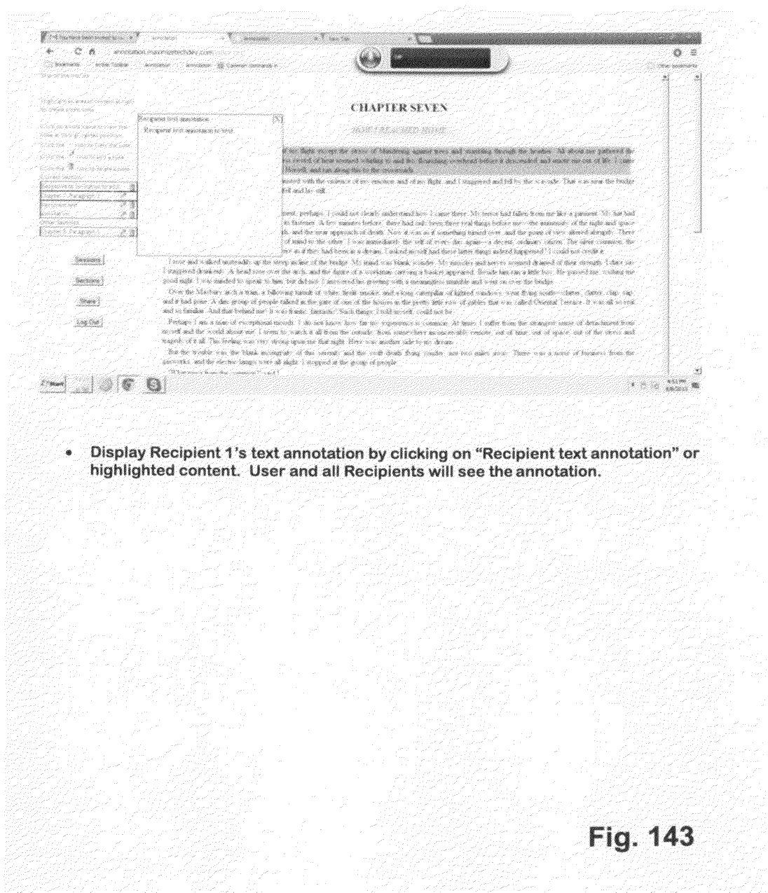

For EPUB chapters, only illustrations of the recipient 1 new annotations of text, image and video are displayed in FIGS. 143, 144 and 145, respectively, since the functions are the same as above when EPUB no chapters registration is selected.

Referring to FIGS. 216 and 217, the system checks in steps 370, 372 374 and 376 whether the “Sections” button 378 (FIG. 113) or the view Annotation button 354 has been selected. If the “Sections” button is selected, a dialog box appears with a choice to select a section of the epub file, as indicated by step 380. IF the recipient selects a section of the epub file as determined in step 382, the selected section of the epub file is displayed with any comments in step 384. The system also checks whether the close button, i.e. X, has been selected in step 386. If so, the system returns to step 370 and waits.

The system also checks whether the view annotation button 354 is selected. If so, all of the annotations from the user and other recipients are viewable although not editable, as discussed above, as indicated in step 388. In addition, a close button is displayed next to the annotation label. If the Annotation button 354 is selected, the system waits for the annotation page to be closed by the close link, as indicated in step 390. The system then returns to step 370 and waits.

If the “Edit Annotation” button 356 (FIG. 113) was selected, the system determines whether the recipient is logged in step 392. If the recipient is not logged in, the log-in page is displayed in step 394. The system waits in step 398 for the user to log in. Once the recipient logs in, the shared annotation session is displayed.

If the recipient is already logged in, the recipient is directed to the annotation session in edit mode, as indicated in step 396.

### Hyperlink Footnote

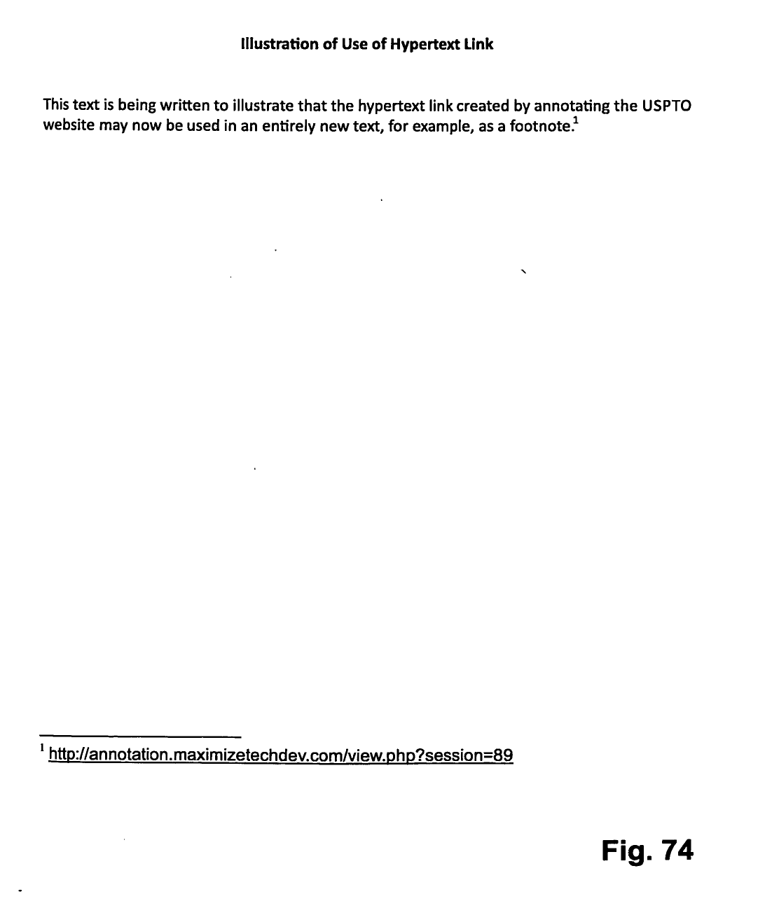

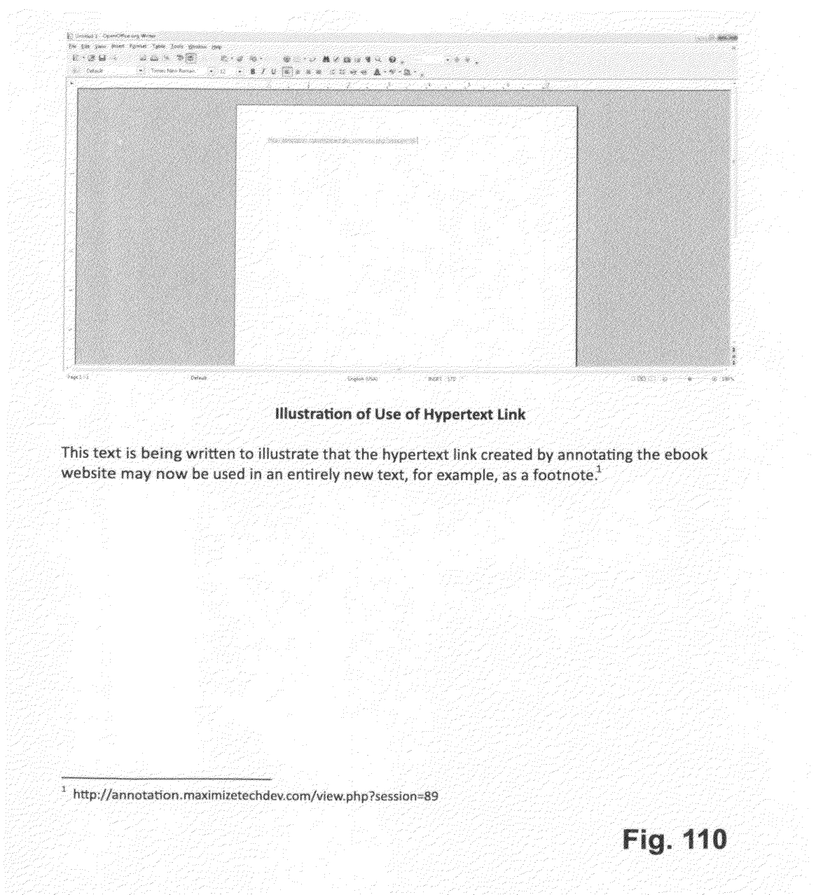

Whenever an account owner or recipient shares annotations with a recipient a hyperlink is created and is emailed to the recipient. The hyperlink can be utilize separately by the account owner or recipient as a form of a footnote to unrelated, new digital text being written by the account owner or recipient. This feature is illustrated for Web Page content in FIG. 74 and, EPUB content in FIG. 110.

Obviously, many modifications and variations of the present invention are possible in light of the above teachings. Thus, it is to be understood that within the scope of the appended claims, the invention may be practiced otherwise than as specifically described above.

What is claimed and desired to be secured by a Letters Patent of the United States is:

1. A method of sharing electronic annotations with, and among, multiple users, the method comprising the steps of
creating an overlay with annotations of text, pictures, or videos spatially registered with digital content,
transferring the overlay to a recipient without the underlying digital content, and
integrating the annotations with the digital content at spatially registered sites for viewing by each user and recipient who has the legal right to access the underlying digital content.
